(19) United States
(12) Patent Application Publication
(10) Pub. No.: US 2010/0117908 A2
(43) Pub. Date: May 13, 2010

(54) MULTI-METAMATERIAL-ANTENNA SYSTEMS WITH DIRECTIONAL COUPLERS

(75) Inventors: Cheng-Jung Lee, San Diego, CA (US); Ajay Gummalla, San Diego, CA (US); Maha Achour, San Diego, CA (US); Vaneet Pathak, San Diego, CA (US)

Correspondence Address: Rayspan Corporation, 11975 El Camino Real, Suite 301, San Diego, CA, 92130, UNITED STATES, 858-259-9596, akiko@rayspan.com

(73) Assignee: Rayspan Corporation, San Diego, CA (US)

(21) Appl. No.: 12/340,657

(22) Filed: Dec. 20, 2008

Related U.S. Application Data
(60) Provisional application No. 61/016,392, filed on Dec. 21, 2007.
(60) Provisional application No. 61/054,101, filed on May 16, 2008.
(60) Provisional application No. 61/098,730, filed on Sep. 18, 2008.
(60) Provisional application No. 61/098,731, filed on Sep. 18, 2008.

(51) Int. Cl. H01Q 1/38

(52) U.S. Cl. 343/700 MS

(57) ABSTRACT

Examples of apparatus and techniques for providing metamaterial (MTM) multi-antenna array systems with directional couplers for various applications.

### PRIORITY CLAIMS AND RELATED APPLICATIONS

This document claims the benefits of the following four U.S. Provisional Patent Applications:

1. Ser. No. 61/016,392 entitled “Advanced Metamaterial Multi-Antenna Subsystems” and filed on Dec. 21, 2007;

2. Ser. No. 61/054,101 entitled “Metamaterial Antenna with Multiple Antenna Elements for Dual-Band Operations” and filed on May 16, 2008;

3. Ser. No. 61/098,730 entitled “Advanced Metamaterial Multi-Antenna System” and filed on Sep. 19, 2008; and

4. Ser. No. 61/098,731 entitled “Multi-Band Multi-Antenna System” and filed on Sep. 19, 2008.

The entire disclosures of the above applications are incorporated by reference as part of the disclosure of this document.

### BACKGROUND

The propagation of electromagnetic waves in most materials obeys the right handed rule for the (E,H,β) vector fields, where E is the electrical field, β is the magnetic field, and β is the wave vector. The phase velocity direction is the same as the direction of the signal energy propagation (group velocity) and the refractive index is a positive number. Such materials are “right handed” (RH). Most natural materials are RH materials. Artificial materials can also be RH materials.

A metamaterial (MTM) has an artificial structure. When designed with a structural average unit cell size p much smaller than the wavelength of the electromagnetic energy guided by the metamaterial, the metamaterial can behave like a homogeneous medium to the guided electromagnetic energy. Unlike RH materials, a metamaterial can exhibit a negative refractive index with permittivity ∈ and permeability p being simultaneously negative, and the phase velocity direction is opposite to the direction of the signal energy propagation where the relative directions of the (E,H,β) vector fields follow the left handed rule. Metamaterials that support only a negative index of refraction with permittivity ∈ and permeability μ being simultaneously negative are pure “left handed” (LH) metamaterials.

Many metamaterials are mixtures of LH metamaterials and RH materials and thus are Composite Left and Right Handed (CRLH) metamaterials. A CRLH metamaterial can behave like a LH metamaterial at low frequencies and a RH material at high frequencies. Designs and properties of various CRLH metamaterials are described in, Caloz and Itoh, “Electromagnetic Metamaterials: Transmission Line Theory and Microwave Applications,” John Wiley & Sons (2006). CRLH metamaterials and their applications in antennas are described by Tatsuo Itoh in “Invited paper: Prospects for Metamaterials,” Electronics Letters, Vol. 40, No. 16 (August, 2004).

CRLH metamaterials can be structured and engineered to exhibit electromagnetic properties that are tailored for specific applications and can be used in applications where it may be difficult, impractical or infeasible to use other materials. In addition, CRLH metamaterials may be used to develop new applications and to construct new devices that may not be possible with RH materials.

### SUMMARY

Examples of apparatus and techniques for providing metamaterial (MTM) multi-antenna array systems with directional couplers are described for various applications. In one aspect, such a system includes two or more MTM antennas spaced from one another and each MTM antenna includes at least one unit cell which includes a series inductor, a shunt capacitor, a shunt inductor, and a series capacitor that are structured to form a composite right and left handed (CRLH) MTM structure. This system includes an MTM directional coupler comprising MTM transmission lines that are coupled to the MTM antennas and each MTM transmission line transmits a signal to or receives a signal from a respective MTM antenna. Each MTM transmission line includes a transmission line section, a shunt inductor, and a series capacitor that are structured to form a CRLH MTM structure and that are configured relative to an adjacent MTM transmission line coupled to an adjacent MTM antenna to reduce coupling between adjacent MTM antennas. In one implementation of this system, each MTM antenna is structured to exhibit two different resonance frequencies, each being a frequency different from a harmonic frequency of the other. In another implementation, this system includes a signal filter coupled to an MTM transmission line of the MTM directional coupler to transmit a selective frequency while blocking other frequencies.

In another aspect, an MTM multi-antenna array system for decoupling N number of signals between N number of antennas is provided to include an N-element metamaterial (MTM) antenna array; and an N-way directional coupler coupled to the N-element MTM antenna array. The N-way directional coupler has 2N ports.

These and other aspects and various implementations and their variations are described in detail in the attached drawings, the detailed description and the claims.

### BRIEF DESCRIPTION OF THE DRAWINGS

FIG. 1 illustrates an example of a 1D CRLH MTM TL based on four unit cells.

FIG. 2 illustrates an equivalent circuit of the 1D CRLH MTM TL shown in FIG. 1.

FIG. 3 illustrates another representation of the equivalent circuit of the 1D CRLH MTM TL shown in FIG. 1.

FIG. 4A illustrates a two-port network matrix representation for the 1D CRLH TL equivalent circuit shown in FIG. 2.

FIG. 4B illustrates another two-port network matrix representation for the 1D CRLH TL equivalent circuit shown in FIG. 3.

FIG. 5 illustrates an example of a 1D CRLH MTM antenna based on four unit cells.

FIG. 6A illustrates a two-port network matrix representation for the 1D CRLH antenna equivalent circuit analogous to the TL case shown in FIG. 4A.

FIG. 6B illustrates another two-port network matrix representation for the 1D CRLH antenna equivalent circuit analogous to the TL case shown in FIG. 4B.

FIG. 7A illustrates an example of a dispersion curve for the balanced case.

FIG. 7B illustrates an example of a dispersion curve for the unbalanced case.

FIG. 8 illustrates an example of a 1D CRLH MTM TL with a truncated ground based on four unit cells.

FIG. 9 illustrates an equivalent circuit of the 1D CRLH MTM TL with the truncated ground shown in FIG. 8.

FIG. 10 illustrates an example of a 1D CRLH MTM antenna with a truncated ground based on four unit cells.

FIG. 11 illustrates another example of a 1D CRLH MTM TL with a truncated ground based on four unit cells.

FIG. 12 illustrates an equivalent circuit of the 1D CRLH MTM TL with the truncated ground shown in FIG. 11.

FIG. 13 illustrates a Multi-Antenna System comprising an N-element antenna array and an N-way directional coupler.

FIG. 14 illustrates an N-way directional coupler.

FIG. 15 illustrates an N-way metamaterial directional coupler.

FIG. 16 illustrates a configuration of the three-antenna system.

FIG. 17A illustrates a structure of a three-element metamaterial antenna array: top view of top layer.

FIG. 17B illustrates a structure of a three-element metamaterial antenna array: top view of bottom layer.

FIG. 18 illustrates a structure of a three-element metamaterial antenna array: 3-D view.

FIG. 19 illustrates simulated results of the three-element metamaterial antenna array shown in FIGS. 17A, 17B, and 18.

FIG. 20 illustrates a structure of the three-way directional coupler with six-ports: 3-D view.

FIG. 21 illustrates simulated results of the three-way directional coupler shown in FIG. 20 for the input signal at P1.

FIG. 22 illustrates simulated results of the three-way directional coupler shown in FIG. 20 for the input signal at P2.

FIG. 23A illustrates a three-antenna system: top view.

FIG. 23B illustrates a three-antenna system: bottom view.

FIG. 24 illustrates a structure of the three-antenna system: 3-D view.

FIG. 25 illustrates measured results of the three-antenna system shown in FIG. 24.

FIG. 26 illustrates measured radiation efficiencies for the three antennas in the three-antenna system shown in FIG. 24.

FIG. 27 illustrates a three-way MTM coupler.

FIG. 28 illustrates simulated results of the three-way MTM coupler shown in FIG. 27 for the input signal at P1.

FIG. 29 illustrates simulated results of the three-way MTM coupler shown in FIG. 27 for the input signal at P2.

FIG. 30 illustrates simulated results of the three-antenna system using three-way MTM coupler.

FIG. 31A illustrates an example of a multi-antenna system configuration.

FIG. 31B illustrates one implementation of the multi-antenna system configuration shown in FIG. 31A.

FIGS. 32A-32D illustrates an example of a multi-antenna system structure. A) 3-D view. B) Top view. C) Bottom view. D) Cross sectional view.

FIG. 33 illustrates the implementation of antenna array portion of the multi-antenna system structure shown in FIG. 31.

FIG. 34 illustrates an example of a microwave directional coupler that can be used in a multi-antenna system shown in FIG. 31.

FIG. 35 illustrates the return losses and isolation results of the metamaterial antenna array shown in FIG. 33.

FIG. 36 illustrates the return losses and isolation results of the multi-antenna system example shown in FIG. 32.

FIGS. 37A-37C illustrates the radiation patterns of the multi-antenna system shown in FIGS. 32A-32D. A) x-z plane. B) y-z plane. C) x-y plane.

FIGS. 38A-38B illustrates A) Fabricated multi-antenna system. B) Measured return losses and isolation for multi-antenna system example shown in FIGS. 32A-32D.

FIG. 39 illustrates the measured radiation efficiencies of multi-antenna system shown in FIGS. 32A-32D and metamaterial antenna array shown in FIG. 33.

FIGS. 40A-40D illustrates an example of a multi-antenna system A) 3-D view. B) Top view. C) Bottom view. C) Cross sectional view.

FIGS. 41A-41C illustrates various elements of an MTM coupler for the multi-antenna system shown in FIGS. 40A-40D.

FIG. 42 illustrates simulation results of the return losses and isolation of the multi-antenna system shown in FIGS. 40A-40D.

FIGS. 43A-43C illustrates radiation patterns of the multi-antenna system shown in FIG. 40A-40D A) x-z plane. B) y-z plane. C) x-y plane.

FIGS. 44A-44C illustrates A) Fabricated multi-antenna system shown in FIGS. 40A-40D. B) Fabricated MTM coupler. C) Measured return losses and isolation for multi-antenna system Shown in FIGS. 40A-40D.

FIG. 45 illustrates the measured radiation efficiencies of multi-antenna system shown in FIGS. 40A-40D and metamaterial antenna array shown in FIG. 33.

FIGS. 46A-46D illustrates an example of a multi-antenna system structure. A) 3-D view. B) Top view. C) Bottom view. D) Cross sectional view.

FIGS. 47A-47C illustrates various elements of the metamaterial antenna array with a metamaterial transmission line feed.

FIG. 48 illustrates an example of the MTM coupler for multi-antenna system shown in FIGS. 46A-46D.

FIG. 49 illustrates the simulation results of the multi-antenna system shown in FIGS. 46A-46D.

FIGS. 50A-50C illustrates the radiation patterns of the multi-antenna system shown in FIGS. 46A-46D. A) x-z plane. B) y-z plane. C) x-y plane.

FIGS. 51A-51D illustrates a multi-antenna system structure. A) 3-D view. B) Top view. C) Bottom view. D) Cross sectional view.

FIGS. 52A-52C illustrates a configuration of the multi-antenna system for USB application in detail.

FIG. 53 illustrates an simulation results of the metamaterial antenna array shown in FIGS. 52A-52C without the CPW MTM coupler.

FIG. 54 illustrates a simulation results of the multi-antenna system shown in FIGS. 52A-52C.

FIGS. 55A-55C illustrates the radiation patterns of the multi-antenna system shown in FIGS. 52A-52C. A) x-z plane. B) y-z plane. C) x-y plane.

FIG. 56A-56B illustrates the use of the multi-antenna systems for a time division duplex application.

FIG. 57A illustrates a dualband multi-antenna system.

FIG. 57B illustrates one implementation of the dualband multi-antenna system shown in FIG. 57A.

FIGS. 58A-58C illustrates individual layers of one implementation of dualband multi-antenna system.

FIG. 59 illustrates simulated results of metamaterial antenna array shown in FIGS. 59A-59C.

FIGS. 60A-60B illustrates A) microwave directional coupler. B) simulation results of microwave directional coupler.

FIG. 61 illustrates simulation results of the dualband multi-antenna system shown in FIGS. 59A-59C.

FIG. 62 illustrates a dualband metamaterial antenna array.

FIGS. 63A-63B illustrates the dualband metamaterial antenna array A) Top View of Top Layer. B) Top View of Bottom Layer.

FIGS. 64A-64B illustrates simulation results of the dualband metamaterial antenna array shown in FIGS. 62, 63A-63B.

FIGS. 65A-65B illustrates A) a microwave directional coupler. B) simulation results of the microwave directional coupler.

FIGS. 66A-66B illustrates A) a dualband multi-antenna system. B) simulation results of the dualband multi-antenna system.

FIGS. 67A-67B illustrates simulation results of one example of a metamaterial antenna array.

FIGS. 68A-68B illustrates an equivalent circuit model of a metamaterial transmission line which is implemented by cascading N unit cells periodically.

FIG. 69 illustrates an equivalent circuit model of MTM coupler.

FIG. 70 illustrates simulation results the MTM coupler.

FIG. 71 illustrates simulation results the dualband multi-antenna System using MTM coupler shown in FIG. 69.

FIGS. 72A-72E illustrates a metamaterial antenna array. A) Layer1. B) Layer2. C) Layer3. D) Layer4. E) Four-Layer FR-4.

FIG. 73 illustrates a 3D view of the metamaterial Antenna Array shown in FIGS. 72A-72E.

FIG. 74 illustrates measurement results of the metamaterial antenna array shown in FIGS. 72A-72E and FIG. 73.

FIGS. 75A-75E illustrates a vertical directional coupler A) Layer1. B) Layer2. C) Layer3. D) Layer4. E) Four-Layer FR-4.

FIG. 76 illustrates simulation results of the vertical directional coupler shown in FIGS. 75A-75E.

FIGS. 77A-77E illustrates a dualband multi-antenna system using vertical directional coupler A) Layer1. B) Layer2. C) Layer3. D) Layer4. E) Four-Layer FR-4.

FIG. 78 illustrates measurement results of the dualband multi-antenna system shown in FIGS. 77A-77E.

FIGS. 79A-79B illustrates a MTM coupler with A) a LC network connecting in between two metamaterial transmission lines. B) a series capacitor and a series inductor connecting in between two metamaterial transmission lines.

FIGS. 80A-80C illustrates multiple views of the small dualband multi-antenna system which have two metamaterial antennas and a MTM coupler in which A) represents layer 1, B) represents layer 2, and C) cross section view of layers 1 and 2 and substrate.

FIG. 81 illustrates the simulated return losses and coupling of the small dualband multi-antenna system shown in FIGS. 80A-80C.

FIGS. 82A-82D illustrates A) Generalized circuit model of a FW MTM coupler. B) Generalized circuit model of the FW MTM coupler with two parallel metamaterial transmission lines. C) Planar FW MTM coupler. D) Generalized circuit model of a asymmetric FW MTM coupler.

FIGS. 83A-83D illustrates a vertical FW MTM coupler A) view of overlapping top layer and bottom layer. B) side view. C) top view of bottom layer. D) top view of top layer.

FIGS. 84A-84C illustrates simulation results of the planar FW MTM coupler with C_{L1} variation.

FIGS. 85A-85C illustrates simulation results of the planar FW MTM coupler with Lₘ₁ variation.

FIG. 86 illustrates simulation results of the vertical FW MTM coupler shown in FIGS. 83A-83D.

FIGS. 87A-87B illustrates a dualband multi-antenna system A) top view. B) 3D view.

FIGS. 88A-88C illustrates a vertical FW MTM coupler A) top view of overlapping layer1, layer2, layer3 and layer4. B) side view. C) more details of side view.

FIGS. 89A-89D illustrates individual layers of vertical FW MTM directional coupler A) Layer 1. B) Layer 2. C) Layer 3. D) Layer 4.

FIG. 90 illustrates simulation results of the vertical FW MTM coupler.

FIGS. 91A-91C illustrates a metamaterial antenna array A) top view of overlapping top layer and bottom layer. B) top view of top layer. C) top view of bottom layer.

FIG. 92 illustrates simulation results of the MTM antenna array shown in FIGS. 91A-91C.

FIG. 93 illustrates simulation results of the dualband multi-antenna system shown in FIGS. 87A-87B.

FIG. 94 illustrates a multi-band multi-antenna system.

FIGS. 95A-95F illustrates metamaterial WiFi and WiMax antenna array with A) top view of substrate I. B) bottom view substrate I. C) top view of substrate II. D) bottom view of substrate II. E) top view of substrate III. F) bottom view of substrate III.

FIG. 96 illustrates a 3D view of the metamaterial WiFi and WiMax antenna array.

FIG. 97 illustrates simulated results of the metamaterial WiFi and WiMax antenna array shown in FIGS. 95A-95F and FIG. 96.

FIG. 98 illustrates a microwave coupled line coupler.

FIG. 99 illustrates simulated results of the microwave coupled line coupler shown in FIG. 98.

FIG. 100 illustrates simulated results of the multi-band multi-antenna system with the microwave coupled line coupler.

FIG. 101 illustrates a MTM coupler.

FIG. 102 illustrates simulated results of the MTM coupler shown in FIG. 101.

FIG. 103 illustrates simulated results of the multi-band multi-antenna system with the MTM coupler.

FIG. 104 illustrates a multi-band multi-antenna system with bandpass filters.

FIGS. 105A-105B illustrates A) a Chebyshev WiFi bandpass filter (prototype). B) a Chebyshev WiMax bandpass filter (prototype).

FIG. 106 illustrates simulated results of the Chebyshev WiFi and WiMax bandpass filters shown in FIGS. 105A-105B.

FIG. 107 illustrates simulated results of the multi-band multi-antenna system shown in FIG. 104.

FIG. 108 illustrates a multi-band multi-antenna system with a directional coupler and a bandpass filters.

FIG. 109 illustrates simulated results of the multi-band multi-antenna system with microwave coupled line coupler and bandpass filter.

FIG. 110 illustrates simulated results of the multi-band multi-antenna system with metamaterial directional coupler and bandpass filters.

In the appended figures, similar components and/or features may have the same reference numeral. Further, various components of the same type may be distinguished by following the reference numeral by a dash and a second label that distinguishes among the similar components. If only the first reference numeral is used in the specification, the description is applicable to any one of the similar components having the same first reference numeral.

### DETAILED DESCRIPTION

Metamaterial (MTM) structures can be used to construct antennas and other electrical components and devices, allowing for a wide range of technology advancements such as size reduction and performance improvements. The MTM antenna structures can be fabricated on various circuit platforms, for example, a conventional FR-4 Printed Circuit Board (PCB) or a Flexible Printed Circuit (FPC) board. Examples of other fabrication techniques include thin film fabrication technique, system on chip (SOC) technique, low temperature co-fired ceramic (LTCC) technique, and monolithic microwave integrated circuit (MMIC) technique.

Exemplary MTM antenna structures are described in U.S. patent application Ser. No. 11/741,674 entitled “Antennas, Devices, and Systems Based on Metamaterial Structures,” filed on Apr. 27, 2007, and U.S. patent application Ser. No. 11/844,982 entitled “Antennas Based on Metamaterial Structures,” filed on Aug. 24, 2007, which are hereby incorporated by reference as part of the disclosure of this document.

An MTM antenna or MTM transmission line (TL) is a MTM structure with one or more MTM unit cells. The equivalent circuit for each MTM unit cell includes a right-handed series inductance (LR), a right-handed shunt capacitance (CR), a left-handed series capacitance (CL), and a left-handed shunt inductance (LL). LL and CL are structured and connected to provide the left-handed properties to the unit cell. This type of CRLH TLs or antennas can be implemented by using distributed circuit elements, lumped circuit elements or a combination of both. Each unit cell is smaller than ˜λ/4 where λ is the wavelength of the electromagnetic signal that is transmitted in the CRLH TL or antenna.

A pure LH metamaterial follows the left-hand rule for the vector trio (E,H,β), and the phase velocity direction is opposite to the signal energy propagation. Both the permittivity ∈ and permeability μ of the LH material are negative. A CRLH metamaterial can exhibit both left-hand and right-hand electromagnetic modes of propagation depending on the regime or frequency of operation. Under certain circumstances, a CRLH metamaterial can exhibit a non-zero group velocity when the wavevector of a signal is zero. This situation occurs when both left-hand and right-hand modes are balanced. In an unbalanced mode, there is a bandgap in which electromagnetic wave propagation is forbidden. In the balanced case, the dispersion curve does not show any discontinuity at the transition point of the propagation constant β(ωₒ)=0 between the left- and right-hand modes, where the guided wavelength is infinite, i.e., λ_{g}=2π/|β|→∞, while the group velocity is positive:

$${{v}_{g} = \frac{ⅆ ω}{ⅆ β} \vert}_{β = 0} > 0.$$

This state corresponds to the zeroth order mode m=0 in a TL implementation in the LH region. The CRHL structure supports a fine spectrum of low frequencies with the dispersion relation that follows the negative β parabolic region. This allows a physically small device to be built that is electromagnetically large with unique capabilities in manipulating and controlling near-field radiation patterns. When this TL is used as a Zeroth Order Resonator (ZOR), it allows a constant amplitude and phase resonance across the entire resonator. The ZOR mode can be used to build MTM-based power combiners and splitters or dividers, directional couplers, matching networks, and leaky wave antennas.

In the case of RH TL resonators, the resonance frequency corresponds to electrical lengths θₘ=βₘl=mπ (m=1, 2, 3 . . . ), where l is the length of the TL. The TL length should be long to reach low and wider spectrum of resonant frequencies. The operating frequencies of a pure LH material are at low frequencies. A CRLH MTM structure is very different from an RH or LH material and can be used to reach both high and low spectral regions of the RF spectral ranges. In the CRLH case θₘ=βₘl=mπ, where 1 is the length of the CRLH TL and the parameter m=0, ±1, ±2, ±3 . . . ±∞.

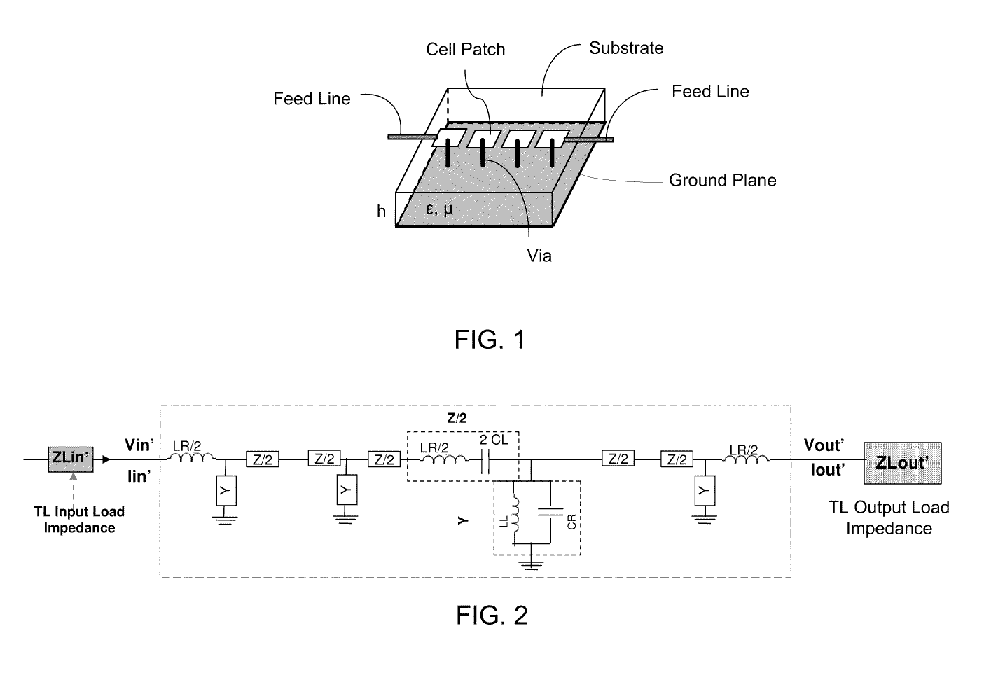

FIG. 1 illustrates an example of a 1D CRLH MTM TL based on four unit cells. One unit cell includes a cell patch and a via, and is a minimum unit that repeats itself to build the MTM structure. The four cell patches are placed on a substrate with respective centered vias connected to the ground plane.

FIG. 2 shows an equivalent network circuit of the 1D CRLH MTM TL in FIG. 1. The ZLin′ and ZLout′ correspond to the TL input load impedance and TL output load impedance, respectively, and are due to the TL coupling at each end. This is an example of a printed two-layer structure. LR is due to the cell patch on the dielectric substrate, and CR is due to the dielectric substrate being sandwiched between the cell patch and the ground plane. CL is due to the presence of two adjacent cell patches, and the via induces LL.

Each individual unit cell can have two resonances ω_{SE} and ω_{SH} corresponding to the series (SE) impedance Z and shunt (SH) admittance Y. In FIG. 2, the Z/2 block includes a series combination of LR/2 and 2CL, and the Y block includes a parallel combination of LL and CR. The relationships among these parameters are expressed as follows:

$${ω}_{SH} = \frac{1}{\sqrt{LL CR}} ; {ω}_{SE} = \frac{1}{\sqrt{LR CL}} ; {ω}_{R} = \frac{1}{\sqrt{LR CR}} ; \\ {ω}_{L} = \frac{1}{\sqrt{LL CL}} where , Z = j ω LR + \frac{1}{j ω CL} and Y = j ω CR + \frac{1}{j ω LL} \qquad Eq . ( 1 )$$

The two unit cells at the input/output edges in FIG. 1 do not include CL, since CL represents the capacitance between two adjacent cell patches and is missing at these input/output edges. The absence of the CL portion at the edge unit cells prevents ω_{SE} frequency from resonating. Therefore, only ω_{SH} appears as an m=0 resonance frequency.

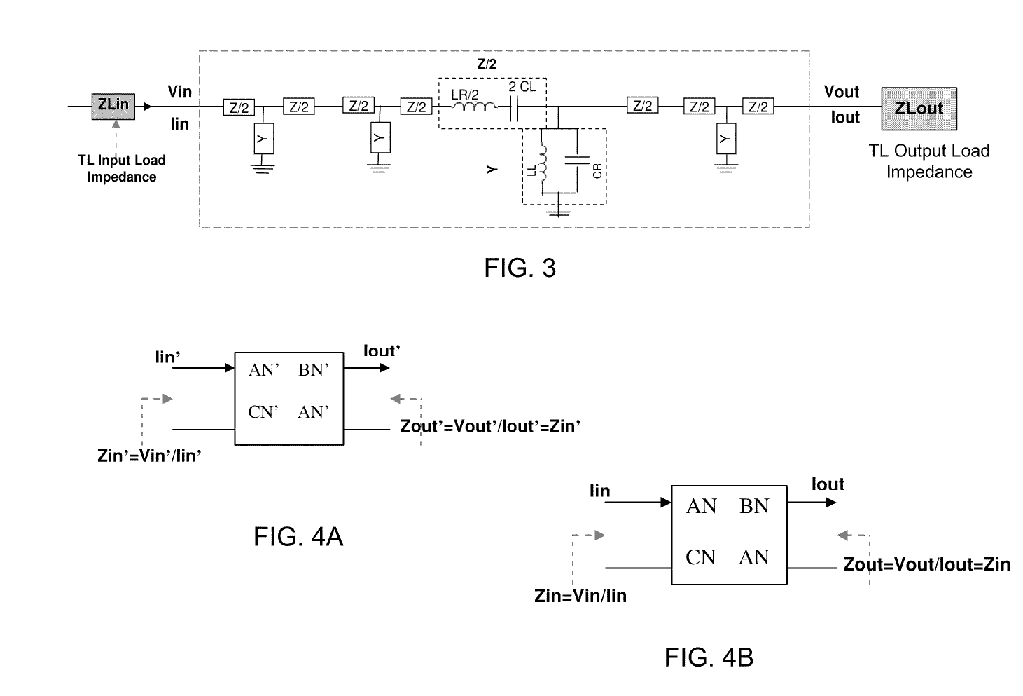

To simplify the computational analysis, a portion of the ZLin′ and ZLout′ series capacitor is included to compensate for the missing CL portion, and the remaining input and output load impedances are denoted as ZLin and ZLout, respectively, as seen in FIG. 3. Under this condition, all unit cells have identical parameters as represented by two series Z/2 blocks and one shunt Y block in FIG. 3, where the Z/2 block includes a series combination of LR/2 and 2CL, and the Y block includes a parallel combination of LL and CR.

FIG. 4A and FIG. 4B illustrate a two-port network matrix representation for TL circuits without the load impedances as shown in FIG. 2 and FIG. 3, respectively,

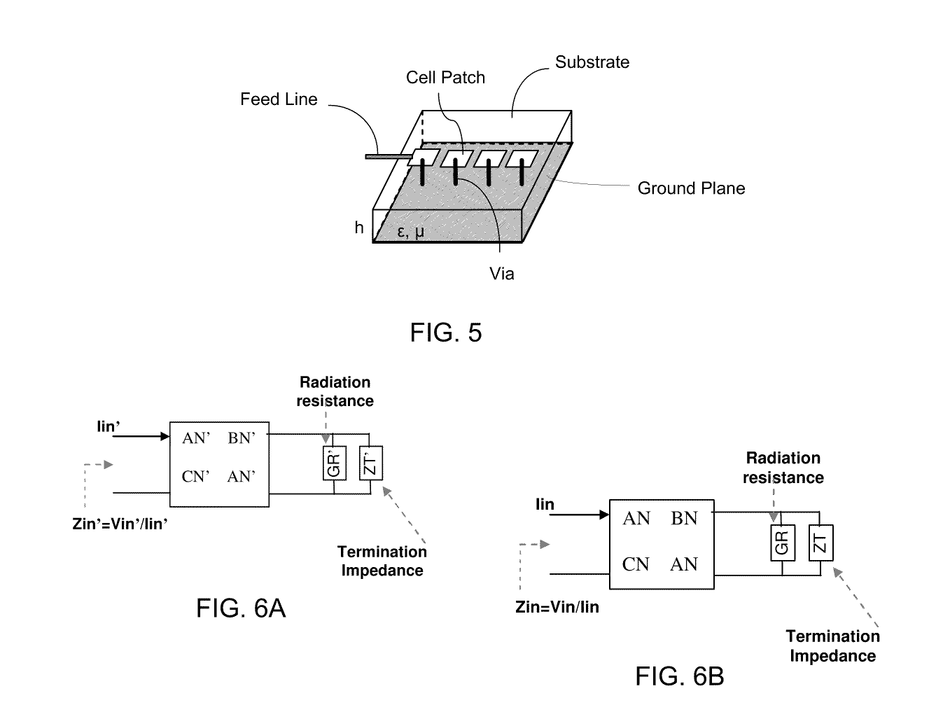

FIG. 5 illustrates an example of a 1D CRLH MTM antenna based on four unit cells. FIG. 6A shows a two-port network matrix representation for the antenna circuit in FIG. 5. FIG. 6B shows a two-port network matrix representation for the antenna circuit in FIG. 5 with the modification at the edges to account for the missing CL portion to have all the unit cells identical. FIGS. 6A and 6B are analogous to the TL circuits shown in FIGS. 4A and 4B, respectively.

In matrix notations, FIG. 4B represents the relationship given as below:

$$( \begin{matrix}Vin \\ Iin\end{matrix} ) = ( \begin{matrix}AN & BN \\ CN & AN\end{matrix} ) ( \begin{matrix}Vout \\ Iout\end{matrix} ) \qquad Eq . ( 2 )$$

where AN=DN because the CRLH MTM TL circuit in FIG. 3 is symmetric when viewed from Vin and Vout ends.

In FIGS. 6A and 6B, the parameters GR′ and GR represent a radiation resistance, and the parameters ZT′ and ZT represent a termination impedance. Each of ZT′, ZLin′ and ZLout′ includes a contribution from the additional 2CL as expressed below:

$${ZLin}^{′} = ZLin + \frac{2}{j ω CL} , \\ {ZLout}^{′} = ZLout + \frac{2}{j ω CL} , \\ {ZT}^{′} = ZT + \frac{2}{j ω CL} \qquad Eq . ( 3 )$$

Since the radiation resistance GR or GR′ can be derived by either building or simulating the antenna, it may be difficult to optimize the antenna design. Therefore, it is preferable to adopt the TL approach and then simulate its corresponding antennas with various terminations ZT. The relationships in Eq. (1) are valid for the circuit in FIG. 2 with the modified values AN′, BN′, and CN′, which reflect the missing CL portion at the two edges.

The frequency bands can be determined from the dispersion equation derived by letting the N CRLH cell structure resonate with nπ propagation phase length, where n=0, ±1, ±2, . . . ±N. Here, each of the N CRLH cells is represented by Z and Y in Eq. (1), which is different from the structure shown in FIG. 2, where CL is missing from end cells. Therefore, one might expect that the resonances associated with these two structures are different. However, extensive calculations show that all resonances are the same except for n=0, where both ω_{SE} and ω_{SH} resonate in the structure in FIG. 3, and only ω_{SH} resonates in the structure in FIG. 2. The positive phase offsets (n>0) correspond to RH region resonances and the negative values (n<0) are associated with LH region resonances.

The dispersion relation of N identical CRLH cells with the Z and Y parameters is given below:

$$\{ \begin{matrix}N β p = {cos}^{- 1} ( {A}_{N} ) , ⇒ \vert {A}_{N} \vert \leq 1 ⇒ 0 \leq χ = - ZY \leq 4 ∀ N \\ \begin{matrix}where {A}_{ N} = 1 at even resonances \\ \vert n \vert = 2 m ∈ \{ \begin{matrix}0 , 2 , 4 , … 2 \times \\ Int ( \frac{N - 1}{ 2} )\end{matrix} \}\end{matrix} \\ \begin{matrix}and {A}_{ N} = - 1 at odd resonances \\ \vert n \vert = 2 m + 1 ∈ \{ 1 , 3 , … ( 2 \times Int ( \frac{N}{ 2} ) - 1 ) \} ,\end{matrix} \end{matrix} \qquad Eq . ( 4 )$$

where Z and Y are given in Eq. (1), AN is derived from the linear cascade of N identical CRLH unit cells as in FIG. 3, and p is the cell size. Odd n=(2 m+1) and even n=2 m resonances are associated with AN=−1 and AN=1, respectively. For AN′ in FIG. 4A and FIG. 6A, the n=0 mode resonates at ω₀=ω_{SH} only and not at both ω_{SE} and ω_{SH} due to the absence of CL at the end cells, regardless of the number of cells. Higher-order frequencies are given by the following equations for the different values of χ specified in Table 1:

$$For n > 0 , {ω}_{\pm n}^{2} = \frac{{ω}_{ SH}^{ 2} + {ω}_{ SE}^{ 2} + χ {ω}_{ R}^{ 2}}{2} \pm \sqrt{\begin{matrix}{( \frac{{ω}_{SH}^{2} + {ω}_{SE}^{2} + χ {ω}_{R}^{2}}{2} )}^{2} - \\ {ω}_{SH}^{2} {ω}_{SE}^{2}\end{matrix}} \qquad Eq . ( 5 )$$

Table 1 provides χ values for N=1, 2, 3, and 4. It should be noted that the higher-order resonances |n|>0 are the same regardless if the full CL is present at the edge cells (FIG. 3) or absent (FIG. 2). Furthermore, resonances close to n=0 have small χ values (near χ lower bound 0), whereas higher-order resonances tend to reach χ upper bound 4 as stated in Eq. (4).

TABLE 1
Resonances for N = 1, 2, 3 and 4 cells

| N\Modes | \|n\| = 0 | \|n\| = 1 | \|n\| = 2 | \|n\| = 3 |
|---|---|---|---|---|
| N = 1 | χ_{(1,0)} = 0; ω₀ = ω_{SH} | | | |
| N = 2 | χ_{(2,0)} = 0; ω₀ = ω_{SH} | χ_{(2,1)} = 2 | | |
| N = 3 | χ_{(3,0)} = 0; ω₀ = ω_{SH} | χ_{(3,1)} = 1 | χ_{(3,2)} = 3 | |
| N = 4 | χ_{(4,0)} = 0; ω₀ = ω_{SH} | χ_{(4,1)} = 2 − \sqrt{2} | χ_{(4,2)} = 2 | |

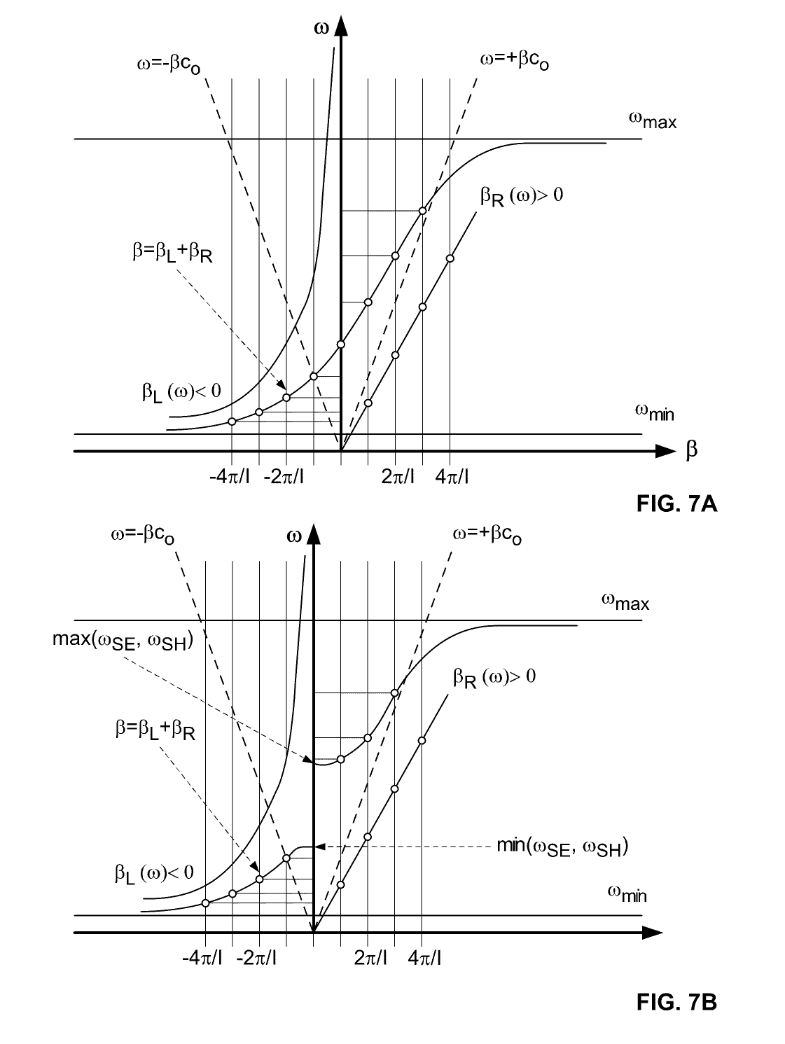

The dispersion curve β as a function of frequency ω is illustrated in FIGS. 7A and 7B for the ω_{SE}=ω_{SH} (balanced, i.e., LR CL=LL CR) and ω_{SE}≠ω_{SH} (unbalanced) cases, respectively. In the latter case, there is a frequency gap between min(ω_{SE}, ω_{SH}) and max(ω_{SE}, ω_{SH}). The limiting frequencies ωₘᵢₙ and ωₘₐₓ values are given by the same resonance equations in Eq. (5) with χ reaching its upper bound χ=4 as stated in the following equations:

$${ω}_{min}^{2} = \frac{{ω}_{SH}^{2} + {ω}_{SE}^{2} + 4 {ω}_{R}^{2}}{2} - \sqrt{\begin{matrix}{( \frac{{ω}_{SH}^{2} + {ω}_{SE}^{2} + 4 {ω}_{R}^{2}}{2} )}^{2} - \\ {ω}_{SH}^{2} {ω}_{SE}^{2}\end{matrix}} \\ {ω}_{max}^{2} = \frac{{ω}_{SH}^{2} + {ω}_{SE}^{2} + 4 {ω}_{R}^{2}}{2} + \sqrt{\begin{matrix}{( \frac{{ω}_{SH}^{2} + {ω}_{SE}^{2} + 4 {ω}_{R}^{2}}{2} )}^{2} - \\ {ω}_{SH}^{2} {ω}_{SE}^{2}\end{matrix}} \qquad ( 6 )$$

In addition, FIGS. 7A and 7B provide examples of the resonance position along the dispersion curves. In the RH region (n>0) the structure size 1=Np, where p is the cell size, increases with decreasing frequency. In contrast, in the LH region, lower frequencies are reached with smaller values of Np, hence size reduction. The dispersion curves provide some indication of the bandwidth around these resonances. For instance, LH resonances have the narrow bandwidth because the dispersion curves are almost flat. In the RH region, the bandwidth is wider because the dispersion curves are steeper. Thus, the first condition to obtain broadbands, 1^{st} BB condition, can be expressed as follows:

$$\begin{matrix}COND 1 \text{:} & \\ \begin{matrix}{1}^{st} BB condition {\vert \frac{ⅆ β}{ⅆ ω} \vert}_{res} = {\vert - \frac{\frac{ⅆ ( AN )}{ⅆ ω}}{\sqrt{( 1 - {AN}^{2} )}} \vert}_{res} << 1 near ω \\ = {ω}_{res} \\ = {ω}_{ 0} , {ω}_{\pm 1} , {ω}_{\pm 2} … ⇒ \vert \frac{ⅆ β}{ⅆ ω} \vert \\ = {\vert \frac{\frac{ⅆ χ}{ⅆ ω}}{2 p \sqrt{χ ( 1 - \frac{χ}{4} )}} \vert}_{res} << 1 with p \\ {= cell size and \frac{ⅆ χ}{ⅆ ω} \vert}_{res} \\ = \frac{2 {ω}_{\pm n}}{{ω}_{R}^{2}} ( 1 - \frac{{ω}_{SE}^{2} {ω}_{SH}^{2}}{{ω}_{\pm n}^{4}} )\end{matrix} & Eq . ( 7 )\end{matrix}$$

where χ is given in Eq. (4) and ω_{R} is defined in Eq. (1). The dispersion relation in Eq. (4) indicates that resonances occur when |AN|=1, which leads to a zero denominator in the 1^{st} BB condition (COND1) of Eq. (7). As a reminder, AN is the first transmission matrix entry of the N identical unit cells (FIG. 4B and FIG. 6B). The calculation shows that COND1 is indeed independent of N and given by the second equation in Eq. (7). It is the values of the numerator and χ at resonances, which are shown in Table 1, that define the slopes of the dispersion curves, and hence possible bandwidths. Targeted structures are at most Np=λ/40 in size with the bandwidth exceeding 4%. For structures with small cell sizes p, Eq. (7) indicates that high ω_{R} values satisfy COND1, i.e., low CR and LR values, since for n<0 resonances occur at χ values near 4 in Table 1, in other terms (1−χ/4→0).

As previously indicated, once the dispersion curve slopes have steep values, then the next step is to identify suitable matching. Ideal matching impedances have fixed values and may not require large matching network footprints. Here, the word “matching impedance” refers to a feed line and termination in the case of a single side feed such as in antennas. To analyze an input/output matching network, Zin and Zout can be computed for the TL circuit in FIG. 4B. Since the network in FIG. 3 is symmetric, it is straightforward to demonstrate that Zin=Zout. It can be demonstrated that Zin is independent of N as indicated in the equation below:

$${Zin}^{2} = \frac{BN}{CN} = \frac{B 1}{C 1} = \frac{Z}{Y} ( 1 - \frac{χ}{4} ) , \qquad Eq . ( 8 )$$

which has only positive real values. One reason that B1/C1 is greater than zero is due to the condition of |AN|≦L in Eq. (4), which leads to the following impedance condition:
0≦−ZY=χ≦4.
The 2^{nd} broadband (BB) condition is for Zin to slightly vary with frequency near resonances in order to maintain constant matching. Remember that the real input impedance Zin′ includes a contribution from the CL series capacitance as stated in Eq. (3). The 2^{nd} BB condition is given below:

$$\begin{matrix}COND 2 \text{:} & \\ {{2}^{ed} BB condition \text{:} near resonances , \frac{ⅆ Zin}{ⅆ ω} \vert}_{near res} << 1 & Eq . ( 9 )\end{matrix}$$

Different from the transmission line example in FIG. 2 and FIG. 3, antenna designs have an open-ended side with an infinite impedance which poorly matches the structure edge impedance. The capacitance termination is given by the equation below:

$${Z}_{T} = \frac{AN}{CN} , \qquad Eq . ( 10 )$$

which depends on N and is purely imaginary. Since LH resonances are typically narrower than RH resonances, selected matching values are closer to the ones derived in the n<0 region than the n>0 region.

To increase the bandwidth of LH resonances, the shunt capacitor CR should be reduced. This reduction can lead to higher ω_{R} values of steeper dispersion curves as explained in Eq. (7). There are various methods of decreasing CR, including but not limited to: 1) increasing substrate thickness, 2) reducing the cell patch area, 3) reducing the ground area under the top cell patch, resulting in a “truncated ground,” or combinations of the above techniques.

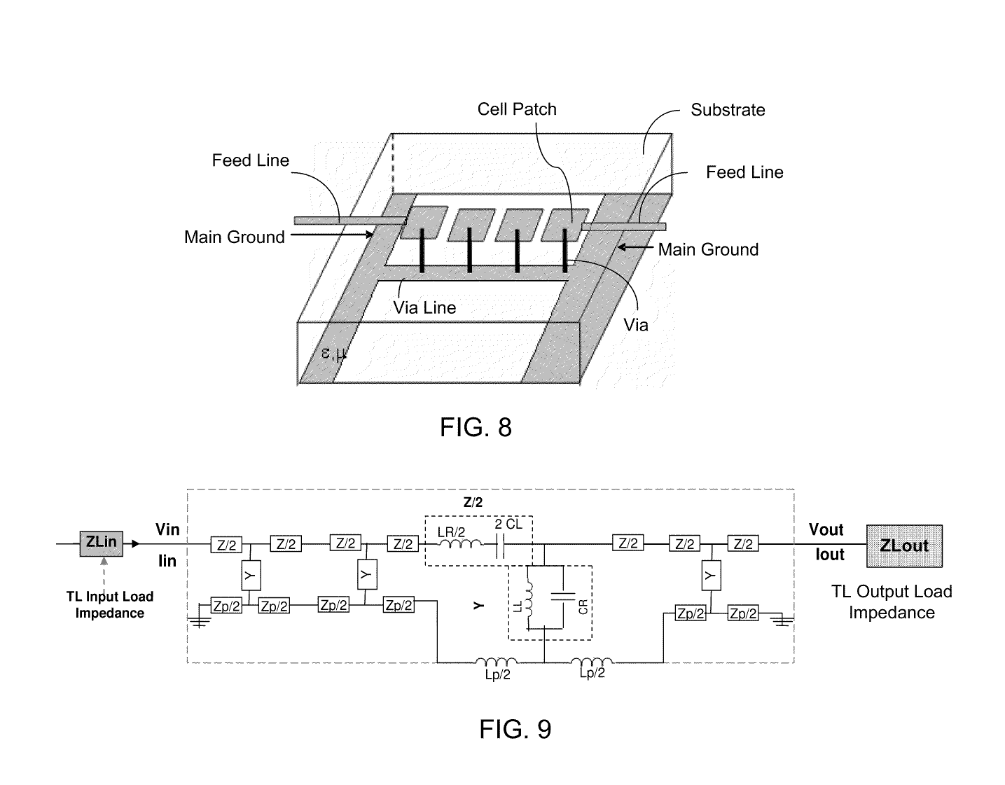

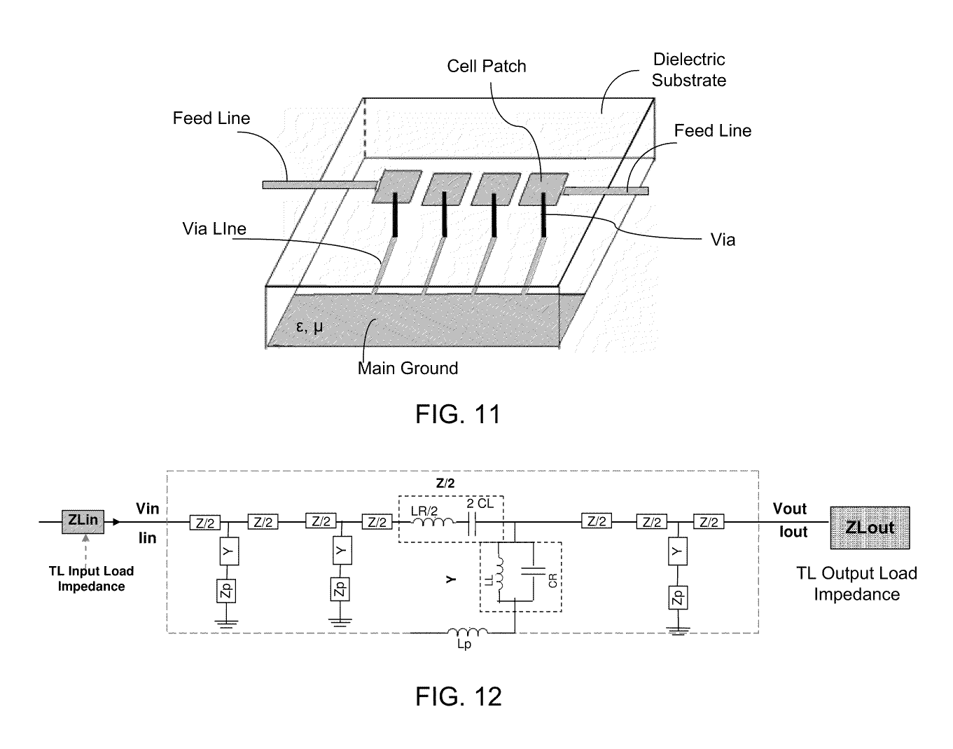

The structures in FIGS. 1 and 5 use a conductive layer to cover the entire bottom surface of the substrate as the full ground electrode. A truncated ground electrode that has been patterned to expose one or more portions of the substrate surface can be used to reduce the area of the ground electrode to less than that of the full substrate surface. This can increase the resonant bandwidth and tune the resonant frequency. Two examples of a truncated ground structure are discussed with reference to FIGS. 8 and 11, where the amount of the ground electrode in the area in the footprint of a cell patch on the ground electrode side of the substrate has been reduced, and a remaining strip line (via line) is used to connect the via of the cell patch to a main ground electrode outside the footprint of the cell patch. This truncated ground approach may be implemented in various configurations to achieve broadband resonances.

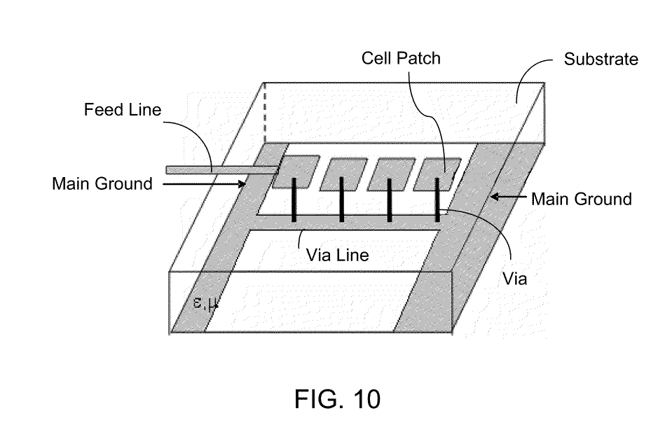

FIG. 8 illustrates one example of a truncated ground electrode for a four-cell transmission line where the ground has a dimension that is less than the cell patch along one direction underneath the cell patch. The ground conductive layer includes a via line that is connected to the vias and passes through underneath the cell patches. The via line has a width that is less than a dimension of the cell path of each unit cell. The use of a truncated ground may be a preferred choice over other methods in implementations of commercial devices where the substrate thickness cannot be increased or the cell patch area cannot be reduced because of the associated decrease in antenna efficiencies. When the ground is truncated, another inductor Lp (FIG. 9) is introduced by the metallization strip (via line) that connects the vias to the main ground as illustrated in FIG. 8. FIG. 10 shows a four-cell antenna counterpart with the truncated ground analogous to the TL structure in FIG. 8.

FIG. 11 illustrates another example of a truncated ground structure. In this example, the ground conductive layer includes via lines and a main ground that is formed outside the footprint of the cell patches. Each via line is connected to the main ground at a first distal end and is connected to the via at a second distal end. The via line has a width that is less than a dimension of the cell path of each unit cell.

The equations for the truncated ground structure can be derived. In the truncated ground examples, CR becomes very small, and the resonances follow the same equations as in Eqs. (1), (5) and (6) and Table 1 as explained below:

Approach 1 (FIGS. 8 and 9)

Resonances: same as in Eqs. (1), (5) and (6) and Table 1 after replacing LR by LR+Lp.

Furthermore, for |n|≠0, each mode has two resonances corresponding to

(1) ω±n for LR being replaced by LR+Lp
(2) ω±n for LR being replaced by LR+Lp/N where N is the number of cells
The impedance equation becomes:

$${Zin}^{2} = \frac{BN}{CN} = \frac{B 1}{C 1} = \frac{Z}{Y} ( 1 - \frac{χ + {χ}_{P}}{4} ) \frac{( 1 - χ - {χ}_{P} )}{( 1 - χ - {χ}_{P} / N )} , \\ where χ = - YZ and χ = - {YZ}_{p} , \\ where Zp = j ω Lp and Z , Y are defined in Eq . ( 2 ) . \qquad Eq . ( 11 )$$

From the impedance equation in Eq. (11), it can be seen that the two resonances ω and ω′ have low and high impedances, respectively. Thus, it is easy to tune near the ω resonance in most cases.
Approach 2 (FIGS. 11 and 12)
Resonances: same as in Eqs. (1), (5), and (6) and Table 1 after replacing LL by LL+Lp.
In the second approach, the combined shunt inductor (LL+Lp) increases while the shunt capacitor CR decreases, which leads to lower LH frequencies.

Modern wireless communication systems use multiple antennas to improve the performance namely, capacity, reliability or coverage. Receive diversity, beam-switching and Multiple-Input-Multiple-Output (MIMO) systems are a few examples of communication systems that can benefit from such advanced multi-antenna systems. Multiple Input Multiple Output (MIMO) is the most promising and challenging wireless transmission technology to improve the capacity of wireless systems. MIMO techniques combine signals from multiple antennas to exploit the multipath in wireless channel and enable higher capacity, better coverage and increased reliability. The key requirement to realize the benefits of multi-antenna systems is to send/receive multiple signals with minimum correlation at the air interface. However, the antenna element spacing needed to minimize the coupling between antennas is 0.5λ₀ where λ₀ is the free space wavelength. This requirement can hinder practical application of MIMO designs based on some other antenna designs. Furthermore most wireless communication standards require operation over multiple bands for world-wide coverage or due to frequency allocation.

Consumer devices like cell phones, Smart phones and client cards continue to shrink in size and the room available for antennas is getting smaller. There are various technical challenges associated with realizing the multiband multi-antenna system in such practical applications. The first challenge is to design a single input multiband antenna in a compact size without compromising radiation efficiency. The second and more challenging issue is to minimize the interaction between the antennas that are placed in very close proximity across all operating bands. The minimum coupling between two closely coupled antennas can be achieved by placing antenna elements half-wavelength away from each other. However, this is not practical in commercial products because of the limited space. If the interaction between antennas is not minimized, the MIMO benefits cannot be obtained.

One of the approaches to improving the isolation for the closely coupled antenna is to integrate microwave directional coupler and antennas into the multi-antenna system. However, the size of conventional microwave coupler prevents it from the practical usage. In addition, the printed circuit board (PCB) fabrication process for the microwave circuit will make the conventional microwave coupler difficult to achieve more than −8 dB coupling. This restriction limits the spacing of the antenna array used in the multi-system, such as MIMO, to at most one sixth of the wavelength. The available area in many wireless devices is generally restricted to a small spacing between two adjacent antennas, e.g., 0.1λ₀˜0.25λ₀ or less, where λ₀ is the free space wavelength. In addition to the single band couple, dualband or multi-band couplers can also be designed.

Metamaterial technology has the advantage of 1) reducing the circuit size while providing equivalent or better performance for antenna and 2) improving isolation in antenna arrays by confining near-fields in a small area. The dispersion engineering used in MTM technology can control the propagation constant and the characteristic impedance of the transmission line so that the physical size of circuit may be independent of the operational frequency and can be significantly reduced to fit in a small area. The metamaterial technology can solve both the challenges (1 and 2) described above. A metamaterial antenna can support multiple frequencies in a small, low-profile and low cost form. Using metamaterial technology, the coupler circuit physical size is independent of the operational frequency and can be significantly reduced to fit in a small area.

The technical features in this document can be used to decouple N coupled antenna elements using an N-way directional coupler. The N-element antenna array can be implemented by using either conventional antennas with right-handed material properties or metamaterial antennas such as CRLH MTM antennas. The N-way directional coupler can be implemented by using conventional transmission lines with right-handed material properties or metamaterial transmission lines. One of advantages for using the metamaterial technology is that the physical size of circuits can be significantly reduced to fit in modern communication system. A metamaterial coupler may also be configured to provide up to 0 dB coupling which cannot be done by using conventional directional coupler. Certain information on features described in this document can also be found in Caloz and Itoh, “Electromagnetic Metamaterials: Transmission Line Theory and Microwave Applications,” John Wiley & Sons, 2006; and Caloz et al., “Generalized Coupled-Mode Approach of Metamaterial Coupled-Line Couplers: Coupling Theory, Phenomenological Explanation, and Experimental Demonstration, IEEE Transactions on Microwave Theory and Techniques, Vol. 55, No. 5, May 2007.

Examples of multiband antenna systems in this document combine a multiband metamaterial antenna array (Metarray™) and either a microwave directional coupler or metamaterial directional coupler (MTM coupler) in a planar form to reduce the coupling arising from the proximity effects of antenna array elements. All the components are jointly optimized to minimize coupling and maximize orthogonality of radiation patterns at multiple frequencies. Examples of multi-antenna systems using metamaterial structures are described below to illustrate various antenna features and antenna system features that can increase spectral efficiency and channel capacity. The metamaterial structures can be configured to increase isolation between different input ports and restore orthogonality between multi-path signals in the analog domain. The systems described in this document can include multiple antennas and a network of couplers where at least one antenna or coupler is based on metamaterial technology.

The metamaterial antenna systems described in this document can also be configured to enable applications that may be impractical or technically difficult to implement based on conventional RF antenna designs using right-handed materials. For example, metamaterial antenna systems described in this document can be designed to achieve high isolation to enable full duplex communication in time division duplex systems. Such operations to date have been considered impractical by using conventional RF antenna designs due to the high coupling between transmitted and received signals.

For example, one approach presented in this document for enhancing the isolation of coupled antenna elements is to incorporate a directional coupler in the antenna system. The directional coupler can eliminate the unwanted coupling signal from the adjacent antenna elements. This can be done by optimizing the coupling magnitude and phase of the directional coupler based on the coupling and phase between the antenna elements. The challenge here is to satisfy the magnitude and phase requirements at multiple frequencies in order to design a multiband multi-antenna system. This document describes various different approaches to realize such multiband multi-antenna systems.

A multi-antenna system may be structured to include closely spaced antenna elements and make each antenna support a different frequency band. The isolation between the two antenna elements are desirable when such a multi-antenna system is used in various applications. For example, access devices such as home gateways may require support for WiFi and WiMax technologies on the same board to create a transition from WLAN to WWAN. Integrating WiFi and WiMax technologies can create significant implementation challenges due to cross talk and isolation issues between WiFi and WiMax frequency bands. Because WiFi and WiMax operate independently, isolation can be an important factor to prevent WiMax radio transmissions from blocking or interfering with WiFi radio transmission, which may be receiving or transmitting data. One possible solution for addressing isolation issues is the use of a filter to suppress the interference between the two closely spaced frequency bands. The filter, however, typically requires a design that is characterized by a flat response in a passband frequency range and a sharp rejection just outside the passband frequency range. For example, to achieve adequate isolation in the WiFi and WiMax frequency bands, the filter should have a passband frequency range of about 2.4 GHz to 2.48 GHz and a rejection that is better than 30 dB at 2.5 GHz and higher. State of the art surface acoustic wave (SAW) and bulk acoustic wave (BAW) filters can achieve the rejection performance but at an increased expense in cost and insertion loss (typically 2-3 dB). Because these filters are placed after the power amplifier or in the receiver path before low noise amplifier (LNA), they can create significant loss in the link budget. In mass production, to meet these sharp transition requirements, high tolerance components need to be used to maintain desired production yields. This increases the manufacturing cost of these filters.

In this regard, a combination of a coupler and filters with slow roll-off in the filter response may be used to meet the antenna rejection requirements without compromising the insertion loss. One reason for this can be attributed to the opposite transfer characteristics of the coupler and the filter. Typically, the coupler can offer good isolation between two ports over a narrow bandwidth. By positioning the coupler isolation band between the two closely-spaced frequency bands, lower filter rejection requirements can be achieved. In a conventional method, typical solutions generally involve the use of a large coupler and filter components and thus may be impractical to implement due to size constraints in certain applications. The metamaterial technology can provide an advantage of reducing circuit size while maintaining or improving performances.

The RF structures and antenna designs in this document can be implemented by using printed circuit boards, such as FR-4 printed circuit boards. Examples of other fabrication techniques include thin film fabrication technique, system on chip (SOC) technique, low temperature co-fired ceramic (LTCC) technique, and monolithic microwave integrated circuit (MMIC) technique.

Various features described in this document include: design rules for the microwave directional coupler and metamaterial directional coupler based on different single-band or multi-band antenna arrays; design of a multi-antenna system including two metamaterial antenna elements and a conventional microwave directional coupler; designs and implementations of a multi-antenna system which includes two metamaterial antenna elements and a metamaterial directional coupler; metamaterial couplers with backward wave (BW) or forward wave (FW) coupling; and introduction of additional discrete or printed components to increase the mutual capacitive or inductive coupling between the two lines. Various implementation examples are provided in this document, including examples of using planar and vertical directional couplers and examples of using coupled microstrip or coplanar waveguide (CPW).

The above design approaches can be applied to other types of directional couplers such as coupled lines fully embedded inside dielectric substrates.

I. Multi-Antenna Array Systems with Directional Couplers

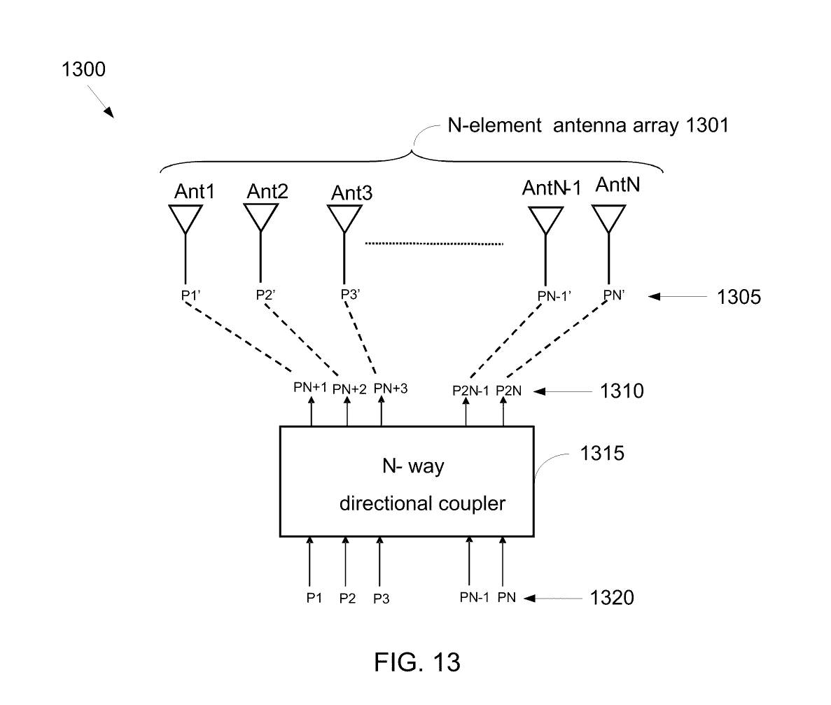

A multi-antenna system include two or more antennas coupled in close proximity in a device. FIG. 13 illustrates a multi-antenna system 1300 comprising an N-element antenna array 1301. Such a system can be designed to have high coupling between adjacent antennas such as Ant1 and Ant2, (Ant2 and Ant3), and AntN-1 and AntN as shown. In such a system, coupling between two non-adjacent antennas, that are separated by one or more antennas and thus are not immediate adjacent to each other, can be much smaller than coupling between adjacent antennas and, thus, has less impact to the system performance then coupling between adjacent antennas.

In FIG. 13, an N-way directional coupler 1315 is introduced to decouple the N antenna elements forming an N-element antenna array 1301. The N-way directional coupler 1315 can be structured to include input ports 1320 (P1, P2, . . . , PN) and output ports 1310 (PN+1, PN+2, . . . , P2N) which are respectively connected to ports 1305 (P1′, P2′, . . . , PN′) of the N-element antenna array 1301. Based on the coupling behavior for the N-element antenna array 1301, the N-way directional coupler 1315 should be designed so that the coupled signals between Pm and Pm+1 where m=1′, 2′, 2N−1′ are decoupled. The N-way directional coupler 1315 can be implemented by using either a metamaterial technology or non-metamaterial approach.

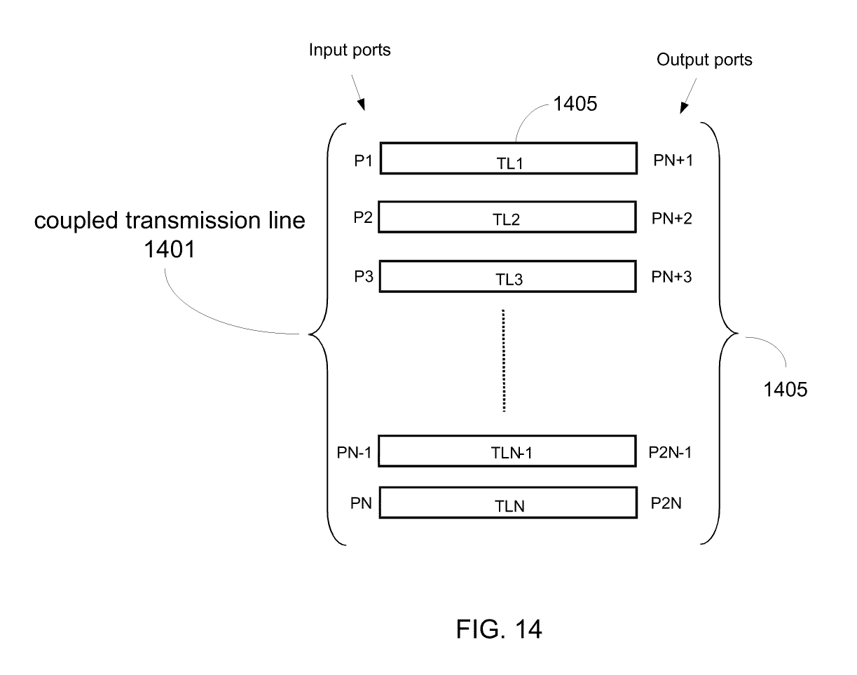

FIG. 14 shows an example of an N-way directional coupler that may be used in the device in FIG. 13. This coupler is implemented by using a coupled transmission line 1401 that includes N transmission lines 1405 that are in parallel with each other. The length and width of each transmission line 1405 and the spacing between two adjacent transmission lines 1405 can be selected and optimized to satisfy the magnitude and phase requirements for eliminating unwanted coupling signals from the adjacent antenna elements (Ant1 . . . AntN) 1301 as shown FIG. 13.

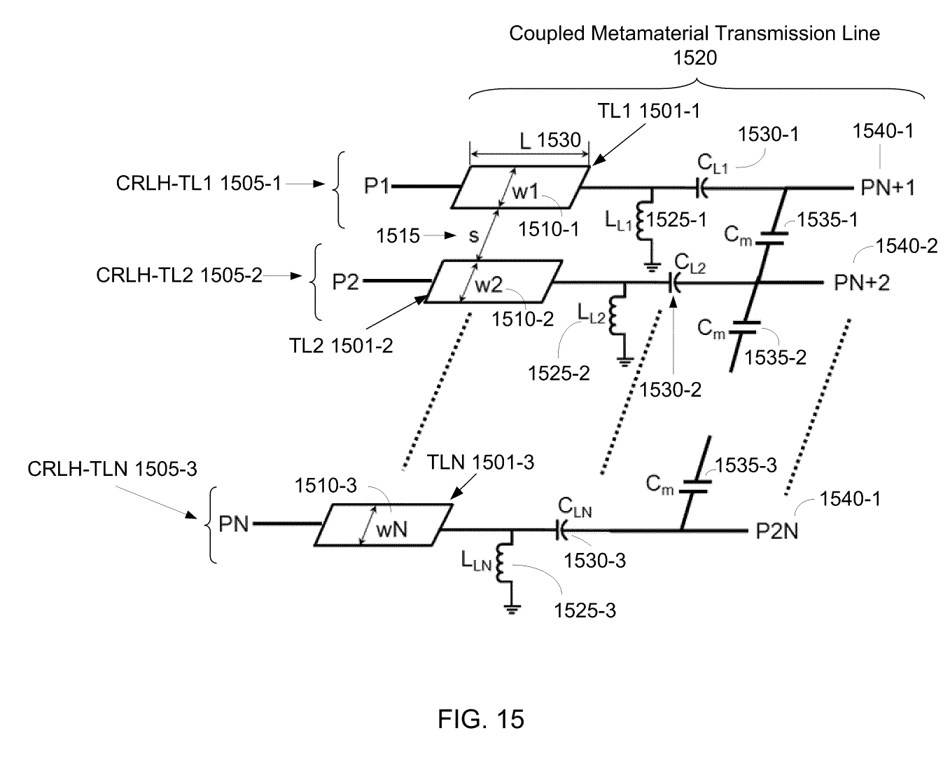

FIG. 15 illustrates an exemplary implementation of an N-way directional coupler utilizing metamaterial technology. The N-way metamaterial directional coupler can be constructed by using a coupled metamaterial transmission line 1520 which includes N CRLH metamaterial transmission lines (CRLH-TLs) 1505-1, 1505-2, 1505-3 that are in parallel with each other. N−1 additional coupling capacitors (1535-1, 1535-2, 1535-3), or collectively referred as Cₘs, are provided and each is connected between two adjacent CRLH-TLs to enhance the coupling. Each CRLH-TL (1505-1, 1505-2, 1505-3) in this example includes a series capacitor (C_{L1}, C_{L2}, C_{LN}), a shunt inductor (L_{L1}, L_{L2}, L_{LN}), and a section of a transmission line (TL1, TL2, TLN), respectively. The transmission lines (1501-1, 1501-2, 1501-3), TL1 . . . TLN, from each CRLH-TLs, form a coupled transmission line which also contributes to the coupling between adjacent ports. For each metamaterial transmission line (CRLH-TL) (1505-1, 1505-2, 1505-3), the series capacitor C_{LN}, (1530-1, 1530-2, 1530-3) and shunt inductor L_{LN}, (1525-1, 1525-2, 1525-3), can have values that are different from each other. Factors related to the transmission line (TL) section (1501-1, 1501-2, 1501-3) that can be tuned to optimize the coupled transmission line, the input impedance, the coupling level between the adjacent ports, and the frequency where maximum coupling occurs may include, but are not limited to, width (1510-1, 1510-2, 1510-3), length 1530, and spacing (1515) between adjacent transmission lines (1501-1, 1501-2, 1501-3), Cₘ (1535-1, 1535-2, 1535-3), C_{L} (1530-1, 1530-2, 1530-3), and L_{L} (1525-1, 1525-2, 1525-3). This can provide more free parameters in comparison to the conventional method to control the frequency response of the N-way directional coupler.

In the following sections, the two- and three-antennas systems demonstrate that the antenna performance, including isolation between antennas and radiation efficiencies, can be improved by incorporating a directional coupler. Such antenna performance improvements may contribute to boosting the communication system performances which may include, but are not limited to, channel capacity, coverage range, and bit error rate.

II. Exemplary Multi-Antenna Systems: Three-Element Antenna Array Coupled to Three-Way Directional Coupler

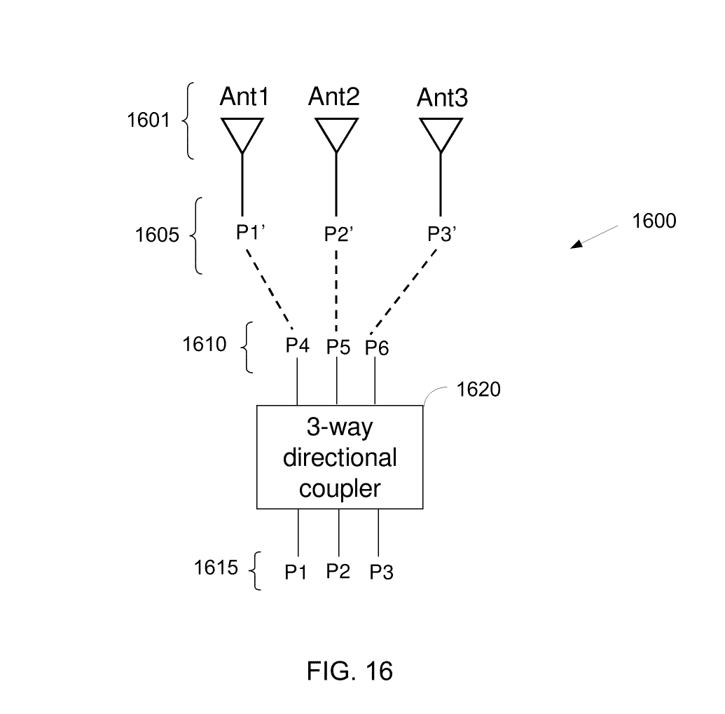

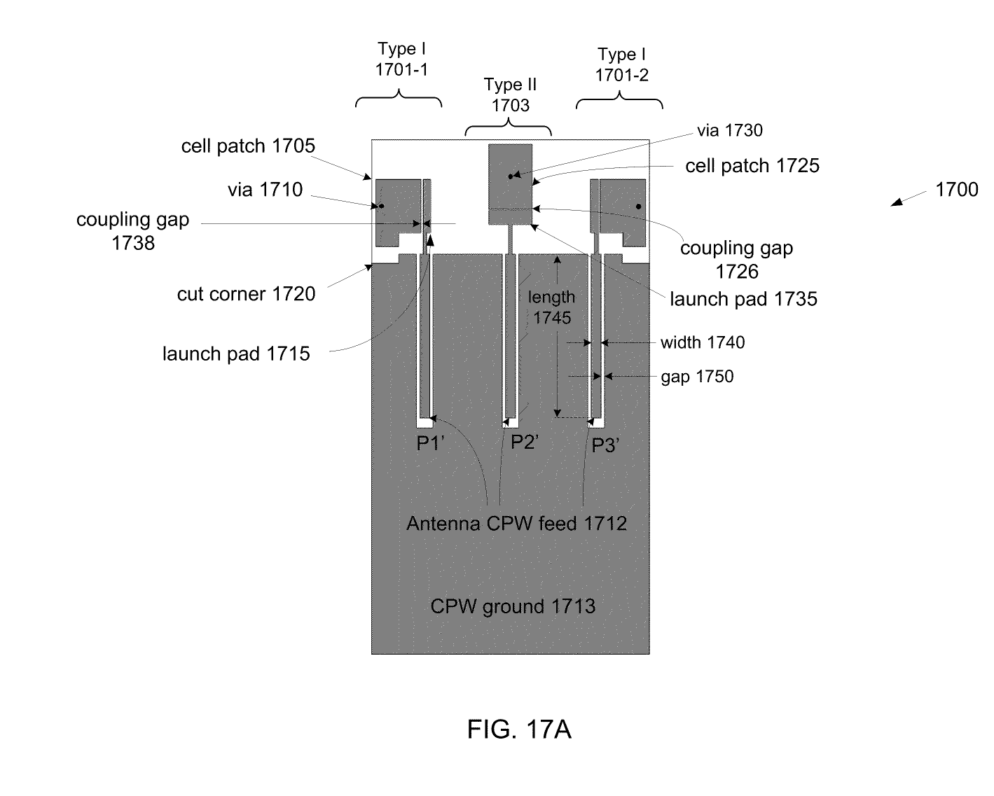

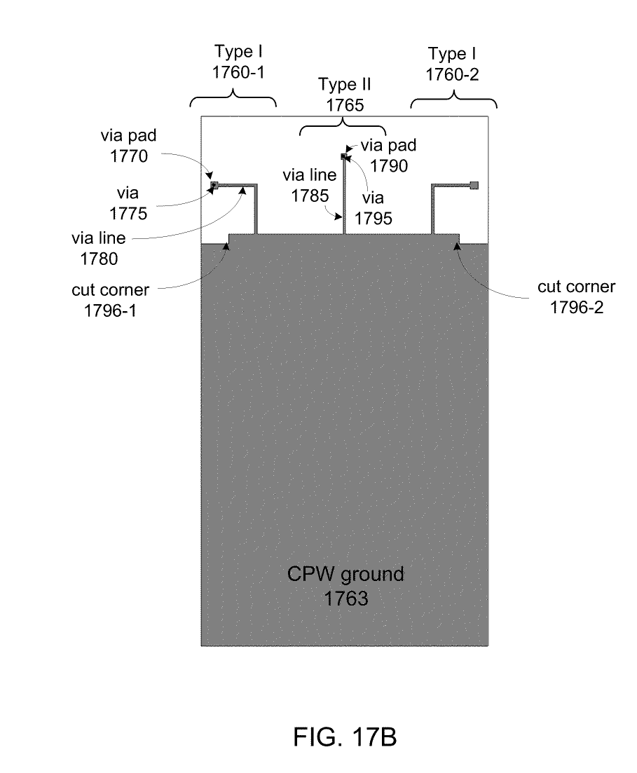

FIG. 16 illustrates an exemplary configuration of the three-antenna system 1600 which includes the three-element metamaterial antenna array 1601 and a three-way directional coupler 1620, which is a subset of the generic multi-antenna system shown in FIG. 13. The three-way directional coupler 1620 can include three inputs 1615, which are denoted as P1, P2, and P3. Three outputs 1610 of the directional coupler, P4, P5, and P6, can be connected to three antenna inputs 1605 of P1′, P2′ and P3′, respectively. Of the Type I and Type II metamaterial antennas described in the example in FIG. 17A in this document, the Type I metamaterial antenna can be used for Ant1 and Ant3 while the Type II metamaterial antenna can be used for Ant2 so that two adjacent antennas are made of different metamaterial types. The structure can be designed to make the coupling between Ant1 and Ant3 relatively small, and the coupling between Ant1 and Ant2 and that between Ant3 and Ant2 relatively large.

Details of various coupling between the inputs of the three-way directional coupler are described next. The input signal from P1 can be coupled to P2 through two paths. The first path starts at P1 and proceeds to P4 via the transmission of the directional coupler 1620. Next, the signal from the output P4 is transmitted to the antenna input P1′ of Ant1. The signal radiated from Ant1 can be coupled to Ant2 which is also coupled to the antenna input P2′. The signal at P2′ is transmitted to P5 and then proceeds through the transmission of the directional coupler 1620 from P5 to P2. The second path starts at P1 and ends at P2 via the coupling of the directional coupler 1620. When the coupled signals from the two paths merge at P2 with the same magnitude and 180° phase difference, the two coupled signals may cancel each other out. This condition generally indicates that the isolation between P1 and P2 can be maximized. The input signal from P3 can be coupled to P2 through two paths. The first path starts at P3 and proceeds to P6 via the transmission of the directional coupler 1620. Next, the signal from the output P6 is transmitted to the antenna input P3′ of Ant3. The signal radiated from Ant3 is coupled to Ant2 which is also coupled to the antenna input P2′. The signal at P2′ is transmitted to P5 and then proceeds through the transmission of the directional coupler 1620 from P5 to P2. The second path starts at P3 and ends at P2 via the coupling of the directional coupler. When the coupled signals from the two paths merge at P2 with the same magnitude and 180° phase difference, the two coupled signals may cancel each other out. This condition generally indicates that the isolation between P3 and P2 can be maximized. In addition, the input signal from P1 can be coupled to P3 through two paths. The first path starts at P1 and proceeds to P4 via the transmission of the directional coupler 1620, and the signal from the output P4 is transmitted to the antenna input P1′ of Ant1. The signal radiated from Ant1 is coupled to Ant3 which is also coupled to the antenna input P3′. The signal at P3′ is transmitted to P6 and then proceeds through the transmission of the directional coupler 1620 from P6 to P3. The second path starts at P1 and ends at P3 via the coupling of the directional coupler 1620. Therefore, to preserve the high isolation between Ant1 and Ant3, the coupling between P1 and P3 through the three-way directional coupler 1620 should be minimized.

II.A. Three-Element Metamaterial Antenna Array

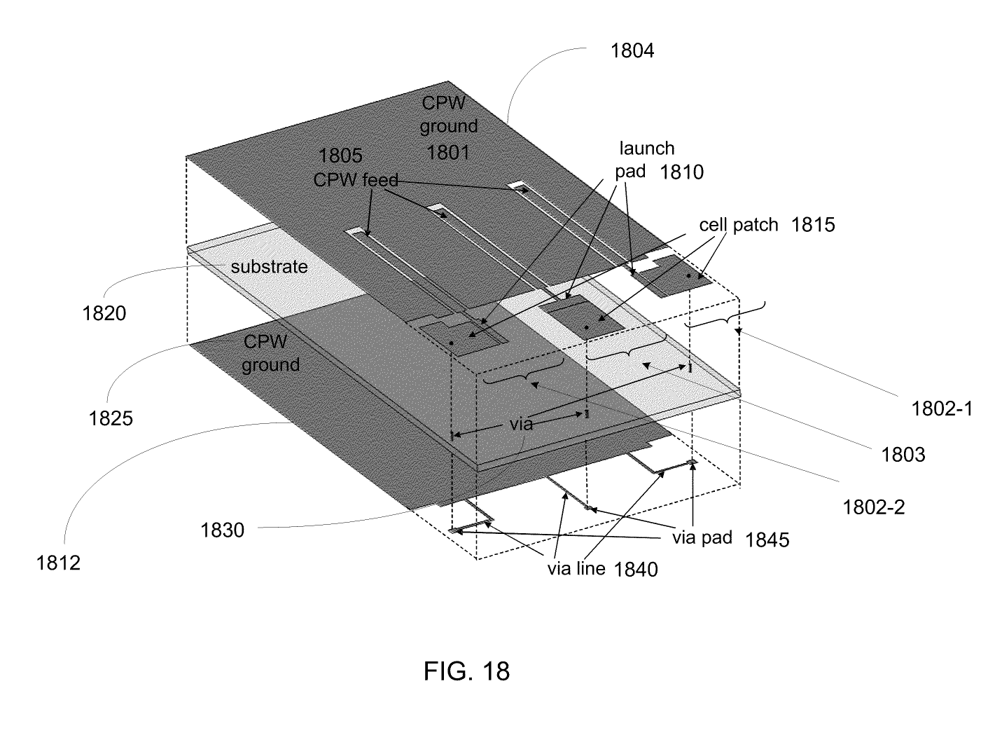

Multiple antennas can be integrated in a single wireless device by using metamaterial technology. FIGS. 17A-17B and FIG. 18 depict an exemplary implementation of a three-element metamaterial antenna array. FIG. 17A represents the top metal layer, FIG. 17B shows the bottom metal layer. The metamaterial antenna array 1700 shown in FIG. 17A includes three antennas, antennas 1701-1 and 1701-2 being made of the Type I metamaterial structure, and the other 1703 being made of the Type II metamaterial structure. Each antenna is coupled to an antenna CPW feed 1712 to send or receive a signal. The width 1740, length 1745, and gap 1750 of the antenna CPW feed 1712 are 1.1 mm, 17.65 mm, and 0.35 mm, respectively. The feed 1712 may also be implemented in a non-CPW design.

FIG. 18 shows a 3-Dimensional perspective view of a three-element metamaterial antenna array having the top layer 1804, bottom layer 1812 and the substrate 1820. All three antennas 1701-1, 1701-2 and 1701-3 in FIGS. 17A and 17B can be placed at one periphery on top of the substrate as shown in FIG. 18. In FIG. 18, the dimension, thickness, and dielectric constant of the substrate 1820 are 30 mm×55.56 mm, 0.787 mm, and 4.4, respectively. The two Type I antennas (1802-1 and 1802-2) can be placed at two sides on top of the substrate 1820 and may be symmetric with respect to the Type II antenna (1803). The Type II antenna 1803 may be located at the middle with respect to the substrate 1820. Although Type I (1802-1 and 1802-2) and Type II (1803) antennas have different shapes. All three antennas 1801-1, 1801-2 and 1801-3 can be designed to operate at the same frequency band. Each antenna can be fed by a 50Ω conductor backed coplanar waveguide (CPW) feed 1805. Also depicted in FIG. 18 are a CPW ground on the top layer 1804, launch pads 1810 on the top layer 1804, cell patches 1815 on the top layer 1804, a CPW ground 1825 located on the bottom layer 1812, vias 1830 located on the substrate 1820, via pads 1845 located on bottom layer 1812, and via lines 1840 also located on the bottom layer 1812.

Exemplary geometries and dimensions are described below with reference to FIGS. 17A-17B and FIG. 18. The two Type I antennas (1701-1 and 1701-2) are constructed identically, and have identical dimensions. Referring again to FIG. 17A, the Type I metamaterial antenna 1701-1 can include a cell patch 1705, a launch pad 1715, a via 1710, a via pad (shown in FIG. 17B) and a via line (shown in FIG. 17B). The cell patch 1705 of the Type I metamaterial antenna can be horizontally divided into an upper rectangular patch and a lower rectangular patch of different dimensions. In the illustrated example, the lower rectangular patch is smaller than the upper rectangular patch. Exemplary dimensions of the two rectangular patches are 4.9 mm×5.8 mm for the upper patch and 2.45 mm×1.5 mm for the lower patch. The cell patch 1705 can be coupled to the launch pad 1715 through a coupling gap 1738 which is about 0.2 mm×5.8 mm. The launch pad 1715 can include two vertically connected rectangular portions: an upper portion and a lower portion. For the Type I metamaterial antenna 1701-1, the upper portion of the launch pad 1715 can be coupled to the cell patch 1705, and the lower portion of the launch pad 1715 can be connected to the antenna CPW feed 1712. Exemplary dimensions of the upper and lower portions of the launch pad 1715 are 0.8 mm×5.8 mm and 0.4 mm×2.3 mm, respectively. The cell patch 1705 can be connected to via pad 1770 of FIG. 17B on the bottom layer of the substrate 1820 of FIG. 18 by using a metallic via 1775. Now, referring to FIGS. 17A-17B, the via 1775 is located at 7.37 mm away from the top of the cell patch 1705 edge portion and 1.40 mm away from the side edge portion of the substrate. The radius of the via 1710 in FIG. 17A is about 0.127 mm. The via pad 1770 in FIG. 17B of the Type I metamaterial antenna 1760-1 is 0.8 mm×0.8 mm and may be connected to the CPW ground 1763 through the via line 1780. For the Type I metamaterial antenna 1760-1, the via line 1780 can include two rectangular strips forming an L-shape strip. One strip of the via line 1780 can be coupled to via pad 1770. Exemplary sizes for the one strip of the via line 1780 are 0.3 mm in width and 3.8 mm in length. The other strip of the via line 1780 can be connected to the CPW ground 1763. Measurements for the other strip of the via line 1780 can be 0.3 mm in width and 5.25 mm in length. Two cut corners (1796-1, 1796-2) of the CPW ground 1763 in close proximity to the Type I metamaterial antenna may be cut on both the top and bottom layers of the substrate as shown in FIGS. 17A-17B. The dimension of the rectangular cut is 2.95 mm×1 mm.

The Type II metamaterial antenna 1703 in FIG. 17A has a different geometry from the Type I metamaterial antenna 1701 and can include a cell patch 1725, a launch pad 1735, a via 1730, a via pad (shown in FIG. 17B) and a via line (shown in FIG. 17B). The cell patch 1725 of the Type II metamaterial antenna 1703, which is generally rectangular in shape and is 4.7 mm×7.0 mm, can be coupled to the launch pad 1735 through a coupling gap 1726 which is 4.7 mm×0.16 mm. The launch pad 1735 may include two vertically connected rectangular portions: an upper portion and a lower portion. The upper portion of the launch pad 1735 can be coupled to the cell patch 1725 via a gap, and the lower portion of the launch pad 1735 can be connected to the 50Ω antenna CPW feed 1712. Exemplary dimensions of the upper and lower portions of the launch pad 1735 are 4.7 mm×1.5 mm and 0.4 mm×3.2 mm, respectively. The cell patch 1725 of FIG. 17A can be connected to the via pad 1790 of FIG. 17B on the bottom layer of the substrate 1820 of FIG. 18 by using a metallic via 1795. Referring to FIGS. 17A-17B, the via 1795 may be located at 3.76 mm away from the top of the cell patch 1725 edge and 2.35 mm away from the cell patch 1725 side edge. The radius of the via 1795 in FIG. 17B can measure 0.127 mm. The via pad 1790 can be coupled to the CPW ground 1763 through the via line 1785. A typical dimension for the via pad 1790 of Type II metamaterial antenna 1765 can be 0.6 mm×0.6 mm. The via line 1785 can be formed by a rectangular shape strip that has a dimension of 0.2 mm×7.8 mm.

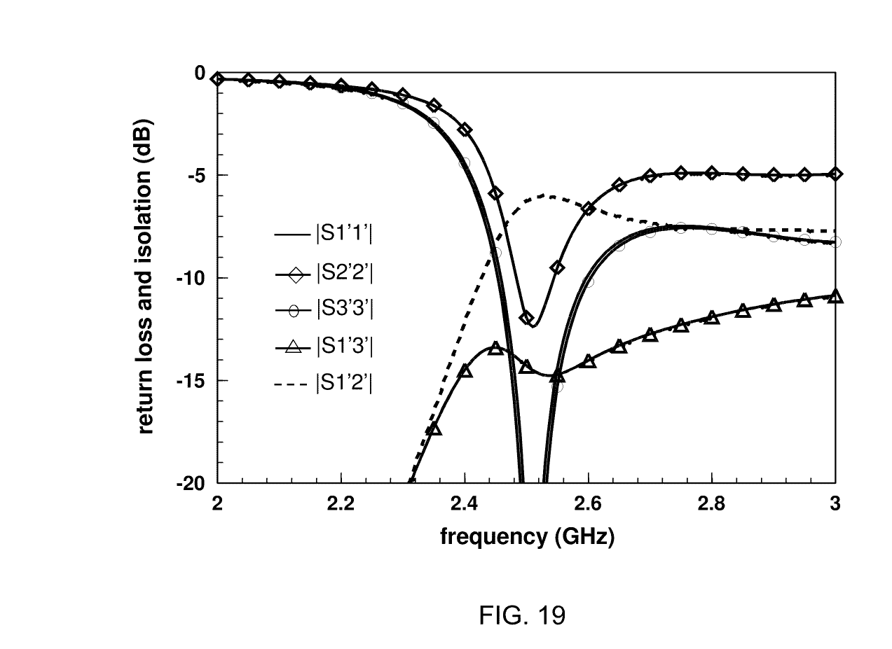

FIG. 19 illustrates the simulation results of the three-element metamaterial antenna array shown in FIGS. 17A-17B and FIG. 18. Notably, the bandwidth within which the return loss is better than −10 dB for the Type I metamaterial antennas can range from about 2.46 GHz to 2.6 GHz as indicated by the simulated values for |S1′1′. The coupling between the two Type I metamaterial antennas can be less than −13 dB across the entire above mentioned bandwidth as indicated by the simulated values for |S1′3′|. Also from FIG. 19, the return loss for the Type II metamaterial antenna may be better than −10 dB from about 2.48 GHz to 2.55 GHz (as indicated by the simulated values for |S2′2′|. The coupling between the Type II metamaterial antenna and Type I metamaterial antennas can be between −8 dB to −6 dB in the range of about 2.43 GHz to 2.6 GHz as shown by the simulated values of |S1′2′|.

II.B1 Three-Element Antenna Array with Three-way Directional Coupler Using Microwave Coupled Lines

In FIGS. 17A and 17B, the three-element metamaterial antenna array can be symmetric with respect to the center of the substrate. Thus, the structure of the three-way directional coupler should also be symmetric. One way to construct the three-way directional coupler is the use of microwave coupled line coupler. A directional coupler can be a four port device built by utilizing a microwave coupler which can have two transmission lines that are parallel to each other. In another embodiment, additional transmission lines are included to form a six-port three-way directional coupler.

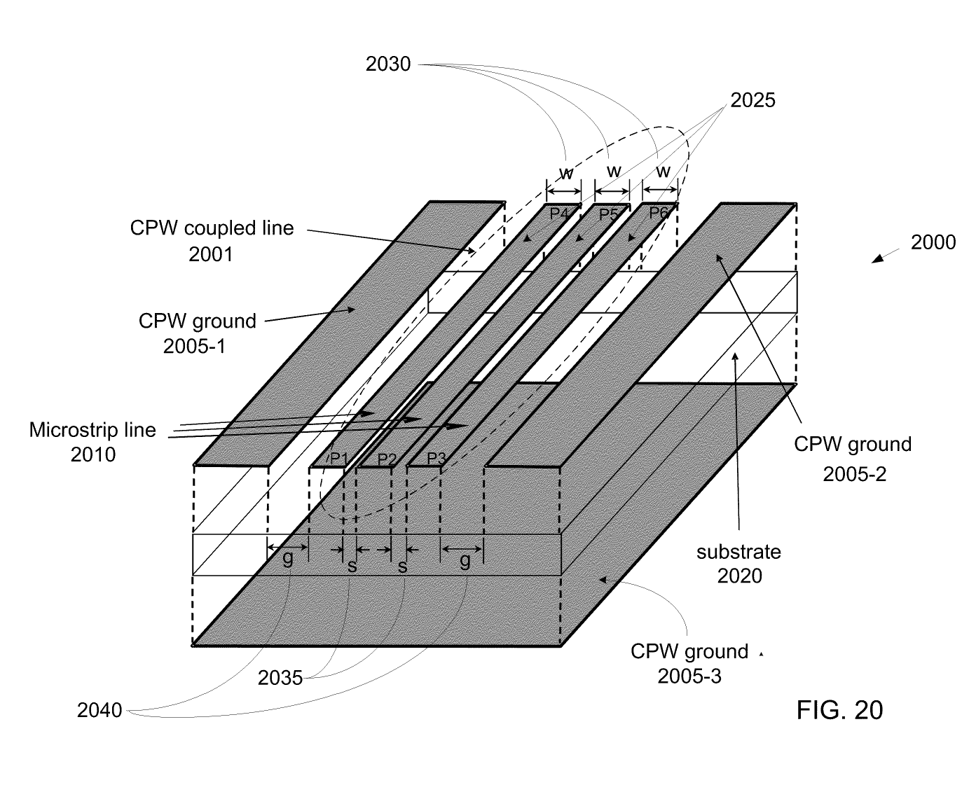

FIG. 20 illustrates a structure of the three-way directional coupler 2000 with six ports (P1, P2, P3, P4, P5, P6), formed on a substrate 2020 such as FR-4. Exemplary values for thickness and dielectric constant of the FR-4 substrate are 0.787 mm and 4.4, respectively. The three-way directional coupler 2000 includes a CPW coupled line 2001, CPW ground electrodes 2005-1 and 2005-2 formed in the same top metallization layer in which the CPW coupled line 2001 is formed and the CPW ground electrode 2005-3 in the bottom metallization layer. The CPW coupled line 2001 can, for example, include three microstrip lines 2025 that are arranged in parallel to each other and separated by a gap 2035. The width 2030, w, of a single microstrip line 2010 may be 1.1 mm and the gap width 2035, s, may be 0.1 mm as shown in FIG. 20. Under this configuration, to maximize the coupling at a frequency of 2.52 GHz, the length of the CPW coupled line 2001 can be set to 16.9 mm. The distance between the CPW coupled line and the top portion of the CPW ground is denoted by “g” 2040 in FIG. 20 and measures 0.75 mm in width.

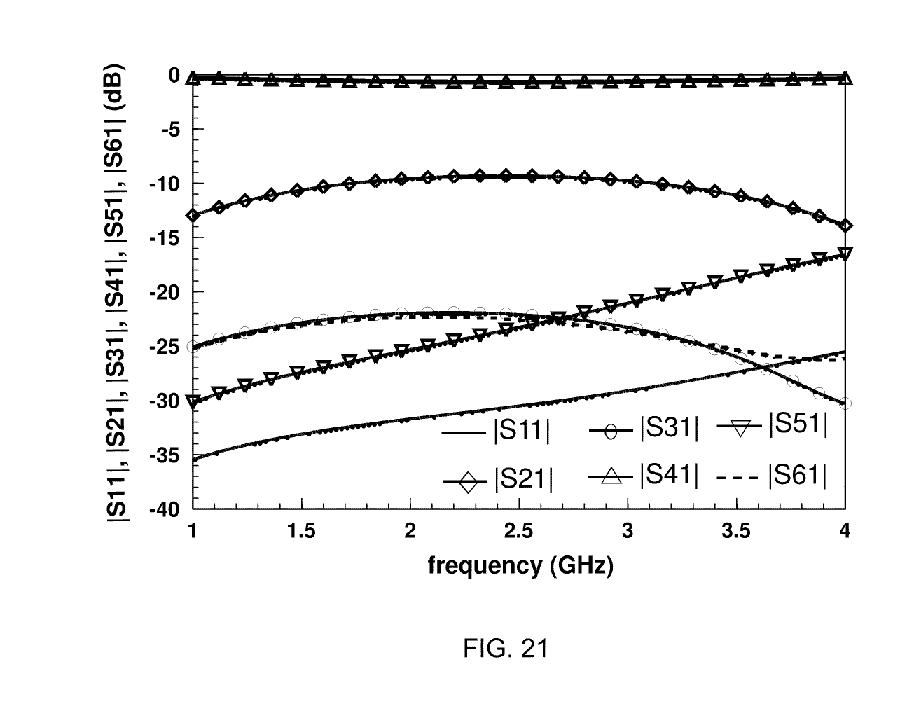

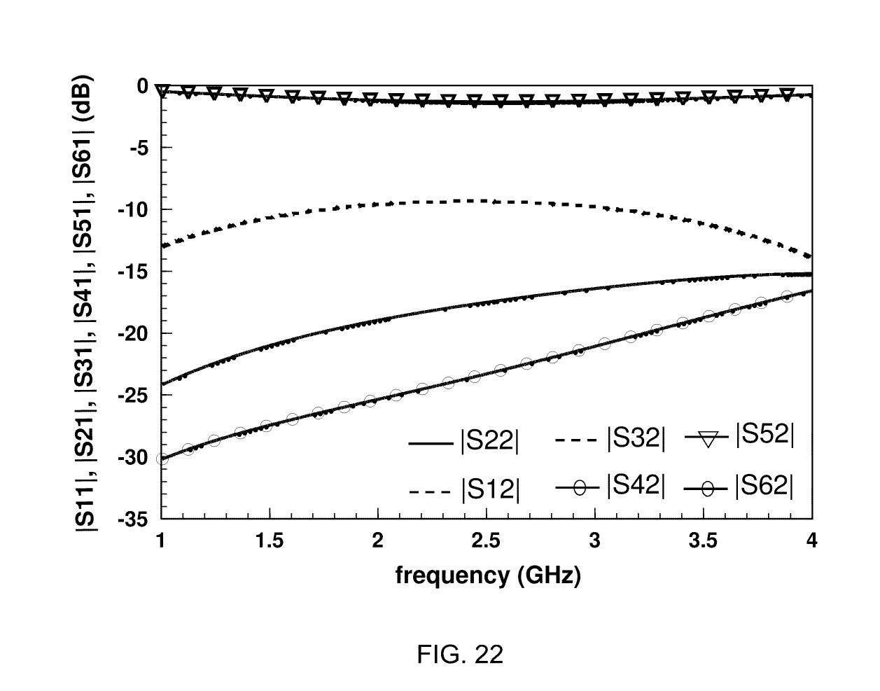

FIG. 21 and FIG. 22 show the simulated results of the three-way directional coupler 2000 in FIG. 20 and indicate all six ports of the three-way directional coupler 2000 are matched to 50Ω. The low insertion losses between P1 and P4 (|S41|), P2 and P5 (|S52|), and P3 and P6 (same as |S41|) are obtained. The maximum coupling of −9.3 dB between P1 and P2 (|S21|) and P3 and P2 (|S32|) or P4 and P5 (same as |S21|) and P6 and P5 (same as |S32|) occurs at around 2.5 GHz. The coupling between P1 and P3 (|S31|) and P4 and P6 (same as |S31|) is less than −20 dB from the range of about 1 GHz to 4 GHz. These results generally satisfy the requirements of a high coupling between (P1 and P2), (P4 and P5), (P2 and P3), and (P5 and P6) and a low coupling between (P1 and P3) and (P4 and P6).

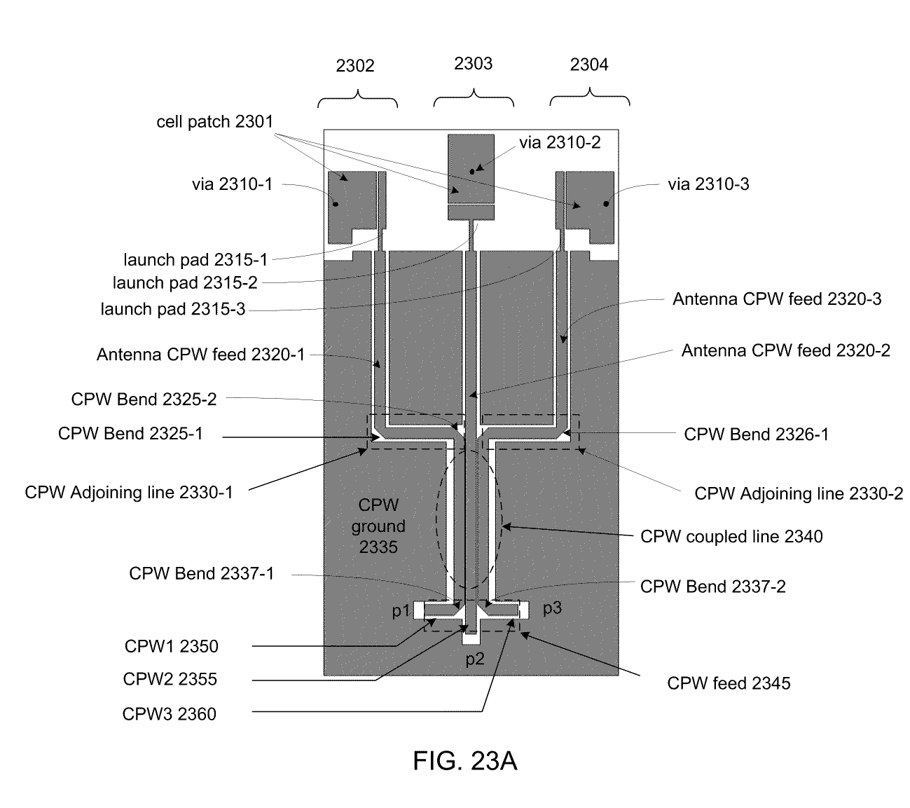

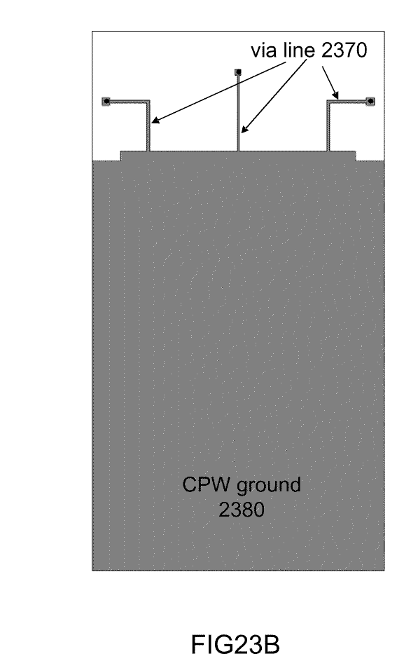

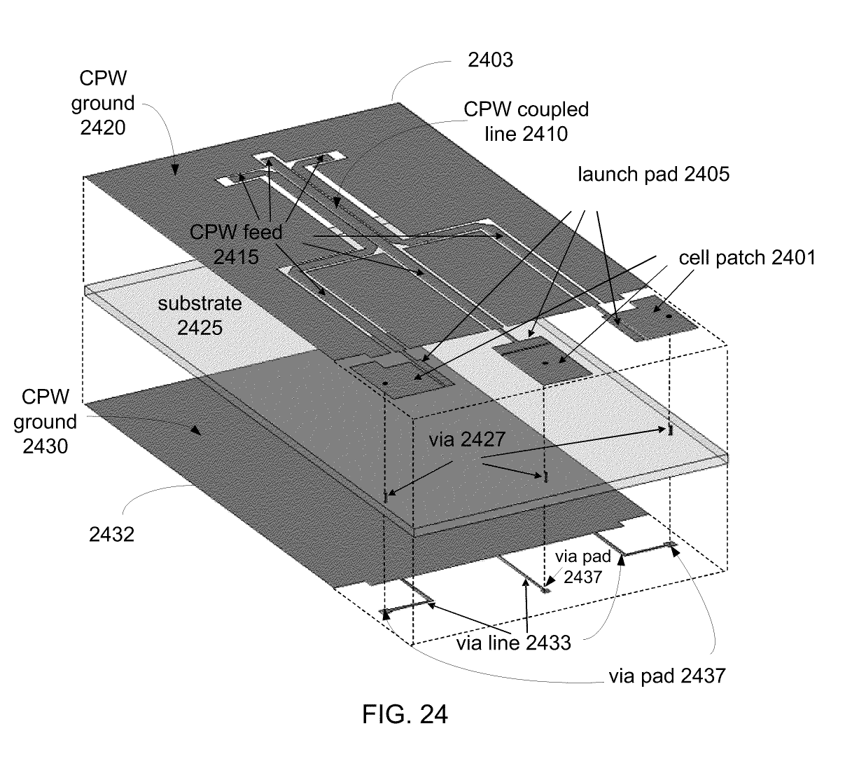

FIGS. 23A, 23B, and 24 show a specific exemplary implementation of the three-antenna system illustrated in FIG. 16 with a three-element metamaterial antenna array and a three-way directional coupler, which is a subset and en example of the multi-antenna system shown in FIG. 13. The dimensions of the Type I and Type II metamaterial antennas shown in FIGS. 23A, 23B, and 24 may be implemented to be the same as the three-element metamaterial antenna array shown in FIGS. 17A-17B and FIG. 18 with the exception of the antenna CPW feed lines. FIG. 23A represents a top layer, FIG. 23B represents a bottom layer, and FIG. 24 represents a 3-Dimensional stacked view of the top layer 2403, bottom layer 2432 and a substrate 2425 of the three-element metamaterial antenna array. The length of the antenna CPW feed 2320 shown in FIG. 23A can be optimized to satisfy the phase requirement as previously indicated.

With respect to the Type I metamaterial antenna 2302 shown on the left-hand side of FIG. 23A, one end portion of an antenna CPW feed 2320-1 is connected to a CPW coupled line 2340 via a CPW adjoining line 2330-1. The antenna CPW feed 2320-1 and the CPW adjoining line 2330-1 form an L-shape structure. The adjoining line 2330-1 can include two CPW bends: a first bend 2325-1 and a second bend 2325-2. The first bend 2325-1 is connected to the antenna CPW feed 2320-1, and the second bend 2325-2 which is connected to the CPW coupled line 2340. The other end portion of the antenna CPW feed 2320-1 is connected to the launch pad 2315-1 of the left-hand side of the Type I metamaterial antenna 2302. For example, the antenna CPW feed 2320-1 may 1.1 mm×18 mm, and the CPW adjoining line 2330-1 may be 6.9476 mm×1.1 mm. The two CPW bends (2325-1, 2325-2) can form a triangle, and the dimensions of the two sides that form the right angle can be 1.1 mm.

For the Type I metamaterial antenna 2304 shown on the right-hand side of FIG. 23A, the antenna CPW feed 2320-3 and the CPW adjoining line 2330-2 structure form a mirrored L-shape structure that is identical in structure and dimensions to the L-shaped structure of the Type I metamaterial antenna 2302 formed on the left-hand side. The antenna CPW feed 2320-2 connected to the Type II metamaterial antenna 2303 may be 1.1 mm×19.1 mm in dimension. The structure of the CPW coupled line 2340 is identical to the three-way directional coupler 2000 shown in FIG. 20 and the dimensions are the same as previously indicated.

Input ports, P1, P2, and P3, of the CPW feed lines CPW1 2350, CPW2 2355, and CPW3 2360 are connected to the CPW coupled line 2340 in which CPW1 2350, CPW2 2355, and CPW3 2360 form a CPW feed 2345 as shown in FIG. 23A. CPW1 2350 and CPW3 2360 each have a dimension of 3 mm×1.1 mm, and each are connected to one end portion of the CPW coupled line 2340 via CPW bends 2337-1 and 2337-2 respectively. The CPW bends (2337-1, 2337-2) may be identical to the first 2325-1 and second 2325-2 CPW bends mentioned above. The CPW2 2355 is connected to the middle portion of the CPW coupled line 2340 and may have a dimension of 1.1 mm×3 mm. Other components shown in FIGS. 23A-23B have been covered in the previous sections which include cell patch 2301, via (2310-1, 2310-2, 2310-3), launch pad (2315-1, 2315-2, 2315-3), via line 2370 and CPW ground 2335.

FIG. 24 depicts a 3-Dimensional stacked view and alignment of the top layer 2403 and the bottom layer 2432 which are also depicted in detail in FIGS. 23A-23B, respectively. Specifically, the components shown in FIG. 24 show a 3-D rendering of the same components depicted in FIGS. 23A-23B which include cell patch 2401, launch pad 2405, CPW coupled line 2410, CPW feed 2415, CPW ground (2420, 2430), substrate 2425, via 2427, via pad 2437, and via line 2433.

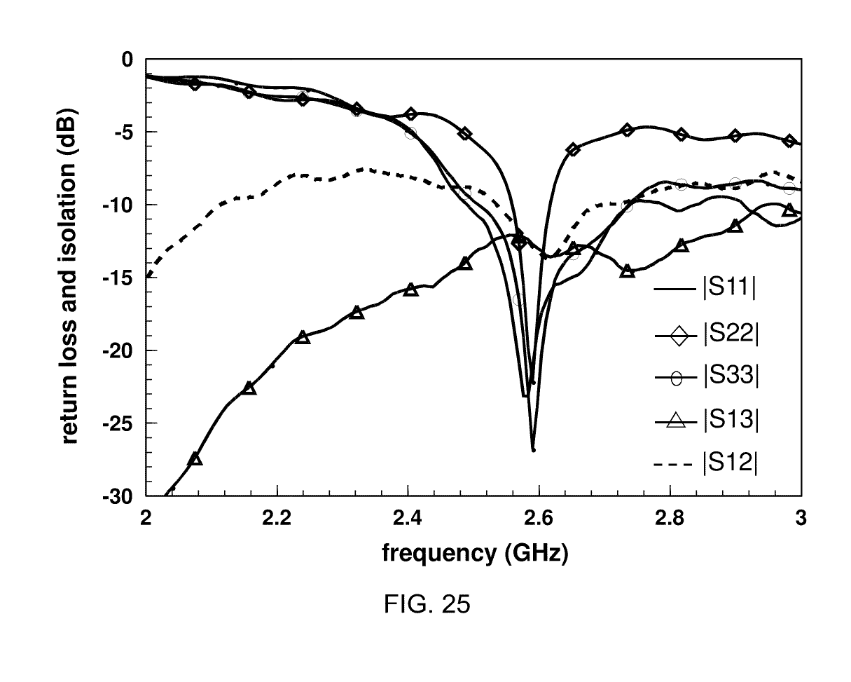

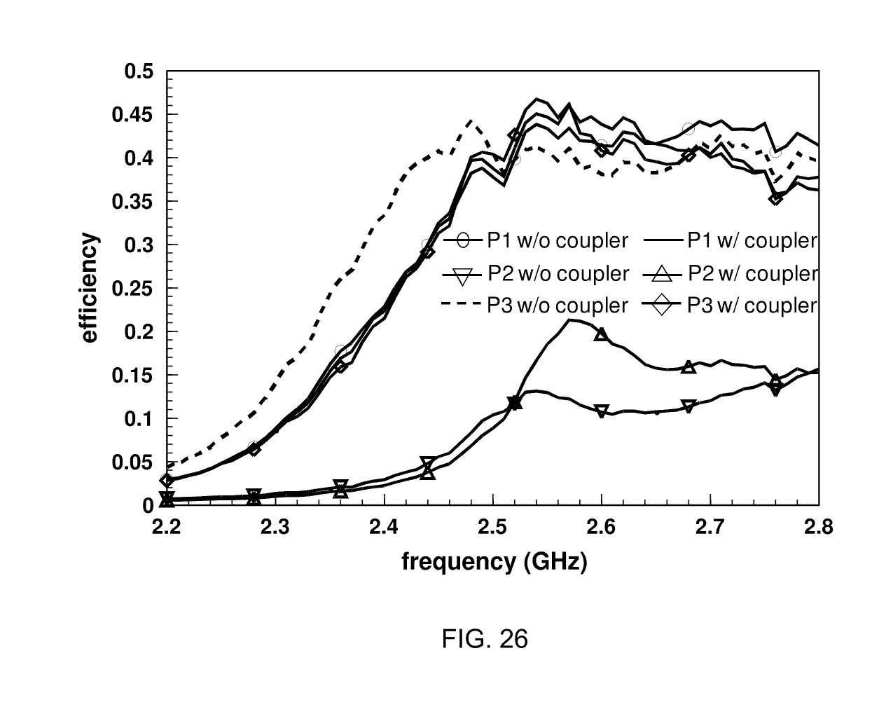

FIG. 25 shows simulation results of the three-antenna system above by using Ansoft HFSS. Notably, the isolation between P1 and P3 is preserved to be less than −10 dB and the isolations between (P1 and P2) and (P3 and P2) are improved in comparison to the results shown in FIG. 19. The measured radiation efficiencies of three antenna system shown in FIG. 24 are illustrated in FIG. 26. Thus, by improving the isolation of the Type II metamaterial antenna, greater radiation efficiency can be achieved as shown in FIG. 26.

II.B2 Three-Element Antenna Array with Three-Way Directional Coupler Using MTM Transmission Lines

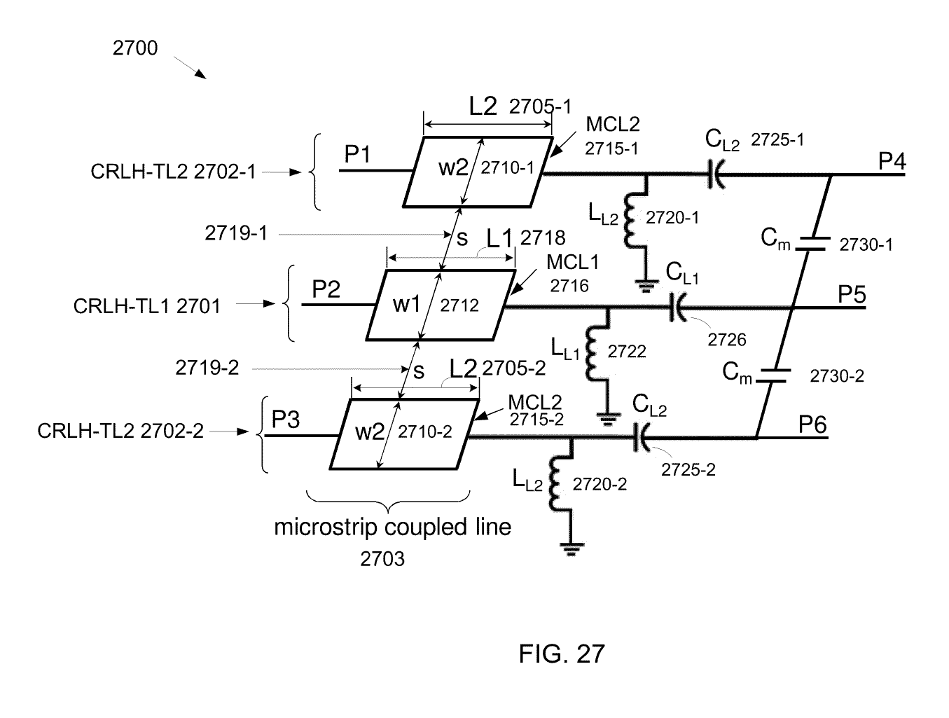

An N-way directional coupler, e.g., a three-way directional coupler can be implemented based on the metamaterial technology to achieve a reduced circuit size with minimal adverse impact to circuit performance. FIG. 27 illustrates an exemplary structure of a three-way MTM coupler 2700 which may be built on a 0.787 mm FR-4 substrate with a dielectric constant of 4.4. This three-way MTM coupler 2700 includes three CRLH metamaterial transmission lines (CRLH-TL1 2701, CRLH-TL2 2702-1, CRLH-TL3 2702-2) that are parallel to each other. To enhance the coupling, a coupling capacitor (2730-1, 2730-2), Cₘ, can be connected in between adjacent metamaterial transmission lines 2701, 2702-1 and 2702-2. The metamaterial transmission line 2701 can be configured in a first configuration, and the other two metamaterial transmission lines, 2702-1 and 2702-2, can be configured a second, different configuration. The configuration differences between CRLH-TL1 2701 and CRLH-TL2 (2702-1, 2702-2) can be used as parameters to optimize the three-way MTM coupler for impedance matching and phase adjustment purposes.

In example in FIG. 27, the CRLH-TL1 2701 may include a section of a microstrip line 2716 (MCL1), a series capacitor 2726 (C_{L1}) and a shunt inductor 2722 (L_{L1}). The CRLH-TL2 may include a section of a microstrip line 2715-1 or 2715-2 (MCL2), a series capacitor 2725-1 or 2725-2 (C_{L2}), and a shunt inductor 2720-1 or 2720-2 (L_{L2}). In one implementation, each of the microstrip lines 2716, 2715-1 and 2715-2 can be the right-handed portion of the respective CRLH-TL 2701, 2702-1 or 2702-2, and the lumped elements generally represent the left-handed portion of the respective CRLH-TL 2701, 2702-1 or 2702-2. For example, the width w1 2712 and length L1 2718 of the microstrip line section 2716, MCL1, may be 0.5 mm and 4 mm, respectively. The series capacitor 2726, C_{L1}, and shunt inductor 2722, L_{L1}, may be 8 pF and 2.3 nH, respectively. The width w2 (2710-1, 2710-2) and length L2 (2705-1, 2705-2) of the microstrip line section (2715-1, 2715-2), MCL2, may be 1.9 mm and 4 mm, respectively. The series capacitor (2725-1, 2725-2), C_{L2}, and shunt inductor (2720-1, 2720-2), L_{L2}, may be 15 pF and 2.9 nH, respectively.

To construct the three-way MTM coupler, the three metamaterial transmission lines (2701, 2702-1, 2702-2) can be arranged in parallel and in the order of CRLH-TL2 2702-1, CRLH-TL1 2701 and CRLH-TL2 2702-2. The three microstrip line sections, which can include one MCL1 2716 and two MCL2's (2715-1, 2715-2), form a three-way microstrip coupled line 2703 which may contribute to the coupling between adjacent metamaterial transmission lines. The spacing, s (2719-1, 2719-2), between each microstrip line section, MCL1 2716 and MCL2 (2715-1, 2715-2), may be 0.1 mm, and the capacitance of the coupling capacitor, Cₘ (2730-1, 2730-2) may be 1 pF. Ports P1, P2, P3, P4, P5, and P6 are I/O ports and are capable of either receiving or transmitting a signal of the three-way MTM coupler 2700.

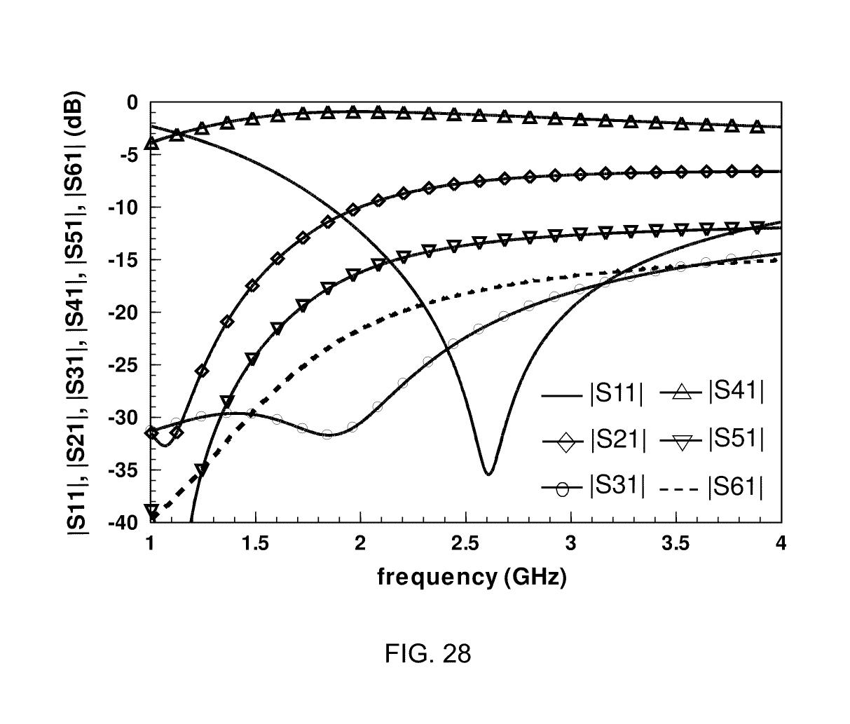

FIG. 28 shows the simulated S-parameters for the input signal at P1 of FIG. 27. Due to the symmetric configuration of the MTM coupler shown in FIG. 27, the same results can be obtained for P3, P4, and P6 as well. The results suggest a good impedance matching in the range of about 1.85 GHz to 4 GHz with a return loss of better than −10 dB. A high coupling may occur between P1 and P2 (P3 and P2, P4 and P5, P6 and P5) in a frequency range of about 2.4 GHz to 2.7 GHz. As can be expected, the coupling between P1 and P3 (P4 and P6) is low.

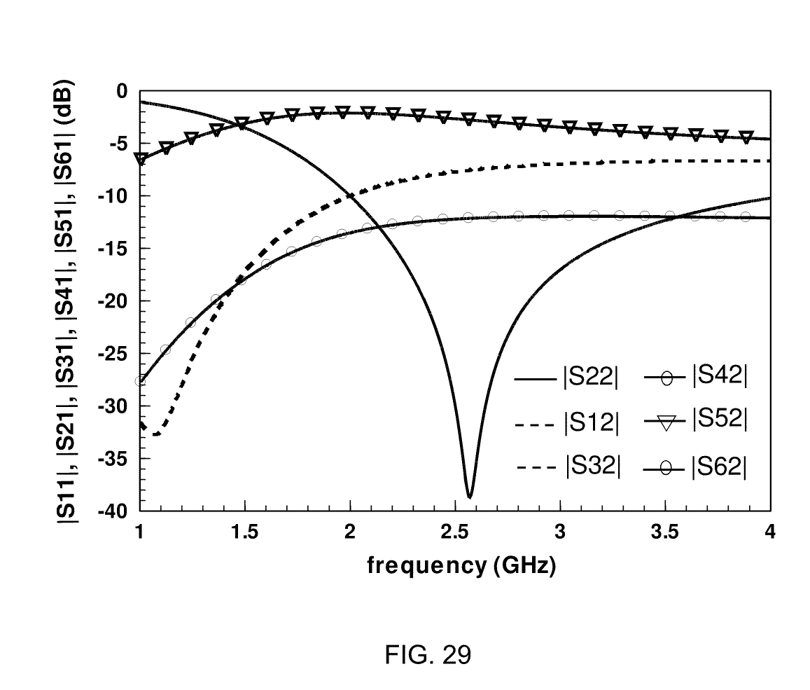

FIG. 29 illustrates the simulated S-parameters for the input signal at P2. The same results can be obtained for P5 as well. The results indicate an impedance matching with a return loss of better than −10 dB in the range of about 2 GHz to 4 GHz. A high coupling occurs between (P2 and P1) and (P2 and P3) and between (P5 and P4) and (P5 and P6) in a frequency range of about 2.4 GHz to 2.7 GHz.

The three-antenna system can be constructed by combining the three-element metamaterial antenna array shown in FIGS. 17A-17B and the three-way MTM coupler 2700 shown in FIG. 27. The three-way MTM coupler 2700 include output ports P4, P5, and P6 (from FIG. 27) and can connect to the three-element metamaterial antenna array input ports P1′, P2′ and P3′ (from FIG. 17A), respectively. The dimensions and the lumped element values associated with the three-way MTM coupler 2700 can be further optimized to satisfy the magnitude and phase requirements for eliminating unwanted coupling signals from the adjacent antenna elements as discussed in the previous sections. In one optimized example where the magnitude and phase requirements are met, the width 2712 and length 2718 of the CRLH-TL1 microstrip line (MCL1) 2716 section shown in FIG. 27 are 0.8 mm and 5 mm, respectively. The series capacitor 2726, C_{L1}, and a shunt inductor 2722, L_{L1}, for CRLH-TL1 2701 are 18 pF and 2.5 nH, respectively. The width (2710-1, 2710-2) and length (2705-1, 2705-2) of the microstrip line (MCL2) (2715-1, 2715-2) section are 1.8 mm and 5 mm, respectively. The series capacitor (2725-1, 2725-2), C_{L2}, and a shunt inductor (2720-1, 2720-2), L_{L2}, for CRLH-TL2 (2702-1, 2702-2) are 8 pF and 3 nH, respectively. In addition, the spacing, s (2719-1, 2719-2), between adjacent microstrip line sections, MCL1 2716 and MCL2 (2715-1, 2715-2), is 0.1 mm, and the capacitance of the coupling capacitor (2730-1, 2730-2), Cₘ, is 1.2 pF.

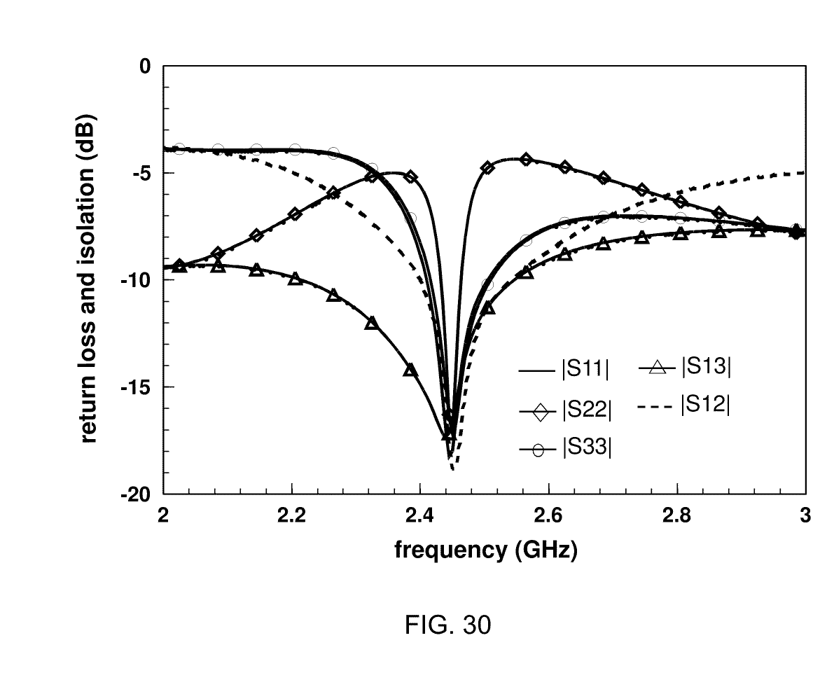

FIG. 30 illustrates the simulated results of the three-antenna system using three-way MTM coupler 2700 in FIG. 27. The impedance matching is maintained as in the case of the three-element metamaterial antenna array shown in FIGS. 17A-17B, 18, 19. The high isolation between P1 and P3 is also retained as predicted. A comparison between FIG. 30 and FIG. 19 indicates that an improved isolation between (P1 and P2) or (P2 and P3) can be achieved. This isolation improvement can lead to higher radiation efficiency as discussed in the previous section.

III. Single-Band Multi-Antenna System: Two-Element Antenna Array with 2-Way Directional Coupler

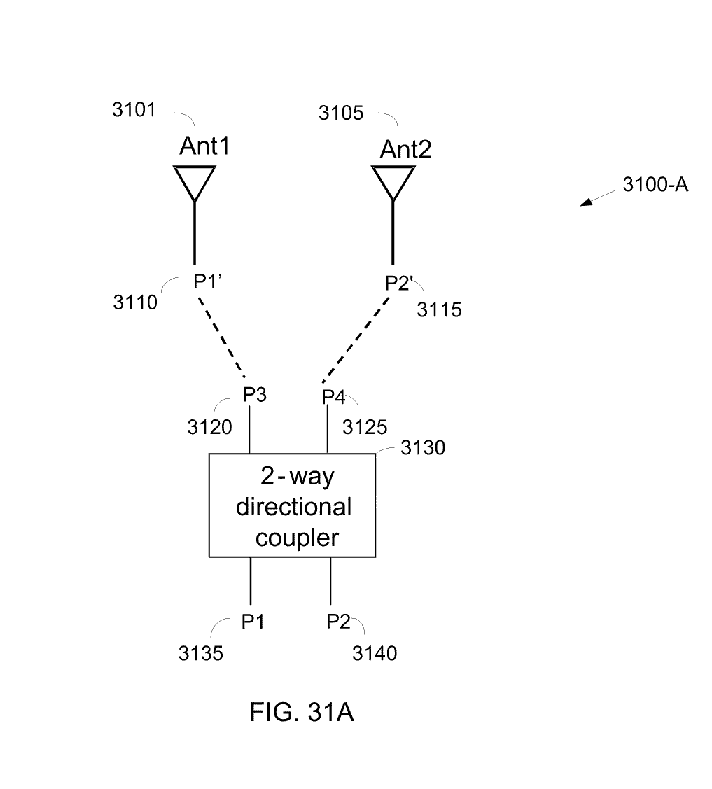

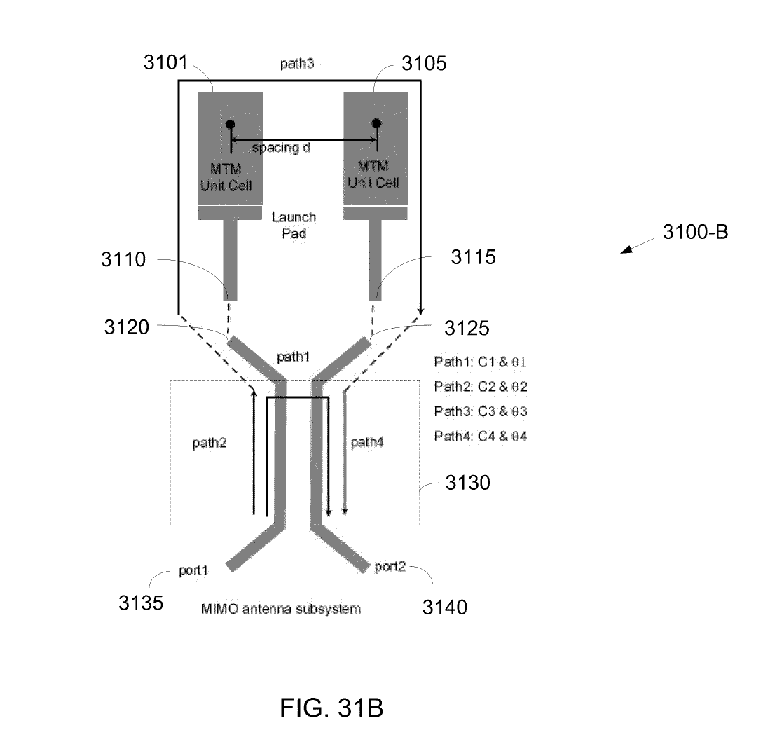

FIG. 31A and FIG. 31B illustrates an exemplary configuration of a two-antenna system 3100-A and 3100-B which includes a two-element metamaterial antenna array (including Ant1 3101 and Ant2 3105) and a two-way directional coupler 3130, which is a subset of the multi-antenna system shown in FIG. 13. The two-way directional coupler 3130 can include two inputs 3135 and 3140, which are denoted as P1 and P2, respectively. Two outputs, P3 3120 and P4 3125, of the directional coupler, can be connected to two antenna inputs P1′ 3110, P2′ 3115, respectively.

A detailed description of coupling between the inputs of the directional coupler is presented next. The input signal from P1 3135 can be coupled to P2 3140 through two paths. The first path starts at P1 3135 and proceeds to P3 3120 via the transmission of the directional coupler 3130. Next, the signal from the output P3 3120 is transmitted to the antenna input P1′ 3110 of Ant1 3101. The signal radiated from Ant1 3101 can be coupled to Ant2 3105 which is also coupled to the antenna input P2′ 3115. The signal at P2′ 3115 is transmitted to P4 3125 and then proceeds through the transmission of the directional coupler 3130 from P4 3125 to P2 3140. The second path starts at P1 3135 and ends at P2 3140 via the coupling of the directional coupler 3130. When the coupled signals from the two paths merge at P2 3140 with the same magnitude and 180° phase difference, the two coupled signals may cancel each other out. This condition generally maximizes the isolation between P1 3135 and P2 3140.

III.A1 Single-Band Two-Element Antenna Array with Two-way Directional Coupler Using Microwave Coupled Lines

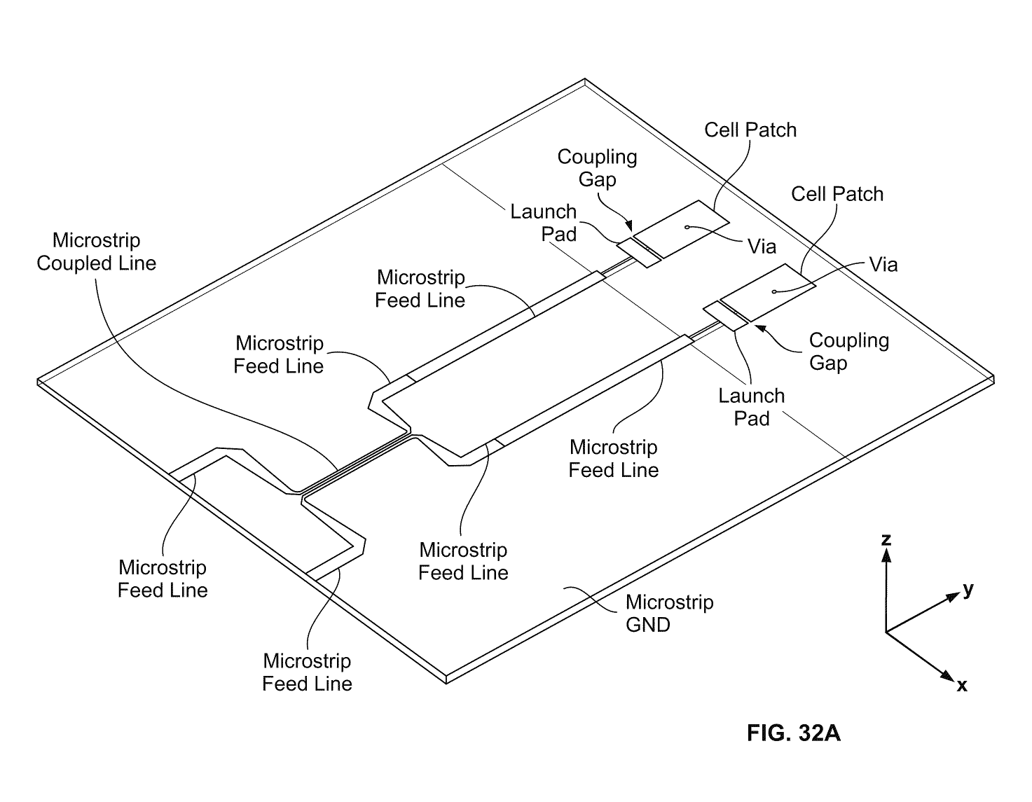

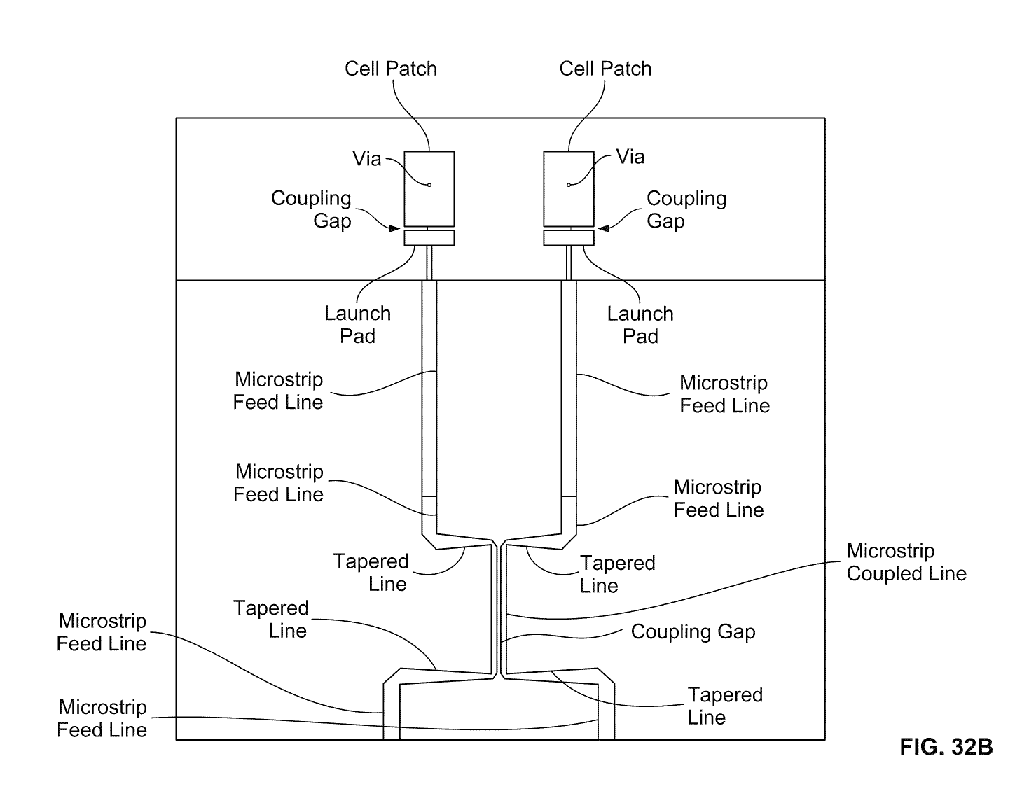

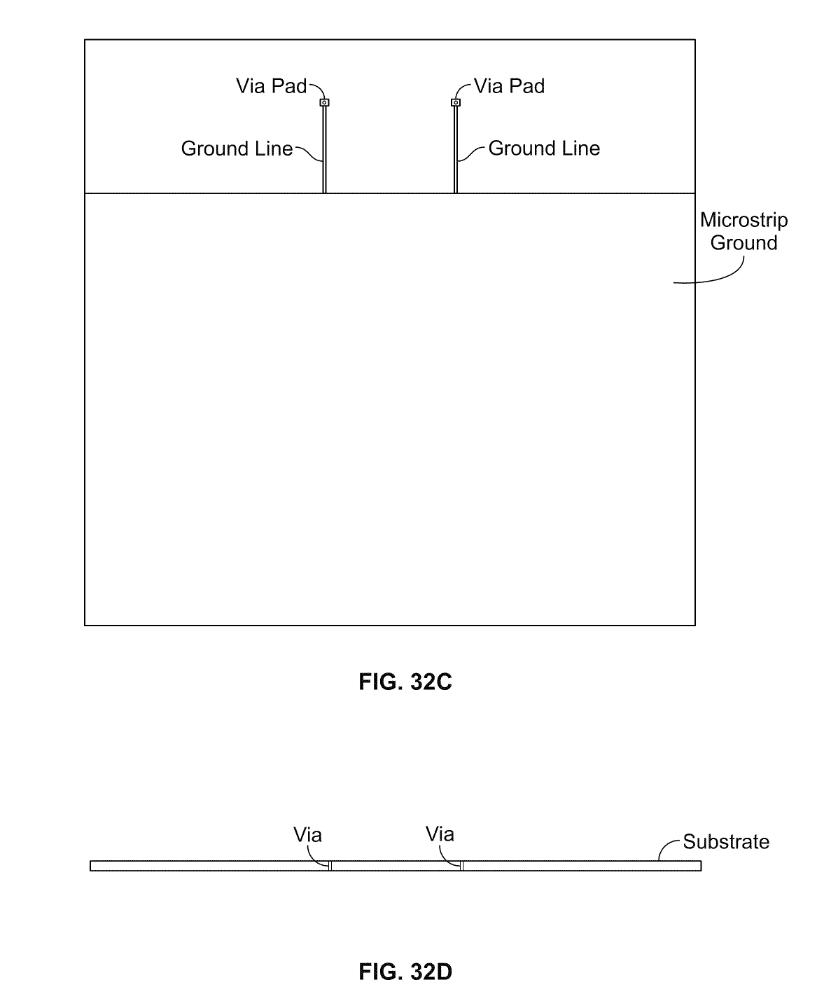

Multiple views showing various layers and elements of the multi-antenna system are depicted in FIGS. 32A-32D. For example, FIG. 32A shows the 3-dimensional view of stacked layers forming the multi-antenna system. FIG. 32B depicts the top layer of the multi-antenna system which comprises two-antenna elements. FIG. 32C depicts the bottom layer of the multi-antenna system, and FIG. 32D depicts a cross-sectional view of the multi-antenna system.

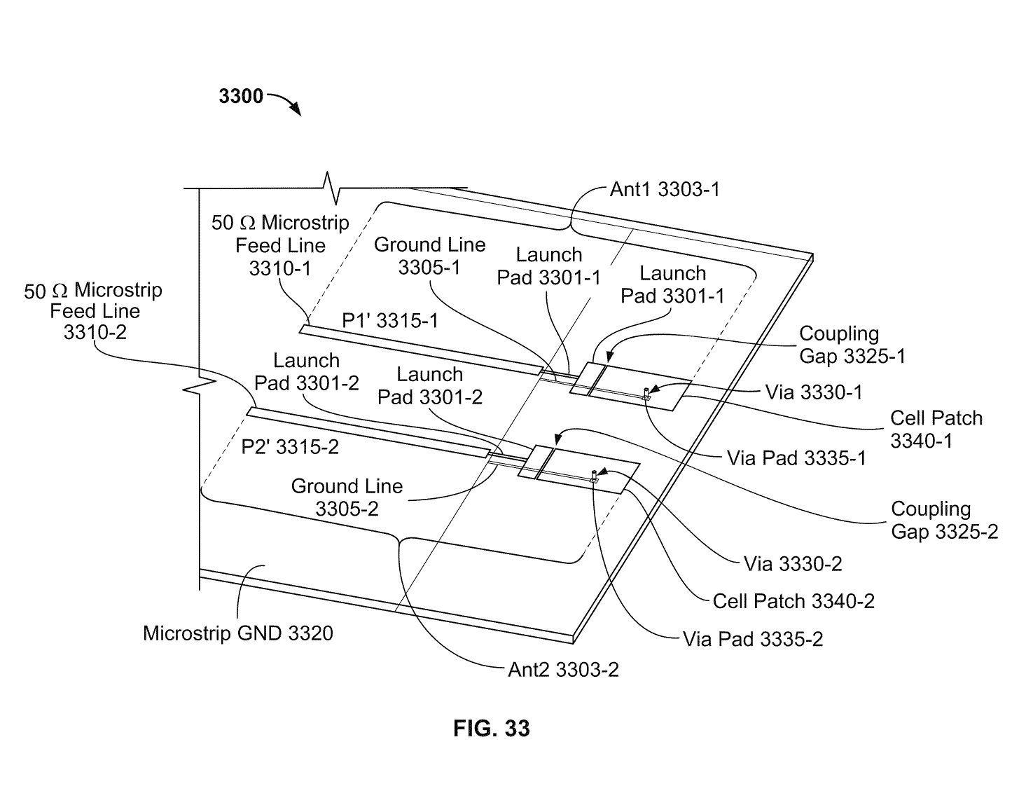

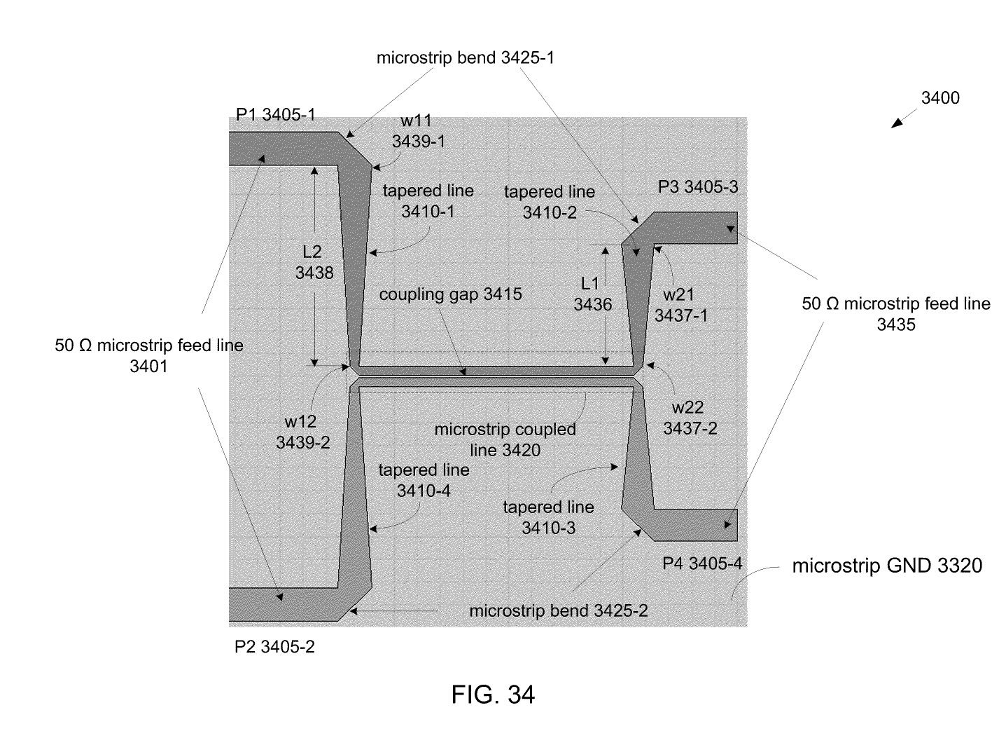

Referring again to FIG. 31A, the multi-antenna system 3100 can include the two-element antenna array (3101, 3105) and the two-way directional coupler 3130 which can be implemented by using a metamaterial antenna array 3300, as shown in FIG. 33, and a microwave directional coupler 3400, as shown in FIG. 34, respectively. A detailed description of each element is presented in Table 2.

In one implementation of the device in FIG. 33, the multi-antenna system 3100 in FIG. 31A can be designed on a 1-mm FR4 substrate with a dielectric constant of 4.4. The Ant1 3303-1 may be fed by a 50Ω microstrip feed line 3310-1 which may have a dimension of 1.4 mm×20 mm. One side of the 50Ω microstrip feed line 3310-1 may be directly connected to a launch pad 3301-1 of the Ant1 3303-1 while the other side of the 50Ω microstrip feed line 3310-1 may be connected to the input port P1′ 3315-1. In this example, the launch pad 3301-1 may include two rectangular shape lines. The dimension of the first rectangular shape line, which is connected to the 50Ω microstrip feed line 3110-1, may have a dimension of 0.4 mm×3.2 mm while the other line is capacitively coupled to the cell patch 3340-1 through a coupling gap 3325-1 (e.g., 0.16 mm) and may have a dimension of 4.7 mm×1.5 mm. The cell patch 3340-1 is shorted to the microstrip ground 3320 through a via 3330-1, a via pad 3335-1 and a ground line 3305-1. The cell patch 3340-1, in this example, may have a dimension of 4.7 mm×7 mm. The via 3330-1 is connected to the cell patch 3340-1 on one side of the substrate and to the via pad 3335-1 on the opposing side of the substrate. The via 3330-1 may have a radius of 0.15 mm and may be located at 2.96 mm from the top open end portion of the cell patch 3340-1 to the center of the via 3330-1. The via pad 3335-1 may have a dimension of 0.6 mm×0.6 mm and is connected to the microstrip ground 3320 through a ground line 3305-1. The dimension of the ground line 3305-1 may be 0.2 mm×8.6 mm. For the metamaterial antenna Ant2 3303-2, dimensions may be the same as the Ant1 3303-1. The spacing between the inside edge portion of the Ant1 3303-1 and the inside edge portion of the Ant2 3303-2 may be about 13 mm. Elements for Ant2 3303-2 include a cell patch 3340-2, via 3330-2, via pad 3335-2, coupling gap 3325-2, 50Ω microstrip feed line 3310-2, ground line 3305-2, port P2′ 3315-2, and launch pad 3301-2.

Referring to FIG. 34, the microwave directional coupler 3400 has four input/output ports (P1 3405-1, P2 3405-2, P3 3405-3, and P4 3405-4) where ports P1 3405-1 and P2 3405-2 can be used for the RF inputs while ports P3 3405-3 and P4 3405-4 are the outputs of the microwave directional coupler 3400, which can be connected to the metamaterial antenna array 3300 of FIG. 33. The dimension of each 50Ω microstrip feed line 3401 at the input end may have a dimension of 1.48 mm×5 mm, while the dimension of each microstrip feed line 3435 at the output end may be a 50Ω element and may have a dimension of 1.4 mm×2.15 mm. The coupling portion of the microwave directional coupler 3400 is realized by a microstrip coupled line 3420 where the length, width and coupling gap 3415 of the microstrip coupled line 3420 may be 14 mm, 0.4 mm and 0.1 mm, respectively. Four ends of microstrip coupled line 3420 are connected to four 50Ω microstrip feed line (3401, 3435) through four microstrip tapered lines (3410-1, 3410-2, 3410-3, 3410-4) and microstrip bends (3425-1, 3425-2) for the impedance matching purpose. The length, L1 3436, of the microstrip tapered line 3410-2 that is connected to the P3 3405-3, may be 5.35 mm. The widths, w21 3437-1 and w22 3437-2, of the microstrip tapered line 3410-2 may be 1.4 mm and 0.4 mm, respectively. The corresponding length and widths of the microstrip tapered line 3410-3 have the same dimensions as the microstrip tapered line 3410-2. The length, L2 3438, of the microstrip tapered line 3410-1 that is connected to the P1 3405-1, may be 8.9 mm. The widths, w11 3439-1 and w12 3439-2, of the microstrip tapered line 3410-1 may be 1.48 mm and 0.4 mm, respectively. The corresponding length and widths of the microstrip tapered line 3410-4 can have the same dimensions as the microstrip tapered line 3410-1.

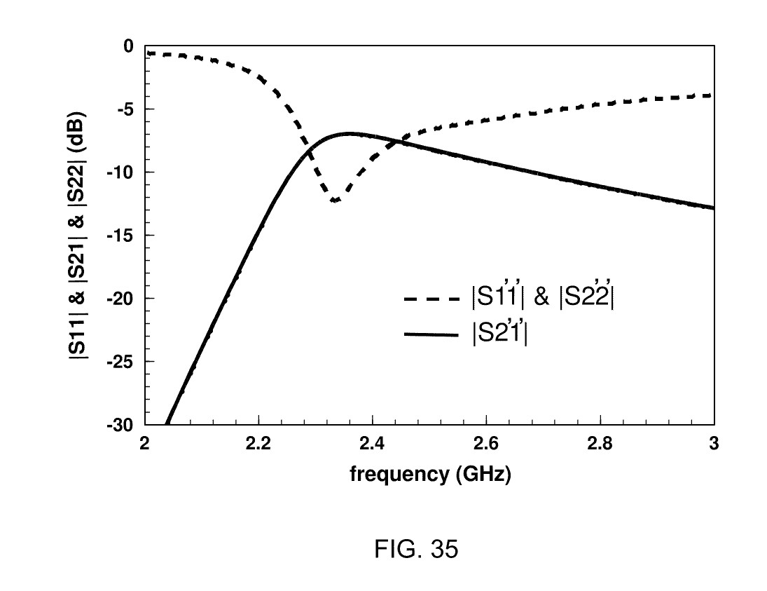

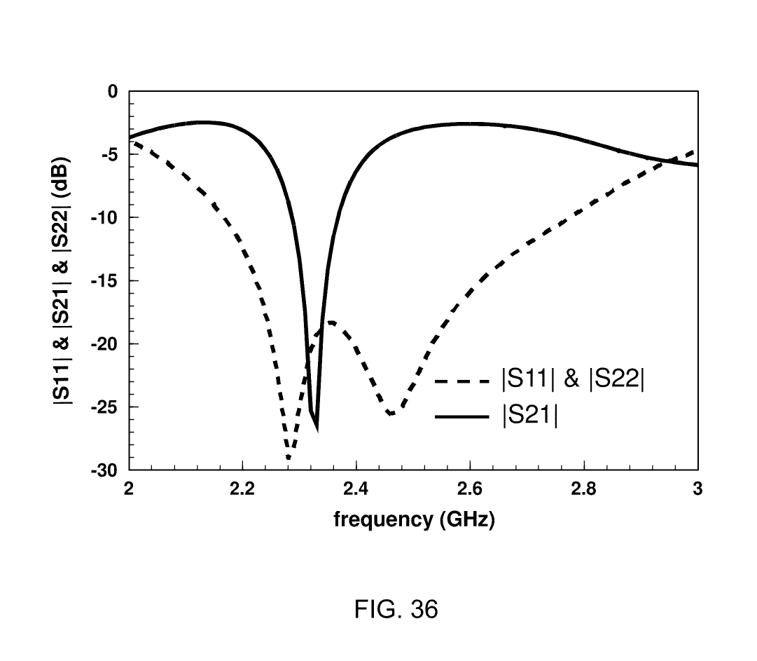

The multi-antenna system shown in FIGS. 32A-32D is simulated by using Ansoft HFSS. Designs are fabricated and tested using a network analyzer. FIG. 35 illustrates the return losses of the two metamaterial antenna elements (3303-1 and 3303-2) and coupling level between the two metamaterial antenna elements (3303-1, 3303-2) in FIG. 33. FIG. 36 illustrates the return losses of the multi-antenna system shown in FIGS. 32A-32D and the coupling level at inputs (P1 3405-1 and P2 3405-2), shown in FIG. 34 when P3 3405-2 and P4 3405-4 are connected to metamaterial antenna elements (3303-1, 3303-2) in FIG. 33. Based on these results, the isolation between the two MTM antenna elements (3303-1, 3303-2) of FIG. 33 can be improved while maintaining a low return loss and a sufficient bandwidth.

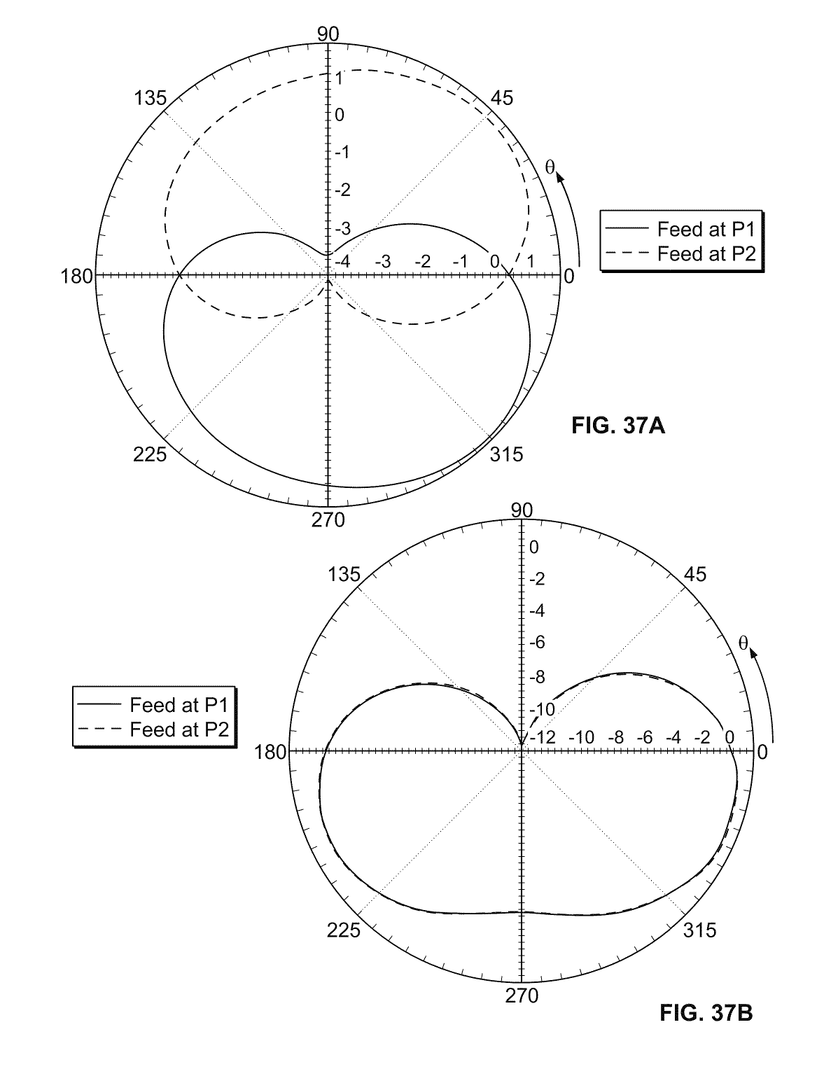

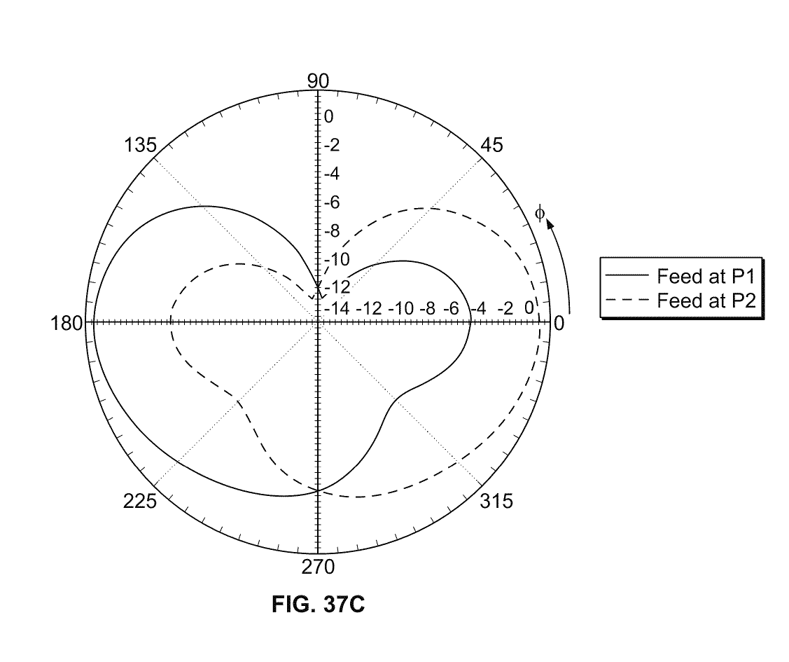

FIGS. 37A-37C illustrate radiation patterns of the multi-antenna system of FIGS. 32A-32D. Notably, radiation beam patterns shown in FIGS. 37A-37C point in opposite directions allowing the two signals to propagate in different paths. Such results generally indicate successful pattern diversity and low far-field envelope correlation in the multi-antenna system of FIGS. 32A-32D.

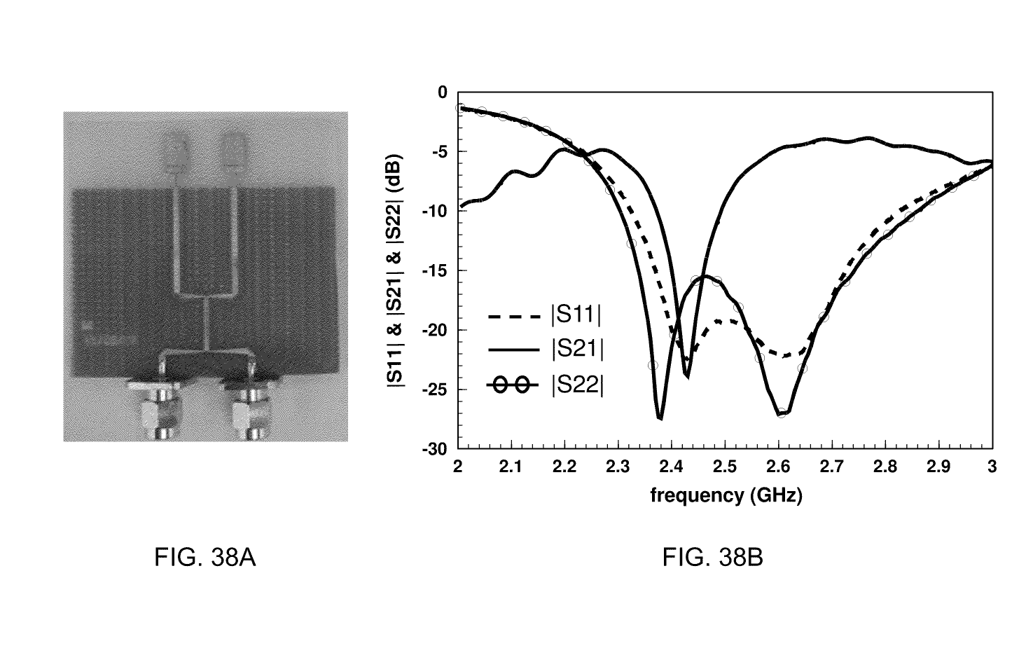

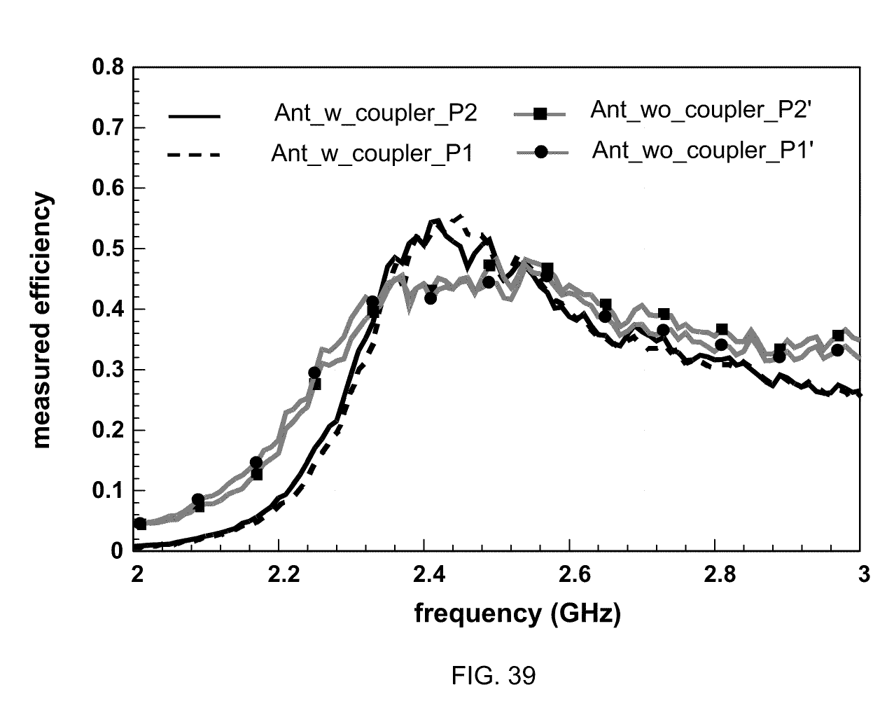

FIG. 38A shows a fabricated multi-antenna system of FIGS. 32A-32D while FIG. 38B depicts the measured return losses and isolation. FIG. 39 illustrates a comparison of the measured radiation efficiencies for the multi-antenna system with (shown in FIGS. 32A-32D) and without (shown in FIG. 33) the microwave directional coupler 3400 as shown in FIG. 34. The efficiency with the microwave directional coupler 3400 is increased by around 10% at about 2.4 GHz.

TABLE 2
Multi-Antenna, Directional Coupler System: Two-Element
Antenna Array, Two-way Directional Coupler using Microwave
Coupled Lines (single band)

| Parameter | Description | | Location |
|---|---|---|---|
| Multi- | Multi-antenna system includes a | | |
| Antenna | Metamaterial Antenna Array and a | | |
| System | Microwave Directional Coupler. | | |
| Metamaterial | Antenna array comprises two MTM | | |
| Antenna | Antenna Elements. | | |
| Array | | | |
| MTM Antenna | Each antenna element comprises an MTM | | |
| Element | Cell coupled to the 50 Ω microstrip | | |
| | line via a Launch Pad. Launch Pad is | | |
| | located on top of the substrate. | | |
| Launch Pad | Two rectangular shape that connects | | Top Layer |
| | Cell Patch to the 50 Ω microstrip feed | | |
| | line. There is a coupling gap between | | |
| | the Launch Pad and the Cell Patch. | | |
| MTM Cell | Cell | Rectangular shape | Top Layer |
| | Patch | | |
| | Via | Cylindrical shape and connects | Top Layer |
| | | the Cell Patch with the Via | to Bottom |
| | | Pad. | Layer |
| | Via | Small square pad that connects | Bottom |
| | Pad | the bottom part of the Via to | Layer |
| | | the GND Line. | |
| | GND | Connects the Via Pad to the | Bottom |
| | Line | main GND | Layer |

| | | |
|---|---|---|
| Microwave | Directional coupler includes a | |
| Directional | Microstrip Coupled Line, four Tapered | |
| Coupler | Lines, and Four Microstrip Bend | |
| Microstrip | Two parallel microstrip line with a | Top Layer |
| Coupled Line | coupling gap in between. | |
| Tapered Line | Microstrip line with different line | Top Layer |
| | width at both ends. | |
| Microstrip | Triangular shape of microstrip | Top Layer |
| Bend | junction to connect two perpendicular | |
| | microstrip lines. | |

III.A2 Single-Band Two-Element Antenna Array with Two-way Directional Coupler using MTM Transmission Line

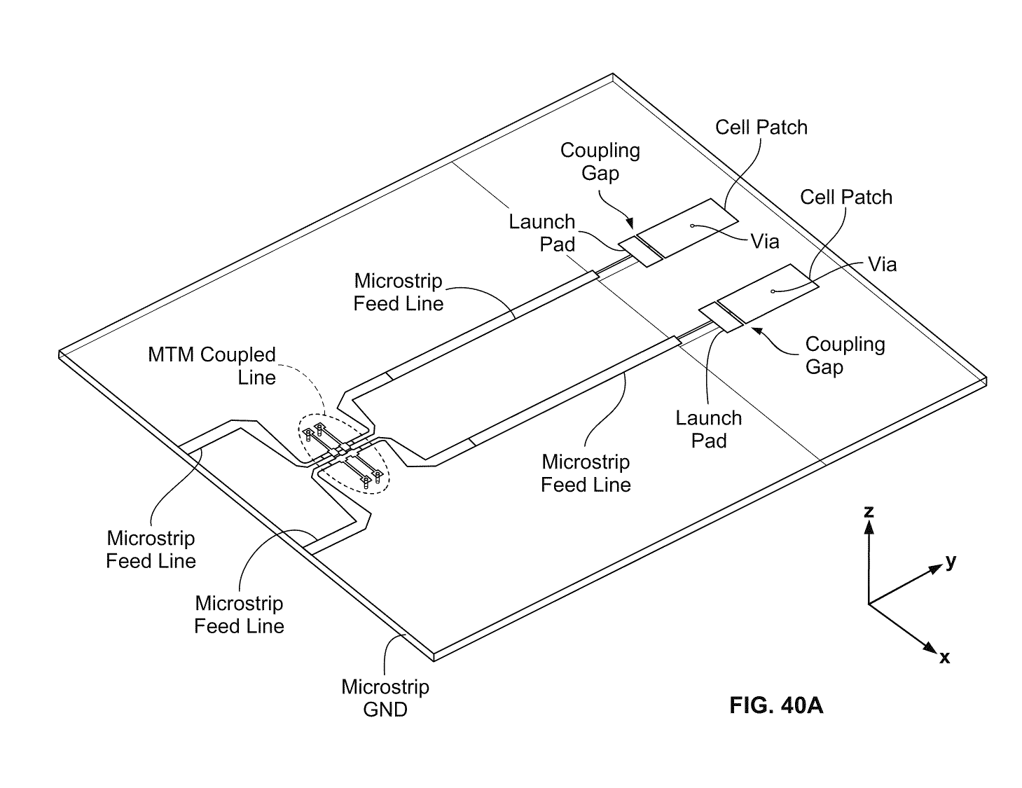

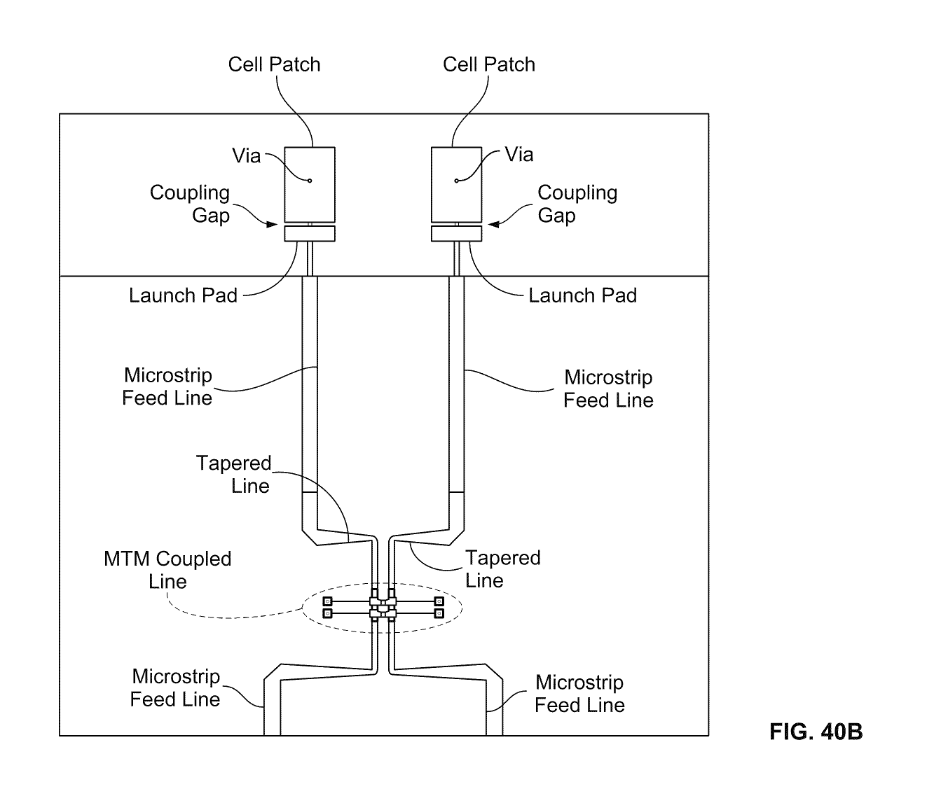

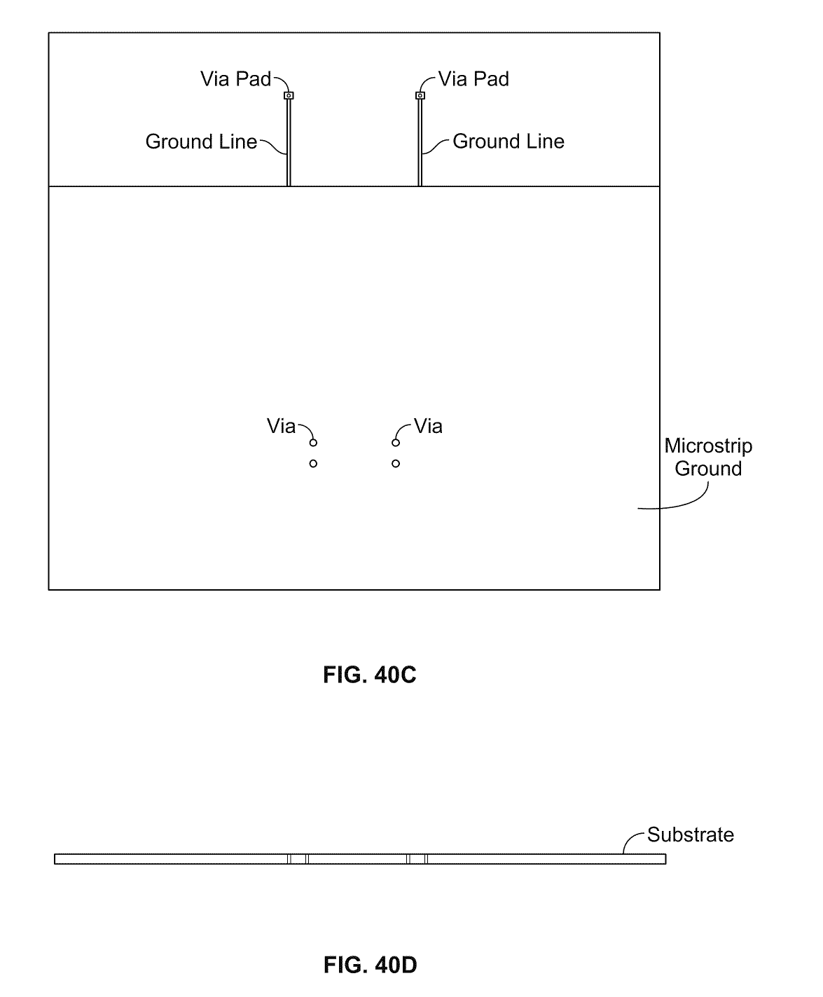

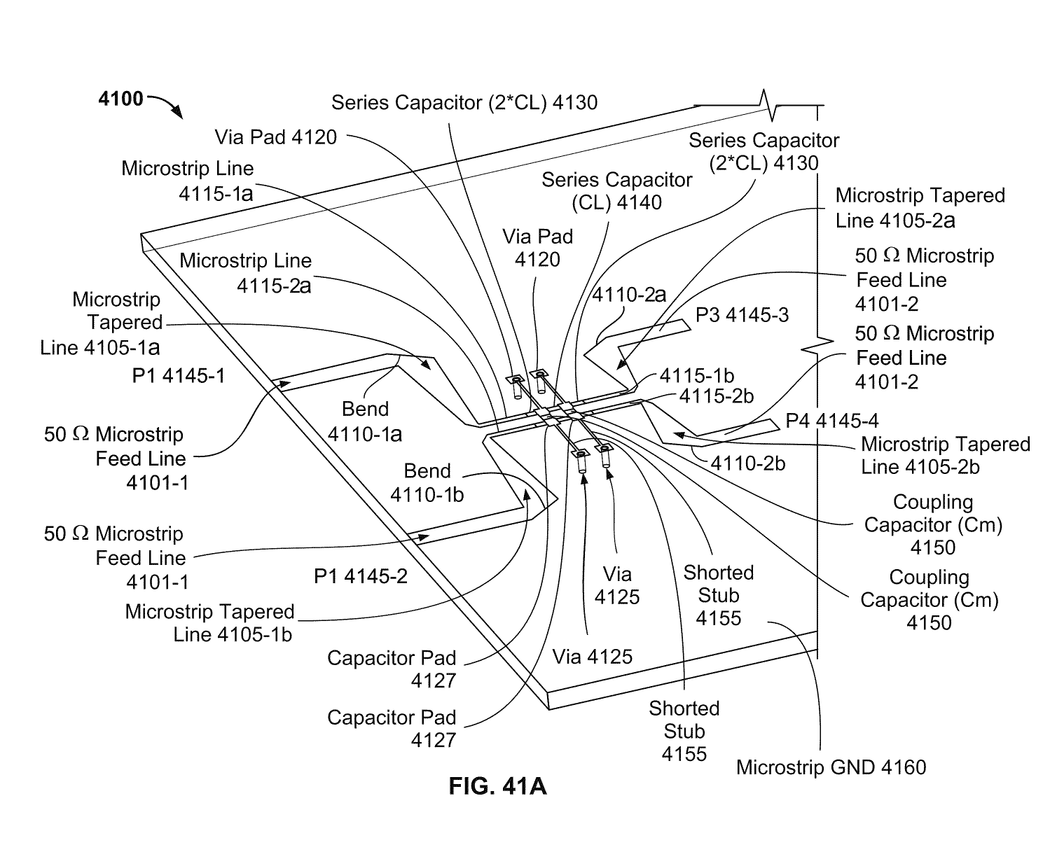

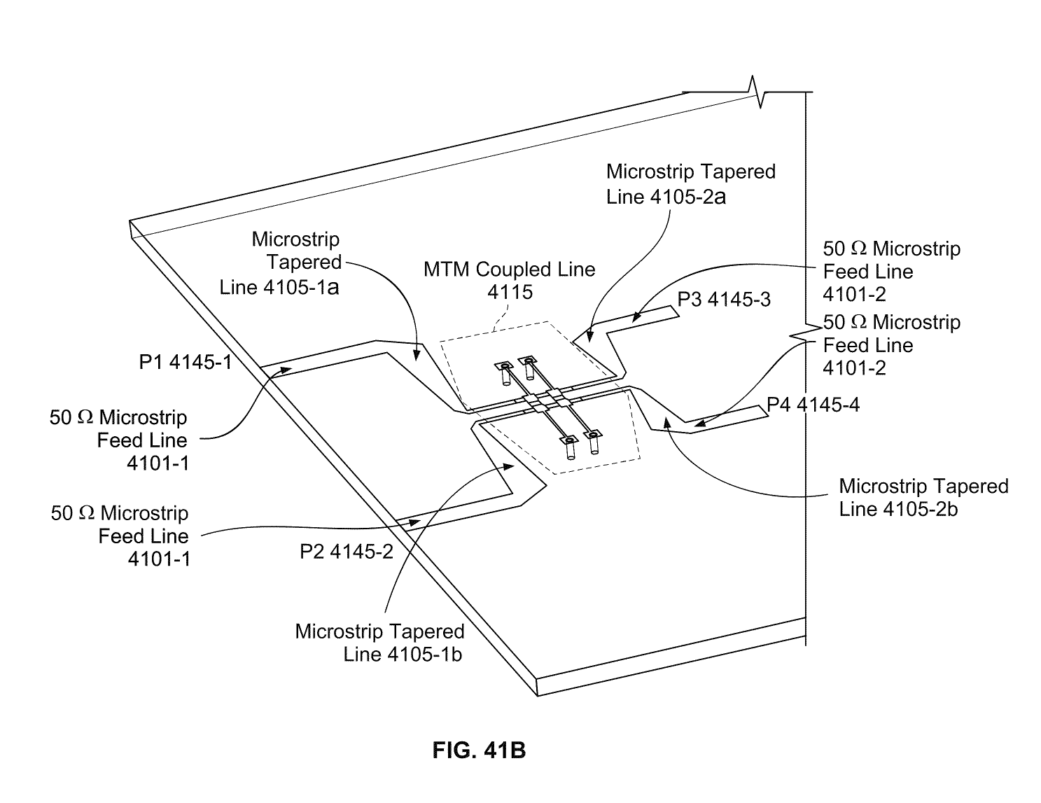

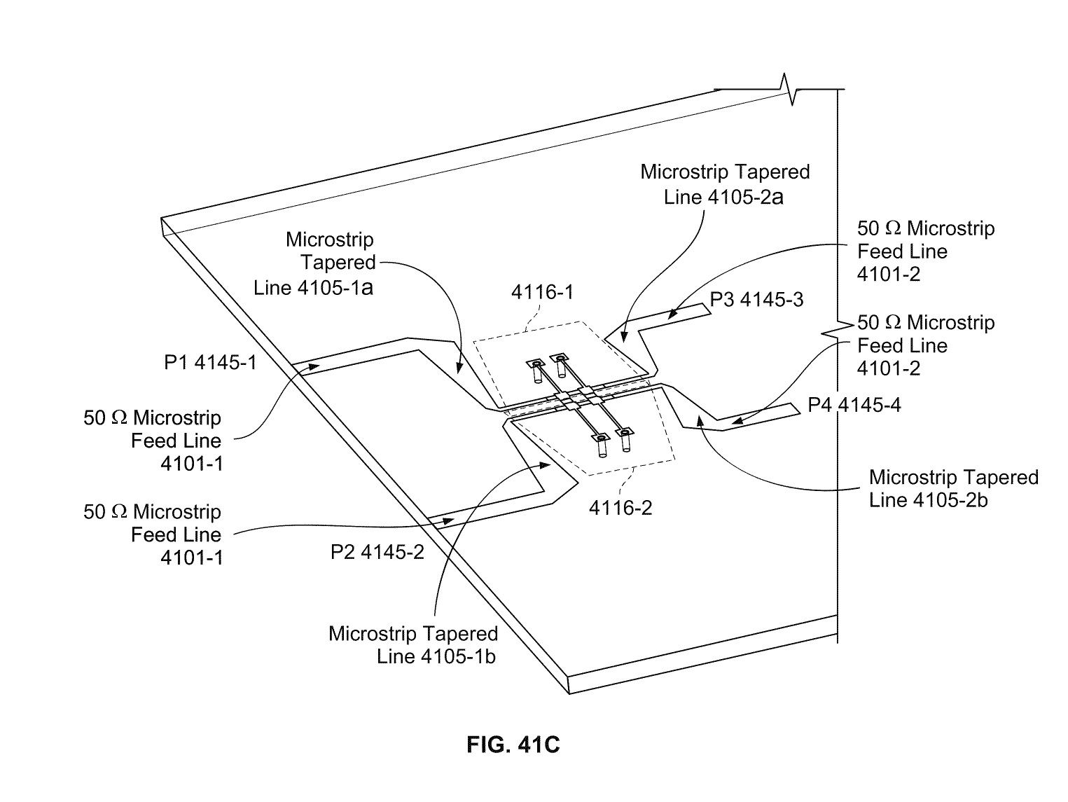

In FIG. 31A, the size of the multi-antenna system 3100 is dependent on the metamaterial antenna array (3101, 3105) and the microwave directional coupler 3130. Therefore, the overall size of the multi-antenna system in FIGS. 32A-32D can be reduced by shrinking the coupler size. As shown in FIGS. 40A-40D, a smaller multi-antenna system can be achieved where the microwave directional coupler 3400 of FIG. 34 is replaced by an MTM coupler 4100 of FIG. 41A, and the two MTM antenna array remains the same as in the previous implementation shown in FIG. 33. FIG. 41B and FIG. 41C show specific portions of the coupled transmission line and a pair of metamaterial transmission lines, respectively, in the same MTM coupler 4100 of FIG. 41A. Each antenna element is presented in detail in Table 3.

A detailed view of the MTM coupler 4100 is presented in FIG. 41A. The MTM coupler 4100 of FIG. 41A has four ports (P1 4145-1, P2 4145-2, P3 4145-3, P4 4145-4) that can be used as input and output to the coupler. In this example, ports P1 4145-1 and P2 4145-2 can be used for the RF inputs while ports P3 4145-3 and P4 4145-4 can be used for the outputs of the MTM coupler, which can be connected to the two metamaterial antenna input ports P1′ 3315-1 and P2′ 3315-2 as shown in FIG. 33. The dimension of each 50Ω microstrip feed line 4101-1 for the two coupler inputs is 1.48 mm×5 mm, and the dimension of each 50Ω microstrip feed line 4101-2 for the two coupler outputs is 1.4 mm×3.15 mm.

To replace the microwave directional coupler 3400 of FIG. 34 with MTM coupler 4100 of FIG. 41A, the microstrip coupled line 3420 shown in FIG. 34 can be replaced by using an MTM coupled line 4115 as shown in FIG. 41B. The MTM coupled line 4115 shown in FIG. 41B can include two parallel MTM transmission lines (4116-1, 4116-2) as shown in FIG. 41C. The MTM transmission line 4116-2 of FIG. 41C can include two microstrip lines sections (4115-2a and 4115-2b), capacitor pads 4127, three series capacitors (4130, 4140) and two shorted stubs 4155 as shown in FIG. 41A. The other MTM transmission line 4116-1 may have identical components as the MTM transmission line 4116-2. The microstrip line sections (4115-1a and 4115-1b, 4115-2a and 4115-2b), in this implementation, can have the same dimensions where each of the line sections measures about 0.4 mm×2 mm.

The MTM coupler 4100 of FIG. 41A may include a coupling portion that is realized by an MTM coupled line 4115 of FIG. 41B where the two MTM transmission lines 4116-1 and 4116-2 of FIG. 41C, can be placed in parallel with each other. In FIG. 41A, a coupling capacitor Cm 4150 may be used to connect the two MTM transmission lines 4116-1 and 4116-2 of FIG. 41C. The total length of the MTM coupled line 4115 shown in FIG. 41B is about 6.4 mm while the gap between the two MTM transmission lines 4116-1 and 4116-2 shown in FIG. 41C is about 1 mm. The coupling capacitor 4150 of 0.5 pF can be used in this implementation to enhance the coupling between the MTM transmission lines (4116-1 and 4116-2) shown in FIG. 41C.

Referring again to FIG. 41A, two microstrip line sections 4115-2a and 4115-2b can be connected by three series capacitors in the sequence of 2C_{L} 4130, C_{L} 4140, and 2C_{L} 4130. Two capacitor pads 4127 located between the two microstrip line sections 4115-2a and 4115-2b can be used as metal bases to mount the series capacitors (4130, 4140) on. In one implementation, C_{L} 4140 is realized by using the chip capacitor with value of 0.85 pF and 2C_{L} is realized by using the chip capacitor with value of 1.7 pF. The spacing between the microstrip line section (4115-2a and 4115-2b) and the capacitor pad 4127 is about 0.4 mm. The spacing between the two capacitor pads 4127 is also about 0.4 mm. Each capacitor pad 4127 has a dimension of about 0.6 mm×0.8 mm. One side of the shorted stub 4155 can be attached at the center of the capacitor pad 4127 and the other side may be connected to the via pad 4120. The via pad 4120 can be connected to the microstrip GND 4160 through the via 4125. The shorted stub 4155 has a dimension of about 0.1 mm×3 mm. The via pad 4120 has a dimension of about 0.6 mm×0.6 mm. The via 4125 can be centered at the via pad 4120 having a radius of about 0.15 mm and height of about 1 mm. The four microstrip line sections (4115-1a, 4115-1b, 4115-2a, 4115-2b) may be connected to the four 50Ω microstrip feed lines (4101-1, 4101-2) through four microstrip tapered lines (4105-1a, 4105-1b, 4105-2a, 4105-2b) and four microstrip bends (4110-1a, 4110-1b, 4110-2a, 4110-2b) for impedance matching purpose. In FIG. 41A, the length of microstrip tapered line (4105-1a, 4105-1b) that is connected to the 50Ω microstrip feed line 4101-1 measures about 8.35 mm while the widths of each microstrip tapered line (4105-1a, 4105-1b) measure about 1.48 mm at one end and about 0.4 mm at the other end. The length of each microstrip tapered line (4105-2a, 4105-2b) that is connected to the 50Ω microstrip feed line 4101-2 measures about 4.9 mm while the widths for each microstrip tapered line (4105-2a, 4105-2b) measure about 1.4 mm at one end portion and about 0.4 mm at the other end portion.

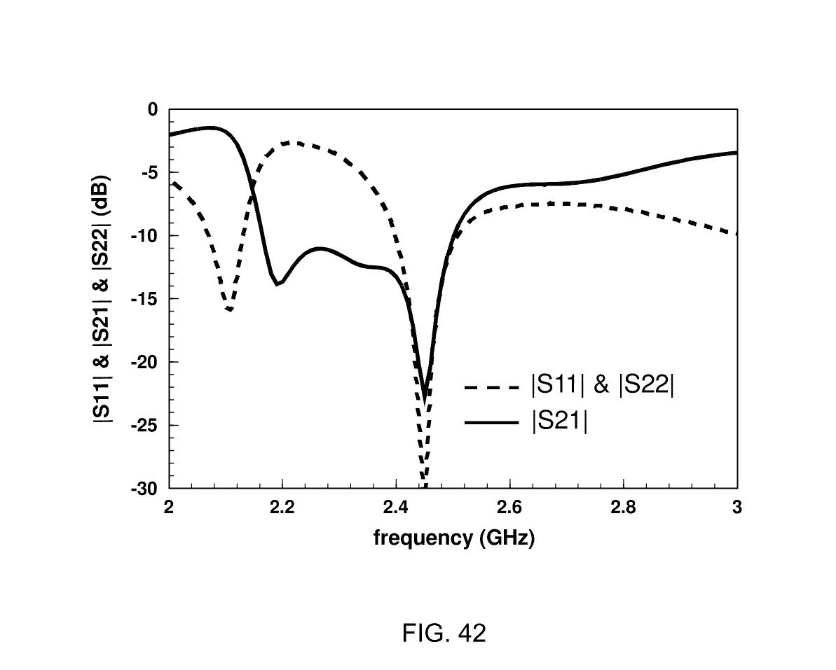

The multi-antenna system shown in FIGS. 40A-40D is simulated by using Ansoft HFSS while designs can be fabricated and tested using a network analyzer. FIG. 42 shows the return losses and coupling level between two inputs of the multi-antenna system shown in FIGS. 40A-40D in which an improvement of the isolation between the two inputs is obtained as compared to the result shown in FIG. 35.

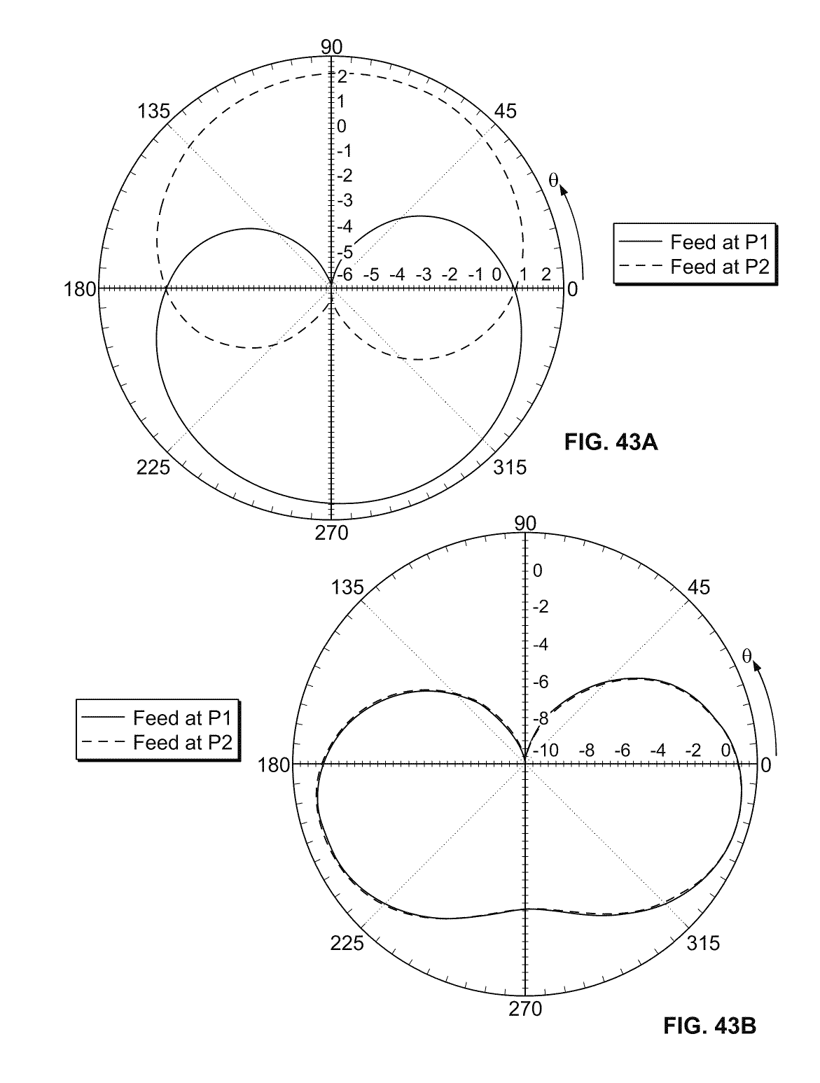

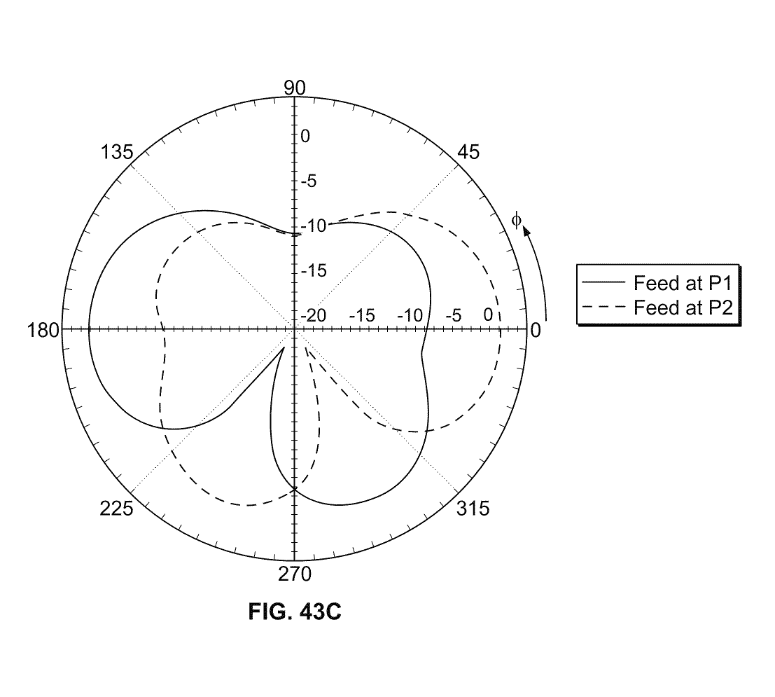

FIG. 43A-43C illustrates radiation patterns of the multi-antenna system using the MTM coupler shown in FIGS. 40A-40D in which two opposite beam directions with respect to two inputs occur. Such results generally indicate successful pattern diversity and low far-field envelope correlation.

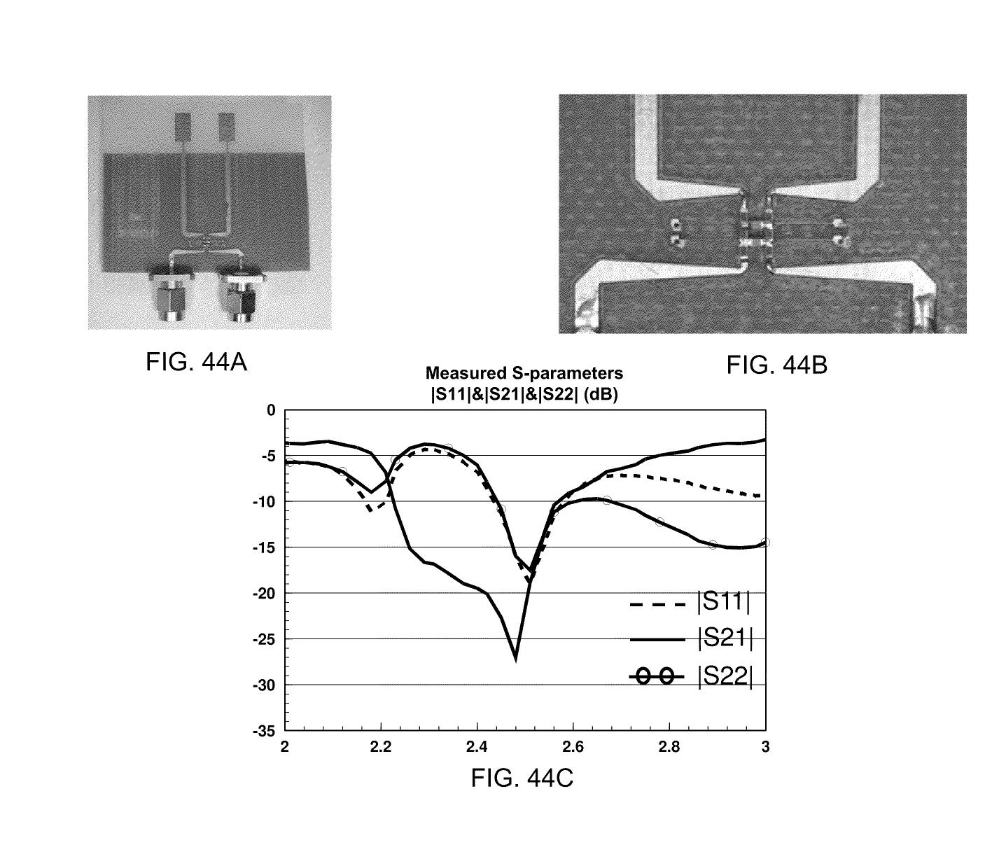

FIGS. 44A-44B shows a fabricated multi-antenna system shown in FIGS. 40A-40D while FIG. 44C illustrates the measured return losses and isolation between two inputs of multi-antenna system shown in FIGS. 40A-40D.

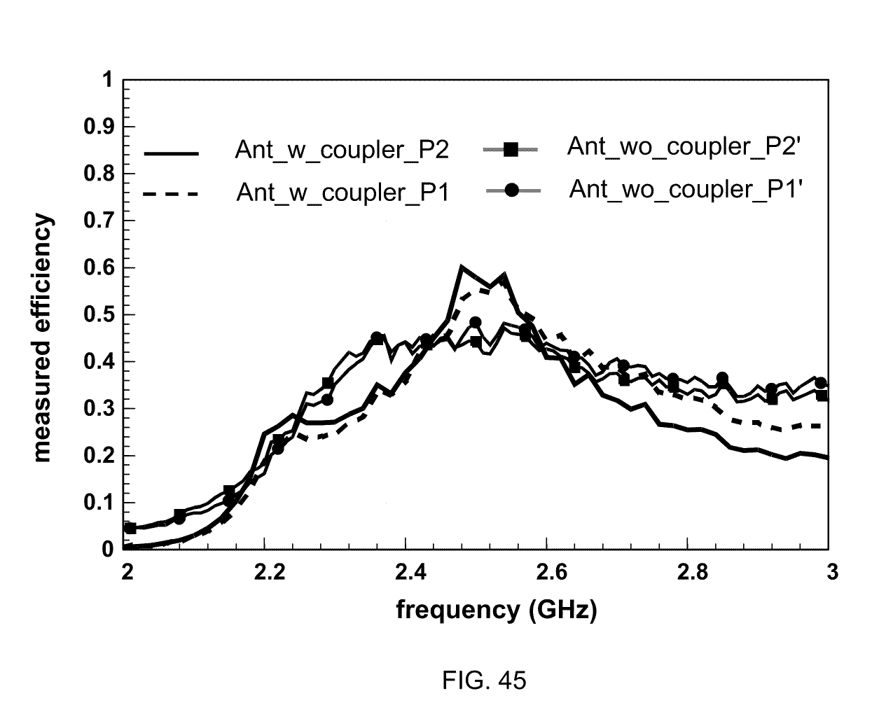

FIG. 45 shows a comparison of the measured radiation efficiencies for the multi-antenna system presented in this section with and without the MTM coupler 4100 shown in FIG. 41A. In this implementation, the efficiency with MTM coupler is raised by about 15% at about 2.5 GHz.

TABLE 3
Multi-Antenna, Directional Coupler System: Two-Element
Antenna Array, Two-way Directional Coupler using MTM
Transmission Line (single band)

| Parameter | Description | | Location |
|---|---|---|---|
| Multi- | Multi-antenna system includes an MTM | | |
| Antenna | Antenna Array and an MTM Coupler. | | |
| System | | | |
| MTM Antenna | Antenna array includes two MTM Antenna | | |
| Array | Elements. | | |
| MTM Antenna | Each antenna element includes an MTM Cell | | |
| Element | coupled to the 50 Ω microstrip line via | | |
| | a Launch Pad. Launch Pad is located on | | |
| | top of the substrate. | | |
| Launch Pad | Two rectangular shape that connects Cell | | Top |
| | Patch to the 50 Ω microstrip feed line. | | Layer |
| | There is a coupling gap between the | | |
| | Launch Pad and the Cell Patch. | | |
| MTM Cell | Cell | Rectangular shape | Top |
| | Patch | | Layer |
| | Via | Cylindrical shape and | Top |
| | | connects the Cell Patch with | Layer to |
| | | the Via Pad. | Bottom |
| | | | Layer |
| | Via Pad | Small square pad that | Bottom |
| | | connects the bottom part of | Layer |
| | | the Via to the Ground Line. | |
| | Ground | Connects the Via Pad to the | Bottom |
| | Line | microstrip ground. | Layer |
| MTM Coupler | Two MTM Transmission Lines parallel to | | |
| | each other with Coupling Capacitor | | |
| | connecting the two lines. Each MTM | | |
| | Transmission Line includes two Microstrip | | |
| | Line sections, Series Capacitors, | | |
| | Capacitor Pad, Shorted Stub, via Pad, and | | |
| | Via. | | |
| | Microstrip | Rectangular shape line. | Top |
| | Line | | Layer |
| | Series | Chip capacitor (2*CL) which | Top |
| | Capacitor | connects one end of the | Layer |
| | | Microstrip Line and one end | |
| | | of the Capacitor Pad. Chip | |
| | | capacitor (CL) which connects | |
| | | between two Capacitor Pads. | |
| | Coupling | Chip capacitor (Cm) which | Top |
| | Capacitor | connects between two | Layer |
| | | Capacitor Pads in the | |
| | | directional perpendicular to | |
| | | the Microstrip Line. | |
| | Capacitor | Rectangular shape. | Top |
| | Pad | | Layer |
| | Shorted | Rectangular shape line with | Top |
| | Stub | one end connected to the | Layer |
| | | Capacitor Pad and the other | |
| | | end connected to the Via Pad. | |
| | Via Pad | Square shape. | Top |
| | | | Layer |
| | Via | Cylindrical shape. Connecting | Top |
| | | Via Pad to microstrip ground. | Layer |

| | | |
|---|---|---|
| Tapered | Microstrip line with different line width | Top |
| Line | at both ends. | Layer |
| Microstrip | Triangular shape of microstrip junction | Top |
| Bend | to connect two perpendicular microstrip | Layer |
| | lines. | |

III.A3 Single-Band Two-Element Antenna Array with MTM Transmission Line Feed and Two-way Directional Coupler Using MTM Transmission Line

To further reduce the overall size of the multi-antenna system of FIGS. 40A-40D, shorter feed lines of the metamaterial antenna array can be utilized to reduce the size while still maintaining the same phase of the previous sections. In this implementation, the shorter feed lines of the metamaterial antenna array can be utilized to decouple the two input/output signals by either microwave directional coupler or the MTM coupler.

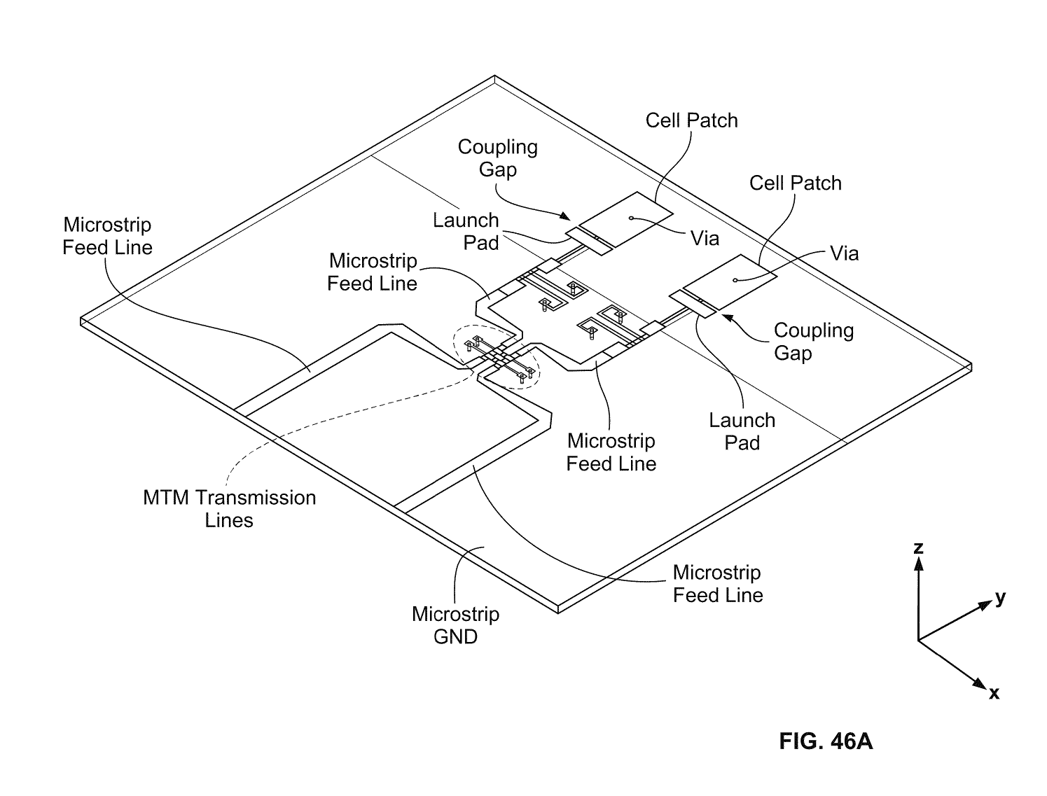

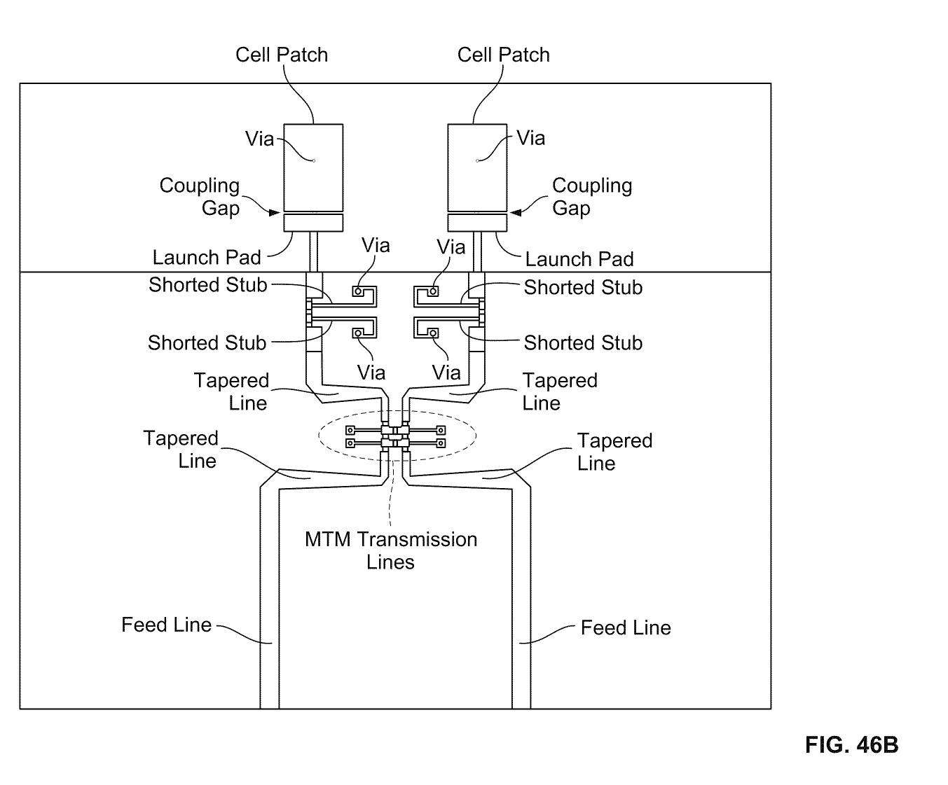

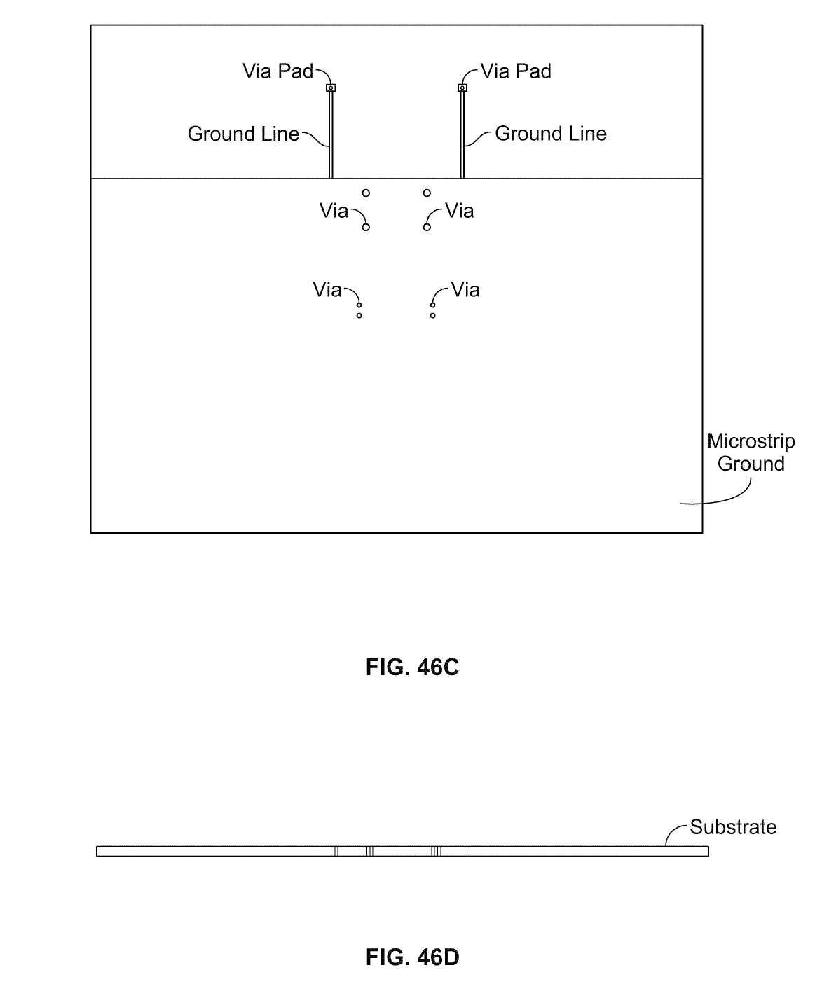

FIGS. 46A-46D illustrates multiple views of layers and elements of the multi-antenna system presented in this section. In this implementation, the multi-antenna system may include a metamaterial antenna array with 13 mm spacing between the inner edges of two antenna elements and an MTM coupler. The multi-antenna system shown in FIGS. 46A-46D can be designed on a 1 mm FR4 substrate having a dielectric constant of 4.4.

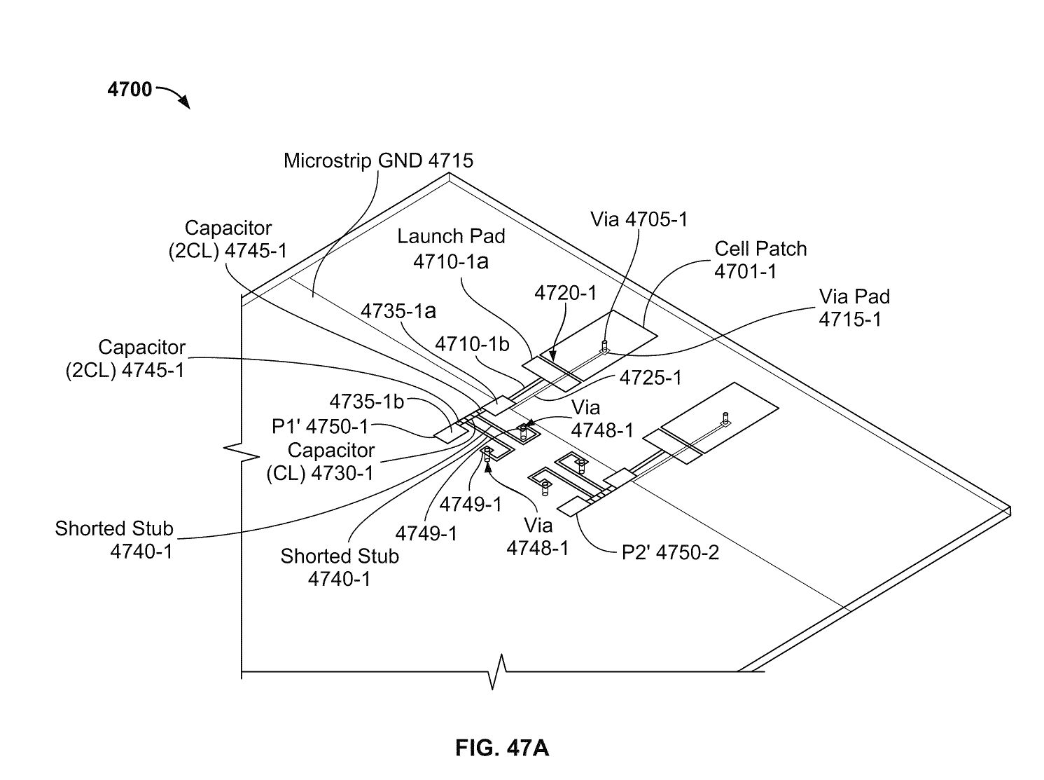

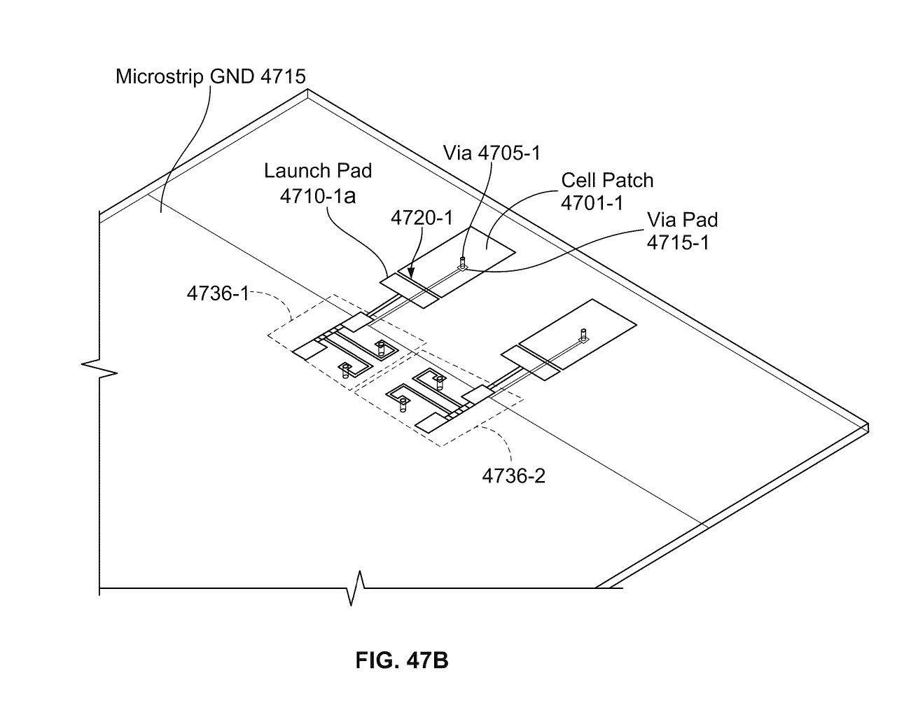

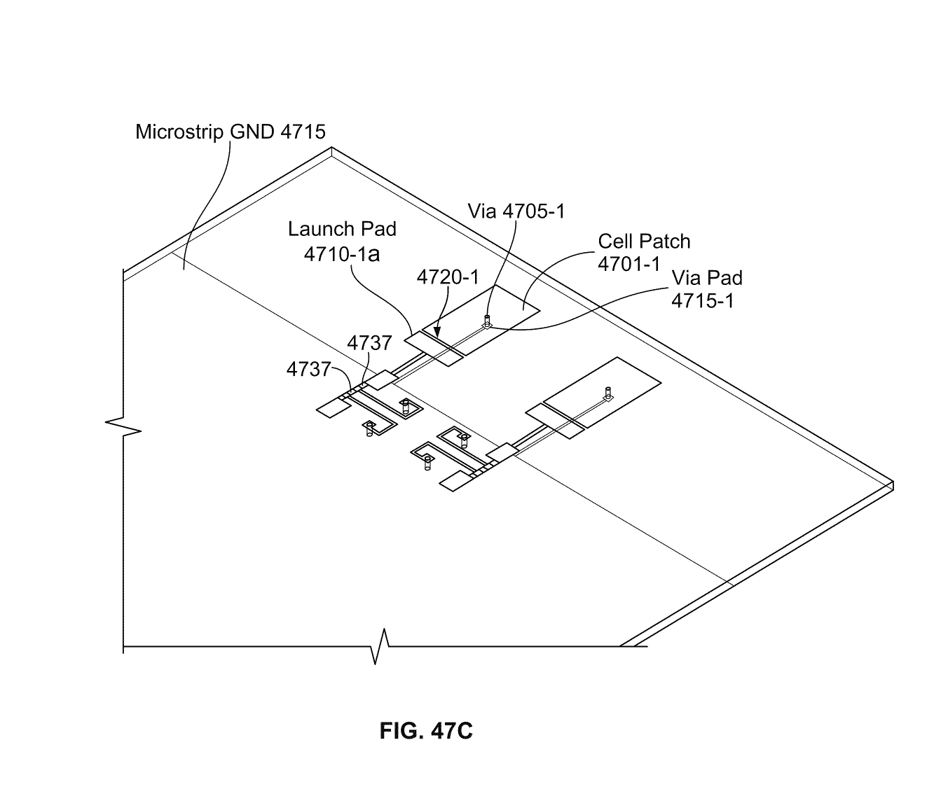

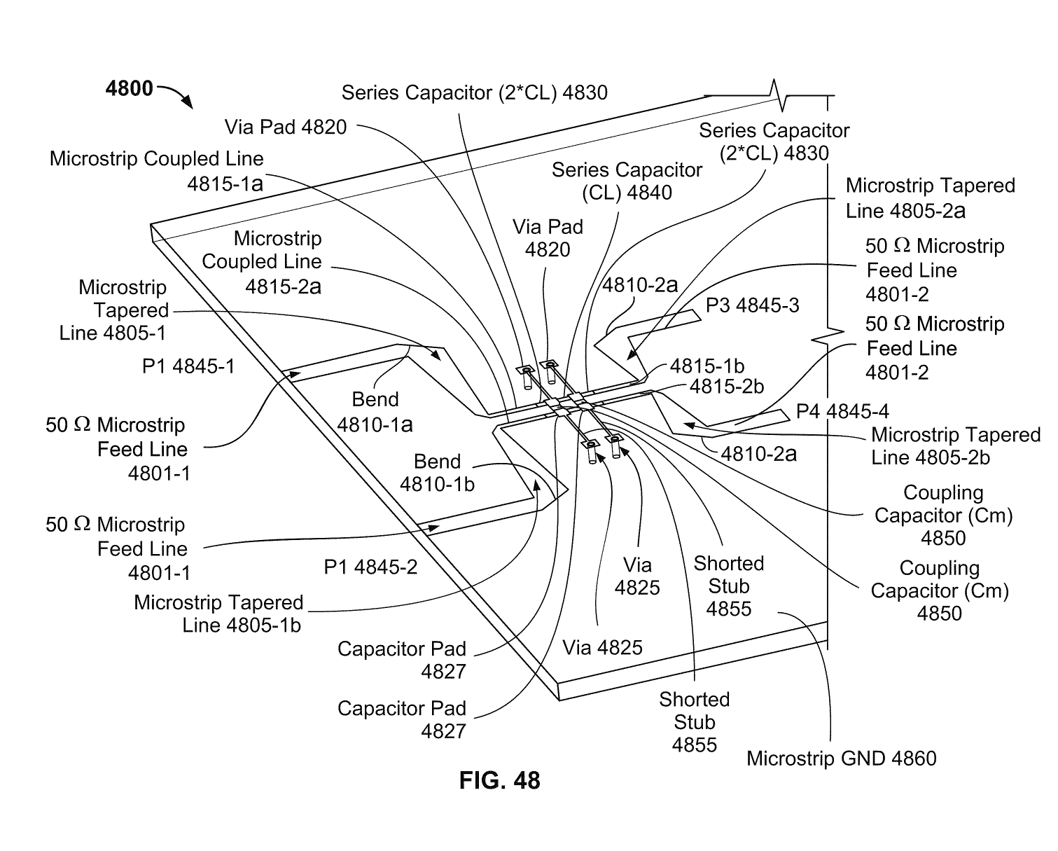

A detailed view of a metamaterial antenna array 4700 and a MTM coupler 4800 are shown in FIG. 47A and FIG. 48, respectively. FIG. 47B represents the same metamaterial antenna array 4700 of FIG. 47A and outlines the specific portions of metamaterial transmission lines. Each element is described in Table 4.

In this example, a metamaterial transmission line (4736-1, 4736-2) shown in FIG. 47B is used instead of using microstrip feed line for the metamaterial antenna array 4700 shown in FIG. 47A. The transmission line designed by metamaterial technology is known to have properties such that the propagation constant can be controlled to satisfy the phase requirement of the design while still maintaining a small physical size. Therefore, significant size reduction of the multi-antenna system can be achieved by using the metamaterial transmission line for the antenna feed.

Referring again to FIG. 47A, one antenna element in the metamaterial antenna array includes an cell patch 4701-1 which is coupled to a launch pad (4710-1a and 4710-1b) through a coupling gap 4720-1. The cell patch 4701-1 may have a dimension of about 4.7 mm×7 mm and the coupling gap 4720-1 may measure about 0.16 mm. The launch pad can include two rectangular shape lines (4710-1a, 4710-1b). The launch pad portion 4710-1b is connected to the metamaterial transmission line 4736-1 and may be of about 0.4 mm×3.2 mm. The launch pad portion 4710-1a is capacitively coupled to the cell patch 4701-1 and may be about 4.7 mm×1.5 mm. The cell patch 4701-1 can be connected to the via pad 4715-1 through a via 4705-1. The via 4705-1 may be further connected to the cell patch 4701-1 on a first side of the substrate and connected to a via pad 4715-1 on the opposing side of the substrate. The via 4705-1 radius may be about 0.15 mm and the via center may be about 2.96 mm away from the top open end of the cell patch 4705-1. The via pad 4715-1 may be about 0.6 mm×0.6 mm. The ground line 4725-1, which may be about 0.2 mm×8.6 mm, can be connected to the via pad 4715-1 and to the microstrip GND 4715.

The metamaterial transmission lines 4736-1 and 4736-2 shown in FIG. 47B may be realized by using a 2-cell CRLH structure. Each metamaterial transmission line (4736-1 and 4736-2) can have a right-handed (RH) and left-handed (LH) portion. Referring again to FIG. 47A, the RH portion may be implemented by two identical sections of 50Ω microstrip lines (4735-1a and 4735-1b) and the LH portion is implemented by using chip capacitors (4730-1 and 4745-1) and shorted stubs 4740-1. In this example, each microstrip section (4735-1a and 4735-1b) may be about 1.4 mm×2 mm. The two microstrip sections are connected to each other through three series capacitors (4745-1, 4730-1) in the order of 2C_{L}, C_{L} and 2C_{L} where C_{L} may be about 1.6 pF. Two capacitor pads 4737 shown in FIG. 47C are placed in between the two microstrip sections 4735-1a and 4735-1b and used as the mounting base of the chip capacitors (4745-1 and 4730-1). The spacing between microstrip section (4735-1a or 4735-1b) and the adjacent capacitor pad 4737 may be 0.4 mm. The spacing between two capacitor pads 4737 may be 0.4 mm. The capacitor pads 4737 may be about 0.5 mm×0.6 mm. One side of two shorted stubs 4740-1 are attached at the center of the capacitor pads 4737 while the other side of the two shorted stubs 4740-1 is connected to via pads 4749-1. The via pads 4749-1 may be connected to the microstrip GND 4715 through vias 4748-1. The shorted stub 4740-1 may include three sections having the same width of about 0.2 mm and varying lengths of about 5 mm, 1.3 mm and 0.9 mm, respectively. The via pad 4749-1 may have a dimension of about 0.762 mm×0.762 mm. The vias 4748-1 is connected to the via pads 4749-1 on a first side of a substrate and to the microstrip GND 4715 on the opposing side of the substrate. The radius of the vias 4748-1 may be about 0.254 mm and may be centered with respect to the via pads 4749-1.

FIG. 48 shows additional details of the MTM coupler 4800 of the multi-antenna system presented in this section. The MTM coupler 4800 has four ports that can be used as an input and output of the MTM coupler 4800, respectively. In this example ports P1 4845-1 and P2 4845-2 can be used for inputs while ports P3 4845-3 and P4 4845-4 can be used as the outputs of the MTM coupler 4800. Ports P3 4845-3 and P4 4845-4 can be connected to the inputs P1′ 4750-1 and P2′ 4750-2 of metamaterial antenna array 4700 shown in FIG. 47A. The detailed descriptions of the MTM coupler 4800 is similar to the MTM coupler 4100 shown in FIGS. 41A-41C.

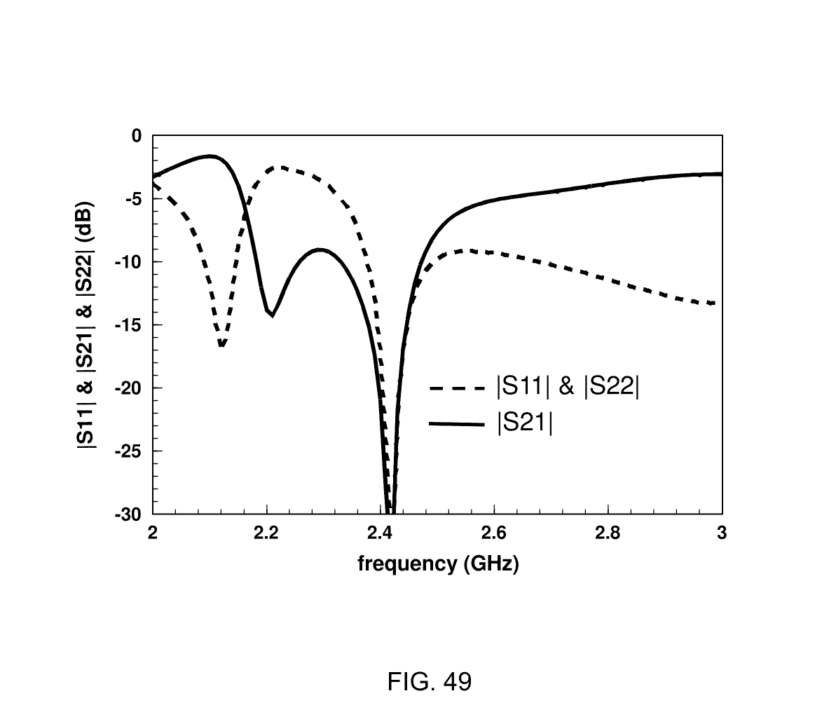

The multi-antenna system in this section is simulated by using Ansoft HFSS. FIG. 49 illustrates the return losses and coupling level between the two inputs of the multi-antenna system shown in FIGS. 46A-46D in which an improvement of the isolation between the two inputs is achieved as compared to the result shown in FIG. 35.

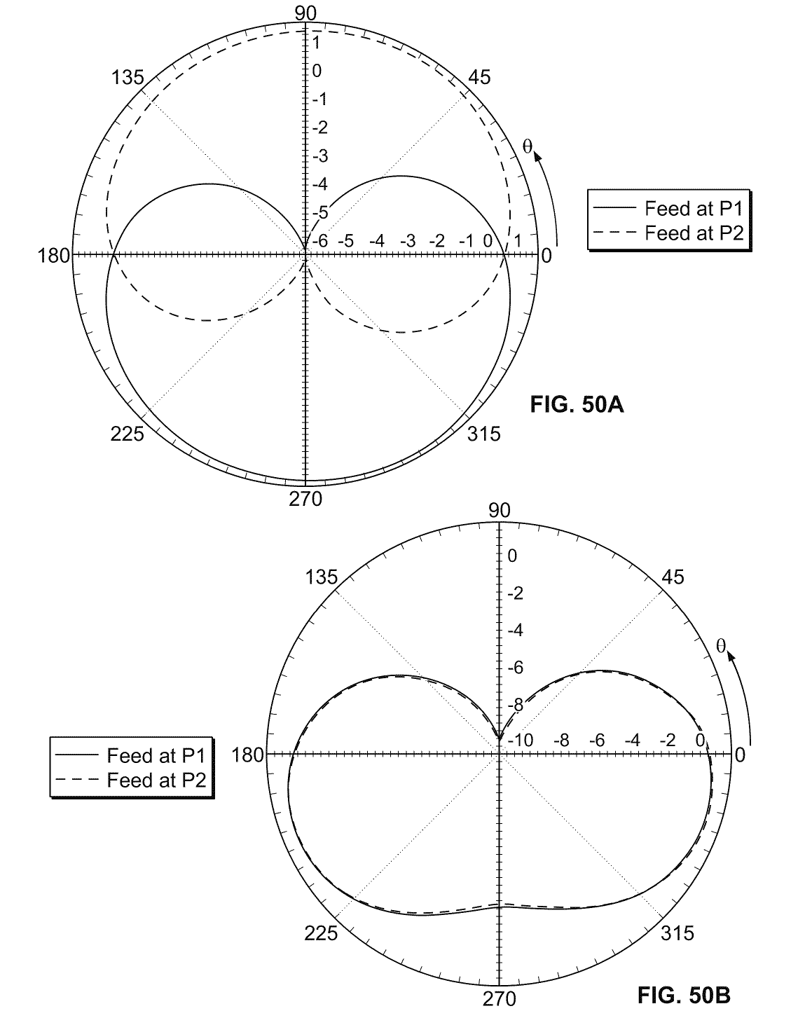

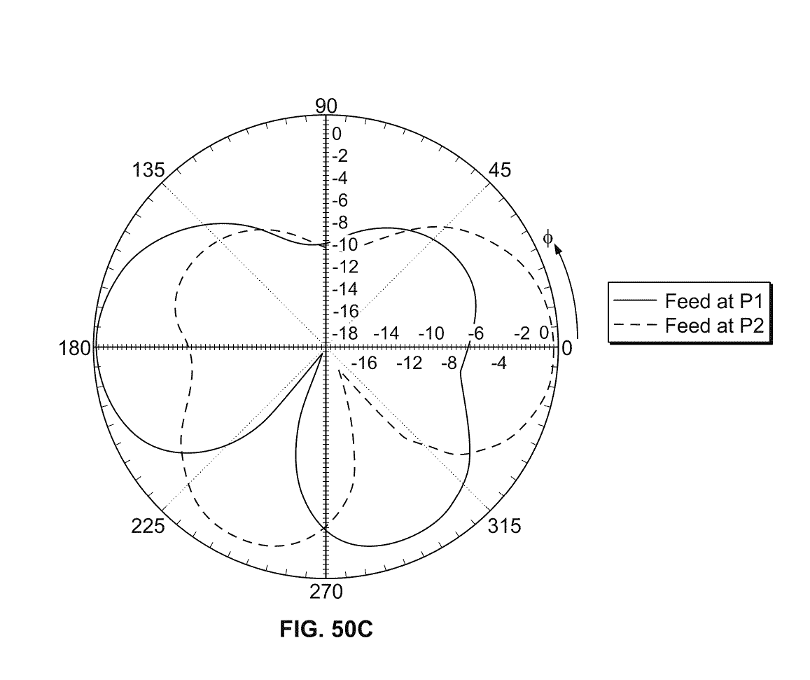

FIGS. 50A-50C illustrates the radiation patterns of the multi-antenna system shown in FIGS. 46A-46D which show two opposite beam directions with respect to two inputs can occur. Such results generally indicate successful pattern diversity and low far-field envelope correlation of the multi-antenna system presented in this implementation.

TABLE 4
Multi-Antenna, Directional Coupler System: Two-Element
Antenna Array with MTM Transmission Line Feed, Two-way
Directional Coupler using MTM Transmission Line (single band)

| Parameter | Description | | Location |
|---|---|---|---|
| Multi- | Multi-antenna system includes an MTM | | |
| Antenna | Antenna Array and an MTM Coupler. | | |
| System | | | |
| MTM | MTM Antenna array includes two MTM | | |
| Antenna | Antenna Elements with MTM Transmission | | |
| Array | Line feeds. | | |
| MTM | Each antenna element includes a MTM | | |
| Antenna | Cell coupled to the 50 Ω MTM | | |
| Element | Transmission Line via a Launch Pad. | | |
| | Launch Pad is located on top of the | | |
| | substrate. | | |
| Launch Pad | Two rectangular shape patches that | | Top Layer |
| | connect Cell Patch to the 50 Ω MTM | | |
| | Transmission Line. There is a coupling | | |
| | gap between the Launch Pad and the Cell | | |
| | Patch. | | |
| MTM Cell | Cell | Rectangular shape | Top Layer |
| | Patch | | |
| | Via | Cylindrical shape and | Top Layer |
| | | connects the Cell Patch | to Bottom |
| | | with the Via Pad. | Layer |
| | Via Pad | Small square pad that | Bottom |
| | | connects the bottom part of | Layer |
| | | the Via to the GND Line. | |
| | GND Line | Connects the Via Pad to the | Bottom |
| | | microstrip GND. | Layer |
| MTM | Microstrip | Rectangular shape. | Top Layer |
| Transmission | Line | Characteristic impedance of | |
| Line | Section | 50 Ω. | |
| | Series | Chip capacitor (2*CL) which | Top Layer |
| | Capacitors | connects one end of the | |
| | | Microstrip Line Section and | |
| | | one end of the Capacitor | |
| | | Pad. Chip capacitor (CL) | |
| | | which connects between two | |
| | | Capacitor Pads. | |
| | Capacitor | Rectangular shape | Top Layer |
| | Pad | | |
| | Shorted | This stub includes three | Top Layer |
| | Stub | Thin Microstrip Sections, | to Bottom |
| | | two Microstrip Bends, Via | Layer |
| | | Pad and a Via. | |
| | Thin | Rectangular shape. | Top |
| | Microstrip | | Layer |
| | Section | | |
| | Microstrip | Triangular shape of | Top Layer |
| | Bend | microstrip junction to | |
| | | connect two perpendicular | |
| | | Thin Microstrip Section | |
| | Via Pad | Rectangular shape. | Top Layer |
| | Via | Cylindrical shape. | Top Layer |
| | | Connecting Via Pad to | to Bottom |
| | | microstrip ground. | Layer |
| MTM | MTM coupler includes an MTM Coupled | | |
| Coupler | Line, four Tapered Lines, and Four | | |
| | Microstrip Bend | | |
| MTM | Two metamaterial transmission lines | | |
| Coupled | parallel to each other. | | |
| Line | | | |
| | Microstrip | Rectangular shape. | Top Layer |
| | Line | | |
| | Series | Chip capacitor (2*CL) which | Top Layer |
| | Capacitor | connects one end of the | |
| | | Microstrip Line and one end | |
| | | of the Capacitor Pad. Chip | |
| | | capacitor (CL) which | |
| | | connects between two | |
| | | Capacitor Pads in the | |
| | | directional parallel to the | |
| | | Microstrip Line. | |
| | Coupling | Chip capacitor (Cm) which | Top Layer |
| | Capacitor | connects between two | |
| | | Capacitor Pads in the | |
| | | directional perpendicular to | |
| | | the Microstrip Line. | |
| | Capacitor | Rectangular shape. | Top Layer |
| | Pad | | |
| | Shorted | Shorted stub includes a | Top Layer |
| | Stub | Microstrip Stub, a Via Pad, | |
| | | and a Via. | |
| | Microstrip | Rectangular shape. | Top Layer |
| | Stub | | |
| | Via Pad | Square shape. | Top Layer |
| | Via | Cylindrical shape. | Top Layer |
| | | Connecting Via Pad to | |
| | | microstrip ground. | |

| | | |
|---|---|---|
| Tapered Line | Microstrip line with different line | Top Layer |
| | width at both ends. | |
| Microstrip | Triangular shape of microstrip junction | Top Layer |
| Bend | to connect two perpendicular microstrip | |
| | lines. | |

III.A4 Two-Element Antenna Array with Two-way Directional Coupler Using MTM Transmission Line (USB Dongle Applications)

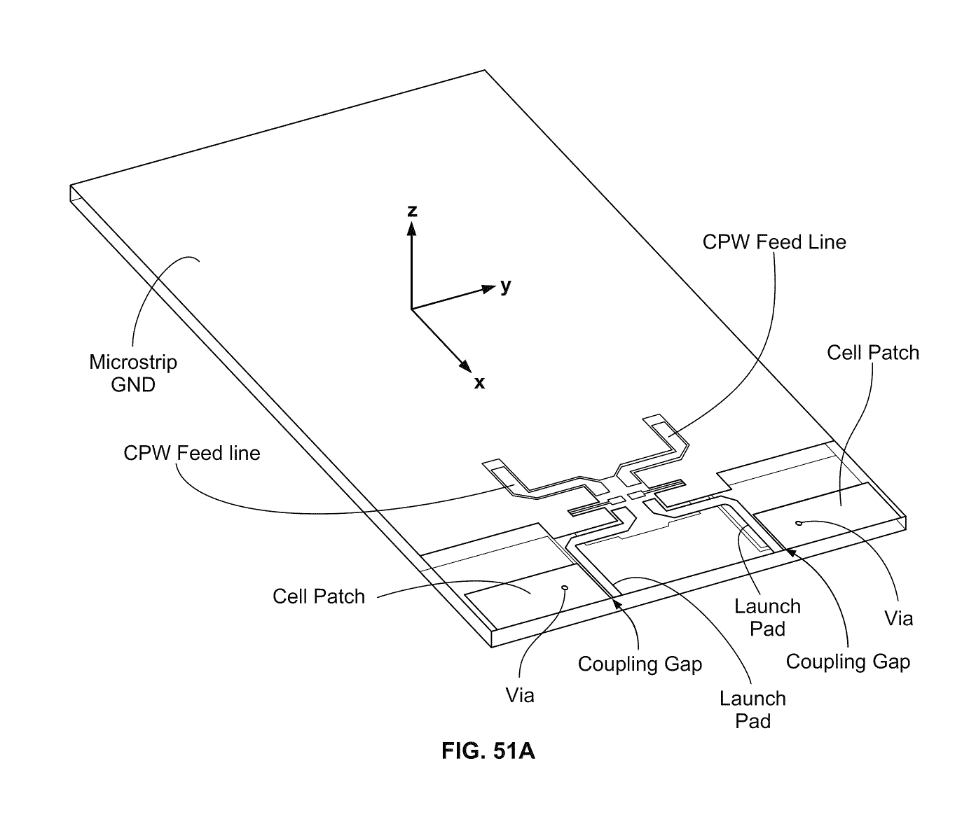

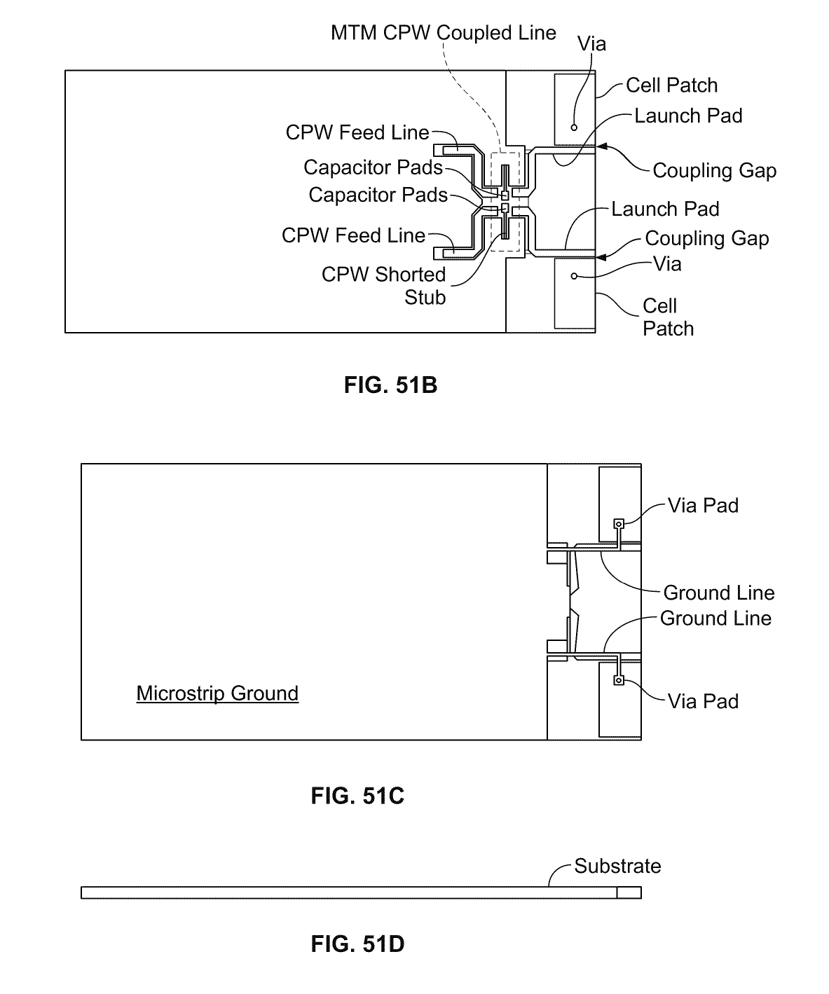

The multi-antenna system shown in FIG. 31A can be applied to the USB dongle applications. FIGS. 51A-51D illustrates another implementation of the multi-antenna system for USB applications. To realize multi-antenna system in a USB dongle, the available area of the multi-antenna system used in USB applications is generally smaller than the available area described in the previous implementations.

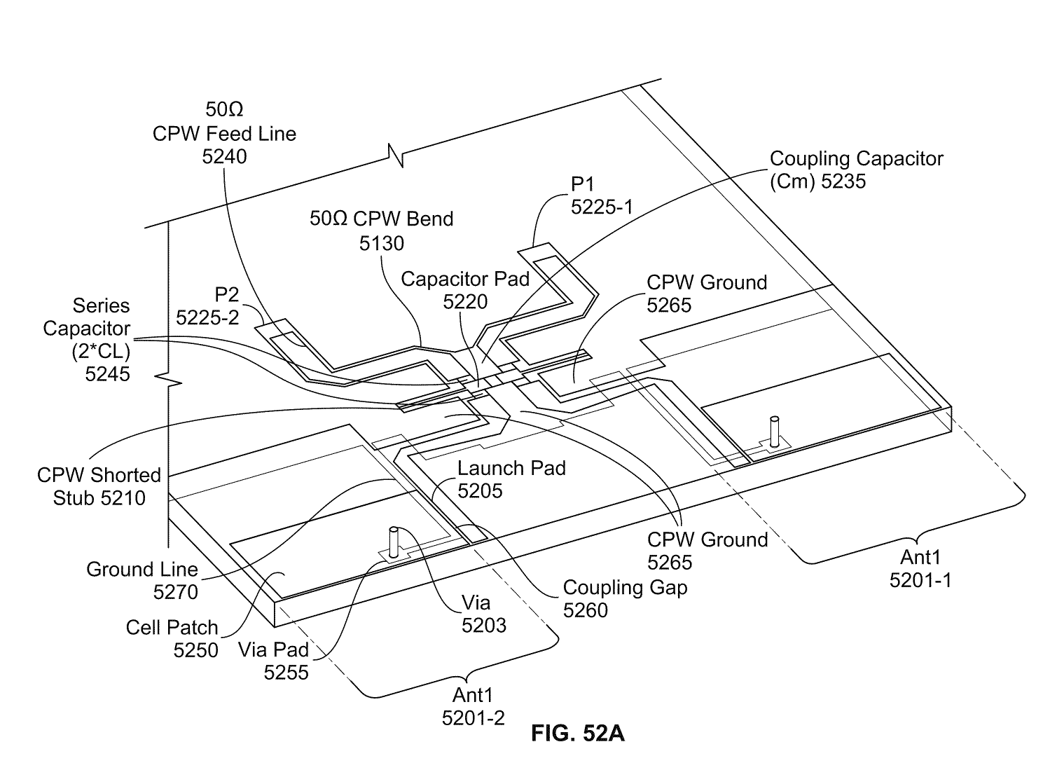

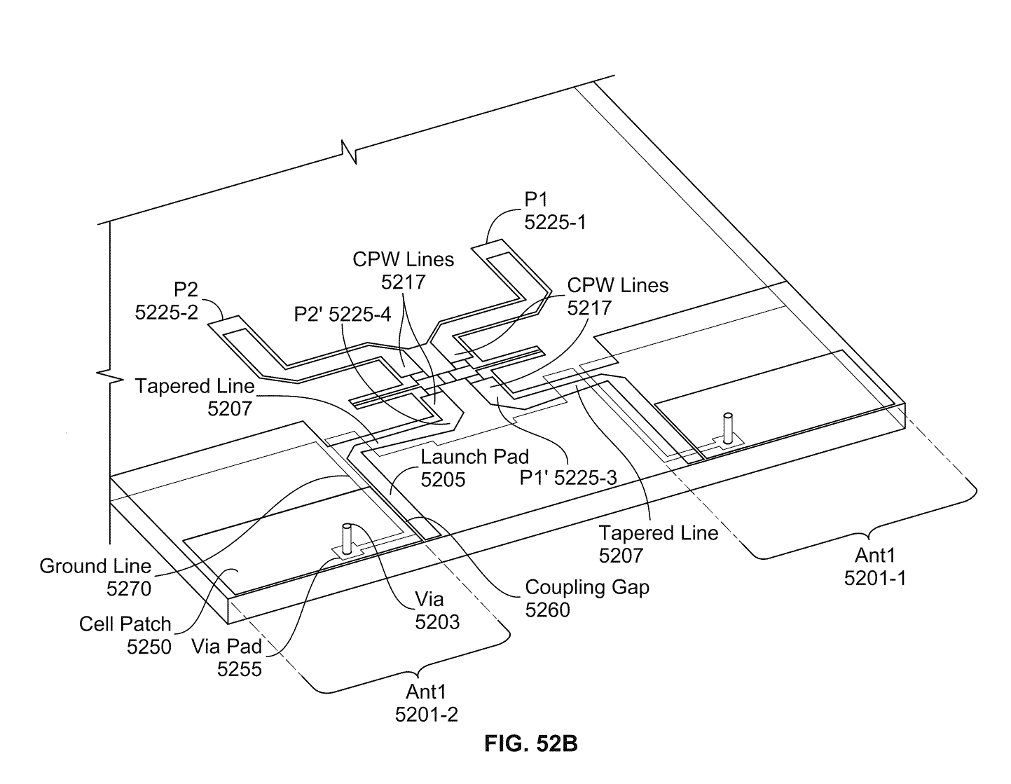

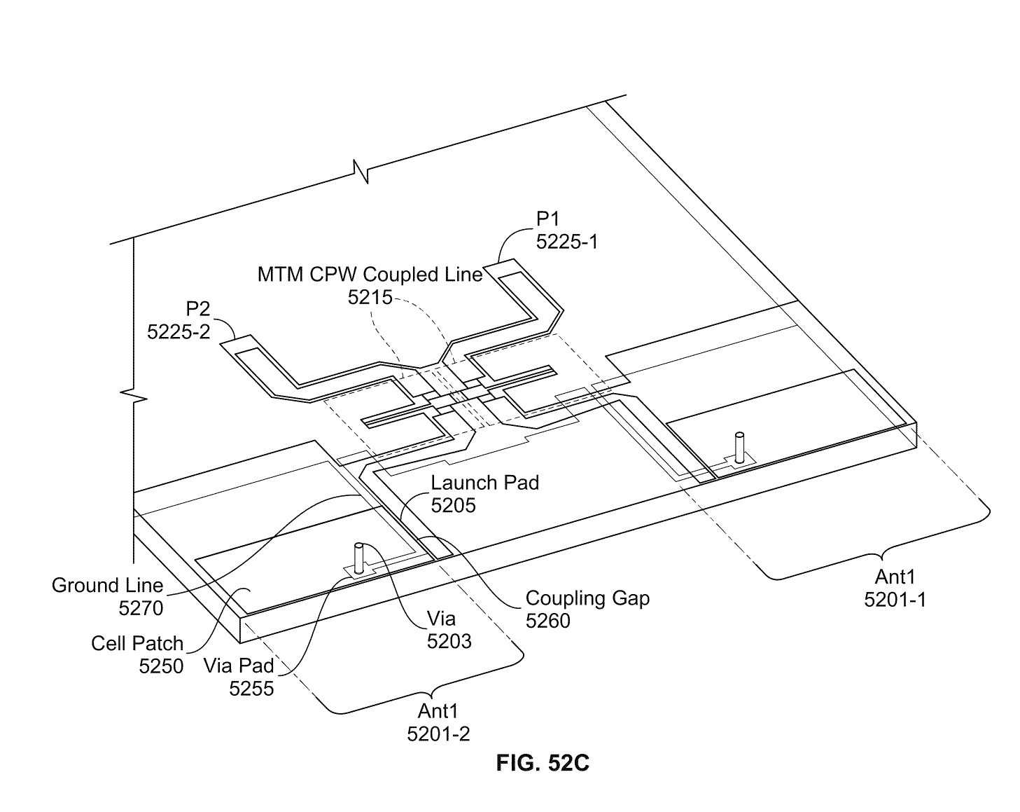

In another implementation of the multi-antenna system, a coplanar waveguide (CPW) MTM coupler can be used to improve the isolation between the two metamaterial antenna elements. To reduce the overall system size, the feed lines of the antennas are eliminated as illustrated in FIG. 52A. Each element is described in detail in Table 5.

In another implementation, the multi-antenna system shown in FIGS. 51A-51D and FIGS. 52A-52C can be designed on a 1-mm FR4 substrate with dielectric constant of 4.4. FIG. 52B represents the same multi-antenna system shown in FIG. 52A and depicts specific elements. Referring to FIGS. 52A-52C, the metamaterial antenna array may include two MTM antenna elements Ant1 (5201-1, 5201-2) where the spacing between the inner edges of the antennas measures about 9.2 mm. Ant1 5201-2, for example, may be capacitively coupled through a coupling gap 5260 to one end of the L-shape launch pad 5205. The other end of the L-shape launch pad 5205 is connected to the ports P1′ 5225-3 and P2′ 5225-4 which can be used as the outputs of the CPW MTM coupler or the inputs of the Ant1 (5201-1 and 5201-2). A cell patch 5250 of the Ant1 5201-2 may have a dimension of about 3.8 mm×7 mm and the dimension of the coupling gap may be about 3.8 mm×0.1016 mm. The L-shape launch pad 5205 may include a rectangular line, two 90° bends and a tapered line 5207 as shown in FIGS. 52A-52C. The dimension of the rectangular line may be about 5.73 mm×0.6 mm. For the tapered line 5207, the dimension may be about 3.27 mm in length and may have a first width of 0.6 mm on one side and a second width of 0.83 mm on the other side. The rectangular line of the launch pad 5205 is connected to tapered line 5207 through a first 90° bend while the tapered line 5207 is connected to the CPW MTM coupler through a second, larger 90° bend. The cell patch 5250 may be also connected to the CPW ground 5265 through a via 5203, and an L-shape ground line 5270. The via 5203 connects the cell patch 5250 on one side of the substrate and a via pad 5255 on the opposite side of the substrate. The radius of the via 5203 may be about 0.127 mm and may be centered at about 6.5 mm away from the CPW ground 5265 and 5.2016 mm from the open end portion of the cell patch 5250. The via pad 5255 may have a dimension of about 0.8 mm×0.8 mm. The L-shape ground line 5270 may include two rectangular lines and a 90° bend. The first rectangular line is connected to the via pad 5255 and may be about 0.3 mm×1.8 mm while the second rectangular line is connected to the CPW ground 5265 and may have a dimension of about 0.3 mm×6.35 mm. The 90° bend located on both sides of connection may have a width of about 0.3 mm.

The CPW MTM coupler illustrated in FIGS. 52A-52C, may include four ports where, in this implementation, ports P1 5225-1 and P2 5225-2 are used for RF inputs while the two outputs P1′ 5225-3 and P2′ 5225-4 are connected to the metamaterial antenna array (5201-1, 5201-2), respectively. A 50Ω CPW feed line 5240 includes two rectangular CPW sections and two 50Ω CPW bends 5130 and may have a dimension of about 0.83 mm×6.155 mm with 0.15 mm spacing to the CPW ground 5265. Two connection sides of the 50Ω CPW bend 5130 may have a width of about 0.83 mm. The coupling portion of this coupler is realized by a MTM CPW coupled line 5215 where two CPW MTM transmission lines are placed in parallel to each other and are connected by a coupling capacitor Cm 5235. The total length of the CPW MTM coupled line 5215 in this example may be about 4.4 mm, and the gap between two CPW MTM transmission lines may be about 1 mm. The chip capacitor Cₘ 5235 (e.g., 0.4 pF) can be used to enhance the coupling between two MTM CPW transmission lines. Each MTM CPW transmission line may include two segments of CPW lines 5217, a capacitor pads 5220, two series capacitors 5245 (2*C_{L}) and one CPW shorted stub 5210. The CPW segments can be identical in this CPW MTM coupler design and each section may have a dimension of about 0.83 mm×1.5 mm. The two CPW lines 5217 on one side can be connected by two series capacitors 5245 of 2C_{L} and a capacitor pad 5220. The capacitor pad 5220 between the two CPW lines 5217 is used as a metal base to mount the series capacitors 5245. In this example, 2C_{L} is realized by using a chip capacitor which may have a value of 1.5 pF. The spacing between the CPW lines 5217 and the capacitor pad 5220 may be about 0.4 mm. The capacitor pad 5220 may be about 0.6 mm×0.8 mm. The CPW shorted stub 5210 can be implemented by using a CPW stub where one side of the CPW stub is attached to the capacitor pad 5220 while the other side is connected directly to the CPW ground 5265. In this example, the CPW shorted stub 5210 may have a dimension of about 0.15 mm×2.5 mm and has a gap to the CPW ground 5265 with a gap which may be about 0.225 mm.

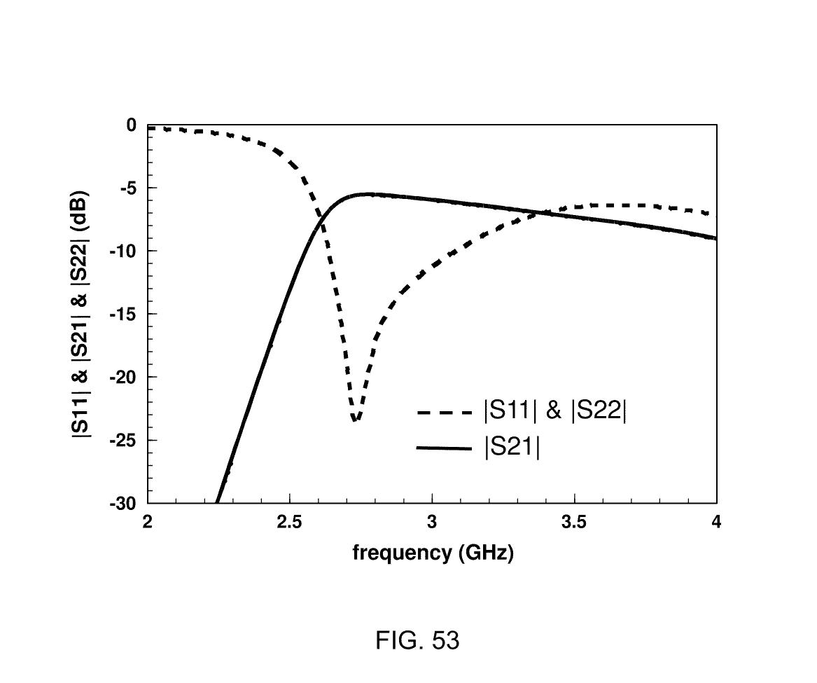

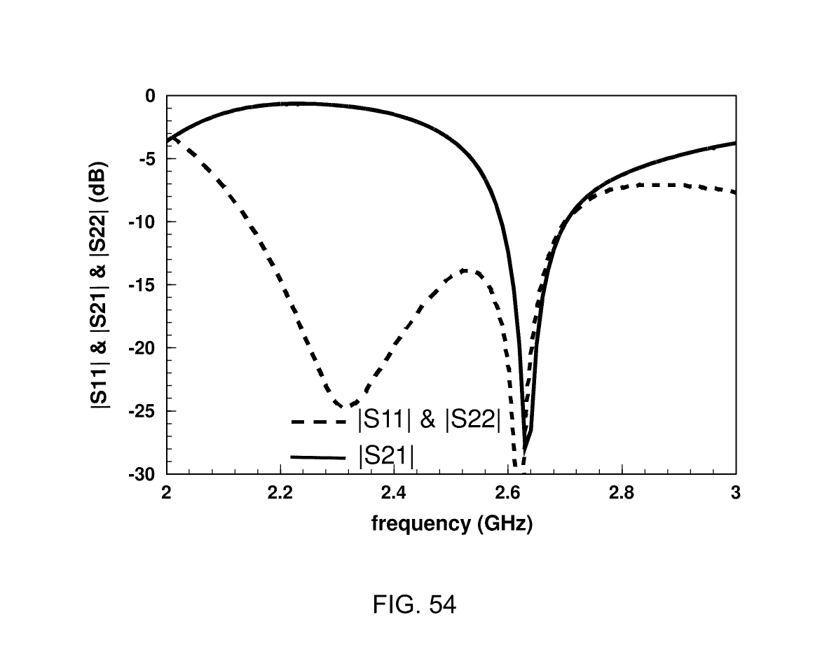

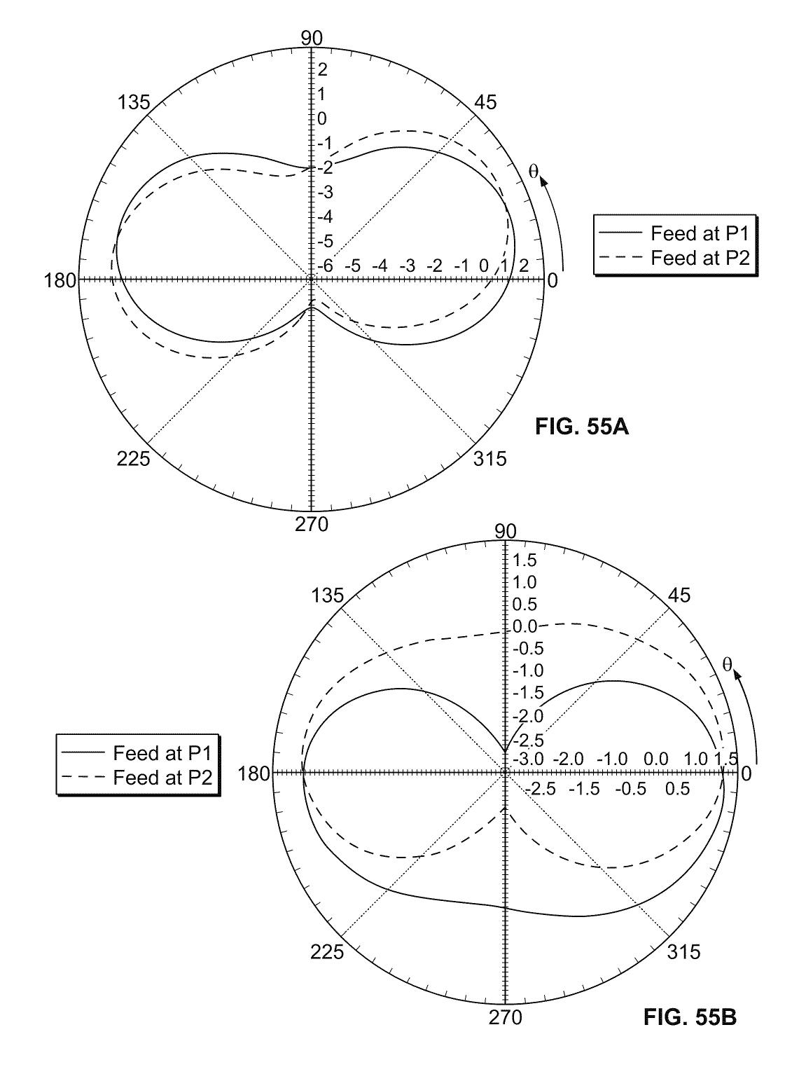

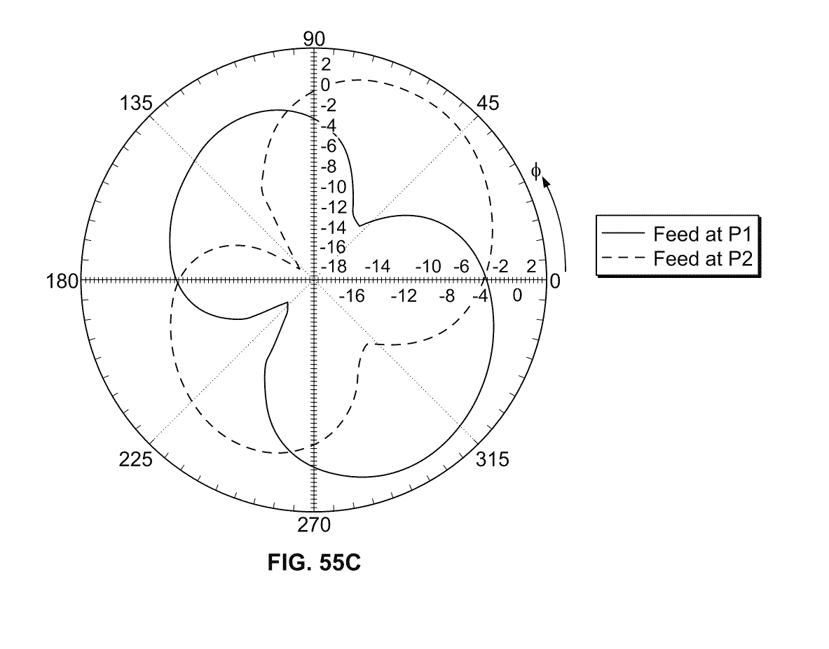

The multi-antenna system shown in FIGS. 52A-52C is simulated by using Ansoft HFSS. FIG. 53 shows the return losses and the coupling level between the two MTM antenna elements (5201-1, 5201-2) of FIG. 52A without the CPW MTM coupler. FIG. 54 illustrates the return losses and the coupling level for the present implementation of the multi-antenna system shown in FIGS. 52A-52C which demonstrates significant improvement of the isolation by using the CPW MTM coupler. FIGS. 55A-55C illustrates the radiation patterns of the present implementation of multi-antenna system shown in FIGS. 52A-52C which show two opposite beam directions with respect to two RF inputs can occur. Such results generally indicate successful pattern diversity and low far-field envelope correlation of the multi-antenna system presented in this implementation.

TABLE 5
Multi-Antenna, Directional Coupler System: Two-Element
Antenna Array, Two-way Directional Coupler using MTM
Transmission Line (USB Dongle Applications)

| Parameter | Description | | Location |
|---|---|---|---|
| Multi- | Multi-antenna system includes an | | |
| Antenna | Metamaterial Antenna Array and an CPW | | |
| System | MTM Coupler. | | |
| Metamaterial | Antenna array includes two MTM Antenna | | |
| Antenna | Elements. | | |
| Array | | | |
| MTM | Each antenna element includes an MTM | | |
| Antenna | Cell coupled to the 50 Ω MTM CPW Coupled | | |
| Element | Line via a Launch Pad. Launch Pad is | | |
| | located on top of the substrate. | | |
| Launch Pad | L-shape. Launch pad includes one | | Top Layer |
| | rectangular line and one Tapered Line | | |
| | and two 90° Bends. | | |
| | Tapered | Microstrip line with | Top Layer |
| | Line | different line widths at both | |
| | | ends. | |
| | 90° Bend | Triangular shape. | Top Layer |
| MTM Cell | Cell | Rectangular shape | Top Layer |
| | Patch | | |
| | Via | Cylindrical shape and | Top Layer |
| | | connects the Cell Patch with | to Bottom |
| | | the GND Pad. | Layer |
| | GND Pad | Small square pad that | Bottom |
| | | connects the bottom part of | Layer |
| | | the Via to the GND Line. | |
| | GND Line | Connects the GND Pad to the | Bottom |
| | | main CPW GND | Layer |
| CPW MTM | CPW MTM Coupler includes a MTM CPW | | |
| Coupler | Coupled Line, two CPW Feed Lines, and | | |
| | four CPW Bends. | | |
| MTM CPW | Two MTM CPW Transmission Lines parallel | | |
| Coupled | to each other. Each MTM CPW Transmission | | |
| Line | Line includes two CPW Segments, Series | | |
| | Capacitor, Capacitor Pad, and CPW | | |
| | Shorted Stub. | | |
| | CPW | Rectangular shape. | Top Layer |
| | Segment | | |
| | Series | Chip capacitor (2*CL) which | Top Layer |
| | Capacitor | connects one end of the CPW | |
| | | Segment and one end of the | |
| | | Capacitor Pad. | |
| | Coupling | Chip capacitor (Cm) which | Top Layer |
| | Capacitor | connects between two | |
| | | Capacitor Pads in the | |
| | | directional perpendicular to | |
| | | the CPW Segment. | |
| | Capacitor | Rectangular shape. | Top Layer |
| | Pad | | |
| | CPW | CPW line shorted to the CPW | Top Layer |
| | Shorted | GND. | |
| | Stub | | |

| | | |
|---|---|---|
| CPW Feed | L-shape with CPW Bend at the joint and | Top Layer |
| Line | at the connection to the MTM CPW Coupled | |
| | Line. | |
| CPW Bend | Triangular shape of CPW junction to | Top Layer |
| | connect two perpendicular CPW lines. | |

IV. Multi-Antenna, Directional Coupler System: Full Duplex Communication Support

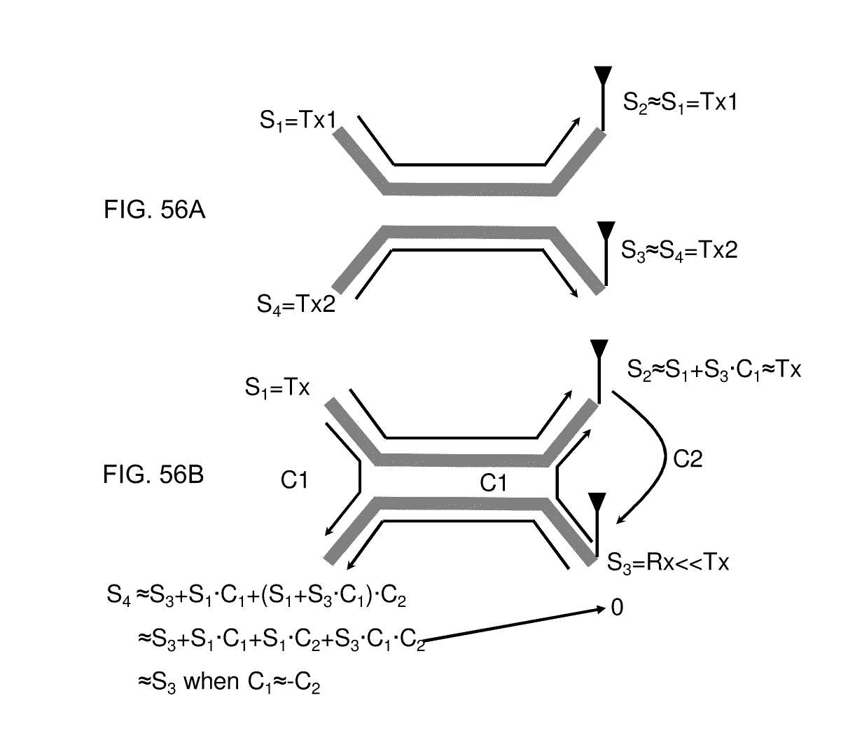

FIG. 56A illustrates a multi-antenna system for a time division duplex application. The antennas are used to either transmit or receive at different time instants. In this example, one antenna is used to transmit a signal to user i while the other antenna is used to receive a signal from user j as illustrated in FIG. 56B. The Tx and Rx signals can also target a single user in a multipath environment where both signals bounce off scattering objects opening two different paths between the multi-antenna system and an end user. As illustrated in FIG. 56B, the transmit signal is coupled with the received signal at the transmit antenna port. But since the received signal power is much small than the transmit signal power, which is further reduced by the coupling factor, it has minimal impact on the transmit signal quality. Similarly, the signal received on the receiver port may include three components: 1) signal received from the Rx antenna, 2) transmit signal coupled to the receive port, and 3) transmit signal coupled through the air. In the case of the present implementation of the multi-antenna system, the two coupling coefficients C1 and C2 are equal in magnitude and opposite in phase. As a result at the receiver port, all the transmitter power is cancelled and only the signal seen by the receive antenna is received at the port. In comparison, other technologies generally have high isolation required between Tx and Rx antennas and, thus, tend to make it difficult to achieve this solution. Such multi-user solution can be used on the client side, access-point or base-station, or on both allowing unique deployment of wireless networks.

In another application, the multi-antenna system in FIG. 56B can be used to eliminate the Tx/Rx switch in a time-division duplex system. As explained above, the transmitted signal may be coupled to the transmit antenna and the receive signal at the receive antenna may be coupled to the receive port resulting in minimal mutual coupling between the two paths. As a result, the need for transmit/receive switch can be eliminated.

V. Dualband Multi-Antenna System: Two-Element Antenna Array with 2-Way Directional Coupler

A microwave directional coupler can be used to decouple two coupled antenna elements. This approach can be applied also to a multiband antenna system.

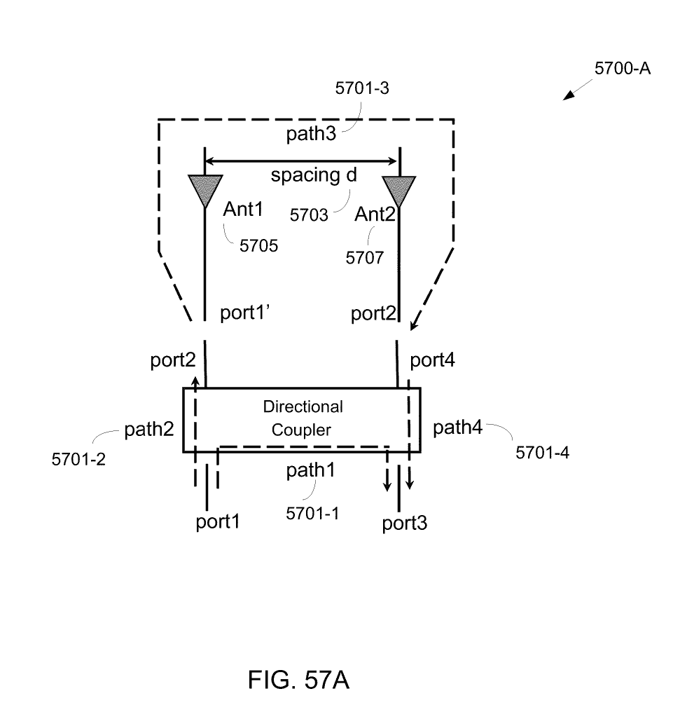

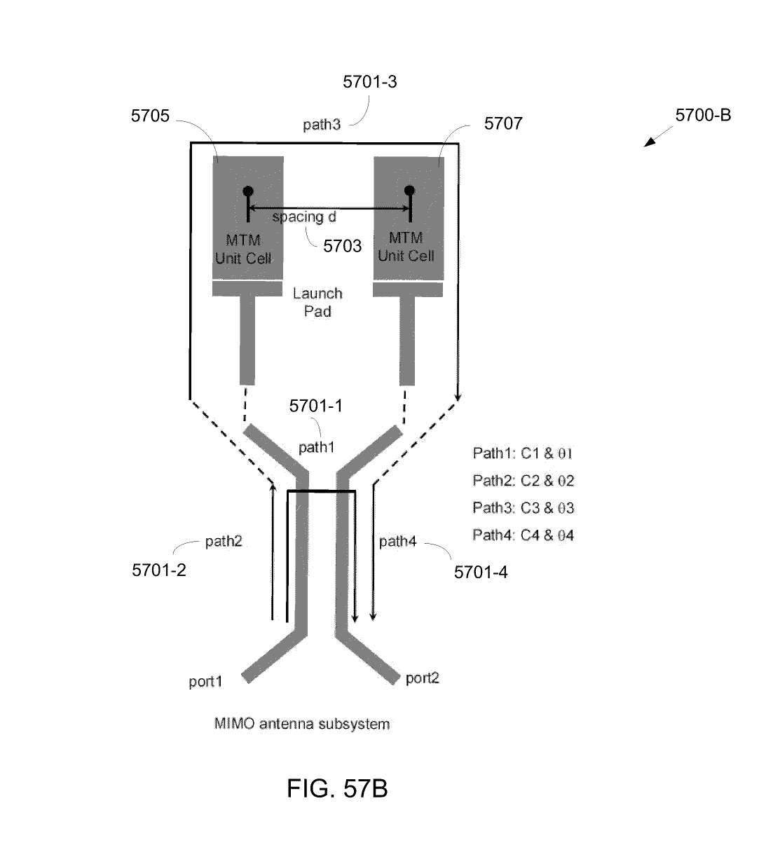

FIG. 57A and FIG. 57B illustrates a configuration of a dual-band multi-antenna system 5700-A and 5700-B, respectively. Four signal transmission paths are denoted as path1 5701-1, path2 5701-2, path3 5701-3 and path4 5701-4. These paths are characterized by coupling magnitudes C1, C2, C3 and C4 and phases θ1, θ2, θ3 and θ4 at the first frequency f1, and C1′, C2′, C3′ and C4′ and phases θ1′, θ2′, θ3′ and θ4′ at the second frequency f2, respectively. Unlike the conventional antenna system where each antenna element is placed at ˜0.5λ₀ where λ₀ is free space wavelength away from the adjacent antenna elements to minimize the isolation, the spacing d 5703 between two antenna elements (5705, 5707) in this dual-band multi-antenna system 5700 can be much smaller, e.g., from 0.1λ₀ up to 0.25λ₀.

Two examples are considered below. The first case, the antenna array has strong coupling (e.g., larger than −10 dB) at both frequencies f1 and f2. The second case, the antenna array has strong coupling at f1 but weak coupling (e.g., less than −10 dB) at f2 where f2>f1.

### Example 1

### Antenna Array has Strong Coupling at f1 and f2

The conditions to decouple two antenna elements are expressed as:

$$at f 1 \{ \begin{matrix}{θ}_{2} + {θ}_{3} + {θ}_{4} - {θ}_{1} = - 180 ° & Eq . ( 14 a ) \\ {C}_{1} = {C}_{2} \cdot {C }_{3} \cdot {C}_{4} & Eq . ( 14 b )\end{matrix} \\ at f 2 \{ \begin{matrix}{θ}_{2}^{′} + {θ}_{3}^{′} + {θ}_{4}^{′} - {θ}_{1}^{′} = - 180 ° & Eq . ( 14 c ) \\ {C}_{1} = {C}_{2}^{′} \cdot {C}_{3}^{′} \cdot {C}_{4}^{′} & Eq . ( 14 d )\end{matrix}$$

By introducing the following relationships of a symmetric directional coupler:
θ₂=θ₄ Eq. (15a)
θ₁≈θ₂+90° Eq. (15b)
θ₂′=θ₄′ Eq. (15c)
θ₁′≈θ₂′+90° Eq. (15d)

we get the following relationships between the phases at f1 and the phases at f2:

$$\begin{matrix}{θ}_{2} \approx - 90 ° - {θ}_{3} & Eq . ( 16 a ) \\ {θ}_{2}^{′} \approx - 90 ° - {θ}_{3}^{′} \\ And & Eq . ( 16 b ) \\ {θ}_{2}^{′} = \frac{f 2}{f 1} \cdot {θ}_{2}^{′} & Eq . ( 16 c )\end{matrix}$$

In addition, using the assumptions of C2=C4≈1 and C2′=C4′≈1 that are applicable to most low loss directional couplers, we obtain the following relationships:
C₁≈C₃ Eq. (17a)
C₁′≈C₃′ Eq. (17b)

It should be noted that C1 has to be smaller than C3. The zero coupling can be obtained at two frequencies f1 and f2 if the Eq. (16a)-(16c) and Eq. (17a)-(17b) are simultaneously satisfied.

### Example 2

### Antenna Array has Strong Coupling at f1 and Weak Coupling at f2 While f2>f1

If C3′ is small, that is, the isolation between two antenna elements is sufficient, the decoupling circuit may not be necessary. Therefore, the conditions to achieve the dual-band antenna system with high isolation using the coupler network are expressed as follows:

$$at f 1 \{ \begin{matrix}{θ}_{2} + {θ}_{3} + {θ}_{4} - {θ}_{1} = - 180 ° & Eq . ( 18 a ) \\ {C}_{1} = {C}_{2} \cdot {C }_{3} \cdot {C}_{4} & Eq . ( 18 b )\end{matrix}$$

Based pm the following relationships of a symmetric directional coupler;
θ₂=θ₄ Eq. (19a)
θ₁≈θ₂+90° Eq. (19b)
the following relationship can be obtained:
θ₂=−90°−θ₃ Eq. (20)

In addition, assuming that C2=C4≈1 and C3′ is weak, the following relationships can be derived:
C₁≈C₃ Eq. (21a)
C₃′<<1 Eq. (21b)
where C1 is smaller than C3. The high isolation between two antenna elements can be achieved if Eq. (20) and Eq. (21a)-(21b) are satisfied.

The directional coupler shown in FIG. 57 can be implemented by using a conventional transmission line technology such as microstrip line and coplanar waveguide (CPW) or by using MTM technology. The MTM technology has several advantages over the conventional transmission line technology. First, the MTM coupler can achieve broader bandwidth. Second, the MTM coupler can provide up to 0 dB coupling whereas the conventional coupler can only provide up to around −8 dB coupling. Third, the MTM coupler can be made to occupy smaller space.

V.A1. Dualband Two-Element Antenna Array with 2-Way Directional Coupler Using Microwave Coupled Line—Condition: f2≠2×f1, f2>f1, Strong Coupling at f1 and f2

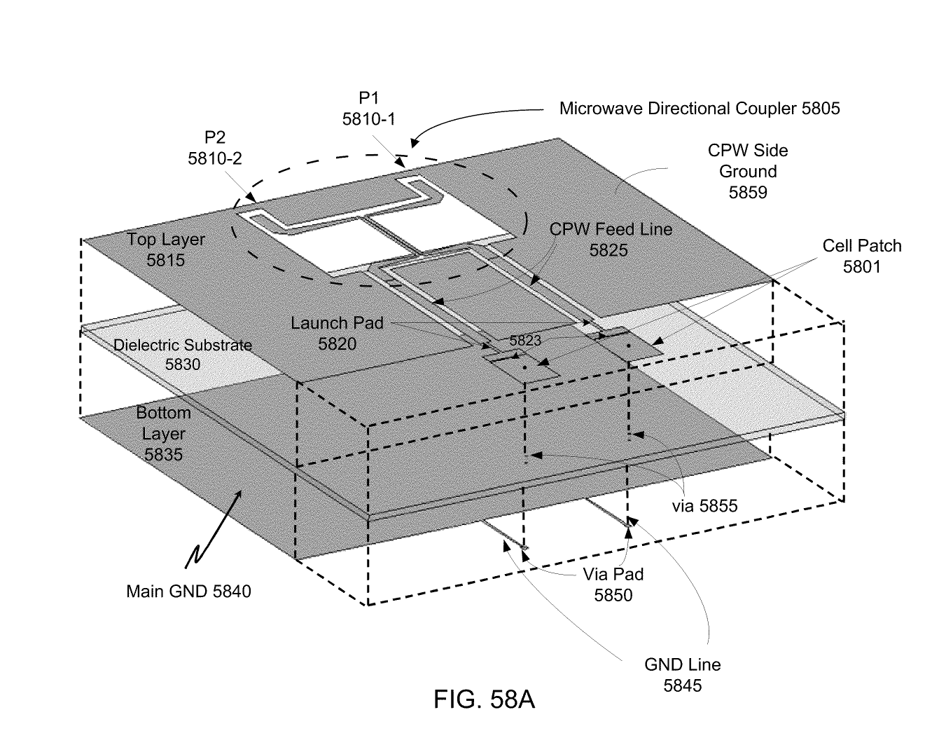

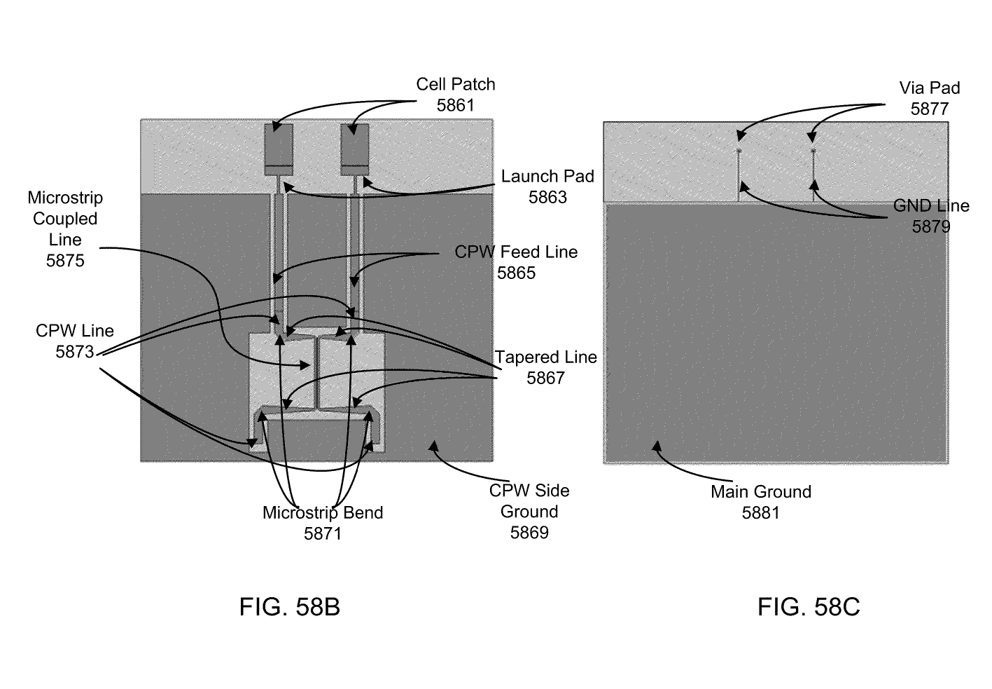

In another embodiment of a multi-antenna system, a dual-band multi-antenna system using the MTM technology is shown in FIG. 58A-58C. The present implementation of the dualband multi-antenna system may include a dualband two-element metamaterial antenna array and a conventional microwave directional coupler. Each element is described in detail in Table 6.

TABLE 6
Two-Element Antenna Array, 2-Way Directional Coupler
using Microwave Coupled Line - Condition: f2 ≠ 2xf1, f2 > f1,
strong coupling at f1 and f2 (Dualband)

| Elements | Description | | Location |
|---|---|---|---|
| Multi- | Dualband Multi-antenna system comprises | | |
| Antenna | a Dualband MTM Antenna Array and a | | |
| System | Microwave Directional Coupler. | | |
| Dualband | Antenna array comprises two MTM Antenna | | |
| MTM | Elements. | | |
| Antenna | | | |
| Array | | | |
| MTM | MTM antenna element comprises an MTM | | |
| Antenna | Cell and a Launch Pad. | | |
| Element | | | |
| Launch Pad | Each Launch Pad comprises two | | Top Layer |
| | rectangular shape patches, one of which | | |
| | connects to the Cell Patch and the | | |
| | other connects to the 50 Ω CPW feed | | |
| | line. There is a coupling gap between | | |
| | the Launch Pad and the MTM Cell. | | |
| MTM Cell | Cell | Rectangular shape. | Top Layer |
| | Patch | | |
| | Via | Cylindrical shape and | Top Layer |
| | | connects the Cell Patch with | to Bottom |
| | | the Via Pad. | Layer |
| | Via Pad | Small square pad that | Bottom |
| | | connects the bottom part of | Layer |
| | | the Via to the GND Line. | |
| | GND Line | Connects the Via Pad to the | Bottom |
| | | main GND. | Layer |

| | | |
|---|---|---|
| Microwave | Directional coupler comprises a | |
| Directional | Microstrip Coupled Line, four Tapered | |
| Coupler | Lines, four Microstrip Bend and four | |
| | CPW lines. | |
| Microstrip | Two parallel microstrip lines with a | Top Layer |
| Coupled | coupling gap in between. | |
| Line | | |
| Tapered | Microstrip line with different line | Top Layer |
| Line | width at both ends. | |
| Microstrip | Triangular shape of microstrip junction | Top Layer |
| Bend | to connect two perpendicular microstrip | |
| | lines. | |

As a specific example, the dualband multi-antenna system shown in FIGS. 58A-58C may be implemented on a 0.787 mm FR-4 substrate having a dielectric constant of 4.4. The metamaterial antenna array includes two metamaterial antenna elements. The metamaterial antenna elements, in this example, are connected to the 50Ω CPW feed line 5825 having a dimension of about 1.4 mm×20 mm with a gap to the CPW side ground 5859 of about 0.83 mm. The spacing between two antenna elements may be about 13 mm from the inner edges of the antenna elements. One side of the CPW feed lines 5825 is directly connected to the launch pads 5820 and the other side may be connected to the outputs of the microwave directional coupler 5805. In this example, each launch pad 5820 may include two rectangular shape patches. The first rectangular patch which is connected to the CPW feed line 5825 and may have a dimension of about 0.4 mm×3.2 mm, and the second rectangular patch is capacitively coupled to the cell patch 5801 which may have a dimension of about 4.7 mm×1.5 mm. The cell patch 5801 is coupled to the launch pad 5820 through a coupling gap 5823 of about 0.16 mm and is shorted to the main ground 5840 through a via 5855, via pad 5850 and a ground line 5845. The dimension of the cell patch 5801, as shown in this example, may be about 4.7 mm×7 mm. The via 5855 can connect the cell patch 5801 on top side of the dielectric substrate 5830 and to the via pad 5850 on the bottom side of the dielectric substrate 5830. The radius of the via 5855 may be about 0.15 mm and its center may be located at about 2.96 mm from the top open end of the cell patch 5801. The dimension of the via pad 5850 may be about 0.6 mm×0.6 mm and is connected to the main ground 5840 through a ground line 5845. The ground line 5845 may have a dimension of about 0.2 mm×8.6 mm.

FIG. 58B illustrates the top view of the top layer 5815 depicted in FIG. 58A and FIG. 58C illustrates the top view of the bottom layer 5835 also depicted in FIG. 58A. Elements shown in FIGS. 58B-58C which are also represented in FIG. 58A include cell patch 5861, launch pad 5863, CPW feed line 5865, CPW Side Ground 5869, CPW Line 5873, Via Pad 5877, GND Line 5879, and Main Ground 5881. Additional elements depicted in FIG. 58B and previously mentioned include tapered line 5867, microstrip bend 5871, and microstrip coupled line 5875.

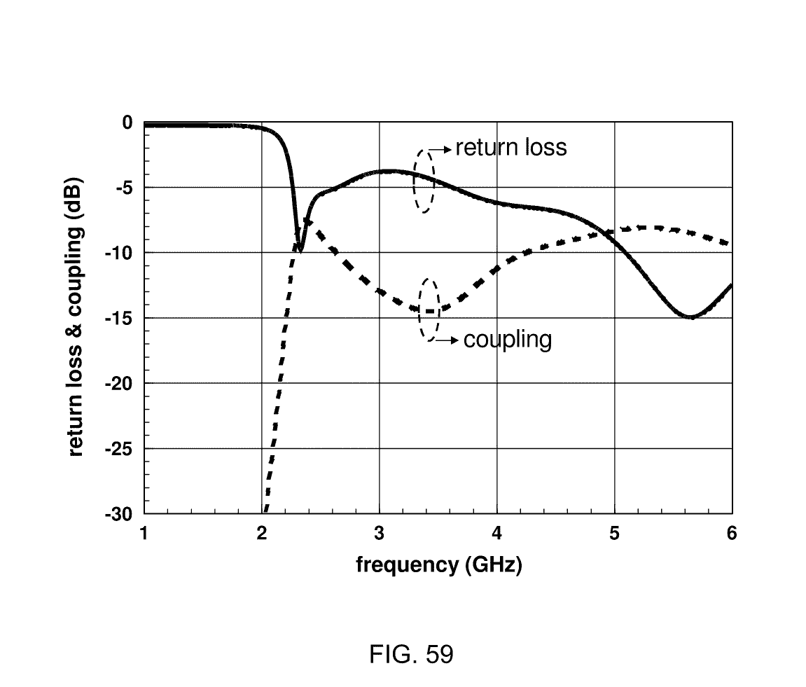

The MTM antenna array in FIGS. 58A-58C without the microwave directional coupler 5805 is simulated by using Ansoft HFSS. The simulation results are shown in FIG. 59 where the coupling and the return losses are plotted as a function of frequency. FIG. 59 shows that the designs of the antenna array and the directional coupler described above make the device to have a strong coupling between two adjacent antennas at two different frequencies f1 and f2 that are not harmonic frequencies to each other. In this example, the metamaterial antenna array operates at two frequencies, f1=2.33 GHz and f2=5.1 GHz-6 GHz, and the coupling is about −7.4 dB and −8.1 dB at f1 and f2, respectively. Since the couplings at these two frequencies are strong (more than −10 dB), the conditions mentioned in Example 1 in Section V are considered to design the microwave directional coupler 5805.

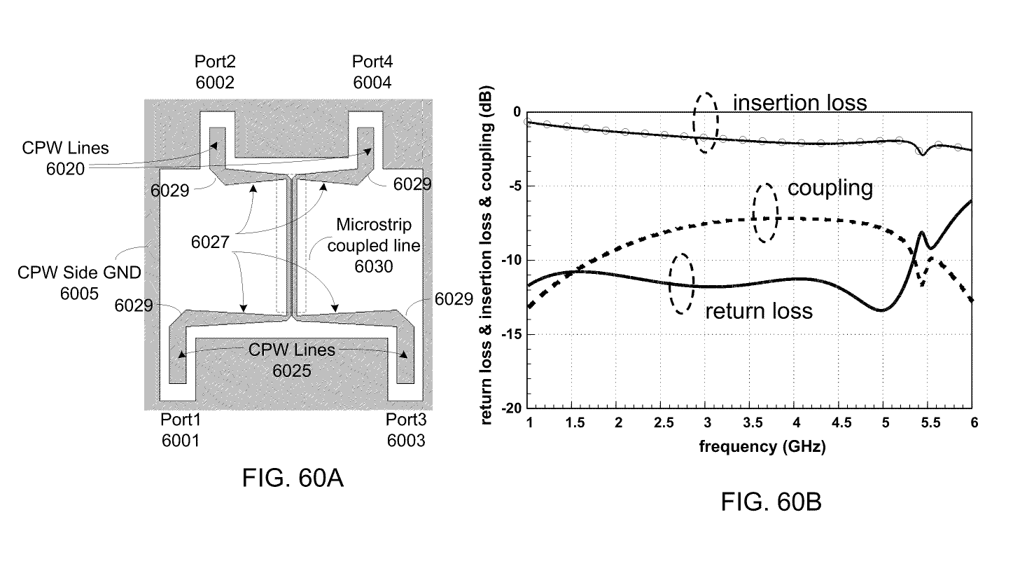

The expanded top view of the microwave directional coupler 5805 in FIG. 58A is shown in FIG. 60A, where in this example Port1 6001 and Port3 6003 are used for RF inputs and Port2 6002 and Port4 6004 are the outputs of this microwave directional coupler. Port2 6002 and Port4 6004 are connected to the inputs of the metamaterial antenna array shown in FIGS. 58A-58C. The dimensions of the CPW lines 6025 for the two coupler inputs may be of 1.48 mm×5 mm, and the gap to the CPW side ground 6005 may be about 0.83 mm. The dimensions of the CPW lines 6020 for the two coupler outputs may be of 1.4 mm×3.65 mm, and the gap to the CPW side ground 6005 may be 0.83 mm. Both input and output CPW lines (6025, 6020) can have characteristic impedance of around 50Ω. The coupling portion of this coupler can be realized by using a microstrip coupled line 6030 where the length of the coupled line, the width of the coupled line, and the coupling gap may be 12 mm, 0.4 mm and 0.1 mm, respectively. The four ends of the microstrip coupled line 6030 can be connected to the four CPW lines (6020, 6025) through the four microstrip tapered lines and the four microstrip bends 6029 for the impedance matching purpose. In this implementation, the length of the microstrip tapered lines 6027 is connected to the RF inputs (Port1 6001, Port3 6003) and may be about 8.8 mm. The widths for the microstrip tapered line 6027 may be about 1.48 mm at one end portion and about 0.4 mm at the other end portion. The microstrip tapered lines 6027 are connected to the coupler output ports Port2 6002 and Port4 6004 and their lengths may be about 5.35 mm. The widths for the microstrip tapered lines 6027 may be about 1.4 mm in one end portion and about 0.4 mm in the other end portion. The microwave directional coupler, in this example, can be simulated by using Ansoft HFSS. FIG. 60B illustrates the return loss, insertion loss and coupling for the present implementation of the microwave directional coupler shown in FIG. 60A with signal input at Port1 6001. The simulated results shown in FIG. 60B demonstrates good impedance matching and sufficient coupling between port1 6001 and port3 6003 over a frequency range from about 1.8 GHz to 5.3 GHz.

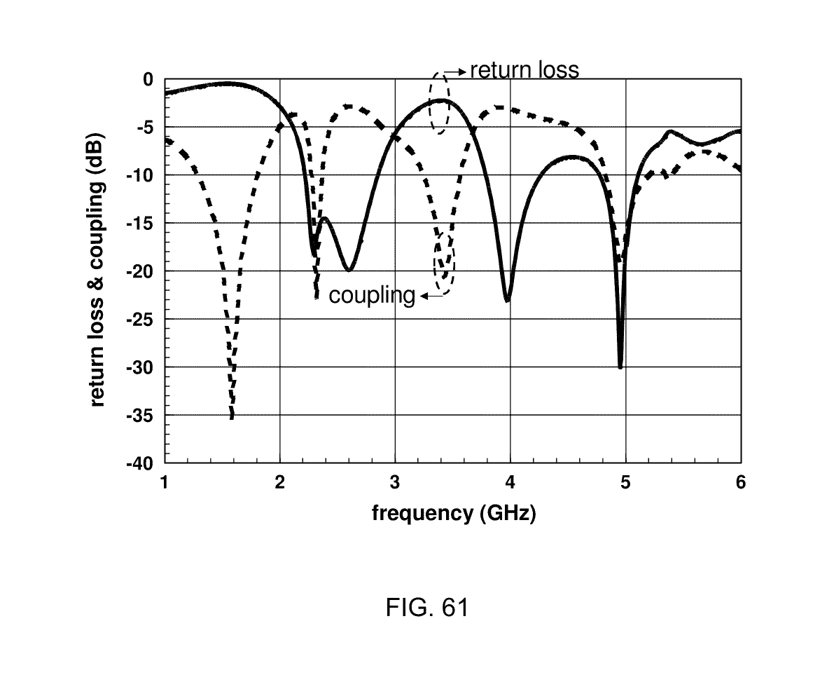

The dualband multi-antenna system of FIGS. 58A-58C is simulated by using Ansoft HFSS. FIG. 61 shows the return losses and coupling level between the two metamaterial antenna array elements in FIGS. 58A-58C. The results of FIG. 61 demonstrates that the isolation between the two antenna elements can be significantly improved in comparison to the case without the microwave directional coupler (FIG. 59) while still maintaining a good return loss at the two frequencies, 2.33 GHz and 4.95 GHz. At these two frequencies, Eq. (16a-16c) and Eq. (17a-17b) are satisfied.

V.A2. Dualband Two-Element Antenna Array with 2-Way Directional Coupler Using Microwave Coupled Line—Condition: f2=2×f1, f2>f1, Strong Coupling at f1 and Weak Coupling at f2

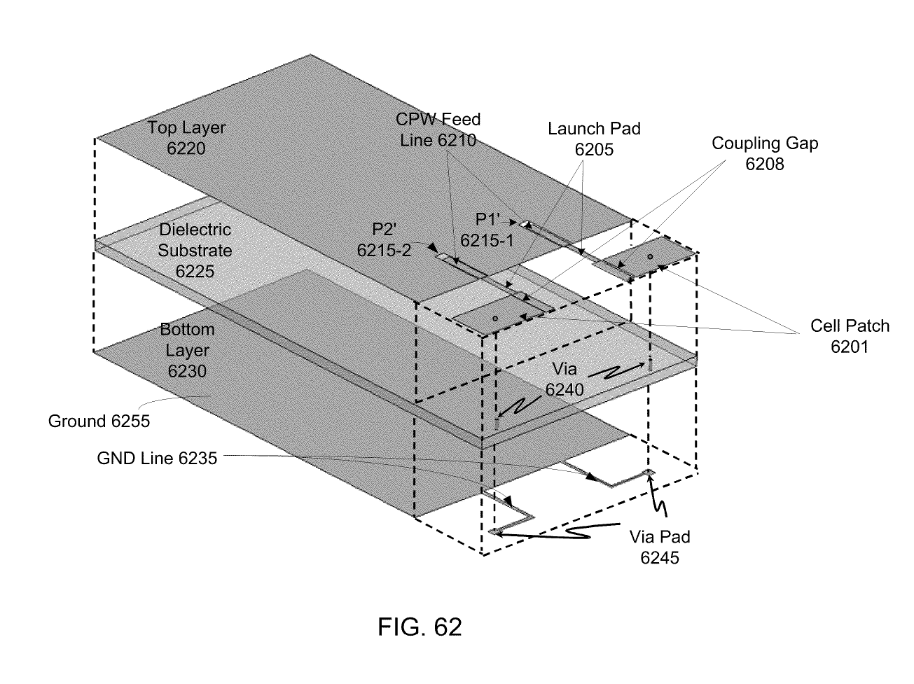

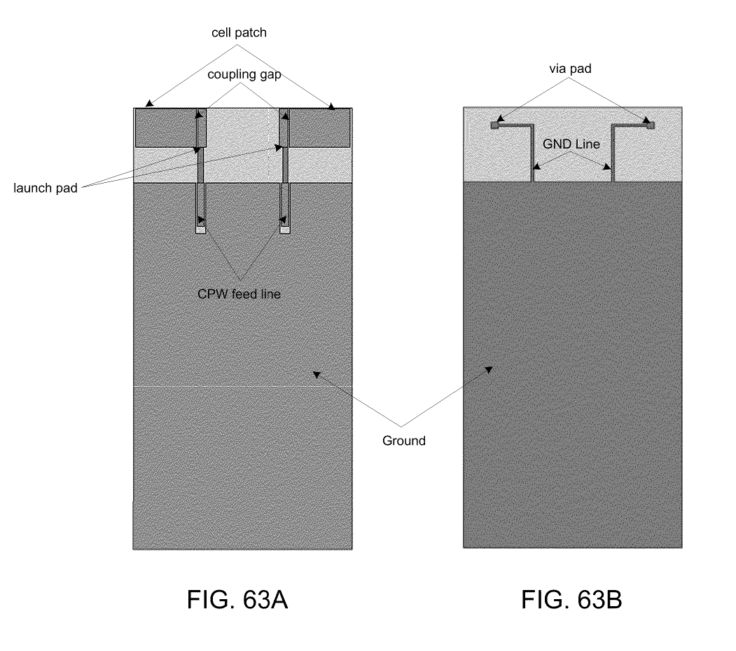

Another dual-band multi-antenna system can be designed to include a two-element metamaterial antenna array and a conventional microwave directional coupler. A detailed description of each element presented for the dual-band multi-antenna system is described in Table 7 and FIG. 62 and FIGS. 63A-63B. FIG. 63A illustrates the top layer 6220 of FIG. 62, and FIG. 63B illustrates the bottom layer 6330 of FIG. 62.

TABLE 7
Two-Element Antenna Array, 2-Way Directional Coupler
using Microwave Coupled Line - Condition: f2 = 2xf1, f2 > f1,
strong coupling at f1 and weak coupling at f2 (Dualband)

| Elements | Description | | Location |
|---|---|---|---|
| Dualband | Dualband multi-antenna system comprises | | |
| Multi- | a Dualband MTM Antenna Array and a | | |
| Antenna | Microwave Directional Coupler. | | |
| System | | | |
| Dualband | Antenna array comprises two MTM Antenna | | |
| MTM Antenna | Elements. | | |
| Array | | | |
| MTM Antenna | Each antenna element comprises an MTM | | |
| Element | Cell and a Launch Pad. | | |
| Launch Pad | Each Launch Pad comprises two | | Top Layer |
| | rectangular shape patches, one of which | | |
| | connects to the MTM Cell and the other | | |
| | one connects to the 50 Ω CPW feed line. | | |
| | There is a coupling gap between the | | |
| | Launch Pad and the Cell Patch. | | |
| MTM Cell | Cell | Rectangular shape | Top Layer |
| | Patch | | |
| | Via | Cylindrical shape and | Top Layer |
| | | connects the Cell Patch with | to Bottom |
| | | the Via Pad. | Layer |
| | Via Pad | Small square pad that | Bottom |
| | | connects the bottom part of | Layer |
| | | the Via to the GND Line. | |
| | GND Line | L shaped line that connects | Bottom |
| | | the Via Pad to the main GND. | Layer |

| | | |
|---|---|---|
| Microwave | Directional coupler comprises a | Top layer |
| Directional | Microstrip Coupled Line. | |
| Coupler | | |
| Microstrip | Two microstrip line parallel with each | Top layer |
| Coupled | other with a gap in between. | |
| Line | | |

The metamaterial antenna array shown in FIG. 62 and FIGS. 63A-63B can be implemented on a 1-mm FR-4 substrate with dielectric constant of 4.4. Each of the antenna element, in this example, can be fed by a 50Ω CPW feed line 6210 and has a dimension of about 0.83 mm×22.88 mm. The length of the CPW feed line 6210 can be selected to satisfy the phase requirement. The spacing between the inner edges of two antenna elements may be about 8.4 mm. One end portion of the CPW feed lines 6210 can be directly connected to the launch pads 6205 and the other end portion can be connected to the outputs of the microwave directional coupler, as described in the next section or to the inputs of the metamaterial antenna elements. Each of the launch pads 6205 may include two rectangular shape patches. The first rectangular patch is connected to the CPW feed line 6210 and may have a dimension of about 0.6 mm×4.1 mm. The second rectangular patch is capacitively coupled to the cell patch 6201 and may have a dimension of about 1 mm×4.4 mm. The cell patch 6201 can be coupled to the launch pad 6205 through a coupling gap 6208 which may be about 0.1524 mm and can be shorted to a ground 6255 through a via 6240, via pad 6245 and ground line 6235. The dimension of the cell patch 6201, in this example, may be about 4.4 mm×7 mm. The via 6240 is connected to the cell patch 6201 on the top side of a dielectric substrate 6225 and to a via pad 6245 on the bottom side of the dielectric substrate 6225. The radius of the via 6240 may be about 0.127 mm, and its center may be located at about 3.3524 mm from the open end portion of the cell patch 6201. The via pad 6245 is connected to the ground 6255 through an L-shape ground line 6235 and may have a dimension of about 0.8 mm×0.8 mm. The ground line 6235 includes a first arm which is connected to the via pad 6245 and may have a dimension of about 0.3 mm×4.1 mm, and a second arm that is connected to the ground 6255 and may have a dimension of about 0.3 mm×6.35 mm.

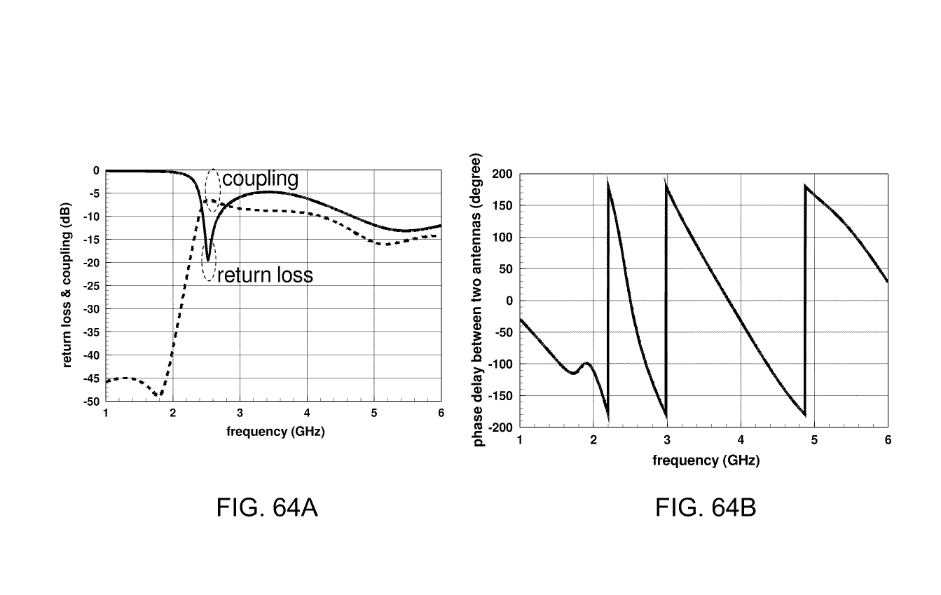

The metamaterial antenna array can be simulated by using Ansoft HFSS, and the results are shown in FIGS. 64A-64B. The results of these figures show that the metamaterial antenna array can operate at two different frequencies, f1=2.5 GHz and f2=5.0 GHz which is a second harmonic frequency of f1. The designs of the antenna array and the directional coupler are selected to have a strong coupling between two adjacent antennas at f1 and a weak coupling at f1. In the example in FIG. 64A, the coupling between the two antennas is −6.47 dB and −15.67 dB at f1 and f2, respectively. Since the coupling at f2 is weak, the conditions mentioned in example 2 in Section V may be considered to design the microwave directional coupler.

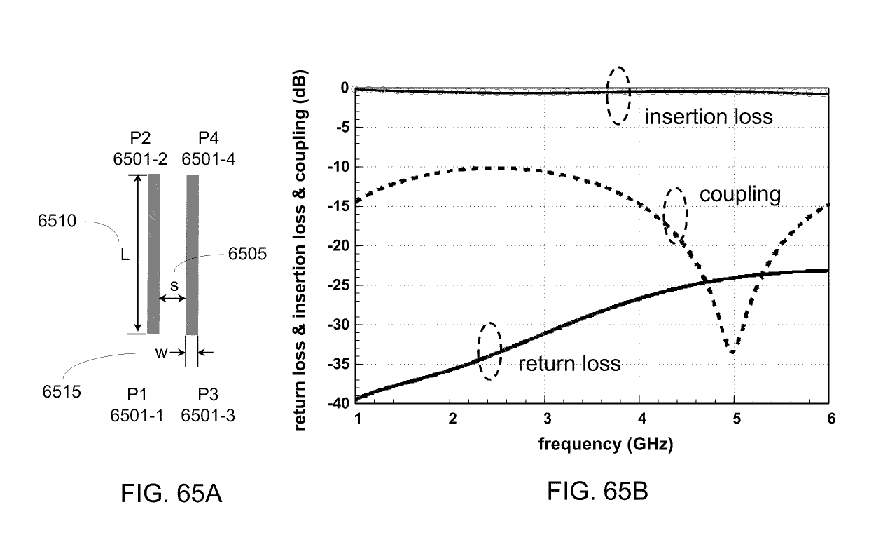

The structure of the microwave directional coupler which can be implemented using microstrip coupled lines is shown in FIG. 65A. In this example, the microwave directional coupler can be designed on a 1 mm FR-4 substrate having dielectric constant of 4.4. As shown in FIG. 65A, the width w 6515 of the microstrip coupled line measures about 1.3162 mm, the length L 6510 measures about 16.7941 mm, and the coupling gap s 6505 measures about 0.2843 mm.

The microwave directional coupler can have four ports where ports P1 6501-1 and P3 6501-3 may be used for RF inputs, and ports P2 6501-2 and P4 6501-4 may be used as the outputs of the coupler, as shown in FIG. 65A. Ports P2 6501-2 and P4 6501-4 is connected to the metamaterial antenna array as shown in FIG. 62 and FIGS. 63A-63B. From FIG. 64B, the phase of 0° at 2.5 GHz may be obtained between P1′ 6215-1 and P2′ 6215-2 of FIG. 62. Thus, by using Eq. (20), the phase delay θ2 from p1 6501-1 to p2 6501-2 in FIG. 65A may be found to be −90° at 2.5 GHz, and the coupling level |S31| may be defined as:

$$C 3 = \vert S 31 \vert = \frac{j k \cdot tan ( {θ}_{2} )}{\sqrt{1 - {k}^{2}} + j \cdot tan ( {θ}_{2} )} \\ where \\ k = \frac{{Z}_{0 e} - {Z}_{0 o}}{{Z}_{0 e} + {Z}_{0 o}} and \sqrt{{Z}_{0 e} \cdot {Z}_{0 o}} \qquad Eq . ( 22 )$$

In Eq. (22), Z₀, Z₀ₑ, and Z₀ₒ are the characteristic impedance, even mode impedance and odd mode impedance, respectively, of the microstrip coupled lines shown in FIG. 65A. The microwave directional coupler in this example, may be designed to have a characteristic impedance of 50Ω (Z₀) and a coupling (20 log |S31|) of −10 dB at 2.5 GHz. The maximum coupling can occur at θ2=−n·90° where n=1, 3, 5, 7 . . . . In this implementation, θ2=−90° and the maximum coupling can occur at 2.5 GHz, while the minimum coupling may occur at 5 GHz. Thus, equations Eq. (21a)-(21b) may be satisfied. FIG. 65B illustrates the simulated return loss, insertion loss, and coupling of the microwave directional coupler shown in FIG. 65A with input signal at P1 6501-1. Referring to FIG. 65B, the microwave directional coupler can be matched well to 50Ω over a frequency range from 1 GHz to 6 GHz and may have a coupling of about −10 dB at 2.5 GHz and about −33 dB coupling at 5 GHz.

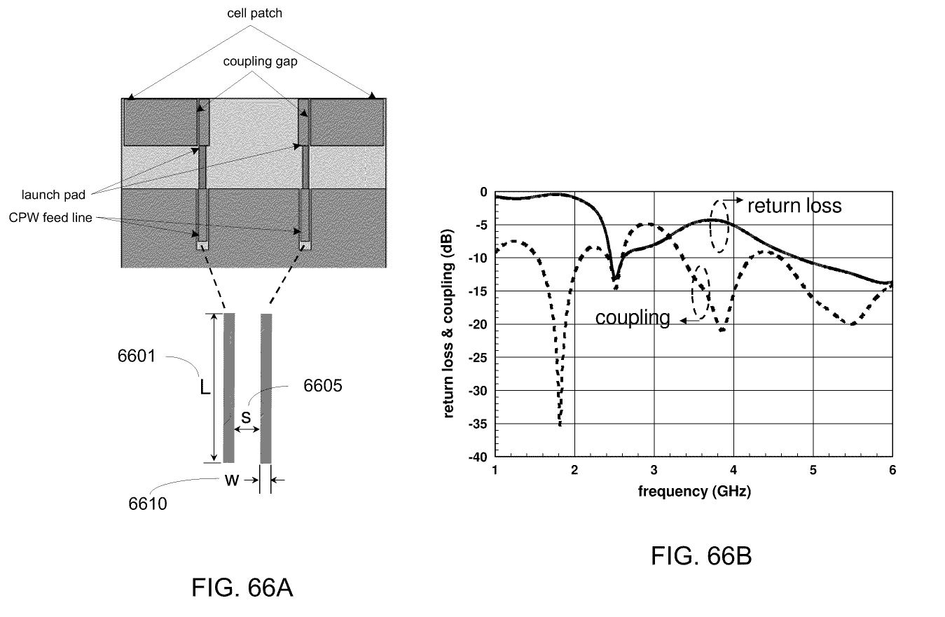

FIG. 66A illustrates an example in which the metamaterial antenna array shown in FIG. 62 and FIGS. 63A-63B is connected to the outputs (P2 6501-2, P4 6501-4) of the microwave directional coupler in FIG. 65A. In this implementation, the length L 6601 of the microstrip coupled line, the width w 6610 of the microstrip coupled line and the coupling gap s 6605 may be set to about 14.44 mm, 1.12 mm, and 0.23 mm, respectively. The simulation results for the dualband multi-antenna system of FIG. 66A are illustrated in FIG. 66B. From these figures, an adequate return loss at 2.5 GHz and 5 GHz may be obtained while the isolations at these two frequencies can be less than about −10 dB.

V.A3. Dualband Two-Element Antenna Array with 2-Way Directional Coupler Using MTM Transmission Line—Condition: f2≠2×f1, f2>f1, Strong Coupling at f1 and Weak Coupling at f2

The use of a conventional microwave directional coupler to improve the isolation between two antenna array elements at two frequencies has been demonstrated in the previous sections. In previous case, design of the coupler may be easier since only the requirement on the phase at f1 had to be satisfied. However, when using the conventional microwave directional coupler, the second frequency f2 has to be the even multiple of the first frequency f1 due to linearity of the transmission line propagation constant. Therefore, in order to design a dual-band multi-antenna system with flexibility, a different type of directional coupler may be required. In this case, an MTM coupler may be used to decouple two coupled metamaterial antenna array elements with f2≠2×f1. In another implementation of a multi-antenna system, a dual-band multi-antenna system may include a two-element metamaterial antenna array and an MTM coupler. A detailed description of each element is presented in Table 8.

TABLE 8
Multi-Antenna, Directional Coupler System: Two-Element
Antenna Array, 2-Way Directional Coupler using MTM
Transmission Line - Condition: f2 ≠ 2xf1, f2 > f 1,
strong coupling at f1 and weak coupling at f2 (Dualband)

| Parameter | Description | | Location |
|---|---|---|---|
| Dualband | Multi-antenna system comprises an MTM | | |
| Multi- | Antenna Array and a MTM Coupler. | | |
| Antenna | | | |
| System | | | |
| MTM Antenna | Antenna array comprises two MTM Antenna | | |
| Array | Elements. | | |
| MTM Antenna | Each antenna element comprises an MTM | | |
| Element | Cell and a Launch Pad. | | |
| Launch Pad | Each Launch Pad comprises two | | Top Layer |
| | rectangular shape patches, one of which | | |
| | connects to the Cell Patch and the | | |
| | other one connects to the 50 Ω CPW feed | | |
| | line. There is a coupling gap between | | |
| | the Launch Pad and the Cell Patch. | | |
| MTM Cell | Cell | Rectangular shape | Top Layer |
| | Patch | | |
| | Via | Cylindrical shape and | Top Layer |
| | | connects the Cell Patch with | to Bottom |
| | | the Via Pad. | Layer |
| | Via Pad | Small square pad that | Bottom |
| | | connects the bottom part of | Layer |
| | | the Via to the GND Line. | |
| | GND Line | L shaped line that connects | Bottom |
| | | the Via Pad to the main GND. | Layer |

| | |
|---|---|
| MTM Coupler | MTM Coupler comprises two MTM |
| | Transmission Lines in parallel to each |
| | other with Mutual Coupling L-C Set in |
| | between. |
| MTM | MTM transmission line comprises N Unit |
| Transmission | Cells cascading periodically along the |
| Line | direction of wave propagation. |
| Unit Cell | Each Unit cell comprises three sets of |
| | inductor and capacitor combination |
| | which include one Series L-C Set, one |
| | Shunt L-C Set, and one Series C-L Set. |

| | |
|---|---|
| Series | Series L-C set comprises one |
| L-C Set | series inductor and one |
| | series capacitor in order. |
| | The free end of the capacitor |
| | connects to the Shunt L-C |
| | Set. |
| Shunt | Shunt L-C set comprises one |
| L-C Set | shunt capacitor and one |
| | series inductor. |
| Series | Series L-C set comprises one |
| C-L Set | series capacitor and one |
| | series inductor in order. The |
| | free end of the capacitor |
| | connects to the Shunt L-C |
| | Set. |

| | |
|---|---|
| Mutual | Mutual coupling includes a mutual |
| Coupling L-C | inductance (Lₘ) and mutual capacitance |
| Set | (Cₘ) |

The structure of the dual-band metamaterial antenna array can be the same as that of the dual-band metamaterial antenna array shown in FIG. 62 and FIGS. 63A-63B, except that some dimensions are different, and is implemented also on a 1 mm FR-4 substrate having a dielectric constant of 4.4.

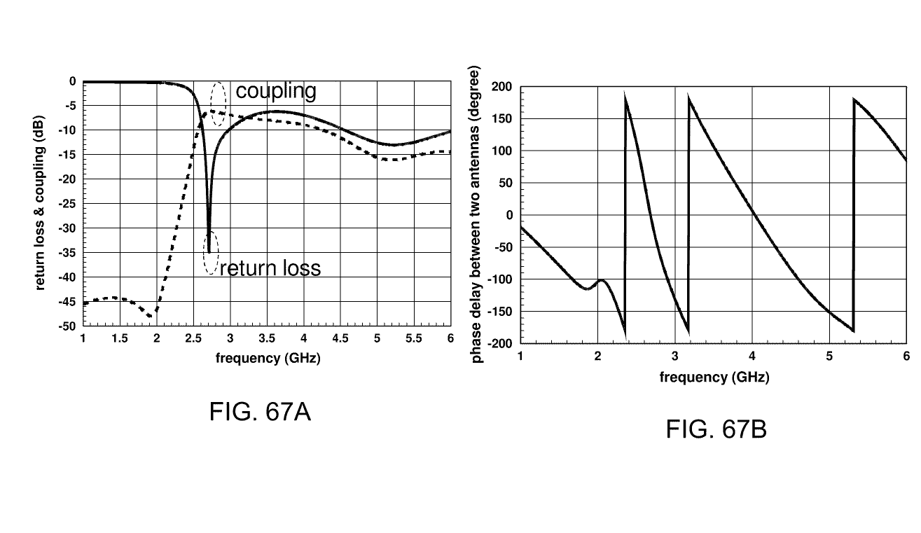

The above MTM antenna array in Table 8 is simulated by using Ansoft HFSS, and the results are shown in FIGS. 67A-67B. The results from these figures illustrate that the MTM antenna array described in this section may operate at two frequencies, f1=2.7 GHz and f2=5.0 GHz, and the coupling is about −6.27 dB and −15.63 dB at f1 and f2, respectively. Since the coupling at f2 is weak, the conditions mentioned in example 2 in Section V are considered to design the MTM directional coupler.

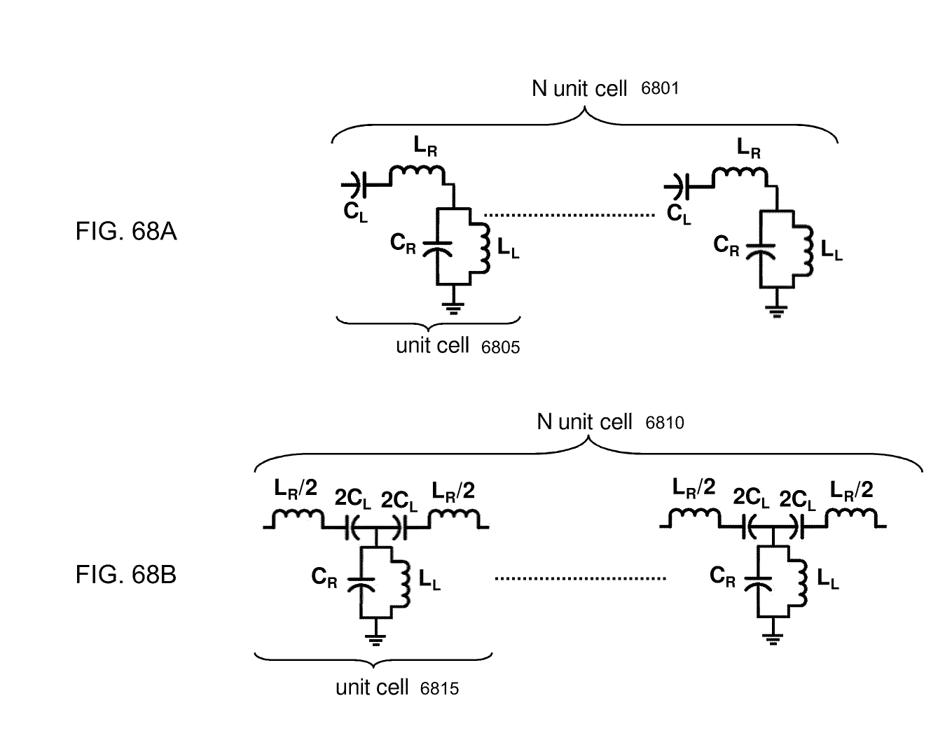

A metamaterial transmission line is an artificial transmission line structure and can be implemented by, for example, cascading N unit cells 6805 periodically. As shown in FIG. 68A, the equivalent circuit model of a metamaterial unit cell 6805 comprises series capacitance (C_{L}), series inductance (L_{R}), shunt capacitance (C_{R}), and shunt inductance (L_{L}). In order to have symmetric response from the metamaterial transmission line, the symmetric unit cell 6815 depicted in FIG. 68B is used in this implementation. See Caloz and Itoh, “Electromagnetic Metamaterials: Transmission Line Theory and Microwave Applications,” John Wiley & Sons (2006) for details in the equivalent circuit models. In FIG. 68B, the series capacitance and inductance are divided into two branches where one branch is on the left hand side of the shunt elements and the other branch is on the right hand side of the shunt element. In order to mimic the unit cell circuit model drawn in FIG. 68A, the series capacitance C_{L} and series inductance L_{R} are chosen to be 2C_{L} and L_{R}/2, respectively, in each branch. In this implementation, the MTM coupler may be realized by coupling two metamaterial transmission lines in parallel.

FIG. 69 shows the equivalent circuit model of the MTM coupler. The coupling between the two metamaterial transmission lines is represented by using mutual inductance (Lₘ) and mutual capacitance (Cₘ) in the circuit model. In this example, port1 6905-1 and port3 6905-3 are used as the inputs, and port2 6905-2 and port4 6905-4 are used as the outputs of the MTM coupler which are to be connected to the inputs of the metamaterial antenna array elements.

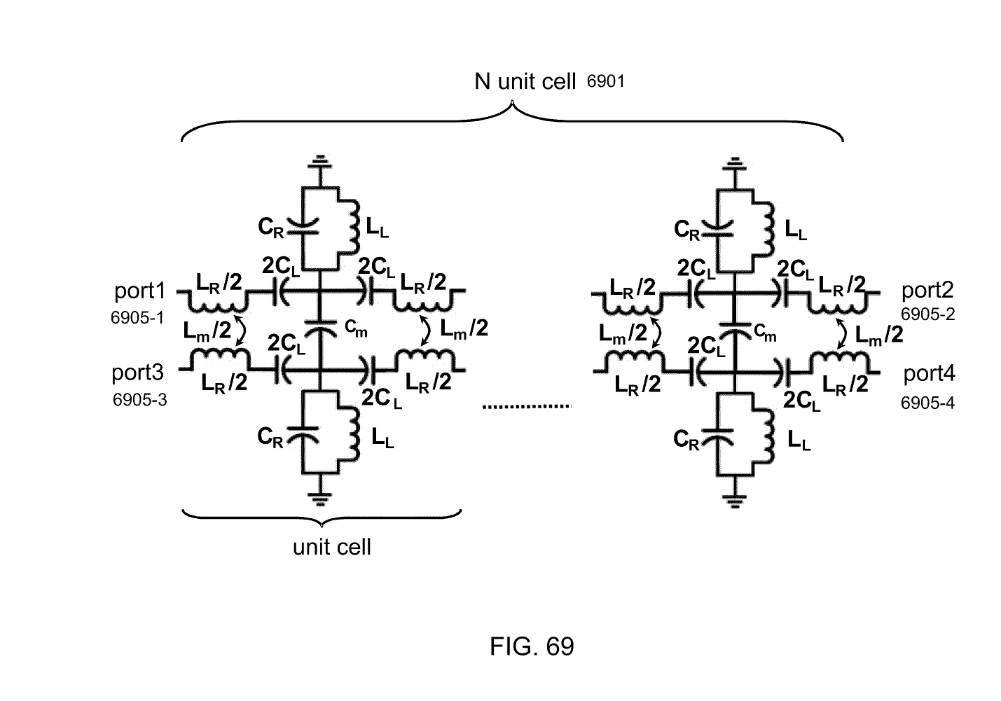

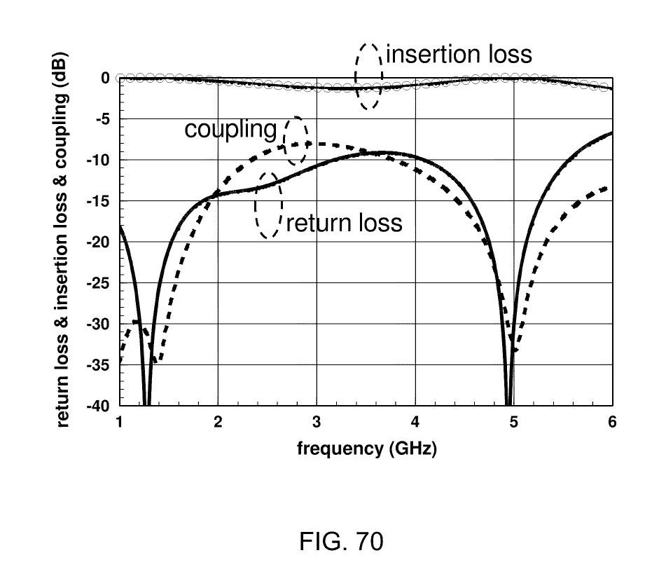

In general, the propagation constant of a metamaterial transmission line is dispersive and has nonlinear response to the frequency. See, for example, Caloz and Itoh, “Electromagnetic Metamaterials: Transmission Line Theory and Microwave Applications,” John Wiley & Sons (2006). Owing to this property, it may be possible to obtain maximum coupling and zero coupling at f1 and f2, respectively by using an MTM coupler, where f2 does not have to be even multiple of f1. Based on the simulation results for the metamaterial antenna array shown in FIG. 67A, the MTM coupler may be designed to have maximum coupling at 2.7 GHz and zero coupling at 5 GHz. In this implementation, L_{L}=7.5 nH, C_{L}=3 pF, L_{R}=1.249nH, C_{R}=0.4996 pF, Lₘ=0.2309 nH, and Cₘ=0.11 pF are obtained. The number of unit cells may be chosen to be 5 to achieve sufficient coupling level. FIG. 70 illustrates the return loss, insertion loss, and coupling of the MTM coupler represented by the equivalent circuit model in FIG. 69. From FIG. 70, the MTM coupler can be matched to 50Ω at both frequencies, 2.7 GHz and 5 GHz. The maximum coupling of −8.038 dB can be obtained at about 2.94 GHz, and about −33.29 dB coupling can be obtained at about 5 GHz.

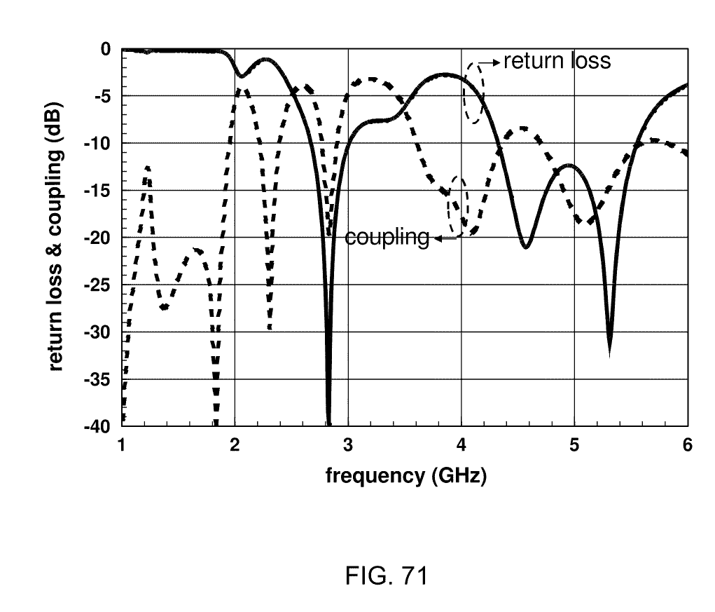

The dual-band multi-antenna system can be constructed by connecting the outputs of the MTM coupler (port2 6905-2 and port4 6905-4) in FIG. 69 directly to the two inputs of the metamaterial antenna array, which is similar in structure to the metamaterial antenna array in FIG. 62 and FIGS. 63A-63B. FIG. 71 shows the simulation results of the return losses and insertion loss of the dual-band multi-antenna system described in this section. Sufficient isolations of about −19.82 dB and −18.64 dB between two elements of the metamaterial antenna array can be obtained at about 2.82 GHz and 5.08 GHz, respectively, while two antennas can be still matched to 50Ω at these two frequencies.

V.A4. Dualband Two-Element Antenna Array with 2-Way Vertical Directional Coupler—Condition: f2≠2×f1, f2>f1, Strong Coupling at f1 and Weak Coupling at f2

To reduce the size of the whole system mentioned in the previous section, the microwave directional coupler in this section can be changed. Instead of using the microstrip coupled line for coupling, a coupled strip line may be used as the coupling portion. In this implementation, the dual-band multi-antenna system may include a two element metamaterial antenna array and a microwave vertical directional coupler. A detailed description of each element is described in Table 9.

TABLE 9
Multi-Antenna, Directional Coupler System: Two-Element
Antenna Array, 2-Way Vertical Directional Coupler - Condition:
f2 ≠ 2xf1, f2 > f1, strong coupling at f1 and weak coupling at f2
(Dualband)

| Elements | Description | | Location |
|---|---|---|---|
| Dualband | Dualband multi-antenna system | | |
| Multi- | comprises an MTM Antenna Array and a | | |
| Antenna | microwave Vertical Directional | | |
| System | Coupler. | | |
| MTM Antenna | Antenna array comprises two MTM | | |
| Array | Antenna Elements and two 50 Ω CPW | | |
| | Antenna Feed Lines. | | |
| MTM Antenna | Each antenna element comprises an | | |
| Element | MTM Cell and a Launch Pad. | | |
| Launch Pad | Each Launch Pad comprises two | | Layer 1 |
| | rectangular shape patches, one of | | |
| | which connects to the Cell Patch and | | |
| | the other one connects to the 50 Ω | | |
| | CPW feed line. There is a coupling | | |
| | gap between the Launch Pad and the | | |
| | Cell Patch. | | |
| MTM Cell | Cell | Rectangular shape | Layer 1 |
| | Patch | | |
| | Via | Cylindrical shape and | Layer 1 to |
| | | connects the Cell Patch | Layer 4 |
| | | with the Via Pad. | |
| | Via Pad | Small square pad that | Layer 4 |
| | | connects the bottom part | |
| | | of the Via to the GND | |
| | | Line. | |
| | GND | L shaped line that | Layer 4 |
| | Line | connects the Via Pad to | |
| | | the main GND. | |

| | | |
|---|---|---|
| 50 Ω CPW | 50 Ω CPW Antenna Feed Lines are on | Layer 1 and |
| Antenna | top and bottom of the substrate and | Layer 4 |
| Feed Line | they are connected through vias. | |
| Vertical | Vertical Directional Coupler | |
| Directional | comprises four 50 Ω CPW Coupler Feed | |
| Coupler | Lines, four Via Pads and one Coupled | |
| | Strip Line. | |
| 50 Ω CPW | Two 50 Ω CPW Coupler Feed Lines are | Layer 1 and |
| Coupler | on Layer 1 and connected to the via | Layer 4 |
| Feed Line | pads on Layer 2 through vias. Another | |
| | two 50 Ω CPW Feed Lines are on Layer 4 | |
| | and connected to the via pads on | |
| | Layer 3 through vias. | |
| Via Pad | Small square pad that connects one | Layer 2 and |
| | side of the via to one end of | Layer 3 |
| | Coupled Strip Line. | |
| Coupled | Two strip line on top of each other | Layer 2 and |
| Strip Line | with a substrate layer in between. | Layer 3 |

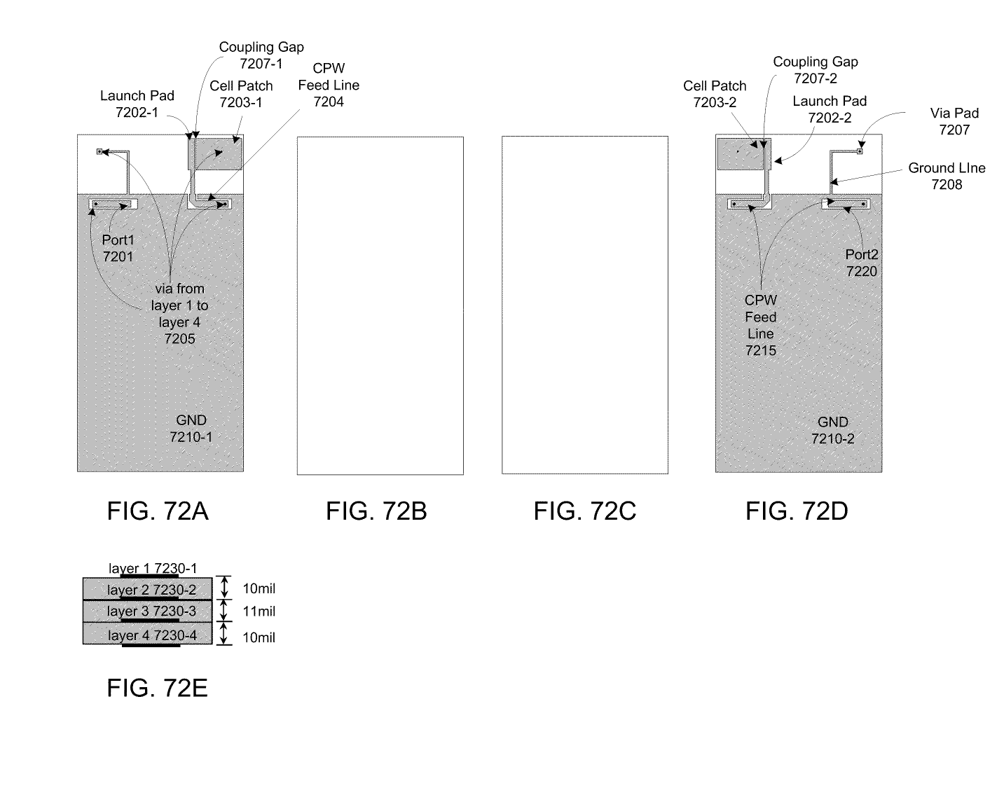

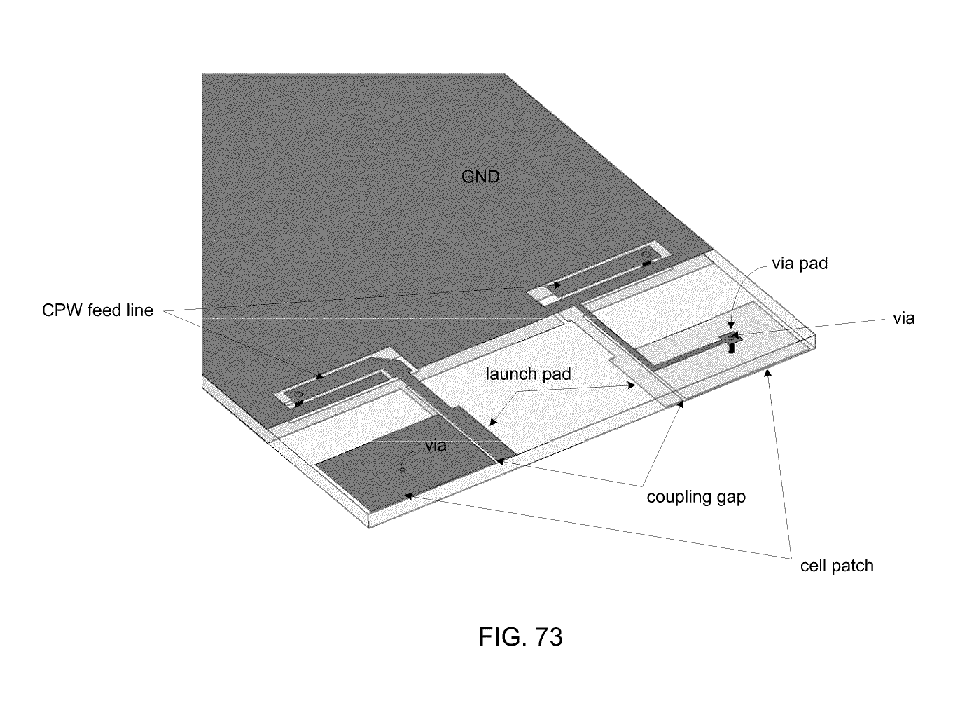

FIGS. 72A-72E and FIG. 73 illustrates a structure of the dual-band metamaterial antenna array. The metamaterial antenna array may be implemented on a 0.787 mm FR-4 substrate having a dielectric constant of 4.4. The space between the inner edges of the two antenna elements may be about 8.4 mm. Each metamaterial antenna can be fed by a 50Ω CPW feed lines 7204, 7215. In FIG. 72A, one end portion of the CPW feed line 7204 is connected directly to a launch pad 7202-1, and the other end portion is connected to another CPW feed line 7215 on the other side of the substrate through a via 7205. In FIG. 72D, one end portion of the CPW feed line 7215 is directly connected to a launch pad 7202-2, and the other end portion is connected to another CPW feed line 7204 on the other side of the substrate through via 7205.

In this implementation, each launch pad (7202-1, 7202-2) may include two rectangular shape patches. The first rectangular shape is connected to the CPW feed line 7204, 7215 and may have a dimension of about 0.6 mm×3.7 mm. The second rectangular shape is capacitively coupled to an cell patch 7203-1, 7203-2 and may have a dimension of about 1 mm×4.8 mm. The cell patch 7203-1 is coupled to the launch pad 7202-1 through a coupling gap 7207-1 (e.g., 0.1524 mm) and is shorted to a ground 7210-2 through a via 7205, via pad 7207 and ground line 7208. The dimension of the cell patch 7203-1, in this example, may be about 4.8 mm×7 mm. The coupling gap 7207-2 between the cell patch 7203-2 and the launch pad 7202-2 may have the same dimensions as the coupling gap 7207-1 previously mentioned. The via 7205 connects the cell patch 7203-1 on one top side of the substrate to a via pad 7207, as shown in FIG. 72D, on the bottom side of the substrate. The via 7205 connects the cell patch 7203-1 and via pad 7207 and may have a radius of about 0.127 mm. The center of the via pad 7207 may be located at about 3.1024 mm from the open end portion of the cell patch (7203-1, 7203-2). The dimension of the via pad 7207 may be about 0.8 mm×0.8 mm and is connected to the ground 7210-2 through an L-shape ground line 7208. The ground line 7208 includes a first arm that is connected to the via pad 7207 and may have a dimension of about 0.3 mm×4.1 mm, and a second arm that is connected to the ground 7210-2 and may have a dimension of about 0.3 mm×6.35 mm.

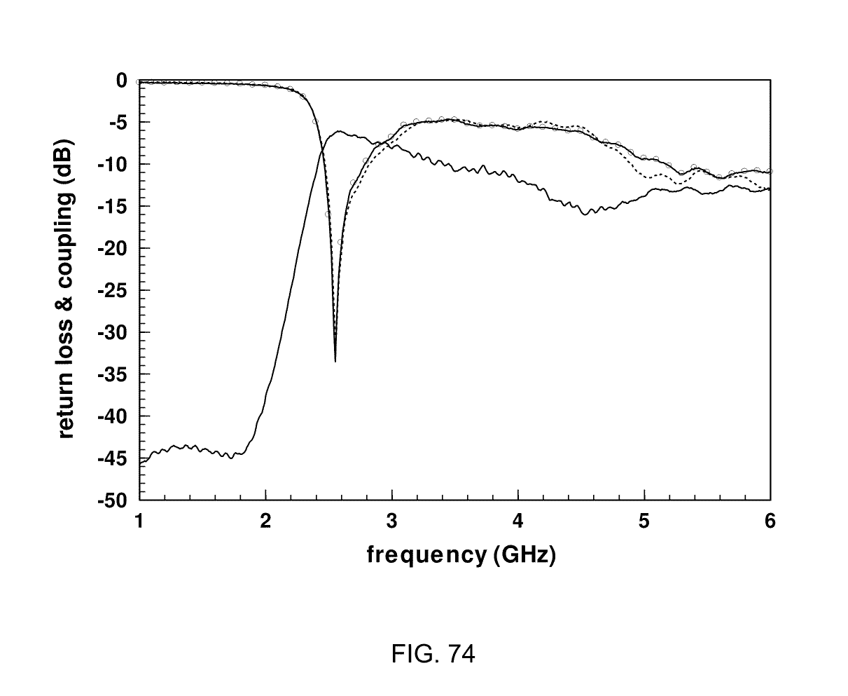

The metamaterial antenna array shown in FIGS. 72A-72E and 73 may be measured by using a network analyzer, and the results are shown in FIG. 74. The results from FIG. 74 illustrates that the metamaterial antenna array shown in FIGS. 72A-72E and 73 may operate at two frequencies, f1=2.57 GHz and f2=5.0 GHz to 6.0 GHz, and the coupling is about −6.0 dB and −13.0 dB at f1 and f2, respectively. Since the coupling at f2 is weak, these conditions, as mentioned example 2 in Section V, are considered in this analysis to design the vertical directional coupler.

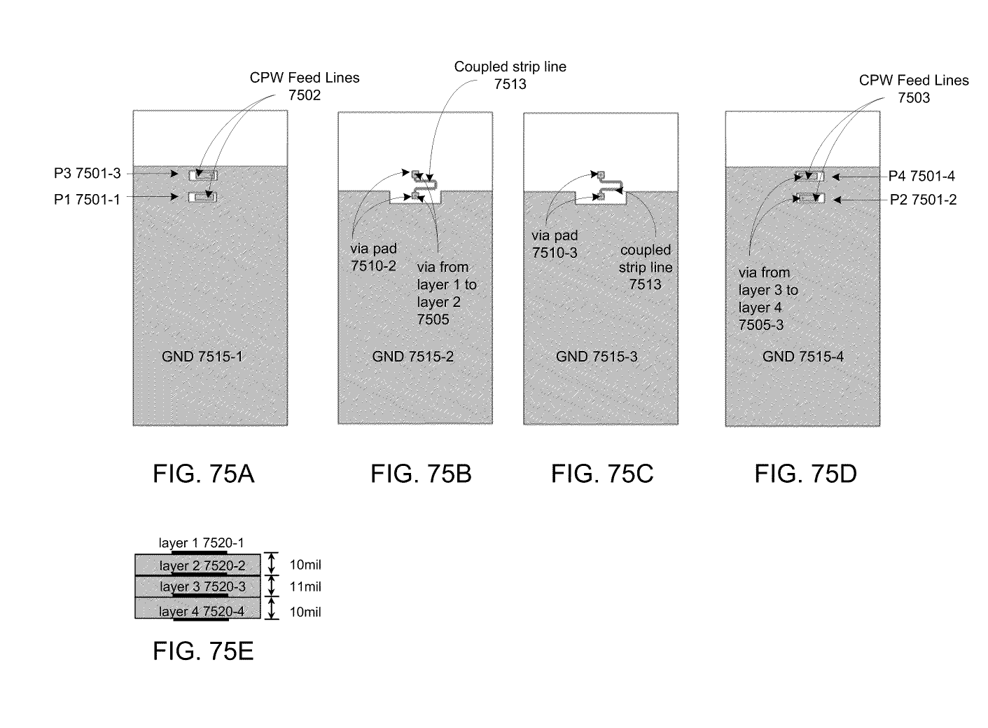

A structure of the vertical directional coupler which is realized by using coupled strip lines 7513 is shown in FIGS. 75A-75E. This vertical directional coupler may be designed on a 0.787 mm FR-4 substrate having a dielectric constant of 4.4 and four metal layers (FIGS. 75A-75D). In FIG. 75E, the thicknesses of the FR-4 substrates in between layer1 7520-1 and layer2 7520-2, layer2 7520-2 and layer3 7520-3, and layer3 7520-3 and layer4 7520-4 may be 10 mil, 11 mil, and 10 mil, respectively. A coupled strip line 7513 of FIGS. 75B and 75C may include two overlapping strip lines printed on layer2 (FIG. 75B) and layer3 (FIG. 75C). In this example, the width W of the coupled strip line 7513 may be about 0.25 mm and the length L may be about 8.2 mm. The dimensions of the vertical directional coupler can be selected to have 50Ω characteristic impedance and sufficient coupling at f1 and low coupling at f2. Thus, the conditions under Eq. (21a) and Eq. (21b) are satisfied.

The vertical directional coupler may include four ports where P1 7501-1 and P2 7501-2 may be used for RF inputs, as shown in FIGS. 75A and 75D, and ports P3 7501-3 and P4 7501-4 can be the outputs of the vertical directional coupler, as shown in FIGS. 75A and 75D. Ports P3 7501-3 and P4 7501-4 of FIGS. 75A and 75D can be connected to the metamaterial antenna array shown in FIGS. 72A-72E, as discussed in the next section. Four ends of the coupled strip line 7513 may be connected to four 1 mm×1 mm via pads (7510-2, 7510-3) in this example. Two CPW feed lines 7502 which are on layer1 of FIG. 75A can be connected to two via pads 7510-2 on layer2 of FIG. 75B through vias 7505. Another pair of CPW feed lines 7503 which are on layer 4 of FIG. 75D may be connected to two via pads 7510-3 on layer3 of FIG. 75C through vias 7507.

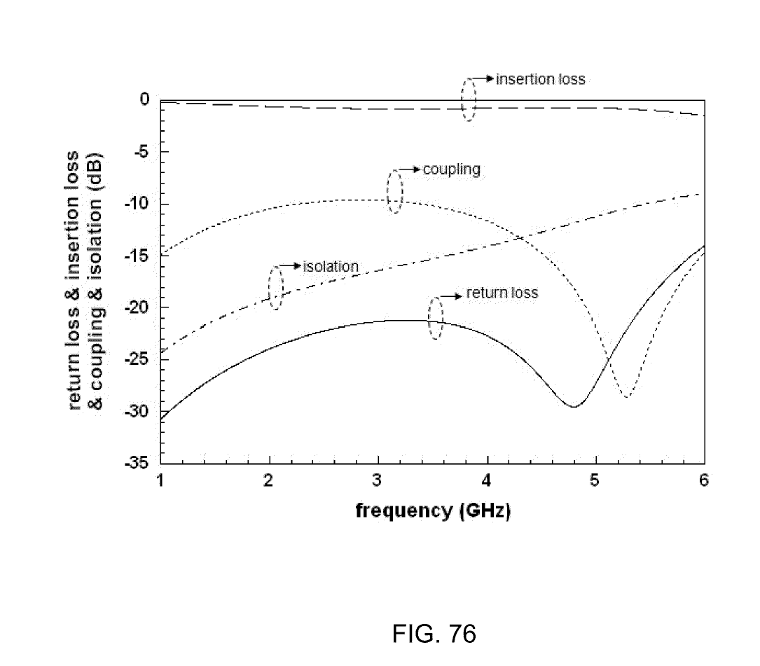

FIG. 76 illustrates the simulated return loss, insertion loss, coupling, and isolation of the vertical directional coupler shown in FIGS. 75A-75E. The results of FIG. 76 demonstrate that the vertical directional coupler is matched well to 50Ω over a frequency range from 1 GHz to 6 GHz and has coupling of about −10 dB at 2.7 GHz and −28.5 dB coupling at 5.28 GHz.

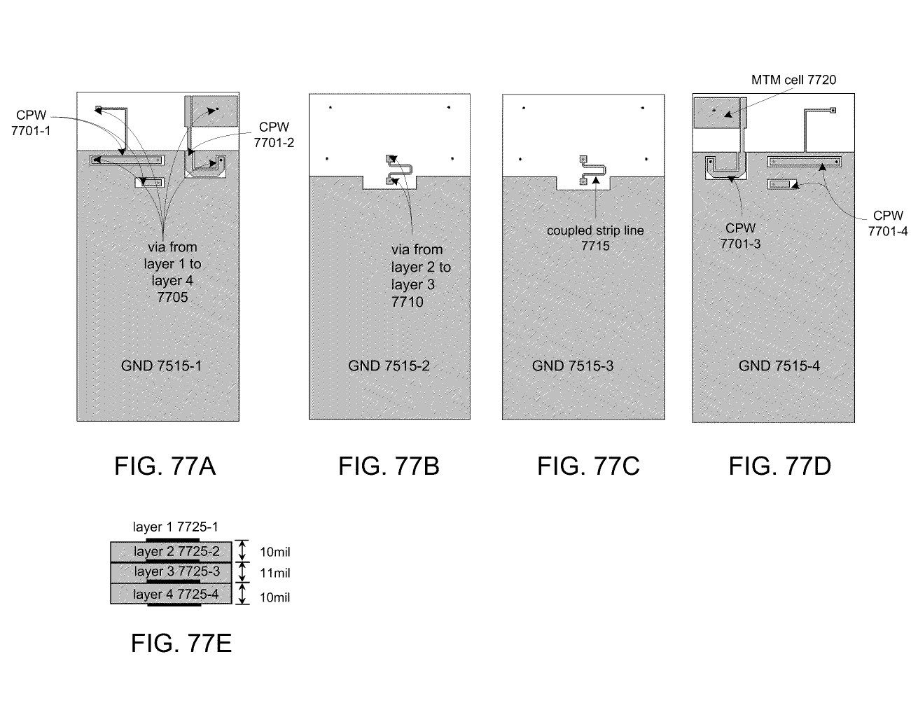

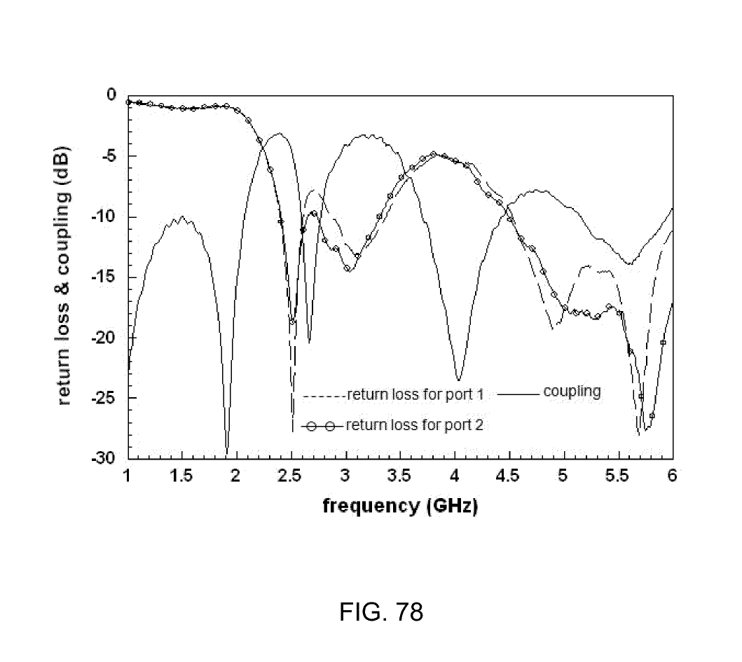

FIGS. 77A-77E shows an example in which the metamaterial antenna array illustrated in FIGS. 72A-72E and FIG. 73 is connected to the outputs of the vertical directional coupler in FIGS. 75A-75E. The CPW (7701-1, 7701-2, 7701-3, 7701-4) of the antenna elements in the system in FIGS. 77A and 77D are slightly different in shape as compared to those in the metamaterial antenna array in FIGS. 72A-72E. This minor structural difference results from the optimization performed during the implementation. The measurement results for the dualband multi-antenna system shown in FIG. 77 are plotted in FIG. 78. The results from FIG. 78 demonstrate that the return loss better than −10 dB from about 2.4 GHz to 3.3 GHz and about 4.5 GHz to 6 GHz can be obtained while the isolations are −20.45 dB and −14 dB at 2.65 GHz and 5.58 GHz, respectively. These results further demonstrate an isolation improvement compared to the one without the coupler as shown in FIG. 74.

V.A5. Dualband Two-Element Antenna Array with 2-Way Directional Coupler Using MTM Transmission Line and LC-Network—Condition: f2≠2×f1, f2>f1, Strong Coupling at f1 and Weak Coupling at f2

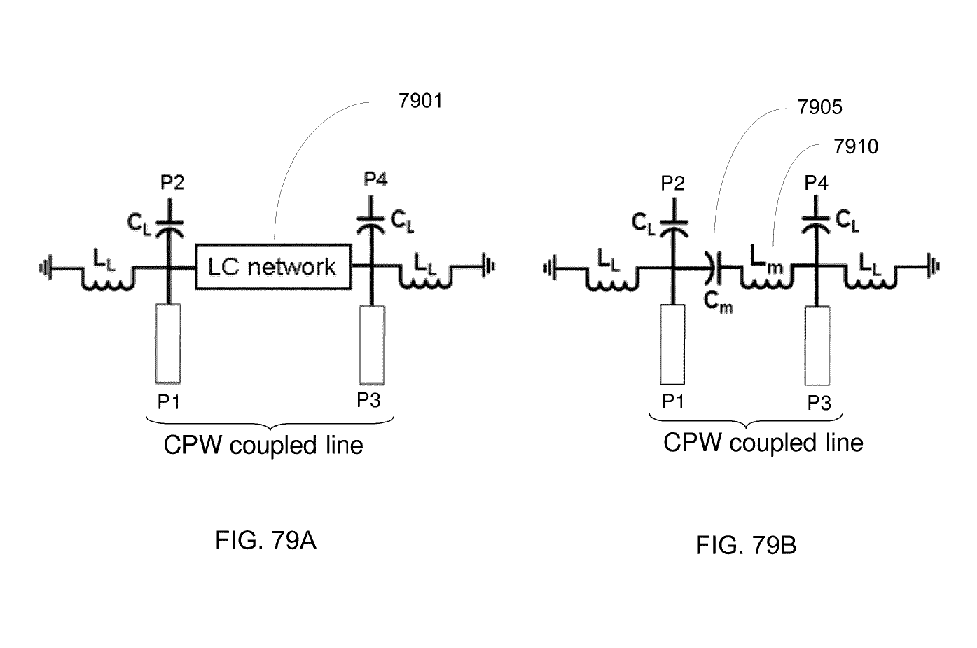

In the previous description, the dualband multi-antenna systems can be achieved by using either a conventional microwave directional coupler or a MTM coupler. The conventional microwave directional coupler used in these dualband multi-antenna system designs can either have a larger physical size which is bulky or multi-layer structure which is complicated. The MTM coupler may require multiple unit cells to satisfy the conditions in dualband operation which can have several lumped elements. In order to design a small dualband multi-antenna system which requires only a single cell MTM coupler, a LC network 7901 as shown in FIG. 79A can be used in the MTM coupler instead of only a single capacitor (Cm). FIG. 79B shows an example of using series capacitor (Cm) 7905 and series inductor (Lm) 7910 in the MTM coupler. By choosing the optimal combination of capacitor and inductor value, the frequency response of this MTM coupler can achieve high coupling at f1 and low coupling at f2.

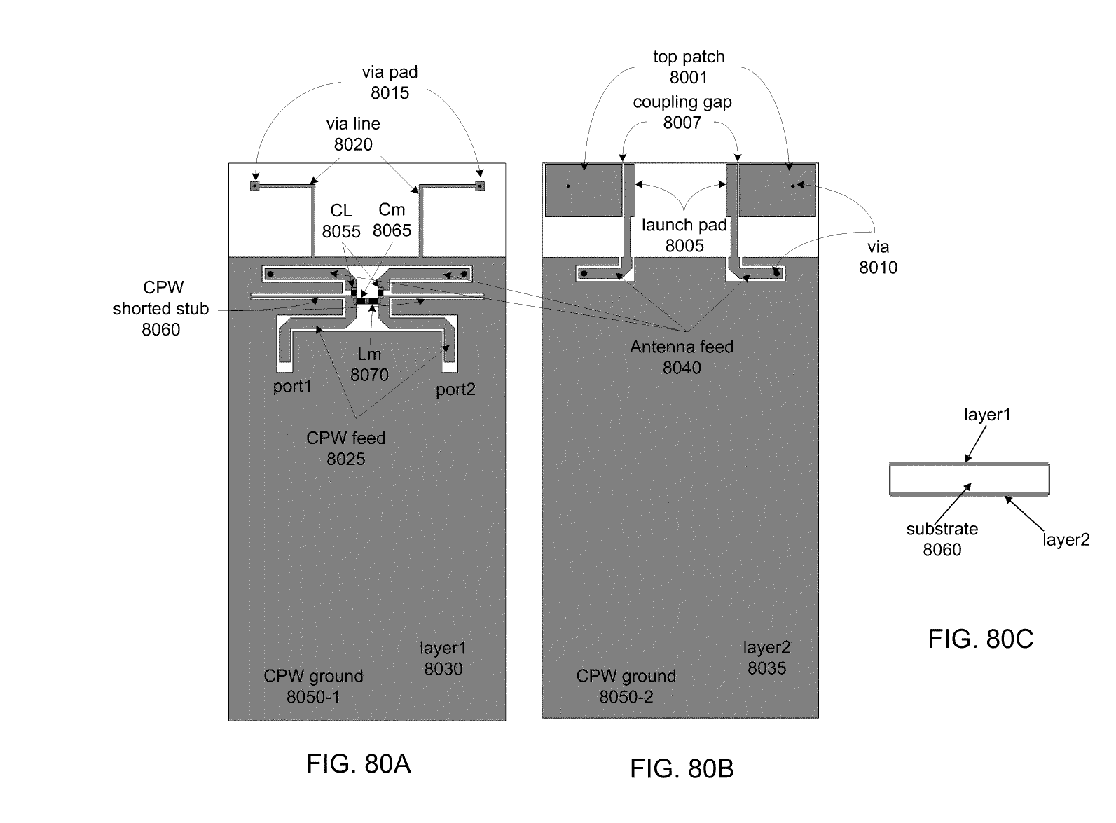

FIGS. 80A-80C shows multiple layers of a small dualband multi-antenna system which may include two metamaterial antennas and a MTM coupler. The small dualband multi-antenna system shown in FIGS. 80A-80C may be constructed on a 1 mm FR-4 substrate 8060 with dielectric constant of 4.4. As illustrated in FIG. 80A and FIG. 80B, each metamaterial antenna may include a top patch 8001, launch pad 8005, via 8010, via pad 8015 and a via line 8020. The antenna is excited by a 50Ω antenna feed 8040 which is printed on layer1 8030 and layer2 8035 and connected by a metallic via 8010. One side of the launch pad 8005 is connected to the antenna feed 8040 and the other side is coupled to the top patch 8001 through a coupling gap 8007. The top patch 8001 is connected to the via pad 8015 on the other side of the substrate by using a metallic via 8010. The via pad 8015 is connected to the CPW ground 8050-1 through the via line 8020. The four ports MTM coupler can include two metamaterial transmission lines and a LC network connecting in between. Each metamaterial transmission line may include a CPW feed 8025, series capacitor (CL) 8055, and a CPW shorted stub 8060. One end portion of the series capacitor (CL) 8055 is connected to the antenna feed 8040 and the other end portion is connected to the CPW feed 8025 and CPW shorted stub 8060. One end portion of the CPW shorted stub 8060 may be connected to the CPW ground 8050-1 and the other end portion may be connected to the CPW feed 8025. The LC network, in this implementation, may include a series capacitor (Cm) 8065 and a series inductor (Lm) 8070. One end portion of the Cm 8065 may be connected to CPW feed 8025 while the other end portion can be connected to Lm 8070. Similarly, one end portion of the Lm 8070 can be connected to another CPW feed 8025 while the other end portion can be connected to Cm 8065. Values for Cm and Lm may be selected to be about 0.4 pF and 6.8 nH, respectively.

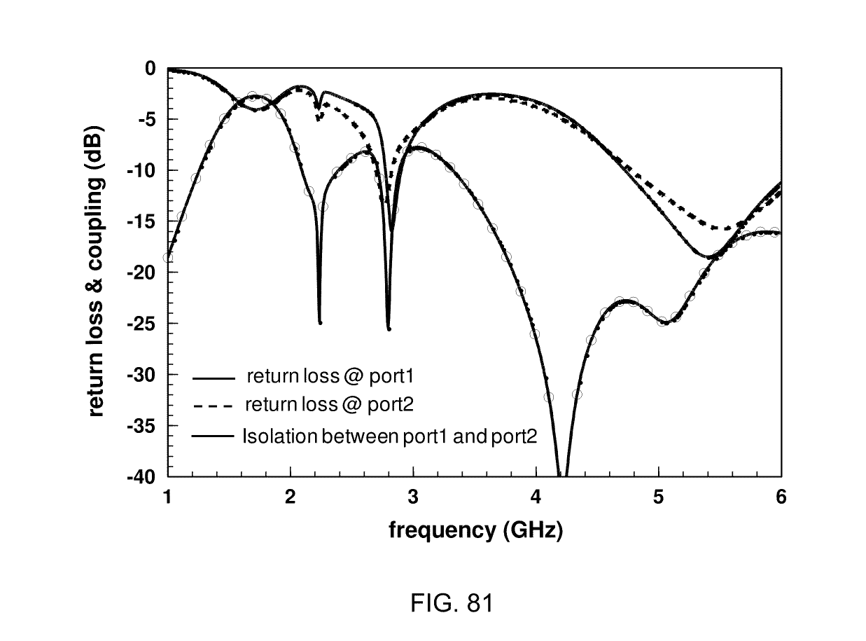

FIG. 81 illustrates the simulated return losses and coupling of the small dualband multi-antenna system shown in FIGS. 80A-80C. The results of FIG. 81 demonstrate that the isolation is better than about −10 dB in the low band (2.77 GHz to 2.9 GHz) and high band (4.72 GHz to 6.0 GHz) while still maintaining sufficient impedance matching at both bands.

VI. Multi-Antenna, Directional Coupler System: 2-Way Forward Wave MTM Coupler

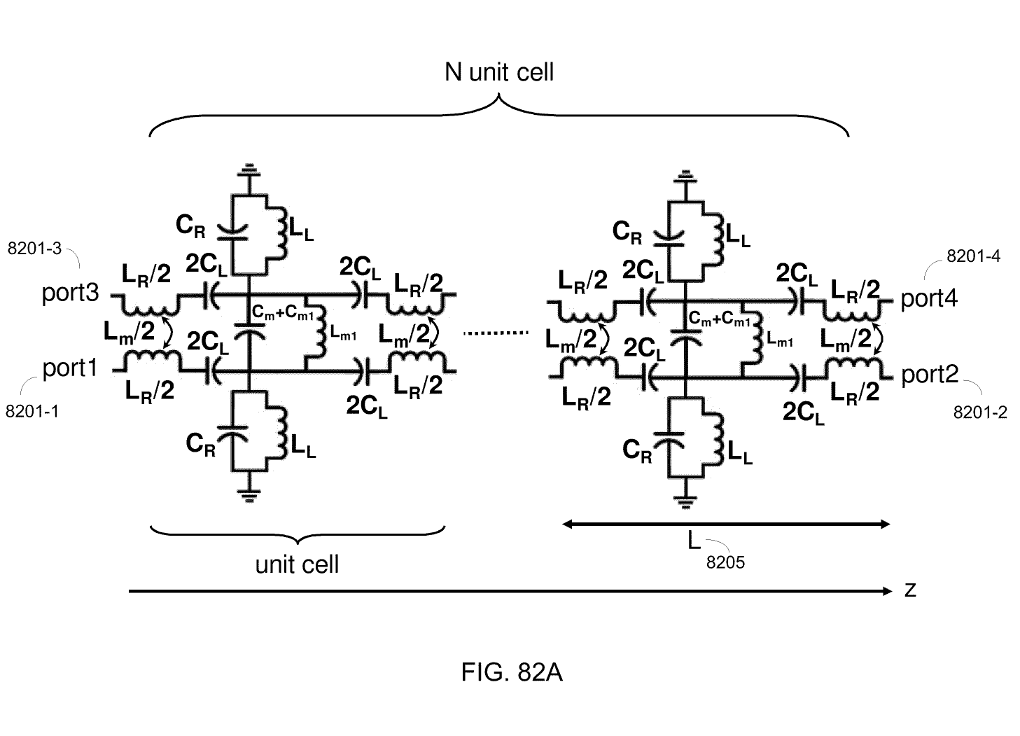

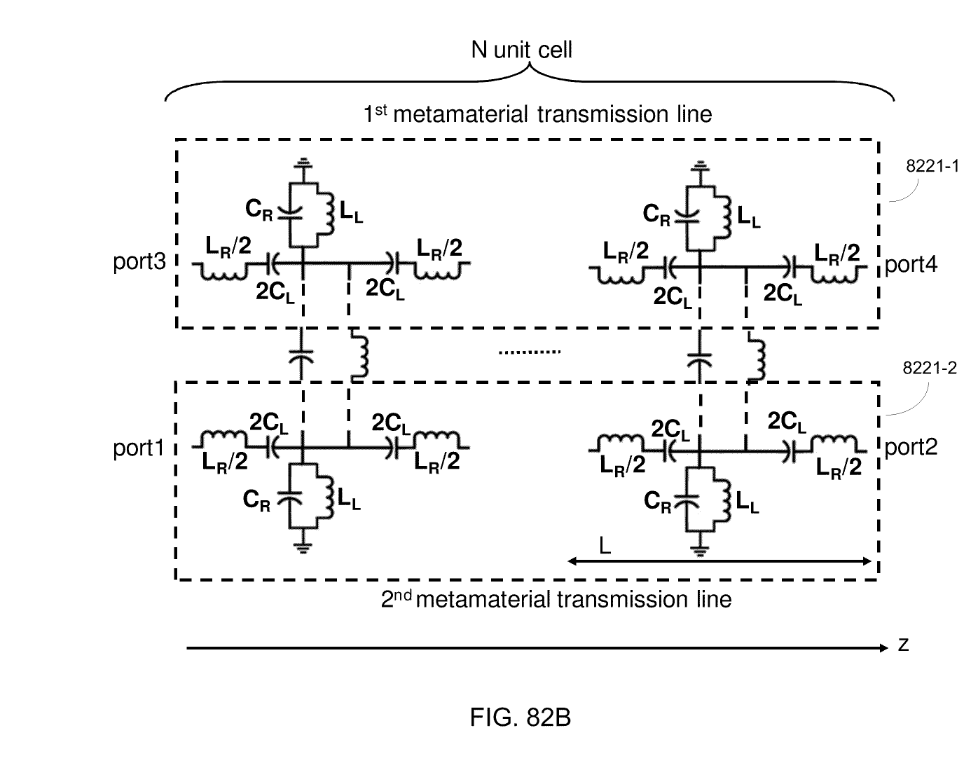

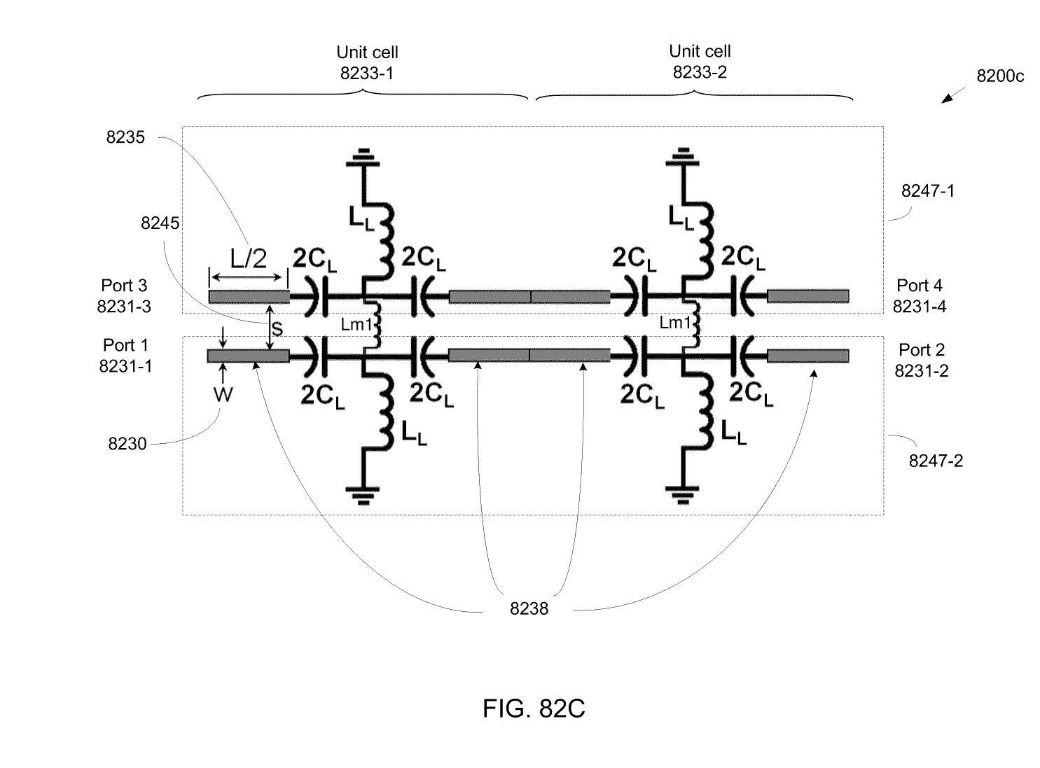

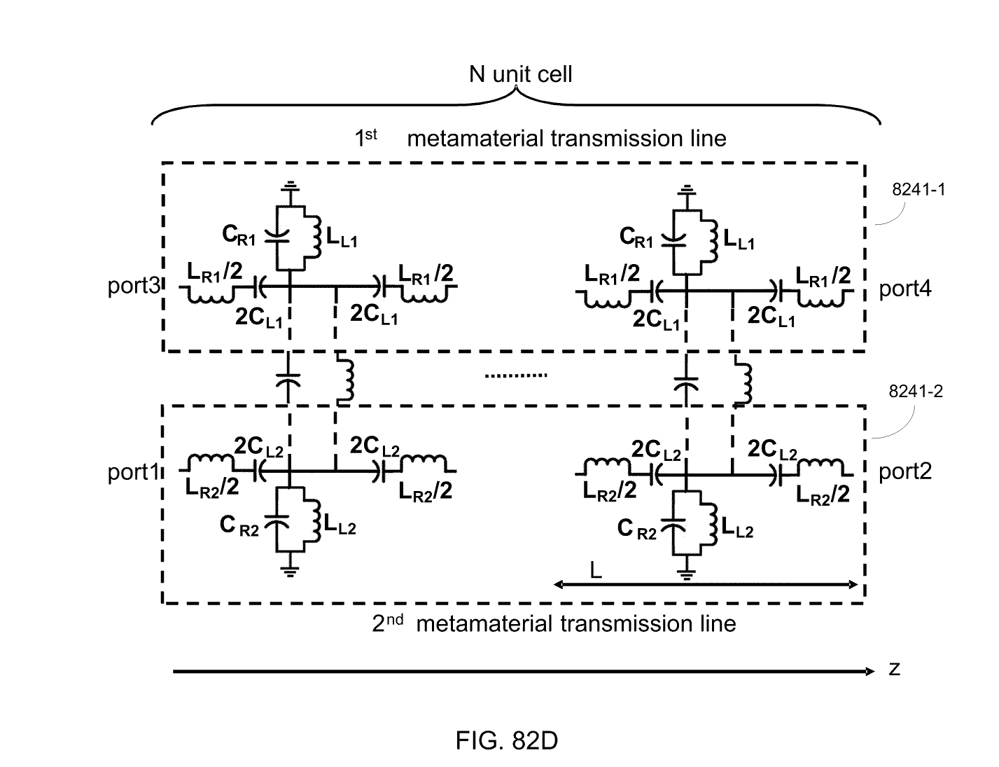

An MTM coupler can be modeled using the general equivalent circuit depicted in FIG. 69, where Lₘ and Cₘ are the induced mutual coupling by the microstrip coupled lines, CPW coupled lines or other type of coupled transmission lines in the planar form or in the 3-D form. These parameters have already been introduced for the MTM coupler represented by the equivalent circuit in FIG. 69. To extend the analysis for a general case, we use additional capacitive coupling by inserting a capacitor Cₘ₁ between the two coupled lines, and additional inductive coupling by inserting an inductor Lₘ₁ between the two coupled lines as shown in FIG. 82A. These additional coupling components can be used to manipulate the MTM coupler between backward-wave (BW) and forward-wave (FW) coupling as well as to create high coupling in some bands and low coupling in other bands. Like other components, Lₘ₁ and Cₘ₁ can be implemented as discrete components or distributed structures.

The following analysis provides a way to estimate a range of Cₘ₁ and Lₘ₁ values as well as C_{L} and L_{L} required for achieving necessary couplings at specific bands given a specific type, length, and impedance of coupled transmission lines. It may be still necessary to simulate the whole structure for final tuning and optimization. The analysis described in “Generalized Coupled-Mode Approach of Metamaterial Coupled-Line Couplers: Coupling Theory, Phenomenological Explanation, and Experimental Demonstration”, IEEE Transactions on Microwave Theory and Techniques, Vol. 55, No. 5, May 2007 can be followed along with making a modification of including additional Cₘ₁ and Lₘ₁ to Cₘ and Lₘ, which are the mutual coupling parameters due the coupled lines. In this analysis, only the symmetric line case is considered.

The theoretical BW and FW coupling factors KBW and KFW are given by:

$$\begin{matrix}KFW = \frac{1}{2} ω \sqrt{{L}_{R} \cdot {C}_{R}} ( \frac{{L}_{m} + {L}_{m 1}}{{L}_{R}} - \frac{{C}_{m} + {C}_{m 1}}{{C}_{R}} ) & Eq . ( 23 a ) \\ KBW = \frac{1}{2} ω \sqrt{{L}_{R} \cdot {C}_{R}} ( \frac{{L}_{m} + {L}_{m 1}}{{L}_{R}} + \frac{{C}_{m} + {C}_{m 1}}{{C}_{R}} ) & Eq . ( 23 b )\end{matrix}$$

The FW a⁺₁ (and a⁺₂) and BW a⁻₁ (and a⁻₂) waves along the 1^{st} (and 2^{nd}) metamaterial transmission lines (8221-1, 8221-2) shown in FIG. 82B are given by the formula below, where z is the position along the metamaterial transmission lines (8221-1, 8221-2):

$$\begin{matrix} {a}_{1}^{+} ( z ) = A {ⅇ}^{- j {β}_{I} z} + B {ⅇ}^{- j {β}_{II} z} + C {ⅇ}^{+ j {β}_{I} z} + D {ⅇ}^{+ j {β}_{II} z} & Eq . ( 24 a ) \\ {a}_{2}^{+} ( z ) = A {ⅇ}^{- j {β}_{I} z} - B {ⅇ}^{- j {β}_{II} z} + C {ⅇ}^{+ j {β}_{I} z} - D {ⅇ}^{+ j {β}_{II} z} & Eq . ( 24 b ) \\ {a}_{1}^{-} ( z ) = A ( \frac{β - {β}_{I} + KFW}{KBW} ) {ⅇ}^{- j {β}_{I} z} + B ( \frac{β - {β}_{II} - KFW}{KBW} ) {ⅇ}^{- j {β}_{II} z} + C ( \frac{β + {β}_{I} + KFW}{KBW} ) {ⅇ}^{+ j {β}_{I} z} + D ( \frac{β + {β}_{II} - KFW}{KBW} ) {ⅇ}^{+ j {β}_{II} z} & Eq . ( 24 c ) \\ {a}_{2}^{-} ( z ) = A ( \frac{β - {β}_{I} + KFW}{KBW} ) {ⅇ}^{- j {β}_{I} z} - B ( \frac{β - {β}_{II} - KFW}{KBW} ) {ⅇ}^{- j {β}_{II} z} + C ( \frac{β + {β}_{I} + KFW}{KBW} ) {ⅇ}^{+ j {β}_{I} z} - D ( \frac{β + {β}_{II} - KFW}{KBW} ) {ⅇ}^{+ j {β}_{II} z} & Eq . ( 24 d )\end{matrix}$$

where, β is the propagation constant of a single uncoupled metamaterial transmission line, β_{I} & β_{II} are the propagation constants of the coupled metamaterial transmission lines for even and odd modes, and are all given by the following relationships:

$$β = ω \sqrt{{L}_{R} \cdot {C}_{R}} ( 1 - \frac{ω}{{ω}_{0}} ) where \\ {ω}_{0} = \frac{1}{\sqrt{{L}_{R} \cdot {C}_{R}}} = \frac{1}{\sqrt{{L}_{R} \cdot {C}_{L}}} \qquad Eq . ( 25 a )$$

and uncoupled metamaterial transmission line impedances

$$\begin{matrix}Z = \frac{\sqrt{{L}_{L}}}{\sqrt{{C}_{L}}} = \frac{\sqrt{{L}_{R}}}{\sqrt{{C}_{R}}} & \\ {β}_{I} = \sqrt{{( KFW + β )}^{2} - {KBW}^{2}} & Eq . ( 25 b ) \\ {β}_{II} = \sqrt{{( KFW - β )}^{2} - {KBW}^{2}} & Eq . ( 25 c )\end{matrix}$$

The scattering parameters of the MTM coupler are defined as follows:

$$\begin{matrix}S 11 = \frac{{a}_{1}^{-} ( z = 0 )}{{a}_{1}^{+} ( z = 0 )} & Eq . ( 26 a ) \\ S 12 = S 34 = \frac{{a}_{1}^{+} ( z = L )}{{a}_{1}^{+} ( z = 0 )} & Eq . ( 26 b ) \\ S 13 = S 24 = \frac{{a}_{2}^{-} ( z = 0 )}{{a}_{1}^{+} ( z = 0 )} & Eq . ( 26 c ) \\ S 14 = S 23 = \frac{{a}_{2}^{+} ( z = L )}{{a}_{1}^{+} ( z = 0 )} & Eq . ( 26 d )\end{matrix}$$

where, L is the total length of one MTM coupler unit cell as shown in FIG. 82A-82B.

The boundary conditions that determine the constant A, B, C, and D in Eq. (24a-24d) are as follows:
a₁⁺(z=0)=a₀ Eq. (27a)
a₂⁺(z=0)=a₁⁻(z=L)=a₂⁻(z=L)=0 Eq. (27b)
Using the above equations, the parameter values such as L_{R}, C_{R}, etc. for an MTM coupler with given coupled lines can be obtained. Thereafter, the scattering matrix Sᵢⱼ that defines the coupling levels and coupler operating bands can be obtained.

The approach presented in this section is for the case where coupling occurs in the forward direction instead of backward direction as in the examples previously presented. In general, symmetric-line couplers as shown in FIG. 82A can couple signals between port1 8201-1 and port4 8201-4 when S141 is high and |S13| is low in Eq. (26a-26d), where |S14| is given by:

$$\begin{matrix}S 14 = - j {ⅇ}^{( - j \frac{{β}_{I} - {β}_{II}}{2} L )} sin ( \frac{{β}_{I} - {β}_{II}}{2} L ) & Eq . ( 28 a ) \\ {\vert S 14 \vert}^{2} = {sin}^{2} ( \frac{{β}_{I} - {β}_{II}}{2} L ) & Eq . ( 28 b )\end{matrix}$$

Most of the TEM transmission line type symmetric couplers have KBW>>KFW in Eq. (23a-23b) because Lₘ/L_{R} is close to Cₘ/C_{R} in value. Thus, the relationship β_{I}≈β_{II} from Eq. (25a-25c) leads |S14| to near zero. Therefore, most, if not all, conventional directional couplers are generally BW in nature. In MTM coupler, the propagation constants β_{I} and β_{II} can be different depending on the values of Lₘ₁ and Cₘ₁ for a given coupled line designed with C_{R}, L_{R}, Cₘ, and Lₘ. Therefore, the following free parameters C_{L}, Cₘ₁, and/or Lₘ₁ may be used to tune and optimize the length L 8205 and coupling level at specific frequency f. Notably, in this case, FW coupling can occur in a MTM coupler when (Lₘ₁+Lₘ)/L_{R}>>(Cₘ₁+Cₘ)/C_{R}. One example of planar MTM coupler with FW coupling will be demonstrated in FIG. 82C in the following description.

The asymmetric MTM coupler can be also implemented by paralleling two metamaterial transmission lines (8241-1, 8241-2) as shown FIG. 82D. In this analysis, C_{L1}, C_{L2}, L_{L1}, and L_{L2} are used to differentiate LH portion of the two parallel metamaterial transmission lines (8241-1, 8241-2) where 1 indicates the 1^{st} metamaterial transmission line (8241-1) and 2 indicates the 2^{nd} metamaterial transmission line (8241-2). The following analysis can provide a way to estimate a range of Cₘ₁ and Lₘ₁ values as well as required C_{L1}, C_{L2}, L_{L1}, and L_{L2} to achieve necessary couplings at specific bands. It may be still necessary to simulate the final structure for final tuning and optimization. The analysis described in “Generalized Coupled-Mode Approach of Metamaterial Coupled-Line Couplers: Coupling Theory, Phenomenological Explanation, and Experimental Demonstration”, IEEE Transactions on Microwave Theory and Techniques, Vol. 55, No. 5, May 2007 can be followed along with making a modification of including the additional Cₘ₁ and Lₘ₁ to Cₘ and Lₘ, which are the mutual coupling parameters due to the coupled lines. The theoretical BW and FW coupling factors KBW and KFW are given by:

$$\begin{matrix}KFW = \frac{1}{2} {ω ( {L}_{R 1} {L}_{R 2} {C}_{R 1} {C}_{R 2} )}^{14} ( \begin{matrix}\frac{{L}_{m} + {L}_{m 1}}{\sqrt{{L}_{R 1} {L}_{R 2}}} - \\ \frac{{C}_{m} + {C}_{m 1}}{\sqrt{{C}_{R 1} {C}_{R 2}}}\end{matrix} ) & Eq . ( 30 a ) \\ KBW = \frac{1}{2} ω {( {L}_{R 1} {L}_{R 2} {C}_{R 1} {C}_{R 2} )}^{14} ( \begin{matrix}\frac{{L}_{m} + {L}_{m 1}}{\sqrt{{L}_{R 1} {L}_{R 2}}} + \\ \frac{{C}_{m} + {C}_{m 1}}{\sqrt{{C}_{R 1} {C}_{R 2}}}\end{matrix} ) & Eq . ( 30 b )\end{matrix}$$

The FW a⁺₁, (and a⁺₂) and a BW a⁻₁, (and a⁻₂) waves along the 1^{st} (and 2^{nd}) metamaterial transmission line are given by the formula below, where z is the position along the MTM coupler:
a₁⁺(z)=Ae^{-jβ}^{_{I}}^{z}+Be^{-jβ}^{_{II}}^{z}+Ce^{+jβ}^{_{I}}^{z}+De^{+jβ}^{_{II}}^{z} Eq. (31a)
a₂⁺(z)=A₂e^{-jβ}^{_{I}}^{z}+B₂e^{-jβ}^{_{II}}^{z}+C₂e^{+jβ}^{_{I}}^{z}+D₂e^{+jβ}^{_{II}}^{z} Eq. (31b)
a₁⁻(z)=A₁′e^{-jβ}^{_{I}}^{z}+B₁′e^{-jβ}^{_{II}}^{z}+C₁′e^{+jβ}^{_{I}}^{z}+D₁′e^{+jβ}^{_{II}}^{z} Eq. (31c)
a₂⁻(z)=A₂′e^{-jβ}^{_{I}}^{z}+B₂′e^{-jβ}^{_{II}}^{z}+C₂′e^{+jβ}^{_{I}}^{z}+D₂′e^{+jβ}^{_{II}}^{z} Eq. (31d)

Here, the coefficients can be expressed in terms of A, B, C, and D as:

$$\begin{matrix}{A}_{3}^{′} = \frac{{A}_{1} ( {β}_{1} - {β}_{I} ) + KFW {A}_{3}}{KBW} & Eq . ( 32 a ) \\ {B}_{3}^{′} = \frac{{B}_{1} ( {β}_{1} - {β}_{II} ) + KFW {B}_{3}}{KBW} & Eq . ( 32 b ) \\ {C}_{3}^{′} = \frac{{C}_{1} ( {β}_{1} + {β}_{I} ) + KFW {C}_{3}}{KBW} & Eq . ( 32 c ) \\ {D}_{3}^{′} = \frac{{D}_{1} ( {β}_{1} + {β}_{II} ) + KFW {D}_{3}}{KBW} & Eq . ( 32 d ) \\ {A}_{1}^{′} = \frac{{A}_{3} ( {β}_{3} - {β}_{I} ) + KFW {A}_{1}}{KBW} & Eq . ( 33 a ) \\ {B}_{1}^{′} = \frac{{B}_{3} ( {β}_{3} - {β}_{II} ) + KFW {B}_{1}}{KBW} & Eq . ( 33 b ) \\ {C}_{1}^{′} = \frac{{C}_{3} ( {β}_{3} + {β}_{I} ) + KFW {C}_{1}}{KBW} & Eq . ( 33 c ) \\ {D}_{1}^{′} = \frac{{D}_{3} ( {β}_{3} + {β}_{II} ) + KFW {D}_{1}}{KBW} & Eq . ( 33 d ) \\ {A}_{2} = A \frac{2 KFW {β}_{1}}{- ( {β}_{1} + {β}_{I} ) ( {β}_{2} - {β}_{I} ) + {KFW}^{2} - {KBW}^{2}} & Eq . ( 34 a ) \\ {B}_{2} = B \frac{2 KFW {β}_{1}}{- ( {β}_{1} + {β}_{II} ) ( {β}_{2} - {β}_{II} ) + {KFW}^{2} - {KBW}^{2}} & Eq . ( 34 b ) \\ {C}_{2} = C \frac{2 KFW {β}_{1}}{- ( {β}_{1} + {β}_{I} ) ( {β}_{2} - {β}_{I} ) + {KBW}^{2} - {KFW}^{2}} & Eq . ( 34 c ) \\ {D}_{2} = D \frac{2 KFW {β}_{1}}{- ( {β}_{1} + {β}_{II} ) ( {β}_{2} - {β}_{II} ) + {KFW}^{2} - {KBW}^{2}} & Eq . ( 34 d )\end{matrix}$$

where, β₁ and β₂ are the propagation constants of the two uncoupled metamaterial transmission lines (8241-1, 8241-2) and β_{I}/β_{II} are the propagation constants of the metamaterial coupled lines even and odd modes and are all given as follows:

$$\begin{matrix}{β}_{1} = ω \sqrt{{L}_{R 1} {C}_{R 1}} ( 1 - \frac{{ω}_{β 1}}{ω} ) where \\ {ω}_{β 1} = \frac{1}{\sqrt{{L}_{L 1} {C}_{R 1}}} = \frac{1}{\sqrt{{L}_{ R 1} {C}_{L 1}}} and \\ uncoupled line impedance Z = \sqrt{\frac{{L}_{L 1}}{{C}_{L 1}}} = \sqrt{\frac{{L}_{R 1}}{{C}_{R 1}}} & Eq . ( 35 a ) \\ {β}_{2} = ω \sqrt{{L}_{R 1} {C}_{R 1}} ( 1 - \frac{{ω}_{β 2}}{ω} ) where \\ {ω}_{β 2} = \frac{1}{\sqrt{{L}_{L 2} {C}_{R 2}}} = \frac{1}{\sqrt{{L}_{ R 2} {C}_{L 2}}} and \\ uncoupled line impedance Z = \sqrt{\frac{{L}_{L 2}}{{C}_{L 2}}} = \sqrt{\frac{{L}_{R 2}}{{C}_{R 2}}} & Eq . ( 35 b ) \\ {β}_{I} = \sqrt{\begin{matrix}{KFW}^{2} - {KBW}^{2} + \frac{{β}_{1}^{2} + {β}_{3}^{2}}{2} + \\ \sqrt{\begin{matrix}{( \frac{ {β}_{ 1}^{ 2} - {β}_{ 3}^{ 2}}{ 2} )}^{2} - {{KBW}^{ 2} ( {β}_{ 1} - {β}_{ 3} )}^{2} + \\ {{KFW}^{ 2} ( {β}_{ 1} + {β}_{ 3} )}^{2}\end{matrix}}\end{matrix}} & Eq . ( 35 c ) \\ {β}_{II} = \sqrt{\begin{matrix}{KFW}^{2} - {KBW}^{2} + \frac{{β}_{1}^{2} + {β}_{3}^{2}}{2} - \\ \sqrt{\begin{matrix}{( \frac{ {β}_{ 1}^{ 2} - {β}_{ 3}^{ 2}}{ 2} )}^{2} - {{KBW}^{ 2} ( {β}_{ 1} - {β}_{ 3} )}^{2} + \\ {{KFW}^{ 2} ( {β}_{ 1} + {β}_{ 3} )}^{2}\end{matrix}}\end{matrix}} & Eq . ( 35 d )\end{matrix}$$

Thus, the scattering parameters of the directional couplers are defined by:

$$\begin{matrix}S 11 = \frac{{a}_{1}^{-} ( z = 0 )}{{a}_{1}^{+} ( z = 0 )} & Eq . ( 36 a ) \\ S 12 = \frac{{a}_{1}^{+} ( z = L )}{{a}_{1}^{+} ( z = 0 )} & Eq . ( 36 b ) \\ S 13 = \frac{{a}_{3}^{-} ( z = 0 )}{{a}_{1}^{+} ( z = 0 )} & Eq . ( 36 c ) \\ S 14 = \frac{{a}_{3}^{+} ( z = L )}{{a}_{1}^{+} ( z = 0 )} & Eq . ( 36 d )\end{matrix}$$

The boundary conditions that determine the constant A, B, C, and D in Eq. (31a-31d) are:
a₁⁺(z=0)=a₀a₃⁺(z=0)=a₁⁻(z=L)=a₃⁻(z=L)=0 Eq. (37)
Where L is the total length of one MTM coupler unit cell. For a given coupled lines determined by L_{R1}, C_{R1}, L_{R2}, C_{R2}, Lₘ, and Cₘ and using Eq. (30a-30b) to Eq. (36a-36d); the scattering matrix Sij that can determine coupling levels and coupler operating bands may be manipulated using the free parameters C_{L1} (or L_{L1}), C_{L2} (or L_{L2}) and Cₘ₁ and/or Lₘ₁.

In this section, two examples of FW MTM couplers are considered. One example is a planar FW MTM directional coupler. The schematic of this coupler is shown in FIG. 82C. The planar FW MTM directional coupler 8200c shown in FIG. 82C can be implemented by paralleling two metamaterial transmission lines (8247-1, 8247-2) with an additional inductor Lₘ₁ (Cm1 is 0 in this example) connecting between the two metamaterial transmission lines (8247-1, 8247-2). Each metamaterial transmission line (8247-1, 8247-2) has two unit cells (8233-1, 8233-2). Each metamaterial unit cell (8233-1 and 8233-2) comprises two transmission lines (represented by a gray rectangular boxes 8238 in FIG. 82C), two series capacitors of 2C_{L} and one shunt inductor of L_{L}. This FW MTM coupler can be fabricated on a FR-4 substrate having a dielectric constant of about 4.4 and thickness of about 0.787 mm. Each of the transmission line 8238 can have an intrinsic series inductance L_{R} and a shunt capacitance C_{R}. Therefore, the implemented planar FW directional coupler in FIG. 82C can be represented by the equivalent circuit of FIG. 82A. The mutual inductor capacitor Cₘ shown in FIG. 82A is induced when the two metamaterial transmission lines (8247-1, 8247-2) are within close proximity.

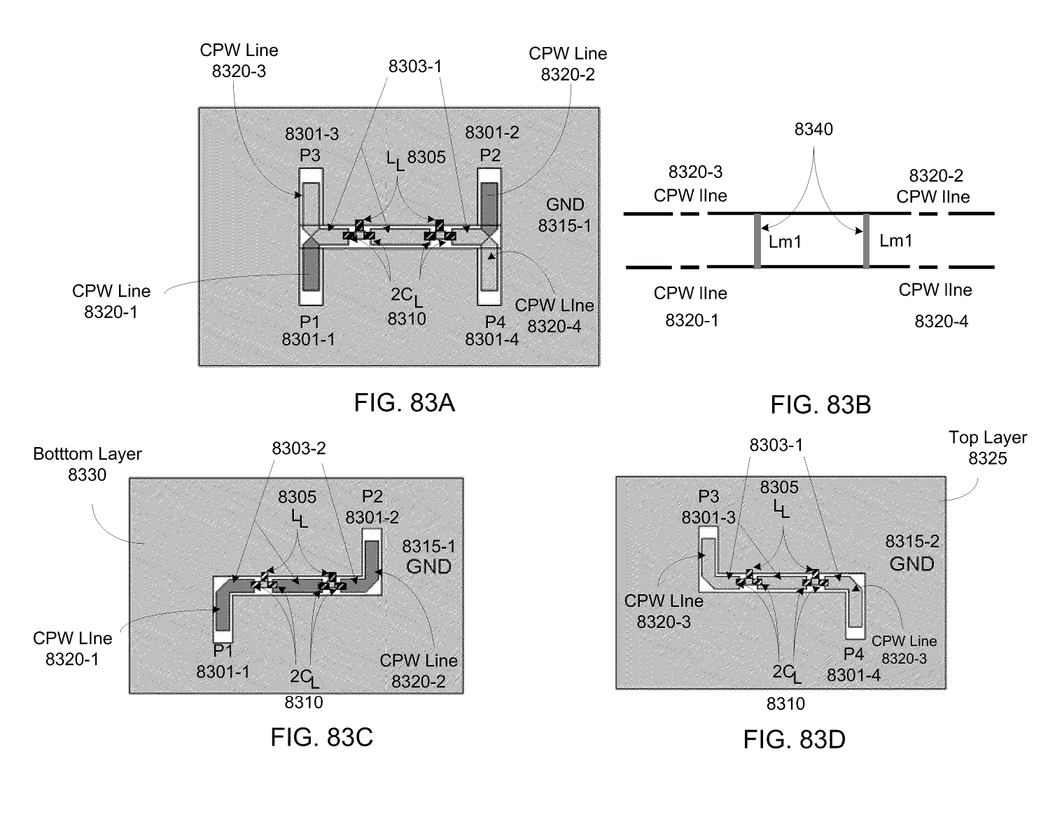

Another example of FW MTM coupler is a vertical FW MTM coupler shown in FIGS. 83A-83D. This FW MTM coupler may be realized by cascading two coupled metamaterial unit cells. In FIG. 83A-83D, each coupled metamaterial cell is built by paralleling two metamaterial unit cells vertically with an additional inductor Lₘ₁ connecting between the two metamaterial unit cells, wherein one set of unit cells is on the top layer 8325 of the substrate (between top layer 8325 and bottom layer 8330), the other set of unit cells is on the bottom layer 8330 of the substrate (between top layer 8325 and bottom layer 8330), and the inductors Lₘ₁ 8340 couple the top and bottom layers as shown in FIG. 83B. Each metamaterial unit cell also comprises two transmission lines 8303-1, two series capacitors 2C_{L} 8310 and one shunt inductor L_{L} 8305. The vertically coupled transmission lines (paralleling transmission line 8303-1 and 8303-2) provide mutual inductance Lₘ and mutual capacitance Cₘ. In addition, each port (P1 8301-1, P2 8301-2, P3 8301-3, P4 8301-4) of the vertical FW MTM coupler is connected to the transmission lines 8303-1, 8303-2 through a CPW line (8320-1, 8320-2, 8320-3, 8320-4).

The planar FW MTM coupler shown in FIG. 82C is designed to have FW coupling at 2.4 GHz.

Some of the design parameters for the planar FW MTM coupler shown in FIG. 82C are summarized in Table 10:

TABLE 10
Planar FW MTM Coupler

| | | |
|---|---|---|
| w | 1.5 | mm |
| s | 0.1 | mm |
| L | 8 | mm |
| Cₘ | 0.2444 | pF |
| C_{R} | 0.936 | pF |
| L_{R} | 2.18 | nH |
| Lₘ | 0.5416 | nH |

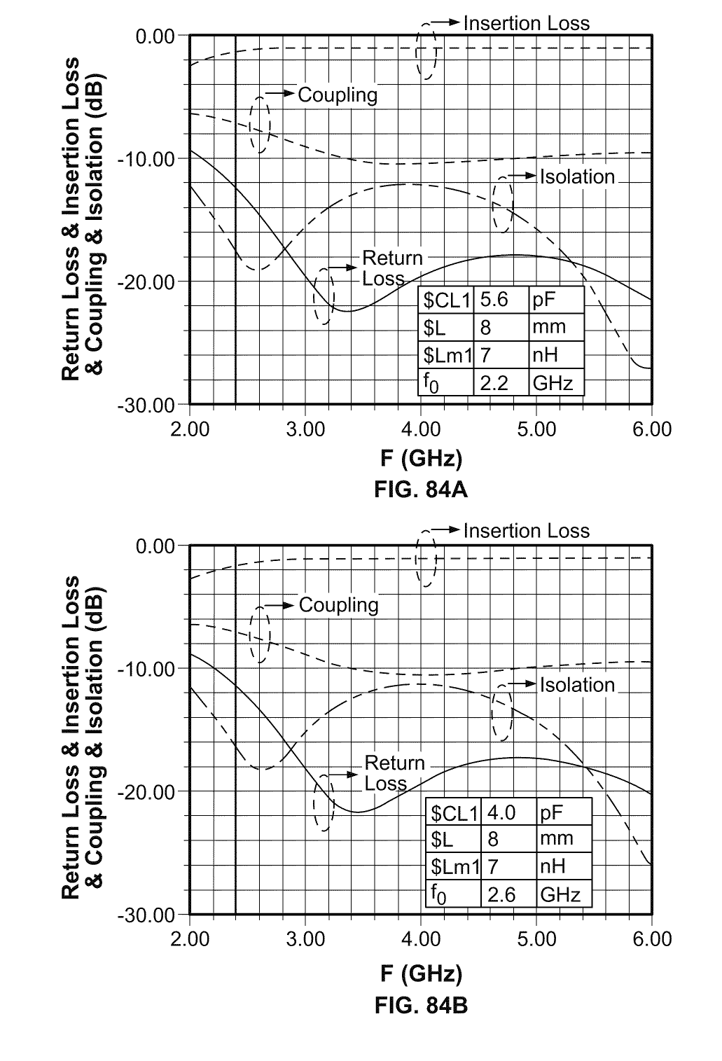

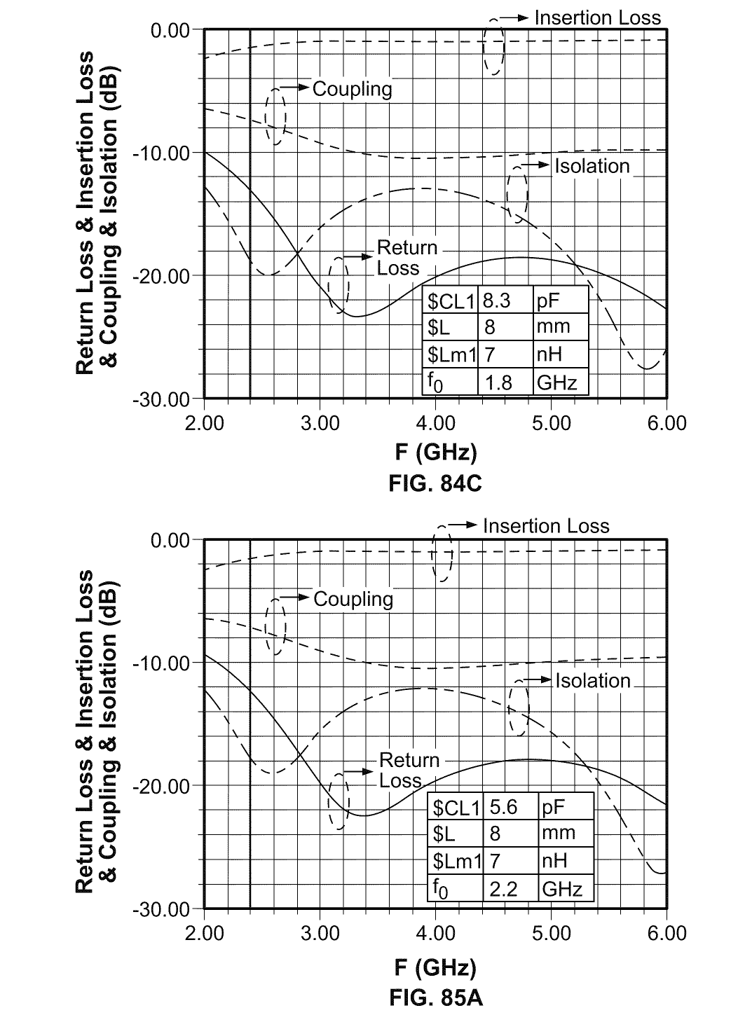

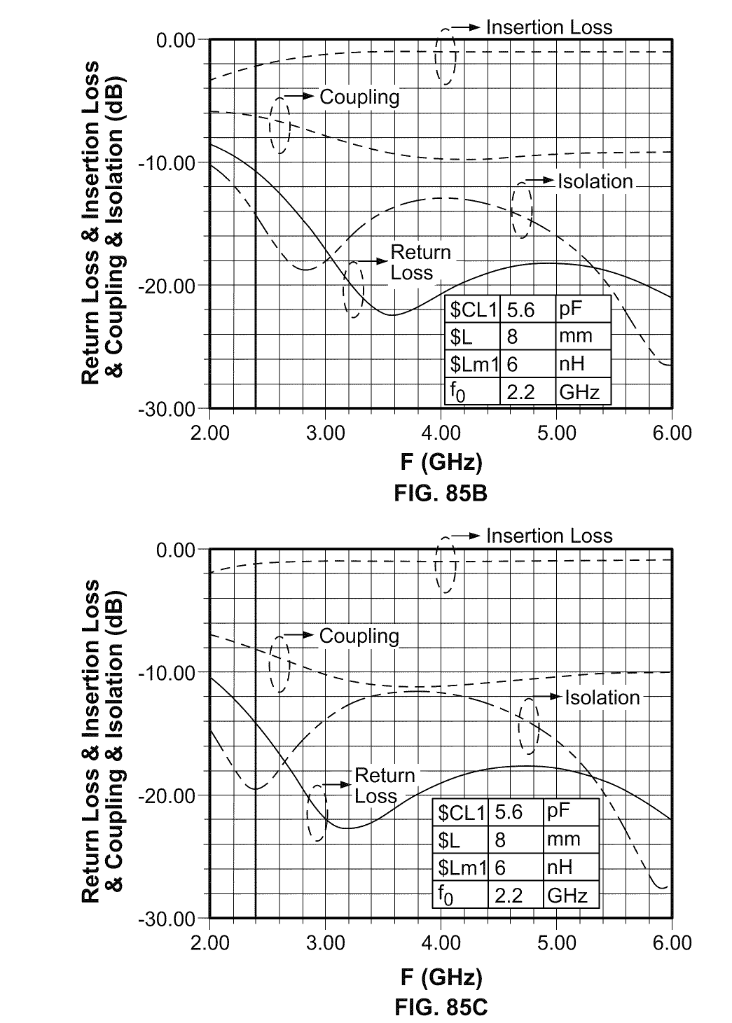

The planar FW MTM coupler is simulated by using Ansoft Designer. In FIGS. 84A-84C, the simulation results for the planar FW MTM coupler are presented. For a fixed Lₘ₁=7nH and length L=8 mm, C_{L} can be varied to change the coupling level at 2.4 GHz. In FIGS. 85A-85D the value of C_{L}=5.6 pF is fix and the value of Lₘ₁ is varied. The coupling level at 2.4 GHz can be changed according to FIGS. 85A-85D.

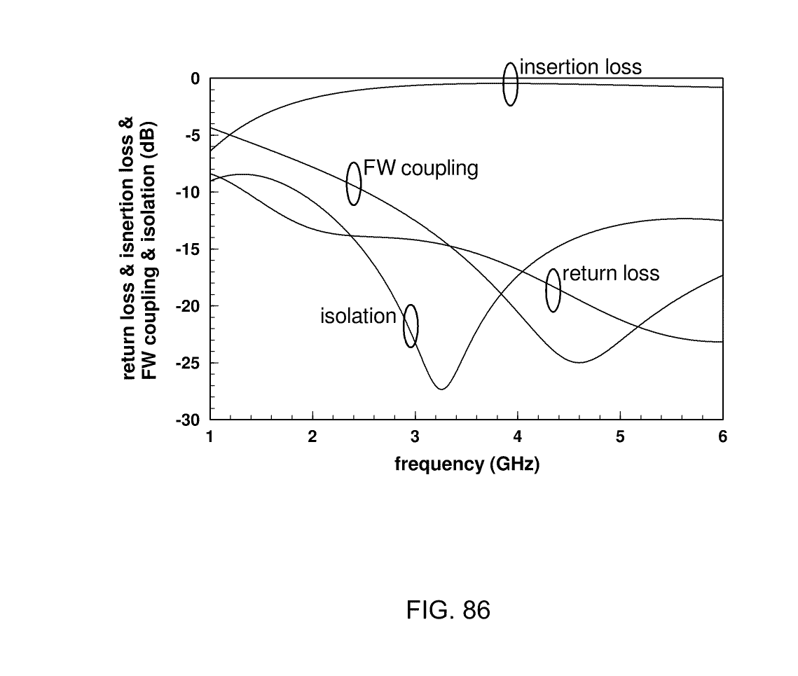

Another example of the vertical FW MTM coupler shown in FIGS. 83A-83D is simulated by using Ansoft HFSS where the simulated results are shown in FIG. 86. The frequency and FW coupling at lower frequency band of the vertical FW coupler can be found to be almost the same as those of the planar FW coupler shown in FIGS. 82A-82D. However, the FW coupling at higher band of the vertical FW coupler is found to be significantly different from that of the planar FW coupler. Furthermore, the coupling levels and bands can be found to be nearly the same between the case of using the planar or vertical coupled microstrip lines and the case of using the coupled CPW.

VI.A. Dualband Two-Element Antenna Array with 2-Way Vertical Forward Wave MTM Coupler—Condition: f2≠2×f1, f2>f1, Strong Coupling at f1 and Weak Coupling at f2

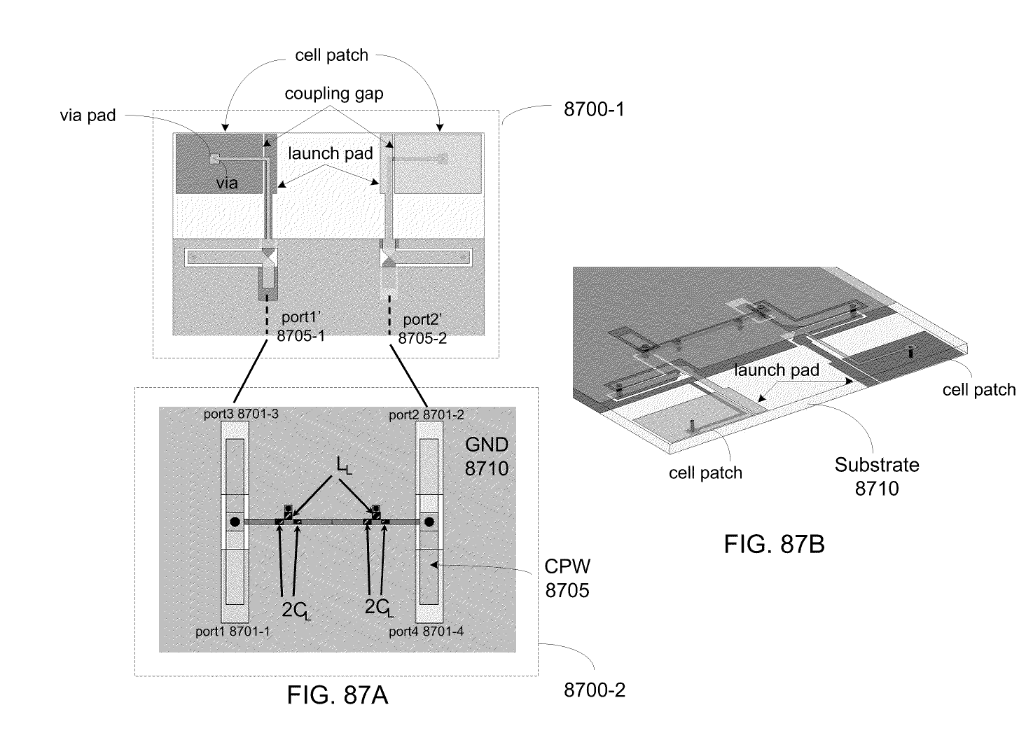

FIGS. 87A-87B depicts another example of dualband multi-antenna system, which integrates a metamaterial antenna array 8700-1 and a vertical FW MTM coupler 8700-2. One of the antennas in the array is printed on top of the substrate 8710 and the other one is printed on bottom of the substrate 8710. In FIG. 87A, the inputs for the antenna array, port1′ 8705-1 and port2′ 8705-2, can be connected to port3 8701-3 and port2 8701-2 of the vertical FW MTM coupler 8700-2, respectively. This antenna array can exhibit high coupling at about 2.4 GHz band and low coupling at about 5 GHz band. The same phase analysis may be followed as in example 2 in Section V and find that the phase constraints are as follows:
θ2=Phase(S12)=θ4=Phase(S34) Eq. (29a)
θ3=Phase(Antenna S1′2′) Eq. (29b)
θ4=Phase(S43) Eq. (29c)
θ2=Phase(S14) Eq. (29d)
θ2+θ3+θ4−θ1=180° Eq. (29e)
2θ2−θ1=−180°−θ3 Eq. (29f)

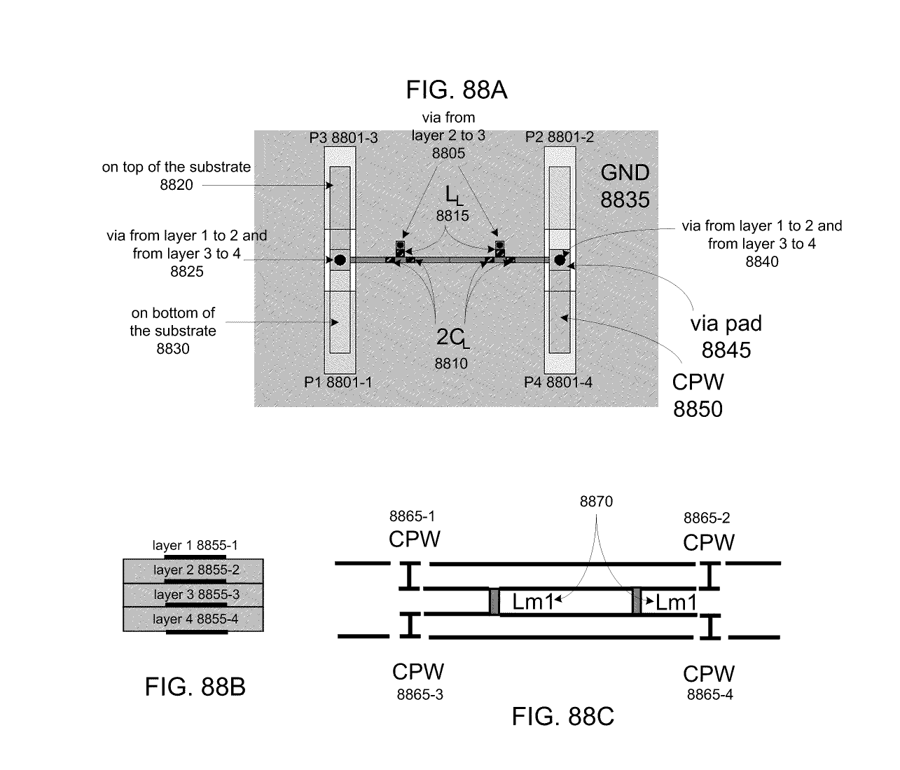

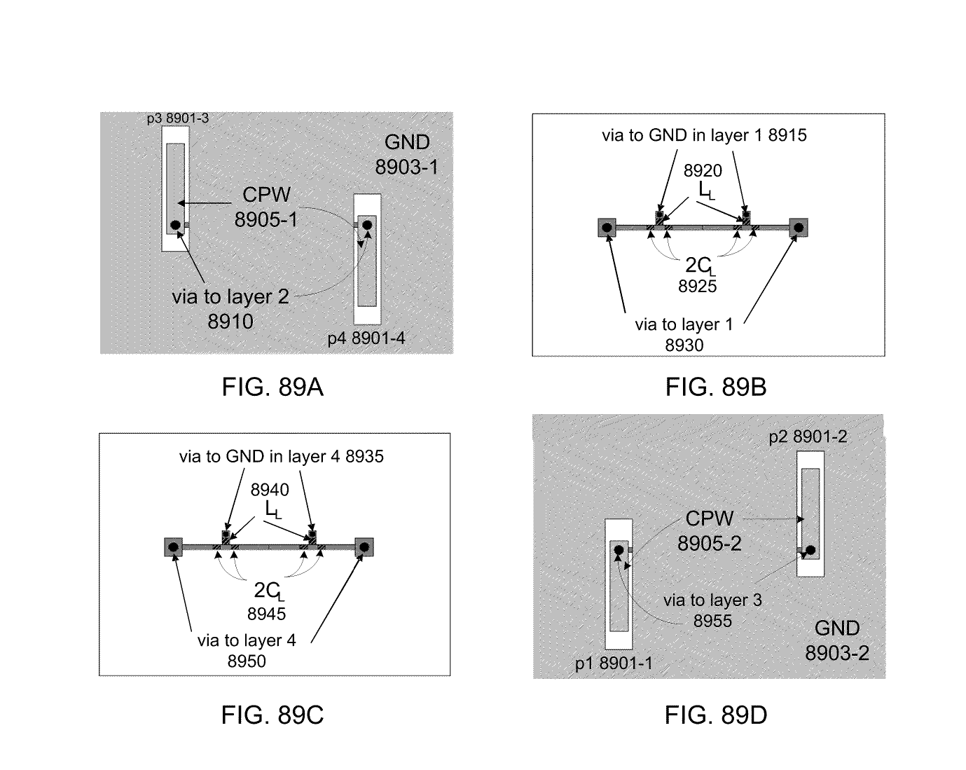

Additional details of the vertical FW MTM coupler 8700-2, as shown in FIG. 87A, are illustrated in FIGS. 88A-88C and 89A-89D. The transmission paths are from p1 8801-1 to P2 8801-2 and from p3 8801-3 to P4 8801-4. The FW coupling paths are from P1 8801-1 to P4 8801-4 and from P2 8801-2 to P3 8801-3. The vertical FW MTM coupler can be implemented on a multi-layer FR4 substrate comprising three dielectric layers and four metal layers, as shown in FIG. 88B. Each dielectric layer measures the height of 10 mil. Based on the analysis on the planar and vertical FW MTM couplers described in the previous section, the parameter values for this vertical coupler may be obtained to be nearly the same as in the previous examples with the exception of C_{L}=2 pF, L_{L}=18 nH and Lₘ₁=7.5 nH.

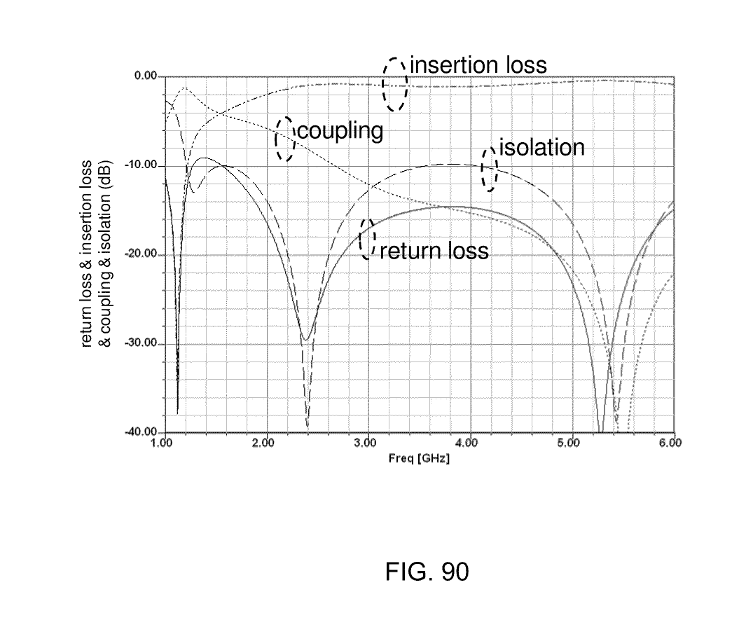

FIG. 90 shows the simulation results of the vertical FW MTM coupler used in the dualband multi-antenna system shown in FIGS. 87A-87B. As noted earlier, the FW coupling is high at 2.4 GHz and low at 5 GHz. There is no BW coupling which is between P1 8801-1 and P3 8801-3 or between P2 8801-2 and P4 8801-4 (isolation shown in FIG. 90) at both 2.4 GHz and 5 GHz.

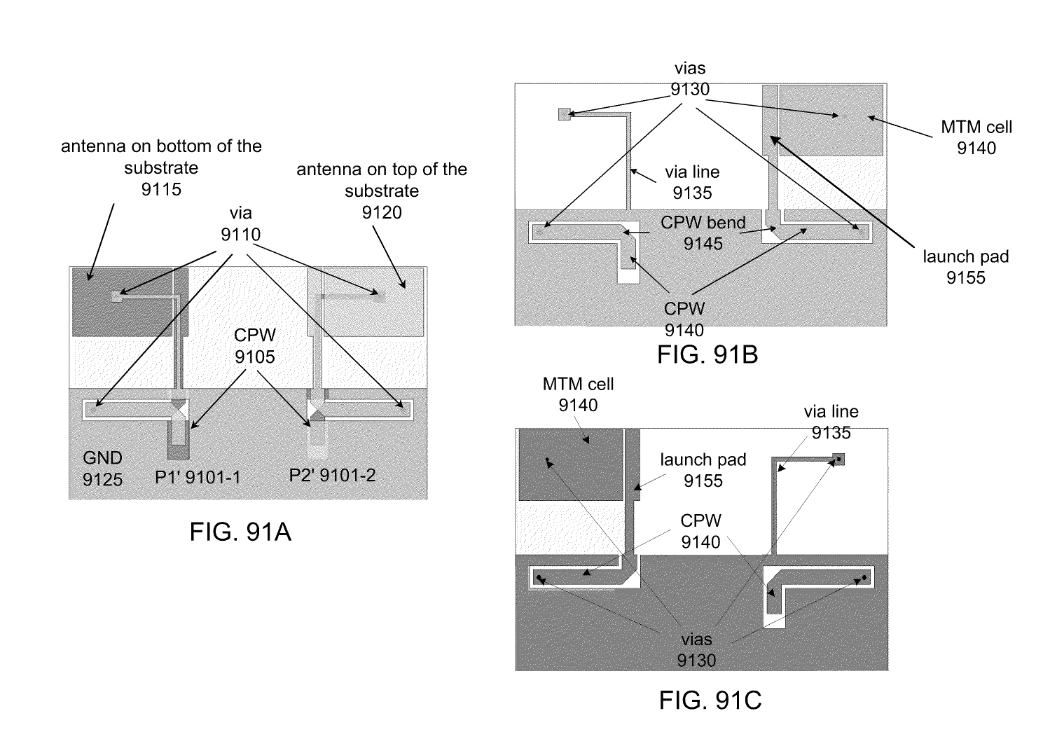

FIGS. 91A-91C shows the structure of the dualband metamaterial antenna array used in the dualband multi-antenna system shown in FIG. 87A-87B. Two antenna elements are on different sides of the substrate.

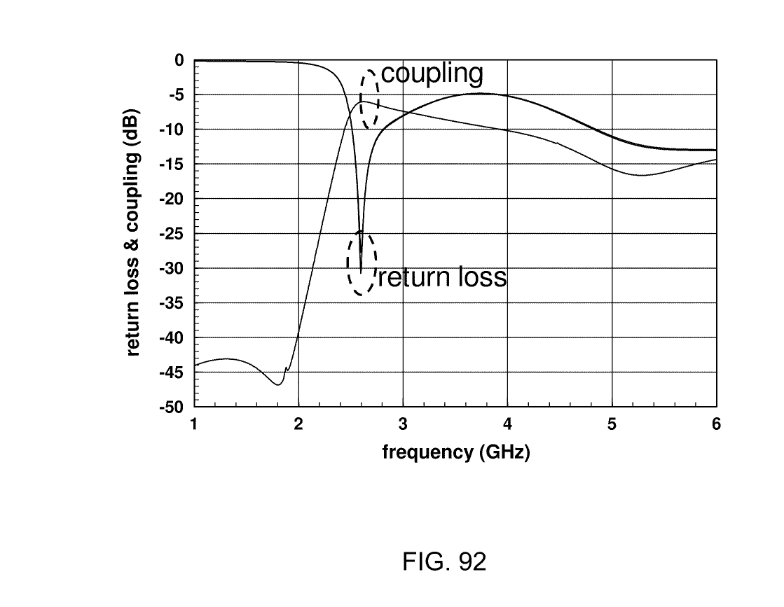

FIG. 92 shows the simulation results of the metamaterial antenna array shown in FIG. 91. It can be seen from FIG. 92 that the coupling is high at about 2.4 GHz (near −6 dB) and low at about 5 GHz.

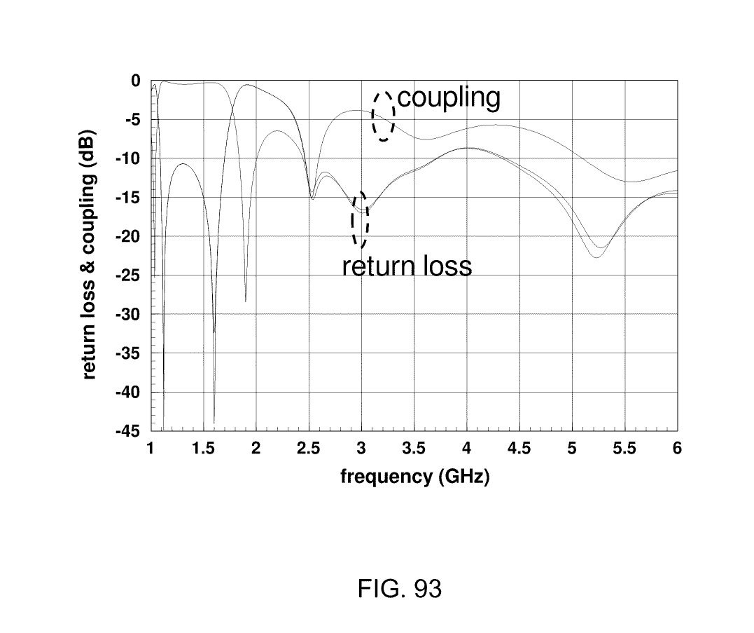

FIG. 93 shows the simulation results of the dualband multi-antenna system shown in FIG. 87. The results of FIG. 93 demonstrate that the coupler can improve the coupling at about 2.5 GHz to −15 dB without affecting the 5 GHz band. The bandwidth coverage may still be adequate at about 2.5 GHz.

VII. Multi-Antenna, Directional Coupler System: WiFi and WiMax Antenna Array, 2-Way Directional Coupler

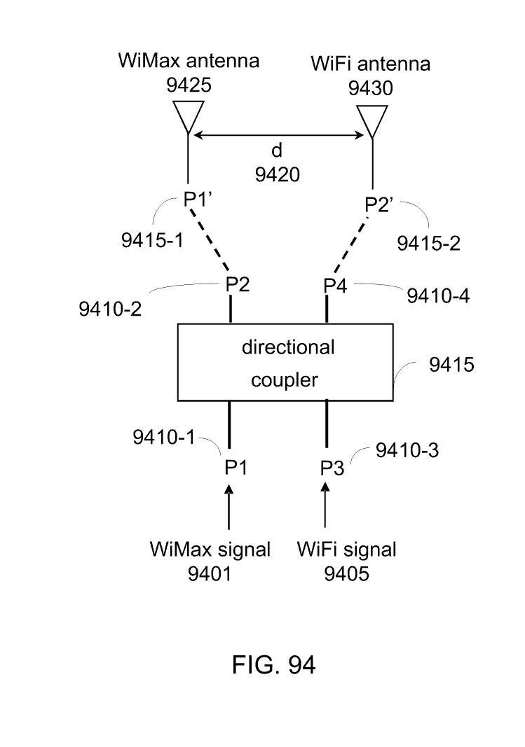

A directional coupler may be used to improve the isolation across a WiFi and WiMax frequency bands. By reducing the isolation between the WiFi and WiMax antennas, the interference between the WiFi and WiMax signals can be minimized. A multi-band multi-antenna system shown FIG. 94 may include a multi-band metamaterial antenna array (9425, 9430) and a directional coupler 9415. The multi-band metamaterial antenna array may include a metamaterial WiFi antenna 9430 and a metamaterial WiMax antenna 9425. The WiFi antenna 9430 may include a port P2′ 9415-2 and can have a frequency range that varies from about 2.4 GHz to 2.48 GHz. The WiMax antenna 9425 may include a port P1′ 9415-1 and can have a frequency range that varies from about 2.5 GHz to 2.7 GHz. As shown in FIG. 94, the spacing, d 9420, between the WiFi and WiMax antennas can be used to determine the magnitude and phase of the coupling between the two antenna elements (9425, 9430).

The directional coupler 9415 shown in FIG. 94 can be a four port passive device. In one implementation, the directional coupler may include input ports P1 9410-1 and P3 9410-3 and output ports P2 9410-2 and P4 9410-4. Each input port may be assigned to a specific signal and each output port may be assigned to a specific antenna that is coupled to the directional coupler 9415. For example, P1 9410-1 can be the input port of a WiMax signal 9401, P3 9410-3 can be the input port of a WiFi signal 9405, P2 9410-2 can be the output port of the directional coupler 9415 connected to the WiMax antenna 9425, and P4 9410-4 can be the output port of the directional coupler 9415 connected to the WiFi antenna 9430.

As shown in FIG. 94, the WiMax signal 9401 can be coupled from the input port P1 9410-1 to the input port P3 9410-3 through two paths. The first path can be traced from the input port P1 9410-1 to the input port P3 9410-3 via the coupling of the directional coupler 9415. The second path can be traced starting at the input port P1 9410-1. From the input port P1 9410-1, the second path can be traced to the output port P2 9410-2 via the transmission of the directional coupler 9415. From the output port P2 9410-2, the second path can be further traced to the WiMax antenna port P1′ 9415-1. From the WiMax antenna port P1′ 9415-1, the second path can be traced to the WiFi antenna port P2′ 9415-2 via the coupling between the WiMax 9425 and WiFi 9430 antennas. From the WiFi antenna port P2′ 9415-2, the second path can be traced to the output port P4 9410-4. From the output port P4 9410-4, the second path can be traced to the input port P3 9410-3 via the transmission of the directional coupler 9415. When the signals from the two paths merge at the input port P3 9410-3 and have the same magnitude and 180° phase difference, the isolation between the WiFi 9425 and WiMax 9430 antennas can be maximized. Therefore, maximizing the isolation between the WiFi and WiMax antennas can be achieved by properly designing the directional coupler and antennas. For directional couplers, several approaches are generally available for achieving optimum isolation requirements. In next section, a microwave coupled line coupler and metamaterial directional coupler for improving isolation and system performance are presented.

VII.A Multi-Antenna, Directional Coupler System: WiFi and WiMax Antenna Array

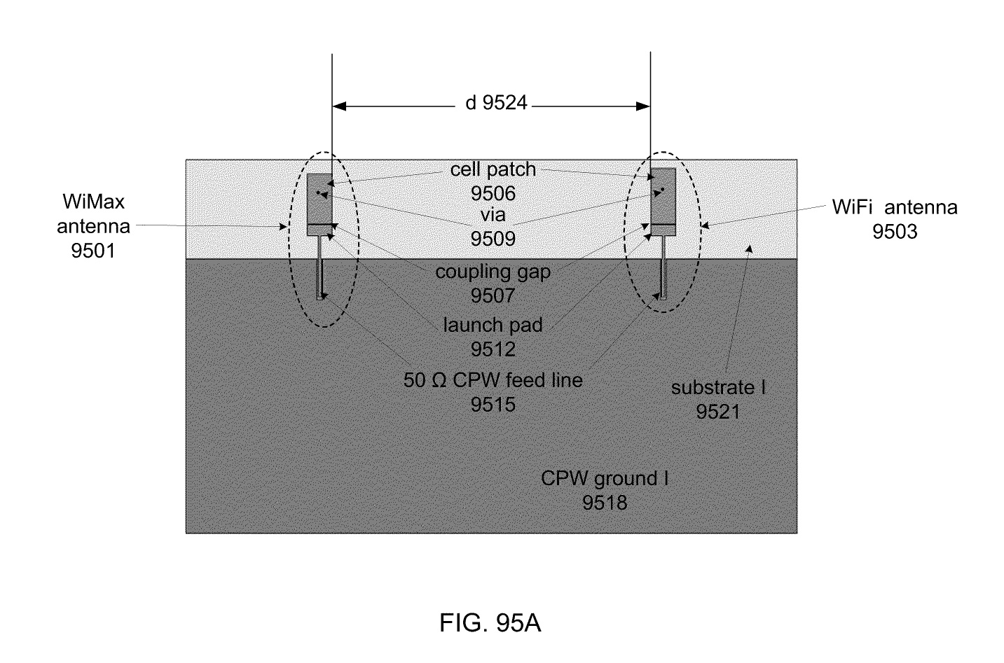

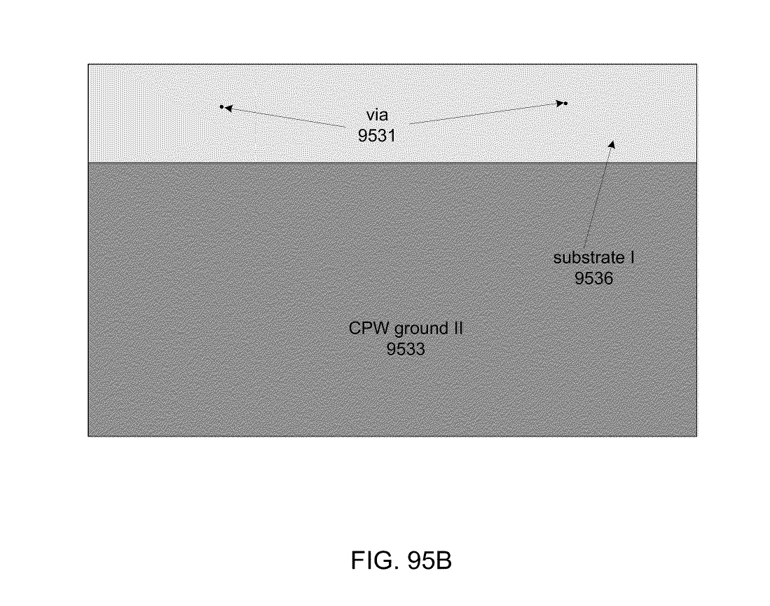

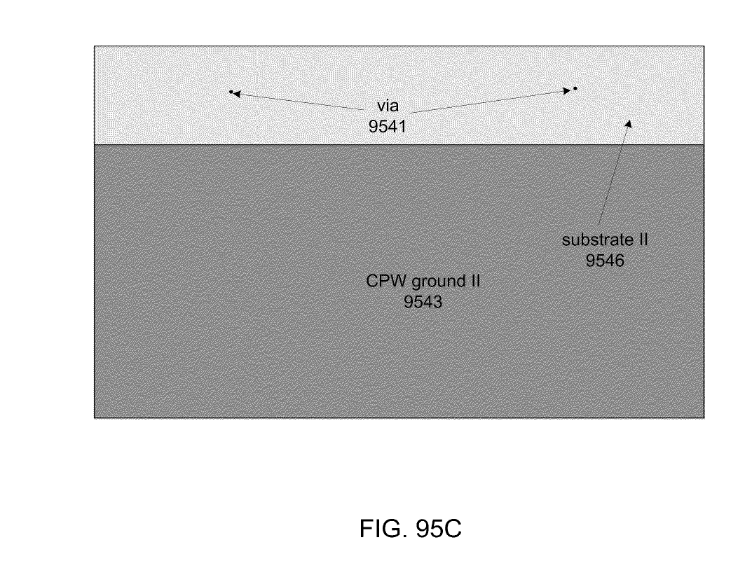

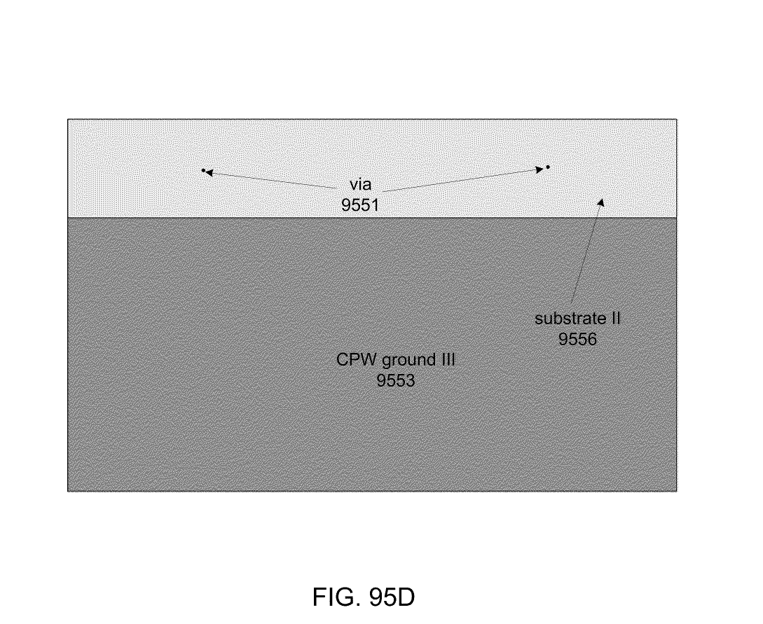

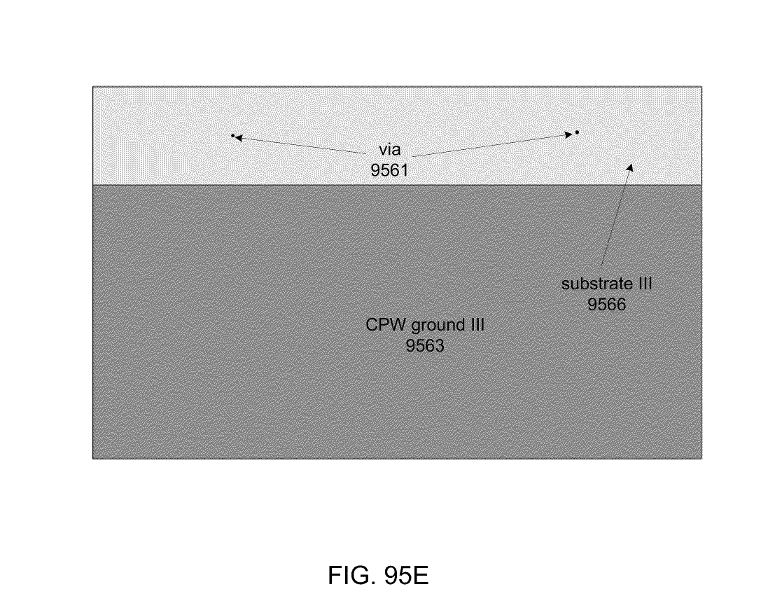

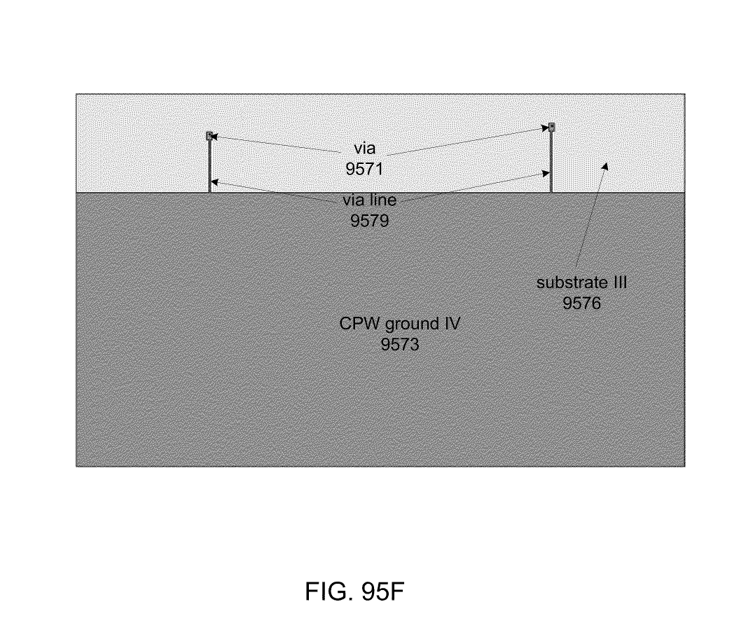

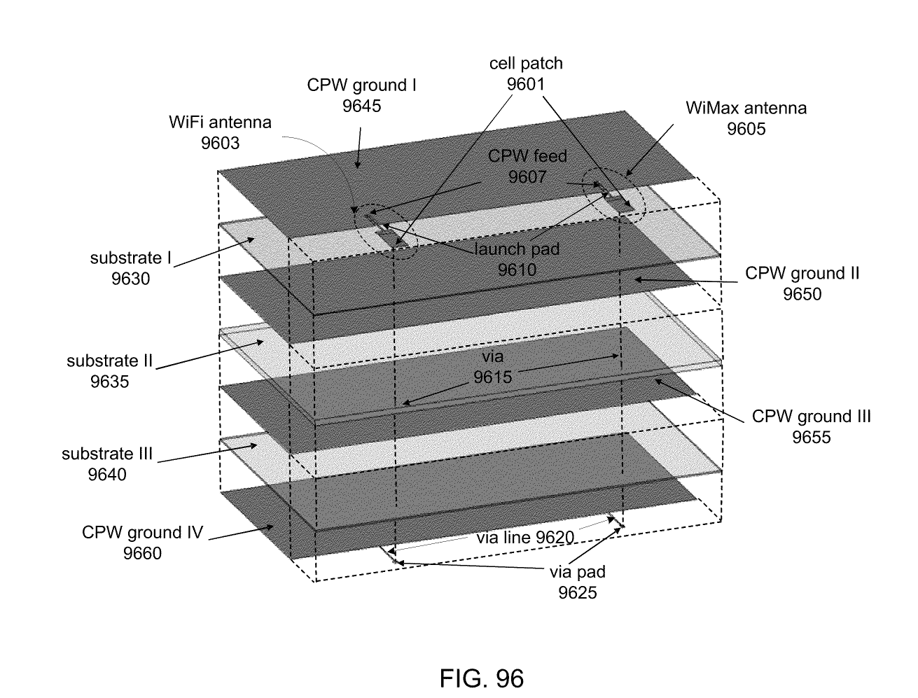

In yet another implementation of a multi-band multi-antenna system, an exemplary multi-band metamaterial antenna array supporting frequency bands used in WiMax and WiFi systems is illustrated in FIGS. 95A-95F and FIG. 96. The multi-band antenna array can be designed on a FR-4 substrate. The four-layer FR-4 substrate can include three substrate layers in which each substrate layer has a dielectric constant of 4.4. As shown in FIG. 96, the three substrate layers are denoted as substrate I 9630, substrate II 9635, and substrate III 9640, and may be 0.254 mm, 1.0668 mm, and 0.254 mm in thickness, respectively. Substrates I, II, and III are also depicted in FIGS. 95A-95F. For example, substrate I include elements 9521 and 9536 as illustrated in FIGS. 95A and 95B, respectively. Substrate II include elements 9546 and 9556 as illustrated in FIGS. 95C and 95D, respectively. Substrate III include elements 9566 and 9576 as illustrated in FIGS. 95E and 95F, respectively. Each substrate may have a width and length that measures 80 mm and 49 mm, respectively. Illustrations of the top and bottom views of each substrate are shown in FIGS. 95A-95F. In addition to the three substrates, the multi-band metamaterial antenna array shown in FIG. 95A may include two antenna elements, a metamaterial WiMax antenna 9501 and a metamaterial WiFi antenna 9503, which can be located at the edge of the substrate 19521. The spacing, d 9524, between the two antennas may be 45 mm as shown in FIG. 95A.

As shown in FIG. 96, the metamaterial WiMax antenna 9605 may include a cell patch 9601, a launch pad 9610, a via 9615, a via pad 9625, and a via line 9620. Referring to FIG. 95A, the cell patch 9506 of the WiMax antenna 9501 can be formed on the top side portion of substrate 19521. In FIG. 96, the via pad 9625 can be formed on the bottom side portion of substrate III 9640. The cell patch 9601 can be connected to the via pad 9625 through a metallic via 9615 and can have a dimension of about 3.2 mm×6.2 mm as shown in FIG. 96. In reference to the via location, the via may be positioned about 3.575 mm away from the top edge portion of the cell patch 9506 and 1.6 mm away from the side edge portion of the cell patch 9506 as illustrated in FIG. 95A. In reference to the via and the via pad physical dimensions, the via radius may be about 0.125 mm, and the via pad dimension may be about 0.762 mm×1 mm. In FIG. 96, the via pad 9625 may be connected to a coplanar waveguide (CPW) ground, CPW ground IV 9660, through the via line 9620. The via line 9620 can be attached at the center of the via pad 9625 and may have a dimension of about 6.7 mm×0.2032 mm. Referring to the cell patch 9506 and the launch pad 9512 of the WiMax antenna 9501 of FIG. 95A, the cell patch 9506 can be coupled to the launch pad 9512 through a coupling gap 9507 that measures about 0.1 mm in width. The launch pad 9512 of the WiMax antenna 9501 may include two rectangular patches. The first rectangular patch may be about 1.5 mm in length and have the same width as the cell patch 9506, and the second rectangular patch may have a dimension of about 0.3 mm×3 mm. As shown in FIG. 95A, the first rectangular patch can be coupled to the cell patch 9506 of the WiMax antenna 9501 while the second rectangular patch can be coupled to a 50Ω CPW feed line 9515. The dimension of the 50Ω CPW feed line 9515 connected to the WiMax antenna 9501 may be about 0.4 mm×5 mm with a gap of 0.2 mm to the CPW ground 19518.

As illustrated in FIGS. 95A-95F and FIG. 96, the metamaterial WiFi antenna 9501 of the multi-band antenna array may include a cell patch 9506, a launch pad 9512, a via 9509, a via pad 9625 and a via line 9620. Referring again to FIG. 96, the cell patch 9601 of the WiFi antenna 9603 can be formed on the top side portion of substrate 19630, and the via pad 9625 can be formed on the bottom side portion of substrate III 9640. The cell patch 9601 can be connected to the via pad 9625 through a metallic via 9615 and may have a dimension of about 3.2 mm×7.3 mm. In reference to the via location, the via 9615 may be positioned about 3.175 mm away from the top edge portion of the cell patch 9601 of WiFi antenna 9603 and about 1.6 mm away from the side edge portion of the cell patch 9601 of WiFi antenna 9603. In reference to the physical dimensions of the via 9615 and the via pad 9625, the via radius may be about 0.125 mm, and the via pad 9625 can be about 0.762 mm×1 mm. The via pad 9625 can be connected to a CPW ground, CPW ground IV 9660, through the via line 9620 as shown in FIG. 96. The via line 9620 can be attached at the center of the via pad 9625 and may have a dimension of about 8.1 mm×0.2032 mm. Referring the WiFi antenna 9503 of FIG. 95A, the cell patch 9506 can be coupled to the launch pad 9512 through a coupling gap which may be about 0.1 mm. The launch pad 9512 of the WiFi antenna 9503 may include two rectangular patches. The first rectangular patch may be 1.5 mm in length and have the same width as the cell patch 9506, and the second rectangular patch may have a dimension of about 0.3 mm×3 mm. As shown in FIG. 95A, the first rectangular patch can be coupled to the cell patch 9506 of the WiFi antenna 9503 while the second rectangular patch can be coupled to a 50Ω CPW feed line 9515. The dimension of the 50Ω CPW feed line 9515 connected to the WiFi antenna 9503 may be 0.4 mm×5 mm with a gap of 0.2 mm to the CPW ground 19518.

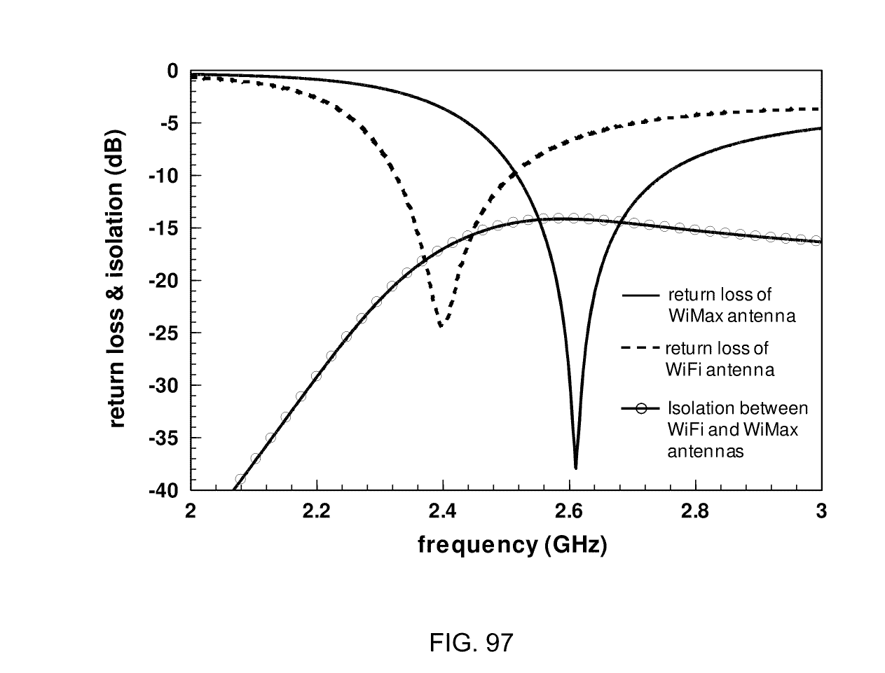

A full-wave simulation of the exemplary multi-band metamaterial antenna array presented in this section is illustrated in FIG. 97. The WiFi frequency band (2.4 GHz˜2.48 GHz) is covered by the WiFi antenna, while the WiMax frequency band (2.5 GHz˜2.7 GHz) is covered by the WiMax antenna. As further illustrated in FIG. 97, the return losses across the WiFi and WiMax bands can be better than −10 dB, and the isolation between the two antennas across the WiFi and WiMax bands can vary from about −17 dB to −14 dB.

VII.B1 Multi-Antenna, Directional Coupler System: WiFi and WiMax Antenna Array, Two-Way Directional Coupler using Microwave Coupled Line

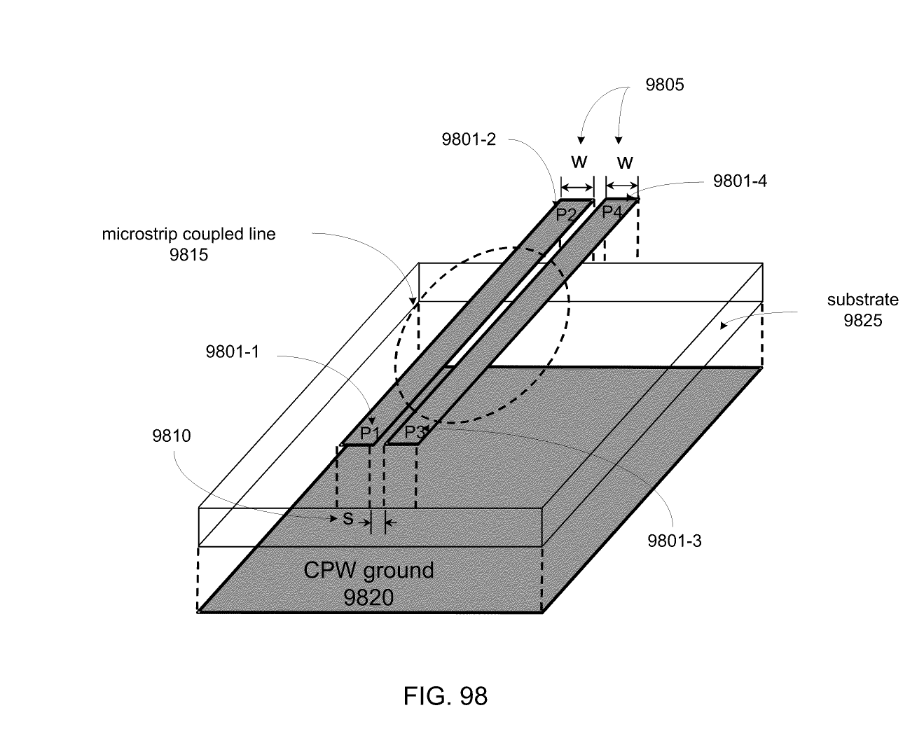

FIG. 98 illustrates an example of a microwave coupled line coupler. In one implementation, the microwave coupled line coupler can be designed on a 10 mil FR-4 substrate with a dielectric constant of 4.4. The coupled line coupler can be formed by using a microstrip coupled line 9815. As shown in FIG. 98, the microstrip couple line 9815 may include two transmission lines that are parallel with each other and separated by a gap, s 9810. The microstrip coupled line 9815 impedance and the coupling level can be determined by the line width, w 9805, and the gap width, s 9810. Ports, P1 9801-1, P2 9801-2, P3 9801-3 and P4 9801-4, of the microstrip coupled line 9815 shown in FIG. 98 can each act as either an input port or an output port. The size of the line width and gap width may be about 0.44 mm and 0.18 mm, respectively. Based on the thickness of the substrate, dielectric constant, line width, and gap width, the coupled line coupler can be matched to 50Ω at each input and output port (P1 9801-1, P2 9801-2, P3 9801-3, P49801-4). As previously indicated, the coupling level can be selected based on the isolation between the WiFi and WiMax antennas. For example, the length of the microstrip coupled line may be set to about 16.7 mm to achieve a maximum coupling between the input ports P1 9801-1 and P3 9801-3 and between the output ports P2 9801-2 and P4 9801-4 at about 2.52 GHz.

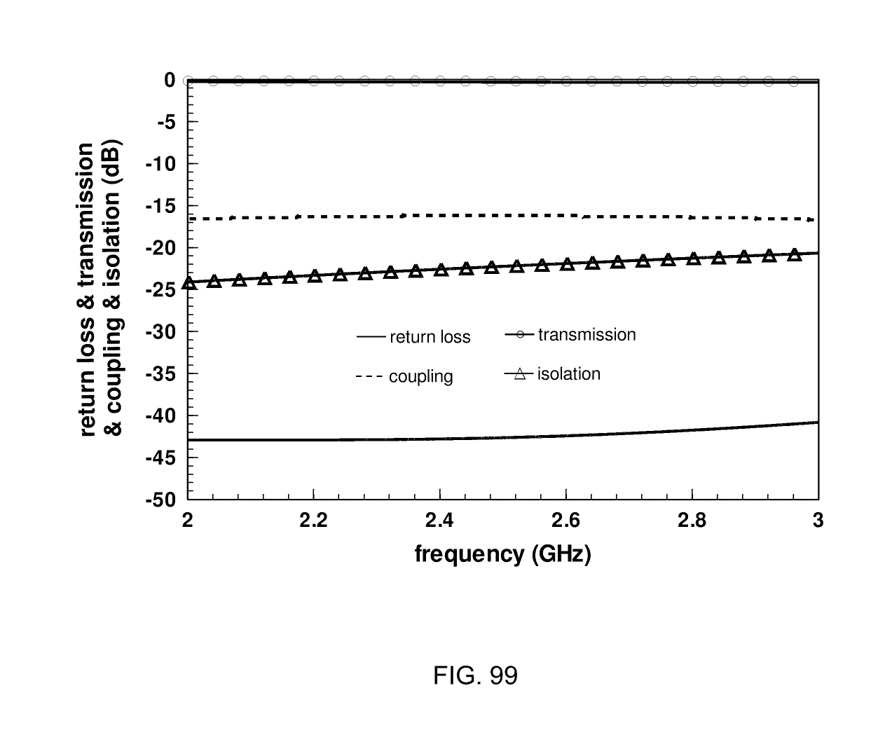

A simulation of the exemplary microwave coupled line coupler is illustrated in FIG. 99. The return loss result indicates that the coupler can be matched to 50Ω across a frequency range of about 2.4 GHz to 2.7 GHz. The coupling across the same bandwidth is about −16.5 dB, which is close to the average isolation between the WiFi and WiMax antennas previously presented.

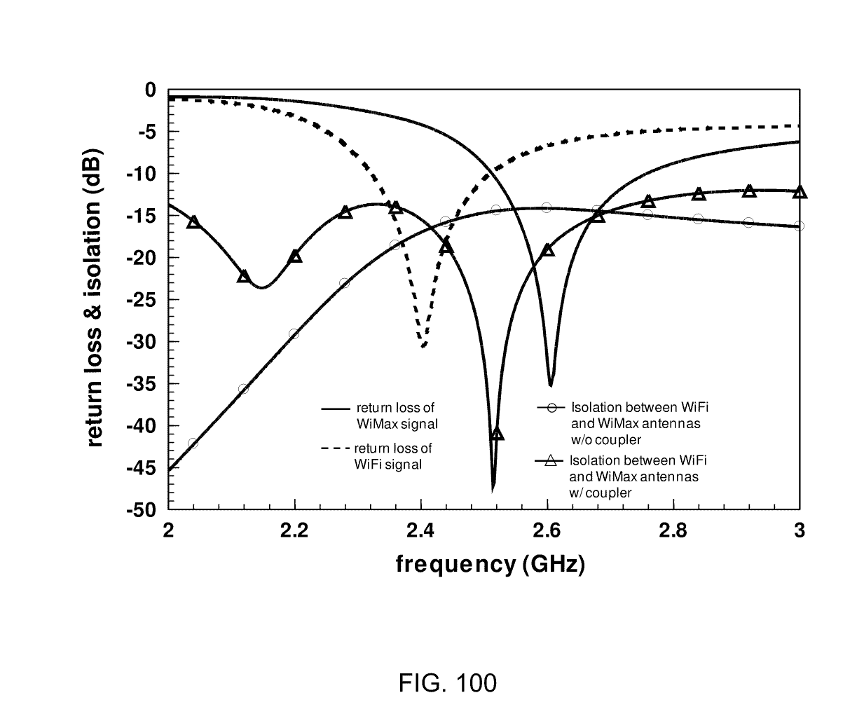

To satisfy the phase condition for improved isolation, two 50Ω transmission lines with an additional phase delay of 46° each can be inserted between the outputs, P2 9801-2 and P4 9801-4 shown in FIG. 98, and inputs, P1′ 9415-1 and P2′ 9415-2 shown in FIG. 94, of the WiFi 9430 and WiMax 9425 antennas. FIG. 100 illustrates the simulated results of the multi-band multi-antenna system shown in FIG. 94 which may include a metamaterial WiFi antenna, a metamaterial WiMax antenna, two additional transmission lines, and a microwave coupled line coupler. Return loss and isolation shown in FIG. 100 demonstrate that the bandwidth of return loss better than −10 dB at the WiFi and WiMax bands are retained, and the isolation between two antennas is improved. Notably, the coupling between the WiFi and WiMax antennas at frequency band edges (2.4 GHz and 2.7 GHz) is similar to the case where coupler is not included while the coupling across both bands (2.4 GHz˜2.7 GHz) is significantly reduced. Therefore, this improvement may be expected to boost the system performance.

VII.B2 Multi-Antenna, Directional Coupler System: WiFi and WiMax Antenna Array, Two-Way Directional Coupler Using MTM Transmission Line

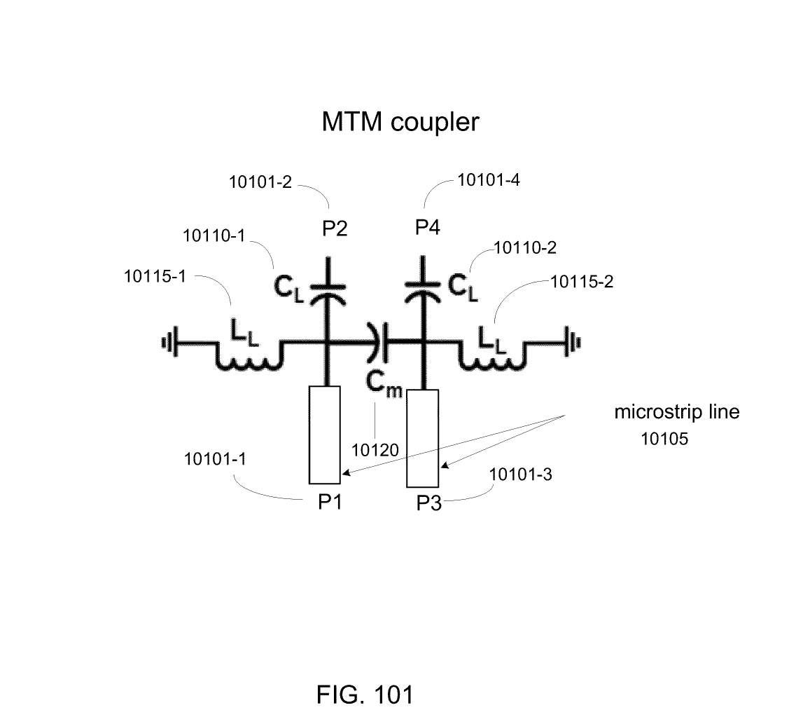

Metamaterial technology can provide a means to design multi-antenna systems that have smaller antenna elements and allow close spacing between adjacent antennas. A MTM coupler can be constructed using a coupled metamaterial transmission line as previously mentioned. The coupled metamaterial transmission line can be constructed by placing two metamaterial transmission lines in parallel to each other where coupling may occur between the two metamaterial transmission lines. The two metamaterial transmission lines can be identical or different depending on the application requirements. The coupling between the two metamaterial transmission lines can be achieved in three ways: 1) by placing the two metamaterial transmission lines in close proximity, 2) by placing a LC-network in between two metamaterial transmission lines that are in close proximity, and 3) by placing a LC network in between two metamaterial transmission lines that are not in close proximity. FIG. 101 illustrates an example of a MTM coupler where a one unit cell coupled metamaterial transmission line is used.

In another implementation, the MTM coupler can be designed on a 10 mil FR-4 substrate with a dielectric constant of 4.4. The metamaterial transmission line shown in FIG. 101 can utilize a lumped element for (C_{L} 10110-110110-2, L_{L}, 10115-1 10115-2) and a microstrip line 10105 for (C_{R}, L_{R}). The coupled metamaterial transmission line can be constructed by placing two identical metamaterial transmission lines in parallel and separated by a small gap. An additional lumped capacitor (Cₘ) can be attached between the two metamaterial transmission lines to enhance the coupling. The substrates thickness, dielectric constant, width and coupling gap of the microstrip coupled line which is realized by paralleling two microstrip lines 10105 with each other can provide a characteristic impedance of 50Ω. The width and coupling gap dimension may be about 0.44 mm and 0.21 mm, respectively. Other parameters may include the length of the microstrip line 10105, which may be 4 mm, and C_{L} 10110-110110-2, L_{L} 10115-1 10115-2, and Cₘ 10120, which may be about 4 pF, 5 nH, and 0.4 pF, respectively. These values may be used to match the 50Ω impedance and the required coupling level between the two metamaterial transmission lines.

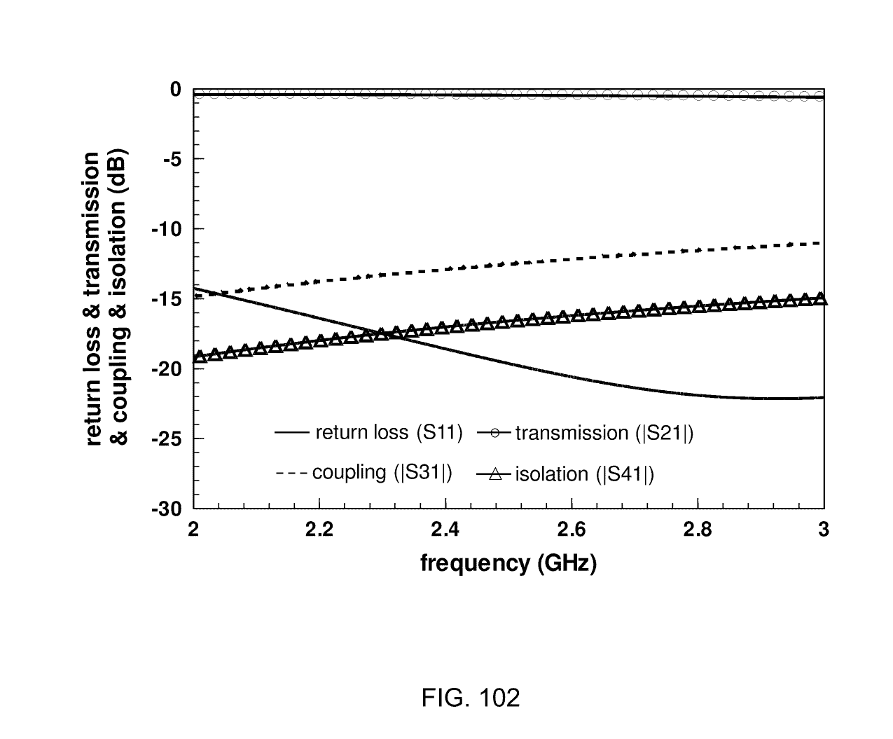

FIG. 102 illustrates the simulated results of the MTM coupler shown in FIG. 101. Notably, the return loss is better than −10 dB across the entire frequency range of about 2.4 GHz to 2.7 GHz, where the coupling level may vary from about −14.4 dB at 2.4 GHz to −13.4 dB at 2.7 GHz.

In another embodiment, the MTM coupler shown in FIG. 101 may be combined with the WiFi and WiMax antennas shown in FIGS. 95A-95F and FIG. 96. In this implementation, ports P1 (10101-1) and P3 (10101-3) shown in FIG. 101 can be used as input ports for input signals. The ports, P2 10101-2 and P4 10101-4, as shown in FIG. 101 can be used as the outputs of the MTM coupler. To satisfy the phase condition as previously indicated, two 50Ω transmission lines with an additional phase delay of 80° each can be inserted between the outputs of the MTM coupler, P2 10101-2 and P4 10101-4 shown in FIG. 101, and the inputs of the WiFi and WiMax antennas, P1′ 9415-1 and P2′ 9415-2 of FIG. 94, respectively.

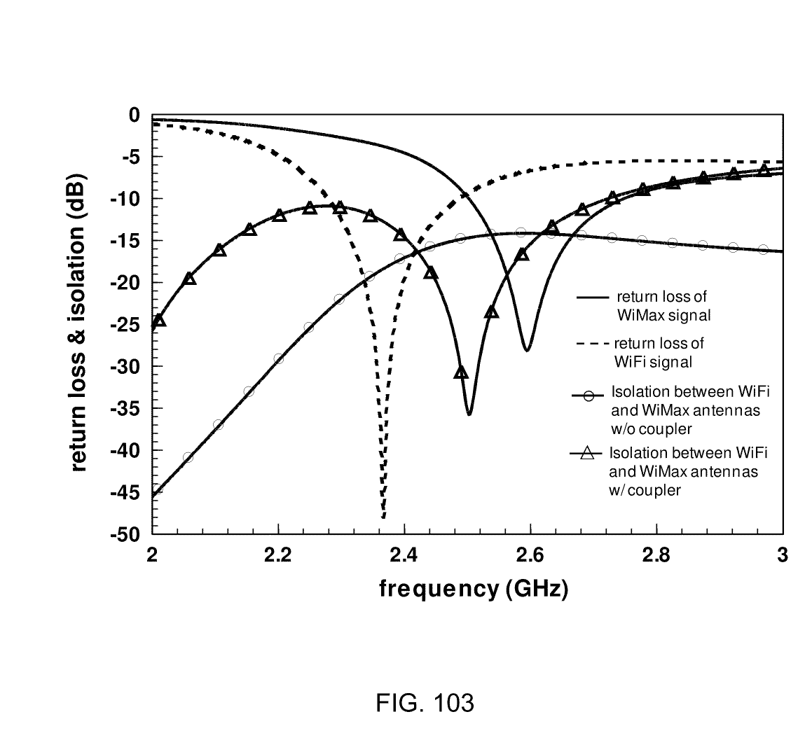

FIG. 103 illustrates simulated results of this multi-band multi-antenna system shown in FIG. 94 which may include a metamaterial WiFi antenna, a metamaterial WiMax antenna, two additional transmission lines and a MTM coupler. As shown in FIG. 103, the bandwidth having a return loss better than −10 dB at the WiFi and WiMax bands are retained while the isolation between the two antennas is improved. Notably, the coupling between the WiFi and WiMax antennas at the frequency band edges (2.4 GHz and 2.7 GHz) are similar to the case where the MTM coupler is not introduced while the coupling across both bands (2.4 GHz˜2.7 GHz) can be significantly reduced. Hence, this improvement may be expected to boost the system performance.

VII.C1 Multi-Antenna, Directional Coupler System: WiFi and WiMax Antenna Array, Bandpass Filters

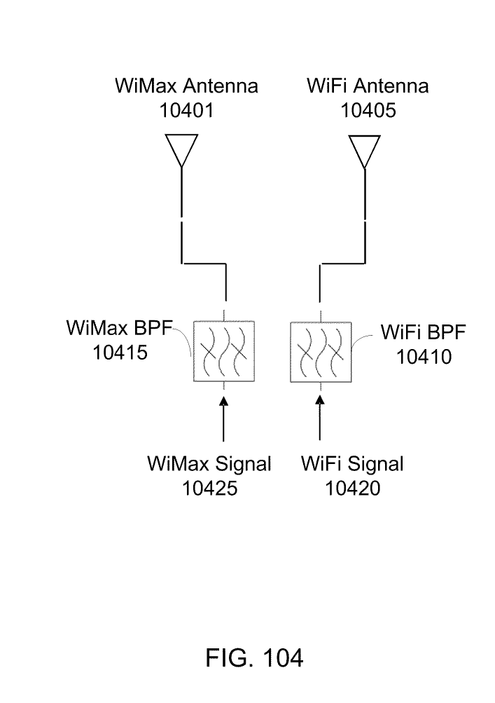

In another embodiment, coupling between the WiFi and WiMax antennas can be reduced when two bandpass filters are utilized in the multi-band multi-antenna system. In another implementation, an exemplary multi-band multi-antenna system shown in FIG. 104 may include a WiFi antenna 10405, a WiMax antenna 10401, a WiFi bandpass filter 10410, and a WiMax bandpass filter 10415. One end of the WiFi bandpass filter 10410 can be connected to the WiFi antenna 10405 to block a coupling signal radiated from the WiMax antenna 10401. Similarly, one end of the WiMax bandpass filter 10415 can be connected to the WiMax antenna 10401 to block a signal radiated from the WiFi antenna 10405. Thus, the isolation between the WiFi signal and the WiMax signal can be determined by the rejection strength of each bandpass filter (10410 and 10415).

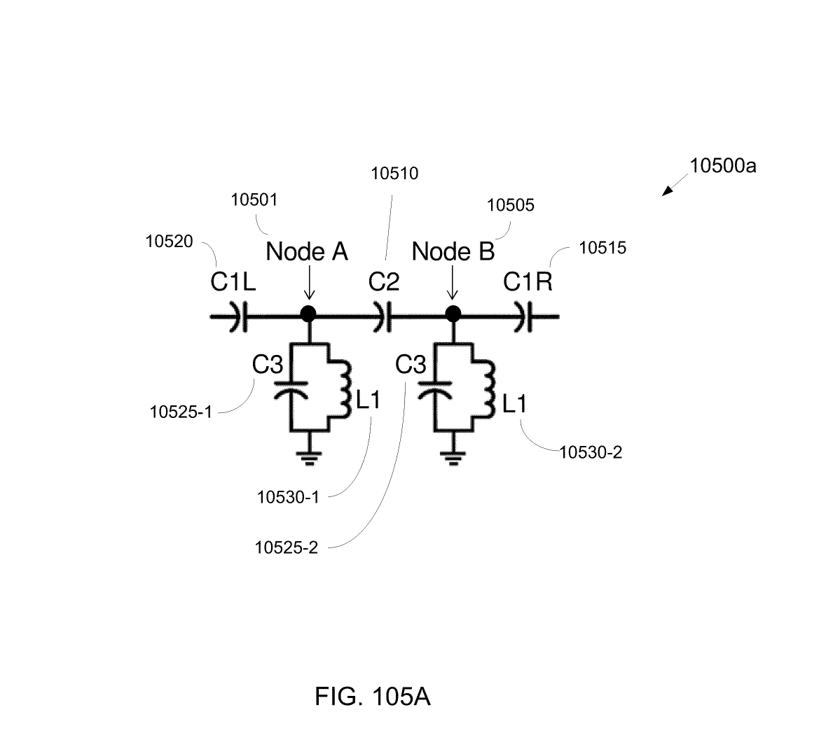

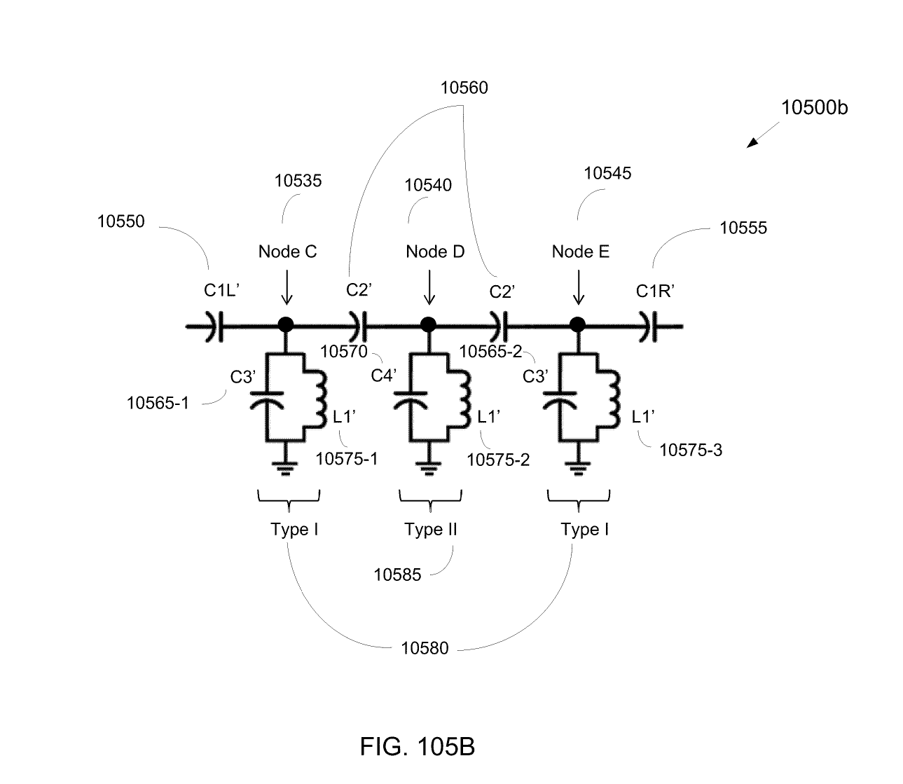

Presently, there are various topologies of bandpass filters available. For example, a Chebyshev type of filter can be introduced to demonstrate one design concept. In one implementation, a simple lumped element method can be used to implement a bandpass filter design. FIG. 105A shows an example of a Chebyshev WiFi bandpass filter 10500a. The filter shown in FIG. 105A may include three series capacitors (10520, 10510, 10515) and two shunt L-C resonators (10525-1 and 10530-1, 10525-2 and 10530-2). The three capacitors are connected in the order of C1L 10520, C2 10510, and C1R 10515 where one end of each capacitor, C1L 10520 and C1R 10515, is left unconnected. In one configuration, the unconnected end of C1L 10520 may be used as the bandpass filter's input while the unconnected end of C1R 10515 may be used as the bandpass filter's output. In yet another configuration, the unconnected end of C1L 10520 may be used as the output while the unconnected end of C1R 10515 may be used as the input. The two shunt L-C resonators can be identical and may include a shunt capacitor C3 (10525-1, 10525-2) and a shunt inductor L1 (10530-1, 10530-2). One shunt L-C resonator can be affixed at a connecting node A 10501 while the other shunt L-C resonator can be attached at connecting node B 10505.

FIG. 105B depicts an example of a WiMax bandpass filter 10500b. The filter may include four series capacitors (10550, 10560, and 10555) and three shunt L-C resonators (10580, 10585). The four capacitors can be connected in the order of C1L′ 10550, C2′ 10560, C2′ 10560, and C1R′ 10555 where one end of each capacitor, C1L′ 10550 and C1R′ 10555, is left unconnected. In one configuration, the unconnected end of C1L′ 10550 may be used as the bandpass filter's input while the unconnected end of C1R′ 10555 may be used as the bandpass filter's output. In yet another configuration, the unconnected end of C1L′ 10550 may be used as the output while the unconnected end of C1R′ 10555 may be used as the input. In the WiMax bandpass filter 10500b, two types of shunt L-C resonators can be used: Type I 10580 and Type II 10585. The Type I 10580 shunt L-C resonator may include a shunt capacitor C3′ (10565-1, 10565-2) and a shunt inductor L1′ (10575-1, 10575-2). The Type II 10585 shunt L-C resonator may include of a shunt capacitor C4′ 10570 and a shunt inductor L1′ 10575-2. One Type I 10580 shunt L-C resonator can be affixed at Node C 10535, which is in between C1L′ 10550 and C2′ 10560, while a second Type I 10580 shunt L-C resonator can be attached at Node E 10545, which is in between C2′ 10560 and C1R′ 10555. The Type II 10585 shunt L-C resonator can be attached at Node D 10540, which is in between the two C2′ 10560 capacitors.

For the Chebyshev WiFi bandpass filter 10500a shown in FIG. 105A, values for C1, C2, C3, and L1 can be designed at 0.185 pF, 0.03 pF, 0.64 pF, and 5 nH, respectively. Likewise, for the Chebyshev WiMax bandpass filter 10500b illustrated in FIG. 105B, values of C1L′, C1R′, C2′, C3′, C4′, and L1′ can be designed at 0.177 pF, 0.177 pF, 0.024 pF, 0.273 pF, 0.422 pF, and 8 nH, respectively.

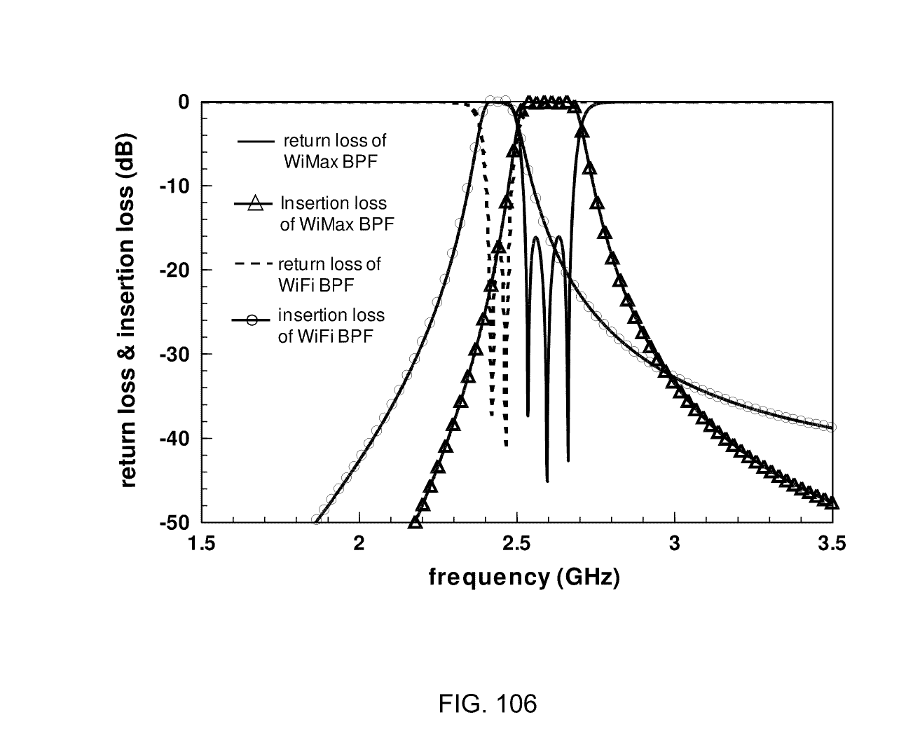

FIG. 106 illustrates the simulated results of the Chebyshev WiFi 10500a and WiMax bandpass filter 10500b. The return losses for WiFi and WiMax bandpass filters (10500a, 10500b) are better than −10 dB across 2.4 GHz to 2.48 GHz and 2.51 GHz to 2.68 GHz, respectively. The rejection level for the WiFi bandpass filter 10500a at 2.5 GHz and 2.7 GHz are −2.63 dB and −23.03 dB, respectively. The rejection level for the WiMax bandpass filter 10500b at 2.4 GHz and 2.48 GHz are −24.48 dB and −7.83 dB.

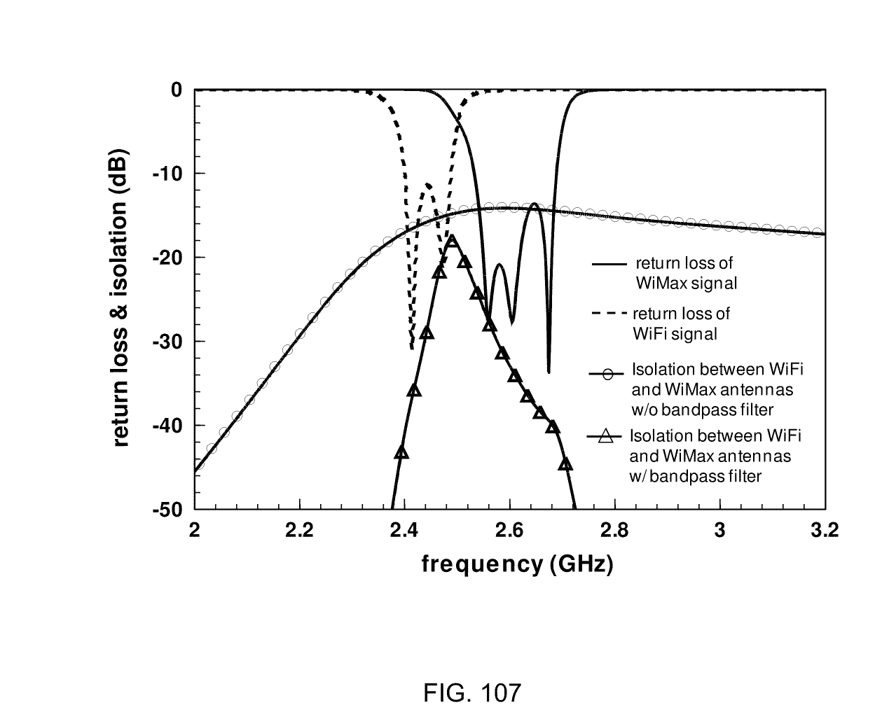

The simulated results of the multi-band multi-antenna system shown in FIG. 104 are plotted in FIG. 107. From FIG. 107, the results show that return losses of better than −10 dB for both WiFi and WiMax bands are retained. FIG. 107 also illustrates the comparison between the isolation of the multi-antenna system shown in FIG. 104 with and without the bandpass filters. From FIG. 107, the coupling between WiFi and WiMax signals decreases by integrating two bandpass filters with the WiFi and WiMax antenna array. However, this improvement is primarily at the frequency range that is close to the lower band edge portion of WiFi band and the higher band edge portion of WiMax band. Such limited improvement can be attributed to two factors: 1) a small band gap between the WiFi and WiMax bands (only 20 MHz), and 2) the higher rejection level cannot be achieved based on the presented bandpass filter type.

VII.C2 Multi-Antenna, Directional Coupler System: WiFi and WiMax Antenna Array, Two-Way Directional Coupler Using Microwave Coupled Line and Bandpass Filters

As previously indicated, the isolation between the WiFi and the WiMax antennas can be improved by using either a directional coupler or bandpass filters. Furthermore, proper operation of directional couplers may be dependent on satisfying the phase requirement. The implementation of a directional coupler in a multi-band multi-antenna system may satisfy the phase requirement and offer improved isolation but at a narrow frequency range.

However, the reduced frequency range may not be sufficient to cover the entire bandwidth range of 2.4 GHz to 2.7 GHz, and, thus, the implementation of the directional coupler alone may not be a sufficient solution improving the isolation between the WiFi and WiMax antennas.

A comparison between FIG. 100, FIG. 103 and FIG. 107 indicates that the isolation frequency responses between the WiFi and WiMax antennas are complementary based on using the directional coupler and the bandpass filters. This suggests that integrating both the directional coupler and the bandpass filters together may be used to mitigate the drawbacks of each individual approach.

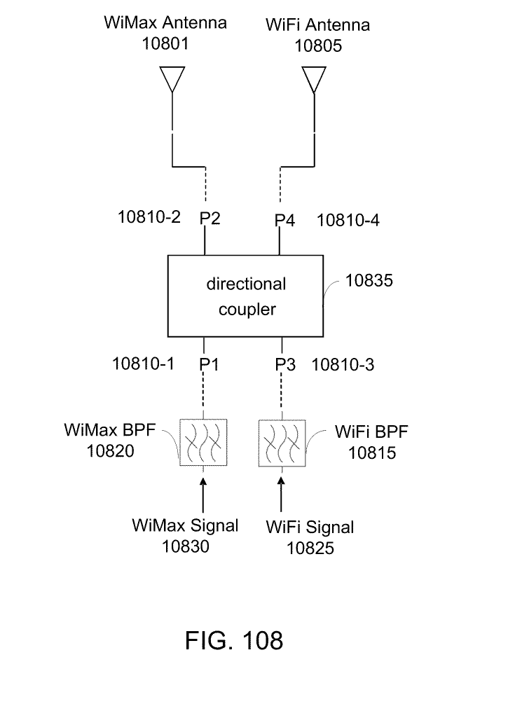

In yet another implementation, an exemplary multi-band multi-antenna system is presented in FIG. 108. The multi-band multi-antenna system shown in FIG. 108 may include a WiFi antenna 10805, a WiMax antenna 10801, a directional coupler 10835, a WiFi bandpass filter 10815, and a WiMax filter 10820. A WiFi signal 10825 is fed to an input of one end of the WiFi bandpass filter 10815 while a WiMax signal 10830 is fed to an input of one end of the WiMax bandpass filter 10820. The output of the WiMax bandpass filter 10820 and the output of the WiFi bandpass filter 10815 can be connected to P1 10810-1 and P3 10810-3, respectively, where P1 10810-1 and P3 10810-3 are inputs of the directional coupler 10835. Outputs, P2 10810-2 and P4 10810-4, of the directional coupler 10835 may be connected to the input of the WiMax antenna 10801 and the WiFi antenna 10805, respectively. The WiFi 10815 and WiMax 10820 bandpass filters shown in FIG. 108 are illustrated in FIGS. 105A and 105B, respectively. The microwave coupled line coupler shown in FIG. 98 and the MTM coupler shown in FIG. 101 can be used for the directional coupler 10835 shown in FIG. 108 of this embodiment.

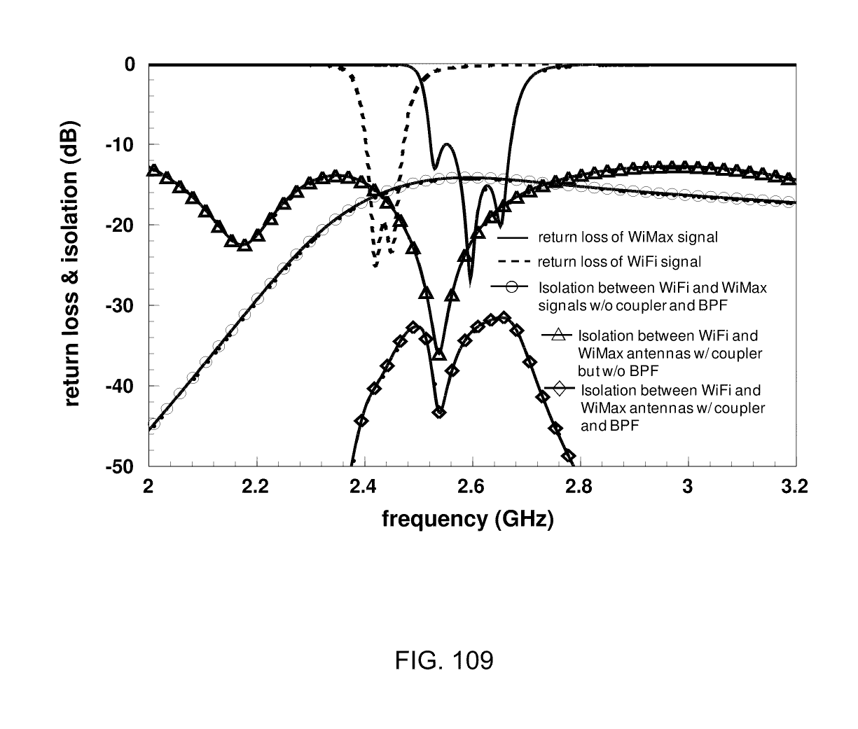

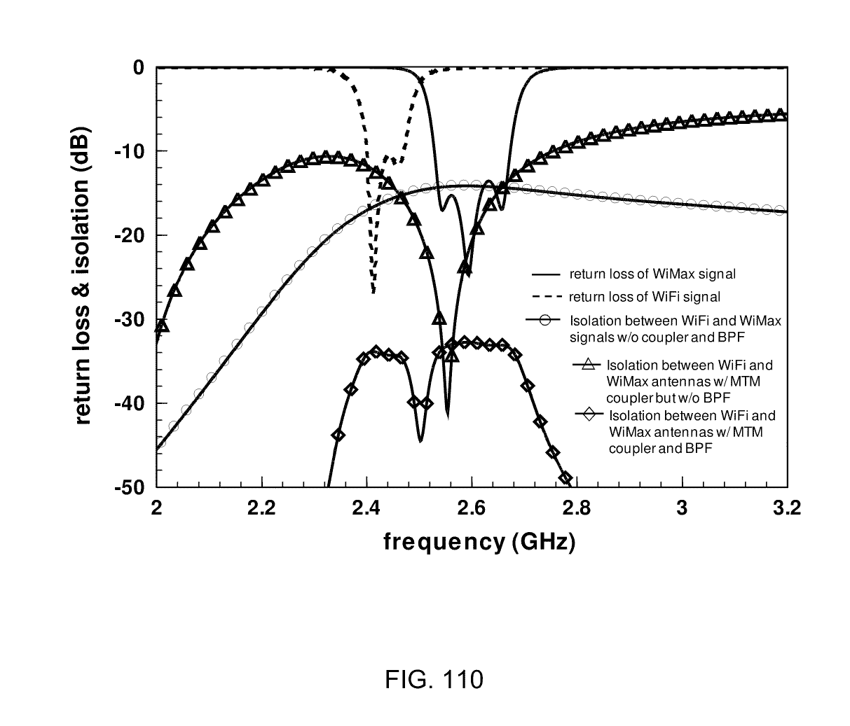

FIG. 109 and FIG. 110 illustrate simulated results of the multi-band multi-antenna system shown in FIG. 108 that combines a microstrip coupled line coupler and a MTM coupler, respectively. Both FIG. 109 and FIG. 110 demonstrate that the isolation between the WiFi antenna and the WiMax antenna can be significantly reduced to less than −30 dB across the frequency range of about 2.4 GHz to 2.7 GHz. Therefore, this improvement may be expected to boost the system performance.

While this document contains many specifics, these should not be construed as limitations on the scope of any invention or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination.

Moreover, although features may be described above are acting in certain combinations and even initially claimed as such, one or more features from a claimed combination can in some cases be exercised from the combination, and the claimed combination may be directed to a subcombination or variation of a subcombination.

Thus, particular implementations have been described. Variations and enhancements of the described implementations, and other implementations can be made based on what is described and illustrated.

What is claimed is:

1. A metamaterial (MTM) multi-antenna array system for decoupling N number of signals between N number of antennas, where N is an integer greater than 1, comprising:
an N-element metamaterial (MTM) antenna array; and
an N-way directional coupler coupled to the N-element metamaterial (MTM) antenna array,
wherein the N-way directional coupler has 2N ports.

2. The metamaterial (MTM) multi-antenna system as in claim 1, wherein the N-way directional coupler comprises a coupled transmission line having N adjacent transmission lines.

3. The metamaterial (MTM) multi-antenna system as in claim 2, wherein the coupled transmission line coupling is controlled by the proximity of the coupled transmission line or LC components between the adjacent transmission lines, or a combination thereof.

4. The metamaterial (MTM) multi-antenna system as in claim 2, wherein the length, width, and spacing between each of the N adjacent transmission line are optimized for decoupling a plurality of coupling signals between adjacent antennas of the N-element MTM antenna array.

5. The metamaterial (MTM) multi-antenna system as in claim 2, wherein the transmission lines are metamaterial (MTM) transmission lines.

6. The metamaterial (MTM) multi-antenna system as in claim 5, wherein each metamaterial (MTM) transmission line comprises a series capacitor, a shunt inductor, and a transmission line section.

7. The metamaterial (MTM) multi-antenna system as in claim 6, wherein the series capacitors, shunt inductors, and coupling capacitors are optimized to decouple a plurality of coupling signals between adjacent antennas of the N-element MTM antenna array.

8. The metamaterial (MTM) multi-antenna system as in claim 1, wherein N=3, the metamaterial (MTM) antenna array comprises three antennas, and the direction coupler is a three-way directional coupler having 6 ports.

9. The metamaterial (MTM) multi-antenna system as in claim 8, wherein the three antennas comprises:
a first antenna having a first configuration;
a second antenna having a second configuration; and
a third antenna having a third configuration;
wherein the first, second, and third antennas operate at substantially the same frequency band.

10. The metamaterial (MTM) multi-antenna system as in claim 9, wherein each of the first, second, and third antennas comprises:
a cell patch formed on a first conductive layer, wherein the first conductive layer is formed on a first side of a substrate;
a launch pad formed on the first conductive layer and electromagnetically coupled to the cell patch, wherein the launch pad is separated from the cell patch by a coupling gap;
a metallic via formed in the first conductive layer and a second conductive layer for providing a conductive path between the first conductive layer and second conductive layer, wherein the via is positioned inside the cell patch and the second conductive layer is formed on an opposing side of the substrate;
an feed line formed on the first conductive layer and coupled to the launch pad;
a first ground formed on the first conductive layer which is coupled to the feed line;
a via pad formed on the second conductive layer, wherein the via pad is coupled to the via;
a via line formed on the second conductive layer, wherein the via line is coupled to the via pad; and
a second ground formed on the second conductive layer, wherein the second ground is coupled to the via line.

11. The metamaterial (MTM) multi-antenna system as in claim 10, wherein the length of the antenna CPW feed line is optimized to satisfy a phase requirement for decoupling a plurality of coupling signals between adjacent antennas of the three-element MTM antenna array.

12. The metamaterial (MTM) multi-antenna system as in claim 9, wherein the three-way directional coupler comprises:
three conductive lines formed on a first conductive layer, wherein the first conductive layer is formed on a first side of a substrate;
a first ground formed on the first conductive layer, wherein the first ground is adjacent and parallel to the conductive lines; and
a second ground formed on a second conductive layer, wherein the second ground is formed on an opposing side of the substrate,
wherein the three conductive lines form a coupled line.

13. The metamaterial (MTM) multi-antenna system as in claim 12, wherein the three conductive lines are arranged in parallel to each other.

14. The metamaterial (MTM) multi-antenna system as in claim 9, wherein the three-way directional coupler comprises:
a first, a second, and third metamaterial (MTM) transmission lines, wherein each of the first, second, and third metamaterial (MTM) transmission lines comprises a transmission line section, a shunt inductor, and a series capacitor;
a first LC Network adjoining the first metamaterial (MTM) transmission line to the second metamaterial (MTM) transmission line; and
a second LC Network adjoining the second metamaterial (MTM) transmission line to the third metamaterial (MTM) transmission line;

15. The metamaterial (MTM) multi-antenna system as in claim 14, wherein the series capacitors, shunt inductors, and coupling capacitors are optimized to decouple a plurality of coupling signals between adjacent antennas of the three-element MTM antenna array.

16. The metamaterial (MTM) multi-antenna system as in claim 14, wherein the width, length, and separation distance of the first, second, and third metamaterial (MTM) transmission lines are optimized to decouple a plurality of coupling signals between adjacent antennas of the three-element MTM antenna array.

17. The metamaterial (MTM) multi-antenna system as in claim 1, wherein N=2, the metamaterial (MTM) antenna array comprises two metamaterial (MTM) antennas, and the direction coupler is a two-way directional coupler having 4 ports.

18. The metamaterial (MTM) multi-antenna system as in claim 17, wherein the two antennas comprises:
a first antenna; and
a second antenna, wherein the first and second antennas operate at substantially the same frequency band.

19. The metamaterial (MTM) multi-antenna system as in claim 18, wherein each of the first and second antennas comprises:
a cell patch formed on a first conductive layer, wherein the first conductive layer is formed on a first side of a substrate;
a launch pad formed on the first conductive layer and electromagnetically coupled to the cell patch, wherein the launch pad is separated from the cell patch by a coupling gap;
a feed line formed on the first conductive layer, wherein one end portion of the feed line is coupled to the launch pad and the other end portion is coupled to the two-way directional coupler;
a metallic via formed in the first conductive layer and a second conductive layer for providing a conductive path between the first conductive layer and second conductive layer, wherein the via is positioned inside the cell patch and the second conductive layer is formed on an opposing side of the substrate;
a via pad formed on the second conductive layer and coupled to the via;
a via line formed on the second conductive layer and coupled to the via pad; and
a ground formed on the second conductive layer and coupled to the ground line.

20. The metamaterial (MTM) multi-antenna system as in claim 17, wherein the two-way directional coupler comprises:
two conductive lines formed on a first conductive layer, wherein the first conductive layer is formed on a first side of a substrate; and
a ground formed on the second conductive layer,
wherein the two conductive lines form a coupled line.

21. The metamaterial (MTM) multi-antenna system as in claim 20, wherein the first and second conductive lines each form a tapered line.

22. The metamaterial (MTM) multi-antenna system as in claim 20, wherein a bend is formed between each feed line and each conductive line.

23. The metamaterial (MTM) multi-antenna system as in claim 20, wherein a bend is formed between each conductive line and coupled line.

24. The metamaterial (MTM) multi-antenna system as in claim 19, wherein the two-way metamaterial (MTM) direction coupler comprises:
a first and second metamaterial (MTM) transmission lines, wherein each of the first and second metamaterial (MTM) transmission lines comprises a transmission line section, a shunt inductor, and a series capacitor; and
an LC Network adjoining the first metamaterial (MTM) transmission line to the second metamaterial (MTM) transmission line.

25. The metamaterial (MTM) multi-antenna system as in claim 18, wherein each of the first and second antennas comprises
a cell patch formed on a first conductive layer, wherein the first conductive layer is formed on a first side of a substrate;
a launch pad formed on the first conductive layer and electromagnetically coupled to the cell patch, wherein the launch pad is separated from the cell patch by a coupling gap;
a metamaterial (MTM) transmission line formed on the first conductive layer, wherein one end portion of the metamaterial (MTM) transmission line is coupled to the launch pad and the other end portion of the metamaterial (MTM) transmission line is coupled to the two-way directional coupler;
a metallic via formed in the first conductive layer and a second conductive layer for providing a conductive path between the first conductive layer and second conductive layer, wherein the via is positioned inside the cell patch and the second conductive layer is formed on an opposing side of the substrate;
a via pad formed on the second conductive layer, wherein the via pad is coupled to the via;
a via line formed on the second conductive layer, wherein the via line is coupled to the via pad; and
a ground formed on the second conductive layer, wherein the ground is coupled to the ground line.

26. The metamaterial (MTM) multi-antenna system as in claim 25, wherein the metamaterial (MTM) transmission line comprises a series capacitor, a shorted stub, and a transmission line section.

27. The metamaterial (MTM) multi-antenna system as in claim 18, wherein each of the first and second antennas comprises:
a cell patch formed on a first conductive layer, wherein the first conductive layer is formed on a first side of a substrate;
an L-shaped launch pad formed on the first conductive layer and electromagnetically coupled to the cell patch, wherein the launch pad is separated from the cell patch by a coupling gap;
a metallic via formed in the first conductive layer and a second conductive layer for providing a conductive path between the first conductive layer and second conductive layer, wherein the via is positioned inside the cell patch and the second conductive layer is formed on an opposing side of the substrate;
a via pad formed on the second conductive layer, wherein the via pad is coupled to the via;
an L-shaped via line formed on the second conductive layer, wherein the L-shaped via line is coupled to the via pad; and
a ground formed on the second conductive layer, wherein the ground is coupled to the L-shaped ground line.

28. The metamaterial (MTM) multi-antenna system as in claim 27, wherein the L-shaped launch pad comprises a rectangular line, two 90° bends and a tapered line.

29. The metamaterial (MTM) multi-antenna system as in claim 27, wherein the two-way directional coupler comprises:
a first and second metamaterial (MTM) transmission lines, wherein each of the first and second metamaterial (MTM) transmission lines comprises a transmission line section, a shorted stub, and a series capacitor; and
an LC Network adjoining the first metamaterial (MTM) transmission line to the second metamaterial (MTM) transmission line.

30. The metamaterial (MTM) multi-antenna system as in claim 29, wherein the shorted stub comprises a stub where one side of the shorted stub is attached directly to a ground.

31. The metamaterial (MTM) multi-antenna system as in claim 1, wherein the metamaterial (MTM) antenna array comprises a plurality input antennas and a plurality of output antennas configured for transmitting and receiving signals at substantially the same time intervals; and
the directional coupler comprises a plurality of input ports and a plurality of output ports in which the input ports communicate a plurality of input port signals and the output ports communicate a plurality of output port signals,
wherein the input port signals are transmitted to the input antennas and the output port signals are received from the output antennas wherein a receive port has an isolation better than 15 dB.

32. The metamaterial (MTM) multi-antenna system as in claim 17, wherein the two antennas are structured to operate at a first frequency and a second frequency, respectively.

33. The metamaterial (MTM) multi-antenna system as in claim 32, wherein the first antenna is configured to receive and transmit a first frequency, f1 and a second, different frequency, f2, each being a frequency different from a harmonic frequency of the other; and
the second antenna is configured to receive and transmit the first frequency, f1 and the second frequency, f2,
wherein the MTM antenna array and the directional coupler are structured to effectuate a strong coupling between two adjacent antennas at both of the first frequency f1 and the second frequency f2.

34. The metamaterial (MTM) multi-antenna system as in claim 33, wherein each of the first and second antennas comprises:
a cell patch formed on a first conductive layer, wherein the first conductive layer is formed on a first side of a substrate;
a launch pad formed on the first conductive layer and electromagnetically coupled to the cell patch, wherein the launch pad is separated from the cell patch by a coupling gap;
a feed line formed on the first conductive layer, wherein one end portion of the feed line is coupled to the launch pad and the other end portion of the feed line is coupled to the two-way directional coupler;
a metallic via formed in the first conductive layer and a second conductive layer for providing a conductive path between the first conductive layer and second conductive layer, wherein the via is positioned inside the cell patch and the second conductive layer is formed on an opposing side of the substrate;
a via pad formed on the second conductive layer and coupled to the via;
a via line formed on the second conductive layer and coupled to the via pad; and
a ground formed on the second conductive layer and coupled to the ground line.

35. The metamaterial (MTM) multi-antenna system as in claim 34, wherein the two-way direction coupler comprises:
two conductive lines formed on a first conductive layer, wherein the first conductive layer is formed on a first side of a substrate; and
a ground formed on the second conductive layer,
wherein the two conductive lines form a coupled line.

36. The metamaterial (MTM) multi-antenna system as in claim 32, wherein the first antenna is configured to receive and transmit a first frequency, f1 and a second higher frequency, f2; and
the second antenna is configured to receive and transmit the first frequency, f1 and the second frequency, f2,
wherein the MTM antenna array and the directional coupler are structured to effectuate a strong coupling between two adjacent antennas at the first frequency f1 and a weak coupling at the second frequency f2.

37. The metamaterial (MTM) multi-antenna system as in claim 36, wherein each of the first and second antennas comprises:
a cell patch formed on a first conductive layer, wherein the first conductive layer is formed on a first side of a substrate;
a launch pad formed on the first conductive layer and electromagnetically coupled to the cell patch, wherein the launch pad is separated from the cell patch by a coupling gap;
a feed line formed on the first conductive layer, wherein one end portion of the feed line is coupled to the launch pad and the other end portion of the CPW feed line is coupled to the two-way directional coupler;
a metallic via formed in the first conductive layer and a second conductive layer for providing a conductive path between the first conductive layer and second conductive layer, wherein the via is positioned inside the cell patch and the second conductive layer is formed on an opposing side of the substrate;
a via pad formed on the second conductive layer, wherein the via pad is coupled to the via;
a via line formed on the second conductive layer, wherein the via line is coupled to the via pad; and
a main ground formed on the second conductive layer, wherein the main ground is coupled to the ground line.

38. The metamaterial (MTM) multi-antenna system as in claim 37, wherein the two-way direction coupler comprises two conductive lines formed on a first conductive layer, wherein the first conductive layer is formed on a first side of a substrate; and
a ground formed on the second conductive layer,
wherein the two conductive lines form a coupled line.

39. The metamaterial (MTM) multi-antenna system as in claim 32, wherein the first antenna is configured to receive and transmit a first frequency, f1 and second frequency, f2; and
the second antenna is configured to receive and transmit the first frequency, f1 and the second frequency, f2,
wherein, f2 is not equal to 2 times f1, f2 is greater f1, and f1 has a strong coupling occurs at frequency, f1, and a weak coupling occurs at a frequency, f2.

40. The metamaterial (MTM) multi-antenna system as in claim 39, wherein each of the first and second antennas comprises:
a cell patch formed on a first conductive layer, wherein the first conductive layer is formed on a first side of a substrate;
a launch pad formed on the first conductive layer and electromagnetically coupled to the cell patch, wherein the launch pad is separated from the cell patch by a coupling gap;
a feed line formed on the first conductive layer, wherein one end portion of the feed line is coupled to the launch pad and the other end portion of the feed line is coupled to the two-way directional coupler;
a metallic via formed in the first conductive layer and a second conductive layer for providing a conductive path between the first conductive layer and second conductive layer, wherein the via is positioned inside the cell patch and the second conductive layer is formed on an opposing side of the substrate;
a via pad formed on the second conductive layer, wherein the via pad is coupled to the via;
a via line formed on the second conductive layer, wherein the via line is coupled to the via pad; and
a main ground formed on the second conductive layer, wherein the main ground is coupled to the ground line.

41. The metamaterial (MTM) multi-antenna system as in claim 40, wherein the two-way direction coupler comprises a first and second metamaterial (MTM) transmission lines, wherein each of the first and second metamaterial (MTM) transmission lines comprises a transmission line section, a shunt inductor, and a series capacitor; and
an LC Network adjoining the first metamaterial (MTM) transmission line to the second metamaterial (MTM) transmission line.

42. The metamaterial (MTM) multi-antenna system as in claim 39, wherein the first antenna comprises
a first cell patch formed on a first conductive layer, wherein the first conductive layer is formed on a first side of a first substrate;
a first launch pad formed on the first conductive layer and electromagnetically coupled to the first cell patch, wherein the first launch pad is separated from the first cell patch by a coupling gap;
a first feed line formed on the first conductive layer, wherein one end portion of the first feed line is coupled to the first launch pad and the other end portion of the first feed line is coupled to the two-way directional coupler;
a first metallic via formed in the first conductive layer and a second conductive layer for providing a conductive path between the first conductive layer and second conductive layer, wherein the first via is positioned inside the first cell patch and the second conductive layer is formed on a first side of a second substrate;
a first via pad formed on the second conductive layer, wherein the first via pad is coupled to the first via;
a first via line formed on the second conductive layer, wherein the first via line is coupled to the first via pad; and
a first ground formed on the second conductive layer, wherein the first ground is coupled to the first ground line;
and, wherein the second antenna comprises:
a second cell patch formed on the second conductive layer;
a second launch pad formed on the second conductive layer and electromagnetically coupled to the second cell patch, wherein the second launch pad is separated from the second cell patch by a coupling gap;
a second feed line formed on the second conductive layer, wherein one end portion of the second feed line is coupled to the second launch pad and the other end portion of the second feed line is coupled to the two-way directional coupler;
a second metallic via formed in the second conductive layer and the first conductive layer for providing a conductive path between the first conductive layer and second conductive layer, wherein the second via is positioned inside the second cell patch;
a second via pad formed on the first conductive layer, wherein the second via pad is coupled to the second via;
a second via line formed on the first conductive layer, wherein the second via line is coupled to the second via pad; and
a second ground formed on the first conductive layer, wherein the second ground is coupled to the second ground line;

43. The metamaterial (MTM) multi-antenna system as in claim 42, wherein the two-way direction coupler comprises a vertical directional coupler.

44. The metamaterial (MTM) multi-antenna system as in claim 43, wherein the vertical directional coupler comprises four 50Ω feed lines, four via pads and one coupled strip line.

45. The metamaterial (MTM) multi-antenna system as in claim 42, wherein the two-way direction coupler comprises a forward wave metamaterial (MTM) directional coupler.

46. The metamaterial (MTM) multi-antenna system as in claim 32, wherein the first antenna is configured to receive and transmit a first frequency;
the second antenna is configured to receive and transmit a second frequency; and
the directional coupler comprises a first port configured to communicate a first signal from the first antenna, a second port configured to communicate a second signal from the second antenna, a third port coupled to the first antenna which is resonant at the first frequency, and a fourth port coupled to the second antenna which is resonant at the second frequency.

47. The metamaterial (MTM) multi-antenna system as in claim 46, wherein
the directional coupler is a microwave directional coupler.

48. The metamaterial (MTM) multi-antenna system as in claim 46, wherein the directional coupler is a metamaterial (MTM) directional coupler.

49. The metamaterial (MTM) multi-antenna system as in claim 32 further comprises:
a first bandpass filter configured to receive and transmit a first signal; and
a second bandpass filter configured to receive and transmit a second signal,
wherein the directional coupler comprises
a first port coupled to the first bandpass filter in which the first port is configured to receive and transmit the first signal from the first bandpass filter;
a second port coupled to the second bandpass filter in which the second port is configured to receive and transmit the second signal from the second bandpass filter;
a third port coupled to the first antenna which is resonant at the first frequency; and
a fourth port coupled to the second antenna which is resonant at the second frequency,
wherein the first antenna is configured to receive and transmit a first frequency, and the second antenna is configured to receive and transmit a second frequency.

50. The metamaterial (MTM) multi-antenna system as in claim 49, wherein
the directional coupler is a microwave directional coupler.

51. The metamaterial (MTM) multi-antenna system as in claim 49, wherein
the directional coupler is a metamaterial (MTM) directional coupler.

52. A metamaterial (MTM) multi-antenna array system, comprising:
two or more MTM antennas spaced from one another, each MTM antenna comprising at least one unit cell comprising a series inductor, a shunt capacitor, a shunt inductor, and a series capacitor that are structured to form a composite right and left handed (CRLH) MTM structure; and
an MTM directional coupler comprising MTM transmission lines that are coupled to the MTM antennas, each MTM transmission line transmitting a signal to or receiving a signal from a respective MTM antenna,
wherein each MTM transmission line comprises a transmission line section, a shunt inductor, and a series capacitor that are structured to form a CRLH MTM structure and that are configured relative to an adjacent MTM transmission line coupled to an adjacent MTM antenna to reduce coupling between adjacent MTM antennas.

53. The system as in claim 52, wherein each MTM antenna is structured to exhibit two different resonance frequencies, each being a frequency different from a harmonic frequency of the other.

54. The system as in claim 53, wherein the MTM antennas and the MTM directional coupler are structured to produce strong coupling between two adjacent MTM antennas at both of the two different resonance frequencies.

55. The system as in claim 54, wherein the MTM antennas and the MTM directional coupler are structured to produce a strong coupling between two adjacent MTM antennas at one of the two different resonance frequencies and a weak coupling between the two adjacent MTM antennas at another one of the two different resonance frequencies.

56. The system as in claim 52, comprises a signal filter coupled to an MTM transmission line of the MTM directional coupler to transmit a selective frequency while blocking other frequencies.
